(19) United States
(12) Patent Application Publication
(10) Pub. No.: US 2010/0141126 A1
(43) Pub. Date: Jun. 10, 2010

(54) ORGANIC ELECTROLUMINESCENT ELEMENT, DISPLAY AND ILLUMINATING DEVICE

(75) Inventors: Shinya Otsu, Tokyo (JP); Masato Nishizeki, Tokyo (JP); Eisaku Katoh, Tokyo (JP); Tomohiro Oshiyama, Tokyo (JP); Dai Ikemizu, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA HOLDINGS, INC., Tokyo (JP)

(21) Appl. No.: 12/598,965

(22) PCT Filed: May 15, 2008
(86) PCT No.: PCT/JP2008/058938

§ 371 Date: Nov. 5, 2009

(30) Foreign Application Priority Data
May 16, 2007 (JP) 2007-130329
Oct. 31, 2007 (JP) 2007-283246

(51) Int. Cl. H05B 33/02

(52) U.S. Cl. 313/504

(57) ABSTRACT

The present invention provides an organic electroluminescent element emitting a short wavelength light and having high emission efficiency and high storage stability, and a display and an illuminating device each employing the organic electroluminescent element.

### FIELD OF THE INVENTION

This invention relates to an organic electroluminescent element, a display and an illuminating device.

### TECHNICAL BACKGROUND

As an emission type electronic displaying device, there is an electroluminescent display (hereinafter referred to as ELD). As devices constituting the ELD, there are mentioned an inorganic electroluminescent element and an organic electroluminescent element (hereinafter referred to as organic EL element).

The inorganic electroluminescent element has been used for a plane-shaped light source, but a high voltage alternating current has been required to drive the element.

An organic EL element has a structure in which a light emission layer containing a light emission compound is arranged between a cathode and an anode, and an electron and a hole are injected into the light emission layer and recombined to form an exciton. The element emits light, utilizing light (fluorescent light or phosphorescent light) generated by inactivation of the exciton, and the element can emit light by applying a relatively low voltage of from several volts to several decade volts. The element has a wide viewing angle and a high visuality since the element is of self light emission type. Further, the element is a thin, complete solid device, and therefore, the element is noted from the viewpoint of space saving and portability.

However, development of an organic EL element for practical use is required which efficiently emits light with high luminance at a lower power.

High emission luminance and long lifetime is attained in Japanese Patent No. 3093796 by doping a slight amount of a fluorescent compound in stilbene derivatives, distyrylarylene derivatives or tristyrylarylene derivatives.

An element is known which comprises an organic light emission layer containing an 8-hydroxyquinoline aluminum complex as a host compound doped with a slight amount of a fluorescent compound (see, for example, Japanese Patent O.P.I. Publication No. 63-264692), and an element is known which comprises an organic light emission layer containing an 8-hydroxyquinoline aluminum complex as a host compound doped with a quinacridone type dye (see for example, Japanese Patent O.P.I. Publication No. 3-255190).

When light emitted through excited singlet state is used as in the above, the upper limit of the external quantum efficiency (next) is considered to be at most 5%, as the generation ratio of singlet excited species to triplet excited species is 1:3, that is, the generation probability of excited species capable of emitting light is 25%, and further, external light emission efficiency is 20%.

Since an organic EL element, employing phosphorescence through the excitation triplet, was reported by Prinston University (see M. A. Baldo et al., Nature, 395, p. 151-154 (1998)), study on materials emitting phosphorescence at room temperature has been actively made.

For example, such an organic EL element is disclosed in M. A. Baldo et al., Nature, 403, 17, p. 750-753 (2000) or U.S. Pat. No. 6,097,147.

As the upper limit of the internal quantum efficiency of the excitation triplet is 100%, the light emission efficiency of the excitation triplet is theoretically four times that of the excited singlet. Such an organic EL element has possibility that exhibits the same performance as a cold cathode tube, and its application to illumination is watched.

Many compounds, mainly heavy metal complexes such as iridium complexes are synthesized and studied in for example, S. Lamansky et al., J. Am. Chem. Soc., 123, 4304 (2001).

An example employing tris(2-phenylpyridine)iridium as a dopant is studied in M. A. Baldo et al., Nature, 403, 17, p. 750-753 (2000) above.

Further, M. E. Tompson et. al. studies an example employing as a dopant L₂Ir (acac) such as (ppy)₂Ir (acac) in The 10^{th} International Workshop on Inorganic and Organic Electroluminescence (EL' 00, Hamamatsu), and Moon-Jae Youn. Og, Tetsuo Tsutsui et. al. an example employing as a dopant tris(2-p-tolylpyridine)iridium {Ir(ptpy)₃} or tris(benzo-[h]-quinoline)iridium {Ir(bzq)₃} in The 10^{th} International Workshop on Inorganic and Organic Electroluminescence (EL' 00, Hamamatsu). (These metal complexes are generally called orthometalated iridium complexes.)

Attempt for preparing an element employing various iridium complexes is made in S. Lamansky et al., J. Am. Chem. Soc., 123, 4304 (2001) or in Japanese Patent O.P.I. Publication No. 2001-247859.

Further, to obtain high emission efficiency, Ikai et al. utilized a hole transporting compound as a host of a phosphorescent compound at The 10th International Workshops on Inorganic and Organic Electroluminescence (EL'00, Hamamatsu). Further, M. E. Tompson et al. utilized various types of electron transporting materials doped with a new iridium complex as a host of a phosphorescent compound.

Orthometalated complexes in which iridium as a center metal is replaced with platinum are also watched. Regarding these complexes, there are known many kinds of complexes having characteristics in the ligands.

Light emission elements employing the above compounds exhibit greatly improved emission luminance and emission efficiency as compared to conventional elements, because the light emission arises from phosphorescence, however, they have a problem in that the emission lifetime is low as compared to conventional elements.

The phosphorescent emission material with high efficiency is difficult to shorten the wavelength of emission light and improve emission lifetime of the element, and does not achieve a level of a practical use at the present.

As a method for shortening the wavelength of emission light, heretofore, there has been known introduction into phenylpyridine of an electron attracting group as a substituent, for example, a fluorine atom, a trifluoromethyl group or a cyano group; or of picolinic acid as a ligand or a pyrazabole type ligand.

The ligand can shorten the wavelength of emission light of a light emission material to emit a blue color light and provide an element with high efficiency, however, while emission lifetime of the element will be greatly deteriorated. An improvement to overcome the trade-off relationship is required.

There is disclosure that a metal complex having phenylpyrazole as a ligand is a light emission material emitting a short wavelength light (see for example, Patent documents 1 and 2). A metal complex is disclosed which is composed of a ligand having a partial structure in which the 5-member ring of phenylpyrazole is condensed with a 6-member ring (see for example, Patent documents 3 and 4).

Recently, it is reported that complexes having as a ligand a condensed ring aromatic compound with 18 π electrons are useful for a blue light emission material (see US Patent No. 2007/0190359). These complexes are relatively stable but further improvement in emission efficiency and storage stability is necessary.

Patent document 1: WO 2004/085450
Patent document 2: Japanese Patent O.P.I. Publication No. 2005/53912
Patent document 3: Japanese Patent O.P.I. Publication No. 2006/28101
Patent document 4: U.S. Pat. No. 7,147,937

### DISCLOSURE OF THE INVENTION

### Problems to be Solved by the Invention

The present invention has been made in view of the above. An object of the invention is to provide an organic electroluminescent element emitting a short wavelength light and having high emission efficiency and high storage stability, and a display and an illuminating device each employing the organic electroluminescent element.

### Means for Solving the Above Problems

The present invention has been attained by the following constitutions.

1. An organic electroluminescent element comprising an anode, a cathode and at least a light emission layer provided between the anode and the cathode, wherein the light emission layer contains a host compound having a glass transition temperature of not less than 110° C. and a phosphorescence emitting metal complex having as a ligand a 6-member aromatic compound condensed with three or more of a 5- or 6-member aromatic ring.

2. The organic electroluminescent element of item 1 above, wherein the phosphorescence emitting metal complex has a partial structure represented by any of formulae (1) through (4) below.

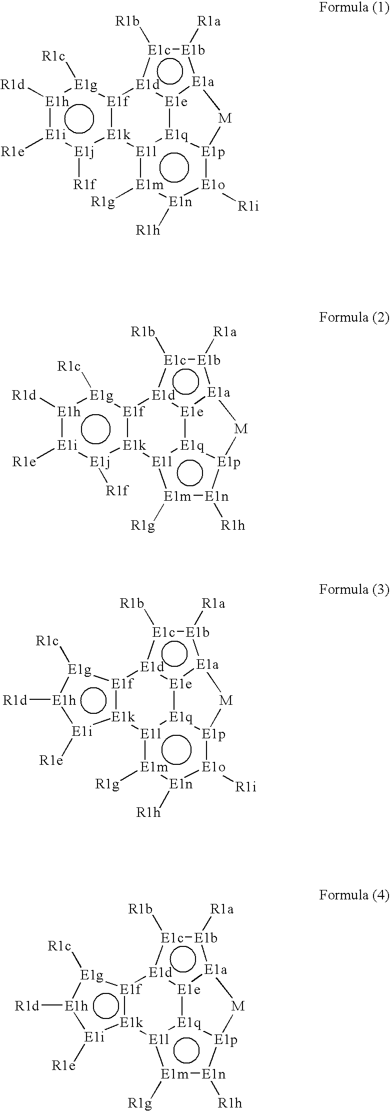

wherein E1a through E1q independently represent a carbon atom or a nitrogen atom; R1a through R1i independently represent a hydrogen atom or a substituent; and M represents a transition metal element belonging to groups 8 to 10 on the periodic table.

3. The organic electroluminescent element of item 1 or 2 above, wherein the host compound has in one molecule at least three of a partial structure represented by the following formula (a),

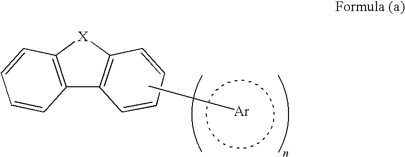

wherein X represents NR′, O, S, CR′R″ or SiR′R″, in which R′ and R″ independently represent a hydrogen atom or a substituent; Ar represents an atomic group necessary to form an aromatic ring; and n represents an integer of from 0 to 8.

4. The organic electroluminescent element of any one of items 1 through 3 above, wherein the lowest excitation triplet energy of the host compound is not less than 2.75 eV.

5. The organic electroluminescent element of any one of items 1 through 4 above, wherein the highest occupied molecular orbital (HOMO) energy level of the host compound is not less than −5.6 eV.

6. The organic electroluminescent element of any one of items 1 through 5 above, wherein the lowest unoccupied molecular orbital (LUMO) energy level of the host compound is not less than −1.45 eV.

7. The organic electroluminescent element of any one of items 1 through 6 above, wherein M represents platinum or iridium.

8. The organic electroluminescent element of any one of items 1 through 7 above, wherein the light emission layer is formed employing a wet process.

9. A display comprising the organic electroluminescent element of any one of items 1 through 8 above.

### EFFECTS OF THE INVENTION

The invention can provide an organic electroluminescent element emitting a specifically short wavelength light and having high emission efficiency and long emission lifetime, and a display and an illuminating device each employing the organic electroluminescent element.

Further, the invention can provide an organic electroluminescent element material useful for an organic electroluminescent element.

### BRIEF EXPLANATION OF THE DRAWINGS

FIG. 1 shows a schematic drawing of one example of a display comprising an organic EL element.

FIG. 2 is a schematic drawing of a display section.

FIG. 3 is a schematic drawing of an illuminating device.

FIG. 4 is a sectional view of an illuminating device.

### EXPLANATION OF SYMBOLS

1. Display
3. Pixel
5. Scanning line
6. Data line
A. Display section.
B. Control section
101. Organic EL element
107. Glass substrate with a transparent electrode
106. Organic EL layer
105. Cathode
102. Glass cover
108. Nitrogen gas
109. Water trapping agent

### PREFERRED EMBODIMENT OF THE INVENTION

The invention can provide an organic electroluminescent element having high emission efficiency, long emission lifetime and high storage stability by the constitution of any of items 1 through 8 described above, and provide a display and an illuminating device each employing the organic electroluminescent element.

The present inventors have made a study on organic EL element materials used in an organic electroluminescent element, particularly on a metal complex compound used as a emission dopant and a host compound.

As a result, it has been found that a metal complex having as a ligand an aromatic compound having a structure analogous to triphenylene and having 18 it electrons emits light with a relatively short wavelength, and is comparatively stable in excited state.

However, these compounds have problem that in an element employing them, emission efficiency is low and luminance after long-term storage lowers.

The present inventors have an extensive study. As a result, they have solved the above problems by a combined use of a host compound having a glass transition temperature of not less than 110° C. and a phosphorescence emitting metal complex having as a ligand a 6-member aromatic compound condensed with three or more of a 5- or 6-member aromatic ring, and completed the invention.

The reason that the organic electroluminescent element of the invention improves emission efficiency and long-term storage stability is not clear, but it is assumed that planarity of a ligand of the phosphorescence emission metal complex (hereinafter also referred to as emission dopant) in the invention is extremely high, and therefore, an interaction between the dopant molecule and the surrounding molecules is extremely high.

It is assumed that when an interaction between a dopant and a host is weak, aggregates are likely to be produced by interaction among the dopants, resulting in lowering of emission efficiency, while when an interaction between a dopant and a host is strong, a glass transition temperature of the host lowers and storage stability of a light emission layer lowers, resulting in lowering of a long-term storage stability.

It is assumed that the host molecule having a high glass transition temperature has a site easily interacting with a dopant ligand with high planarity, and prevents aggregation of the dopants and further enhances storage stability of the light emission layer.

Each of the constituents in the invention will be explained in detail below. <<Phosphorescence Emitting Metal Complex>>

The phosphorescence emitting metal complex in the invention will be explained below.

The phosphorescence emitting metal complex in the invention has as a ligand an aromatic compound condensed with three or more of a 5- or 6-member aromatic ring.

(Aromatic Compound Condensed with Three or More of a 5- or 6-Member Aromatic Ring)

Typical examples of the aromatic compound condensed with three or more of a 5- or 6-member aromatic ring include those in which a ring such as a benzene ring, a pyridine ring, a pyridazine ring, a pyrimidine ring, a pyrazine ring, an s-triazine ring or an as-triazine ring is condensed with three or more of a 5- or 6-member aromatic ring.

Among these, an aromatic compound is preferred which comprises a pyridine ring or a benzene ring as a ring to be condensed. The 5- or 6-member aromatic ring to condense is not specifically limited. Typical examples of the 5-member ring include a pyrrole ring, a furan ring, a thiophene ring, an imidazole ring, a pyrazole ring, an oxazole ring, a thiazole ring, an isoxazole ring, an isothiazole ring and a triazole ring. Among these, an imidazole ring or a pyrazole ring is preferred.

Typical examples of the 6-member ring include a benzene ring, a pyridine ring, a pyridazine ring, a pyrimidine ring, a pyrazine ring, an s-triazine ring or an as-triazine ring. Among these, a benzene ring and a pyridine ring is preferred.

### (Transition Metal Element Belonging to Groups 8 to 10 on the Periodic Table)

The metal atom constituting the phosphorescence emitting metal complex in the invention is preferably a transition metal element belonging to groups 8 to 10 on the periodic table in view of light emission properties, and more preferably iridium or platinum.

In the partial structure represented by any of formulae (1) through (4) above, the transition metal element represented by M corresponds to the metal atom described above.

### <<Partial Structure Represented by any of Formulae (1) Through (4)>>

In the invention, the phosphorescence emitting metal complex having as a ligand a 6-member aromatic compound condensed with three or more of a 5- or 6-member aromatic ring is preferably a compound (hereinafter also referred to as a metal complex or a metal complex compound) having a partial structure represented by any of formulae (1) through (4) above.

Next, the partial structure represented by any of formulae (1) through (4) will be explained.

### (Molecular Skeleton Having 18 π Electrons)

In the partial structure represented by any of formulae (1) through (4) in the invention, the skeleton formed from E1a through E1q has 18 π electrons in total.

In the partial structure represented by any of formulae (1) through (4), a ring formed from E1a through E1e represents a 5-member aromatic heterocyclic ring. Examples of the 5-member aromatic heterocyclic ring include an oxazole ring, a thiazole ring, an oxadiazole ring, an oxatriazole ring, an isoxazole ring, a tetrazole ring, a thiadiazole ring, a thiatriazole ring, an isothiazole ring, a thiophene ring, a furan ring, a pyrrole ring, an imidazole ring, a pyrazole ring, and a triazole ring.

Among these, a pyrazole ring, an imidazole ring, an oxazole ring or a thiazole is preferred. The rings described above may further have a substituent described later.

In the partial structure represented by any of formulae (1) through (4), a ring formed from E1l through E1q represents a 6-member aromatic hydrocarbon ring or a 5- or 6-member aromatic heterocyclic ring.

Examples of the 6-member aromatic hydrocarbon ring formed from E1l through E1q include a benzene ring, which may have a substituent described later.

Examples of the 5- or 6-member aromatic heterocyclic ring formed from E1l through E1q include a furan ring, a thiophene ring, an oxazole ring, a pyrrole ring, a pyridine ring, a pyridazine ring, a pyrimidine ring, a pyrazine ring, a triazine ring, an oxadiazole ring, a triazole ring, an imidazole ring, a pyrazole ring and a triazole ring.

Each of these rings may further have a substituent described later.

In the partial structure represented by any of formulae (1) through (4), a ring formed from E1f through E1k represents a 6-member aromatic hydrocarbon ring or a 5- or 6-member aromatic heterocyclic ring. Examples of the 6-member aromatic hydrocarbon ring or the 5- or 6-member aromatic heterocyclic ring are the same as those denoted above in the 6-member aromatic hydrocarbon ring or the 5- or 6-member aromatic heterocyclic ring formed from E1l through E1q in the partial structure represented by any of formulae (1) through (4).

Examples of the substituent represented by R1a through R1i in the partial structure represented by any of formulae (1) through (4) include an alkyl group (for example, a methyl group, an ethyl group, a propyl group, an isopropyl group, a tert-butyl group, a pentyl group, a hexyl group, an octyl group, a dodecyl group, a tridecyl group, a tetradecyl group, or a pentadecyl group); an cycloalkyl group (for example, a cyclopentyl group or a cyclohexyl group); an alkenyl group (for example, a vinyl group or a allyl group); an alkynyl group (for example, an ethynyl group or a propargyl group); an aromatic hydrocarbon group (also referred to as aromatic carbon ring group or aryl group, for example, a phenyl group, a p-chlorophenyl group, a mesityl group, a tolyl group, a xylyl group, a naphthyl group, an anthryl group, an azulenyl group, an acenaphthenyl group, a fluorenyl group, a phenanthryl group, an indenyl group, a pyrenyl group, or a biphenyl group); an aromatic heterocyclic group (for example, a pyridyl group, a pyrimidinyl group, a furyl group, a pyrrolyl group, an imidazolyl group, a benzimidazolyl group, a pyrazolyl group, a pyrazinyl group, a triazolyl group (foe example, a 1,2,4-triazole-1-yl group or a 1,2,3-triazole-1-yl group), an oxazolyl group, a benzoxazolyl group, a thiazolyl group, an isooxazolyl group, an isothiazolyl group, a furazanyl group, a thienyl group, a quinolyl group, a benzofuryl group, a dibenzofuryl group, a benzothienyl group, a dibenzothienyl group, an indolyl group, a carbazolyl group, a carbolinyl group, a diazacarbazolyl group (in which one of the carbon atoms constituting the carboline ring of the carbolinyl group is substituted with a nitrogen atom), a quinoxalinyl group, a pyridazinyl group, a triazinyl group, a quinazolinyl group or a phthalazinyl group); a heterocyclic group (for example, a pyrrolidyl group, an imidazolidyl group, a morpholyl group or an oxazolidyl group); an alkoxy group (for example, a methoxy group, an ethoxy group, a propyloxy group, a pentyloxy group, a hexyloxy group, an octyloxy group, or a dodecyloxy group); a cycloalkoxy group (for example, a cyclopentyloxy group or a cyclohexyloxy group), an aryloxy group (for example, a phenoxy group or a naphthyloxy group), an alkylthio group (for example, a methylthio group, an ethylthio group, a propylthio group, a pentylthio group, a hexylthio group, an octylthio group, or a dodecylthio group); a cycloalkylthio group (for example, a cyclopentylthio group or a cyclohexylthio group), an arylthio group (for example, a phenylthio group or a naphthylthio group); an alkoxycarbonyl group (for example, a methyloxycarbonyl group, an ethyloxycarbonyl group, a butyloxycarbonyl group, an octyloxycarbonyl group, or a dodecyloxycarbonyl group); an aryloxycarbonyl group (for example, a phenyloxycarbonyl group or a naphthyloxycarbonyl group), a sulfamoyl group (for example, an aminosulfonyl group, a methylaminosulfonyl group, a dimethylaminosulfonyl group, a butylaminosulfonyl group, a hexylaminosulfonyl group, a cyclohexylaminosulfonyl group, an octylaminosulfonyl group, a dodecylaminosulfonyl group, a phenylaminosulfonyl group, a naphthylaminosulfonyl group, or a 2-pyridylaminosulfonyl group); an acyl group (for example, an acetyl group, an ethylcarbonyl group, a propylcarbonyl group, a pentylcarbonyl group, a cyclohexylcarbonyl group, an octylcarbonyl group, a 2-ethylhexylcarbonyl group, a dodecylcarbonyl group, a phenylcarbonyl group, a naphthylcarbonyl group, or a pyridylcarbonyl group); an acyloxy group (for example, an acetyloxy group, an ethylcarbonyloxy group, a butylcarbonyloxy group, an octylcarbonyloxy group, a dodecylcarbonyloxy group, or a phenylcarbonyloxy group), an amido group (for example, a methylcarbonylamino group, an ethylcarbonylamino group, a dimethylcarbonylamino group, a propylcarbonylamino group, a pentylcarbonylamino group, a cyclohexylcarbonylamino group, a 2-ethylhexylcarbonylamino group, an octylcarbonylamino group, a dodecylcarbonylamino group, a phenylcarbonylamino group, or a naphthylcarbonylamino group); a carbamoyl group (for example, an aminocarbonyl group, a methylaminocarbonyl group, a dimethylaminocarbonyl group, a propylaminocarbonyl group, a pentylaminocarbonyl group, a cyclohexylaminocarbonyl group, an octylaminocarbonyl group, a 2-ethylhexylaminocarbonyl group, a dodecylaminocarbonyl group, a phenylaminocarbonyl group, a naphthylaminocarbonyl group, or a 2-puridylaminocarbonyl group); a ureido group (for example, a methylureido group, an ethylureido group, a pentylureido group, a cyclohexylureido group, an octylureido group, a dodecylureido group, a phenylureido group, a naphthylureido group, or a 2-pyridylaminoureido group); a sulfinyl group (for example, a methylsulfinyl group, an ethylsulfinyl group, a butylsulfonyl group, a cyclohexylsulfinyl group, a 2-ethylhexylsulfinyl group, a dodecylsulfinyl group, a phenylsulfonyl group, a naphthylsulfinyl group, or a 2-pyridylsulfinyl group); an alkylsulfonyl group (for example, a methylsulfonyl group or an ethylsulfonyl group, a butylsulfonyl group, a cyclohexylsulfonyl group, a 2-ethylhexylsulfonyl group, or a dodecyl sulfonyl group); an arylsulfonyl group (for example, a phenylsulfonyl group, a naphthylsulfonyl group, or a 2-pyridylsulfonyl group); an amino group (for example, an amino group, an ethylamino group, a dimethylamino group, a butylamino group, a cyclopentylamino group, a 2-ethylhexylamino group, a dodecylamino group, an anilino group, a naphthylamino group, or a 2-pyridylamino group); a halogen atom (for example, a fluorine atom, a chlorine atom or a bromine atom); a fluorinated hydrocarbon group (for example, a fluoromethyl group, a trifluoromethyl group, a pentafluoroethyl group or a fluorophenyl group); a cyano group; an nitro group; a hydroxyl group, a mercapto group; and a silyl group (for example, a trimethylsilyl group, a triisopropylsilyl group, a triphenylsilyl group, or a phenyldiethylsilyl group).

These substituents may further have the substituent described above. A plurality of these substituents may combine with each other to form a ring.

In the invention, the partial structure represented by any of formulae (1) through (4) is preferably a partial structure represented by any of formulae (5) through (8) below.

### <<Partial Structure Represented by any of Formulae (5) Through (8)>>

The partial structure represented by any of formulae (5) through (8) will be explained below.

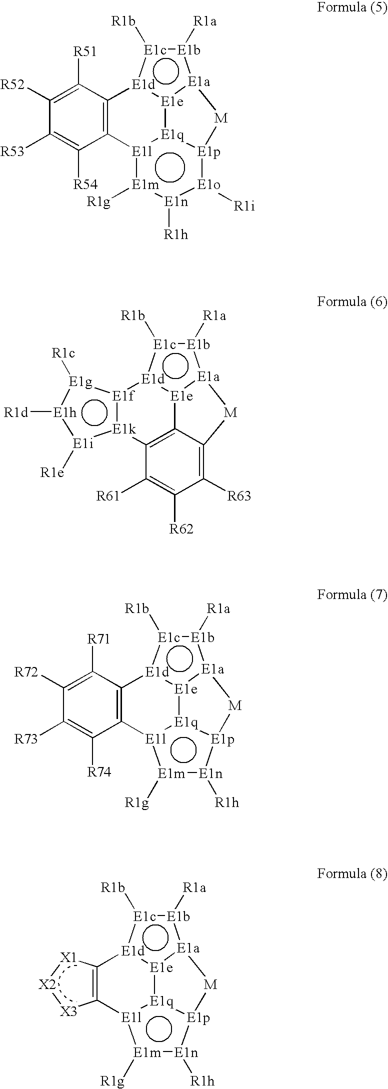

In formulae above, E1a through E1q represent a carbon atom, a nitrogen atom, an oxygen atom or a sulfur atom; the ring formed from E1a through E1e represents a 5-member aromatic heterocyclic ring; the ring formed from E1l through E1p represents a 6-member aromatic hydrocarbon ring or a 5- or 6-member aromatic heterocyclic ring, provided that E1a and E1p are different and represent a carbon atom or a nitrogen atom; R1a through R1i, R51 through R54, and R71 through R74 independently represent a hydrogen atom or a substituent, provided that at least one of these represents a group represented by formula (A) or (B) described later; M represents a transition metal element belonging to groups 8 to 10 on the periodic table; and X1, X2 and X3 independently represent a carbon atom or a nitrogen atom.

The 5-member aromatic heterocyclic ring formed from E1a through E1e in the partial structure represented by any of formulae (5) through (8) is the same as those denoted above in the 5-member aromatic heterocyclic ring formed from E1a through E1e in the partial structure represented by any of formulae (1) through (4).

The 6-member aromatic hydrocarbon ring formed from E1l through E1p in the partial structure represented by any of formulae (5) through (8) is the same as those denoted above in the 6-member aromatic hydrocarbon ring formed from E1l through E1p in the partial structure represented by any of formulae (1) through (4).

The 5- or 6-member aromatic heterocyclic ring formed from E1l through E1p in the partial structure represented by any of formulae (5) through (8) is the same as those denoted above in the 5- or 6-member aromatic heterocyclic ring formed from E1l through E1p in the partial structure represented by any of formulae (1) through (4).

The 5-member aromatic heterocyclic ring formed from E1f through E1k in the partial structure represented by any of formulae (5) through (8) is the same as those denoted above in the 5-member aromatic heterocyclic ring formed from E1a through E1e in the partial structure represented by any of formulae (1) through (4).

The substituent represented by R1a through R1i, R51 through R54, and R71 through R74 in the partial structure represented by any of formulae (5) through (8) is the same as those denoted above in the substituent represented by R1a through R1i in the partial structure represented by any of formulae (1) through (4). At least one of the substituents is preferably a group represented by formula (A) or (B) below.

### (Group Represented by Formula (A) or (B))

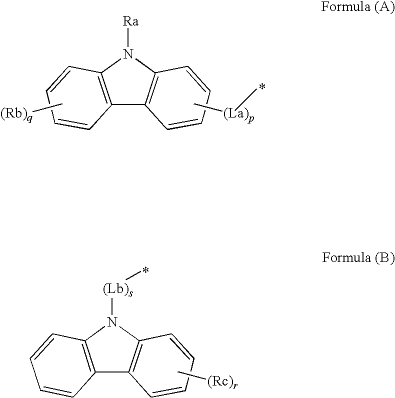

In formula above, Ra, Rb and Re independently represent a hydrogen atom or a substituent; La and Lb represent a divalent linkage group; p and s represent an integer of from 0 or 1; q represents an integer of from 0 to 7; r represents an integer of from 0 to 8; and * represents a linkage site.

It is preferred that in the partial structure represented by any of formulae (5) through (8), the group represented by formula (A) or (B) is linked to a ring formed from E1a through E1e, to a ring formed from E1l through E1q, to at least one of R51 through R54, at least one of R71 through R74 or a ring formed from E1f through E1k, or to a ring formed from X1, X2, X3 and —C═C—.

In the invention, the partial structure represented by any of formulae (5) through (8) is preferably a partial structure represented by any of formulae (9) through (12) below.

### <<Partial Structure Represented by any of Formulae (9) Through (12)>>

The partial structure represented by any of formulae (9) through (12) will be explained below.

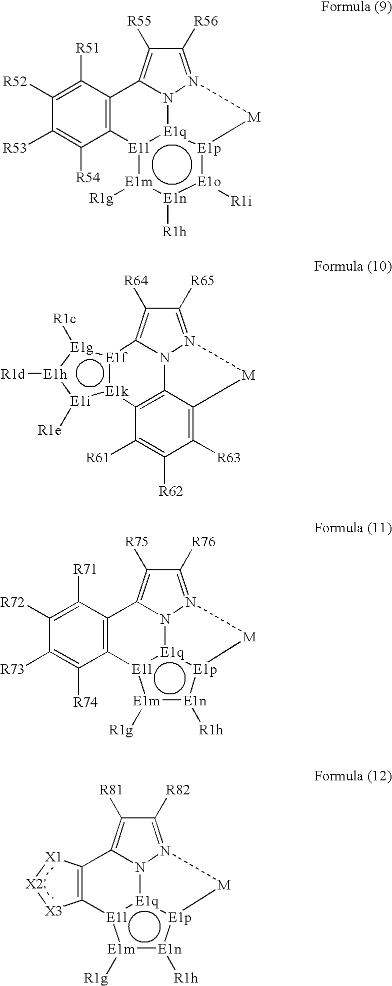

In formulae above, E1f through E1q represent a carbon atom, a nitrogen atom, an oxygen atom or a sulfur atom; the ring formed from E1f through E1k represents a 5-member aromatic heterocyclic ring; the ring formed from E1l through E1p represents a 6-member aromatic hydrocarbon ring or a 5- or 6-member aromatic heterocyclic ring; R51 through R56, R61 through R65, R71 through R76, R81, R82, and R1c through R1h independently represent a hydrogen atom or a substituent, provided that at least one of them is a group represented by formula (A) or (B); M represents a transition metal element belonging to groups 8 to 10 on the periodic table; and X1, X2 and X3 independently represent a substituted or unsubstituted carbon atom or a substituted or unsubstituted nitrogen atom.

The 5-member aromatic heterocyclic ring formed from E1f through E1k in the partial structure represented by any of formulae (9) through (12) is the same as those denoted above in the 5-member aromatic heterocyclic ring formed from E1a through E1e in the partial structure represented by any of formulae (1) through (4).

The 6-member aromatic hydrocarbon ring formed from E1l through E1p in the partial structure represented by any of formulae (9) through (12) is the same as those denoted above in the 6-member aromatic hydrocarbon ring formed from E1l through E1p in the partial structure represented by any of formulae (1) through (4).

The 5- or 6-member aromatic heterocyclic ring formed from E1l through E1p in the partial structure represented by any of formulae (9) through (12) is the same as those denoted above in the 5- or 6-member aromatic heterocyclic ring formed from E1l through E1p in the partial structure represented by any of formulae (1) through (4).

The substituent represented by R51 through R56, R61 through R65, R71 through R76, R81, R82, and R1c through R1h in the partial structure represented by any of formulae (9) through (12) is the same as those denoted above in the substituent represented by R1a through R1i in the partial structure represented by any of formulae (1) through (4).

The substituent which the carbon atom or nitrogen atom represented by X1, X2 and X3 may have in the partial structure represented by any of formulae (9) through (12) is the same as those denoted above in the substituent represented by R1a through R1i in the partial structure represented by any of formulae (1) through (4).

It is preferred in the partial structure represented by any of formulae (9) through (12) that at least one of R55, R56, R64, R65, R75, R76, R81 and R82 represents a group represented by formula (A) or (B), at least one of R1g, R1h, R1i, R61, R62, R63, R1g and R1h represents a group represented by formula (A) or (B), at least one of R51 through R54, R1c through R1c and R71 through R74 represents a group represented by formula (A) or (B), or at least one of X1 through X3 represents a group represented by formula (A) or (B).

In the invention, the partial structure represented by any of formulae (5) through (8) is preferably a partial structure represented by any of formulae (13) through (16) below.

### <<Partial Structure Represented by any of Formulae (13) Through (16)>>

The partial structure represented by any of formulae (13) through (16) will be explained below.

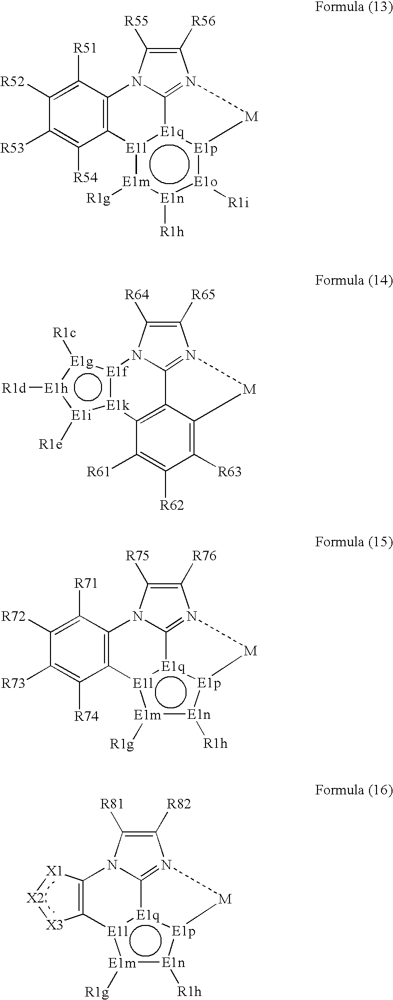

In formulae above, E1f through E1q represent a carbon atom, a nitrogen atom, an oxygen atom or a sulfur atom; the ring formed from E1f through E1k represents a 5-member aromatic heterocyclic ring; the ring formed from E1l through E1p represents a 6-member aromatic hydrocarbon ring or a 5- or 6-member aromatic heterocyclic ring; R51 through R56, R61 through R65, R71 through R76, R81, R82, and R1c through R1h independently represent a hydrogen atom or a substituent, provided that at least one of them is a group represented by formula (A) or (B); M represents a transition metal element belonging to groups 8 to 10 on the periodic table; and X1, X2 and X3 independently represent a substituted or unsubstituted carbon atom or a substituted or unsubstituted nitrogen atom.

The 5-member aromatic heterocyclic ring formed from E1f through E1k in the partial structure represented by any of formulae (13) through (16) is the same as those denoted above in the 5-member aromatic heterocyclic ring formed from E1a through E1e in the partial structure represented by any of formulae (1) through (4).

The 6-member aromatic hydrocarbon ring formed from E1l through E1p in the partial structure represented by any of formulae (13) through (16) is the same as those denoted above in the 6-member aromatic hydrocarbon ring formed from E1l through E1p in the partial structure represented by any of formulae (1) through (4).

The 5- or 6-member aromatic heterocyclic ring formed from E1l through E1p in the partial structure represented by any of formulae (13) through (16) is the same as those denoted above in the 5- or 6-member aromatic heterocyclic ring formed from E1l through E1p in the partial structure represented by any of formulae (1) through (4).

The substituent represented by R51 through R56, R61 through R65, R71 through R76, R81, R82, and R1c through R1h in the partial structure represented by any of formulae (13) through (16) is the same as those denoted above in the substituent represented by R1a through R1l in the partial structure represented by any of formulae (1) through (4).

The substituent which the carbon atom or nitrogen atom represented by X1, X2 and X3 in the partial structure represented by any of formulae (13) through (16) may have is the same as those denoted above in the substituent represented by R1a through R1i in the partial structure represented by any of formulae (1) through (4).

It is preferred in the partial structure represented by any of formulae (13) through (16) that at least one of R55, R56, R54, R65, R75, R76, R81 and R82 represents a group represented by formula (A) or (B), at least one of R1g, R1h, R1i, R61, R62, R63, R1g and R1h represents a group represented by formula (A) or (B), at least one of R51 through R54, R1c through R1e and R71 through R74 represents a group represented by formula (A) or (B), or at least one of X1 through X3 represents a group represented by formula (A) or (B).

Typical examples of a compound having a partial structure represented by any of formulae (1) through (4), any of formulae (5) through (8), any of formulae (9) through (12) or any of formulae (13) through (16) (hereinafter also referred to as a metal complex or a metal complex compound) will be listed below, but the invention is not limited thereto.

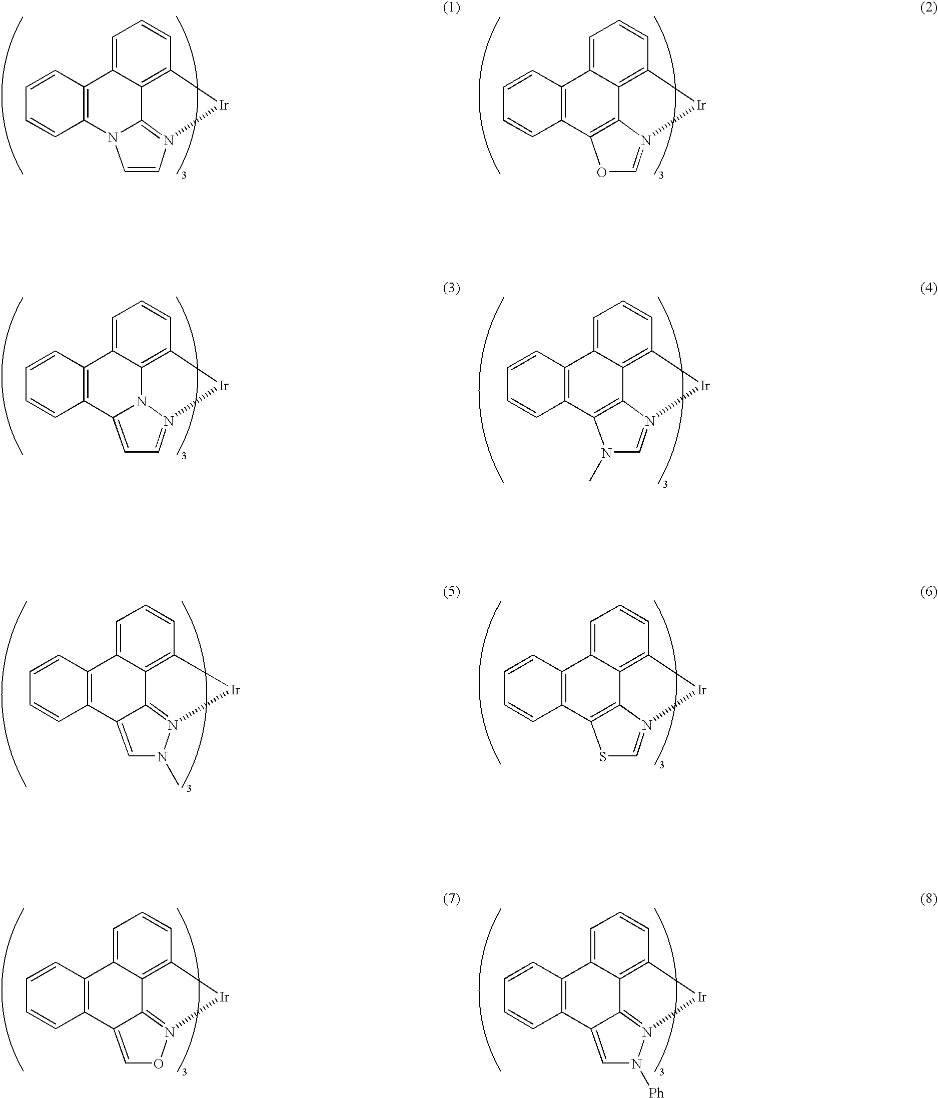

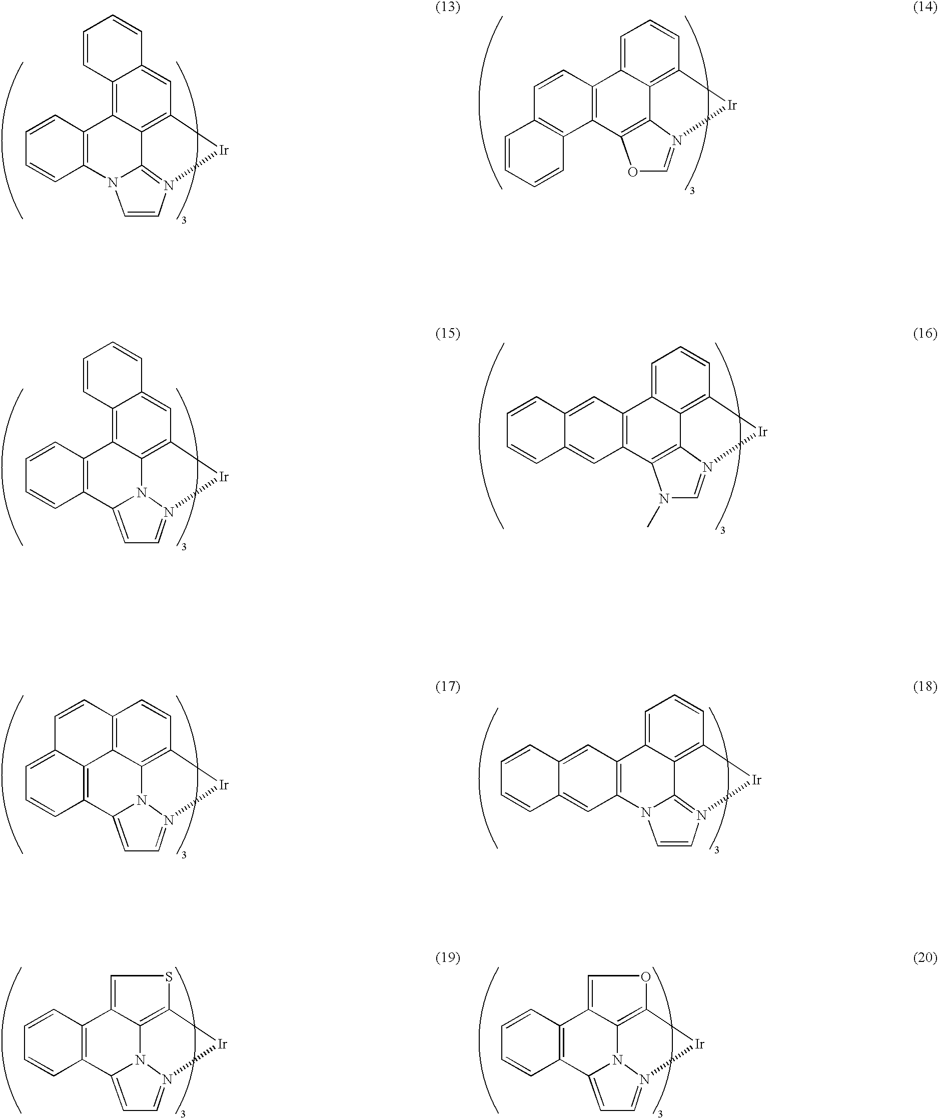

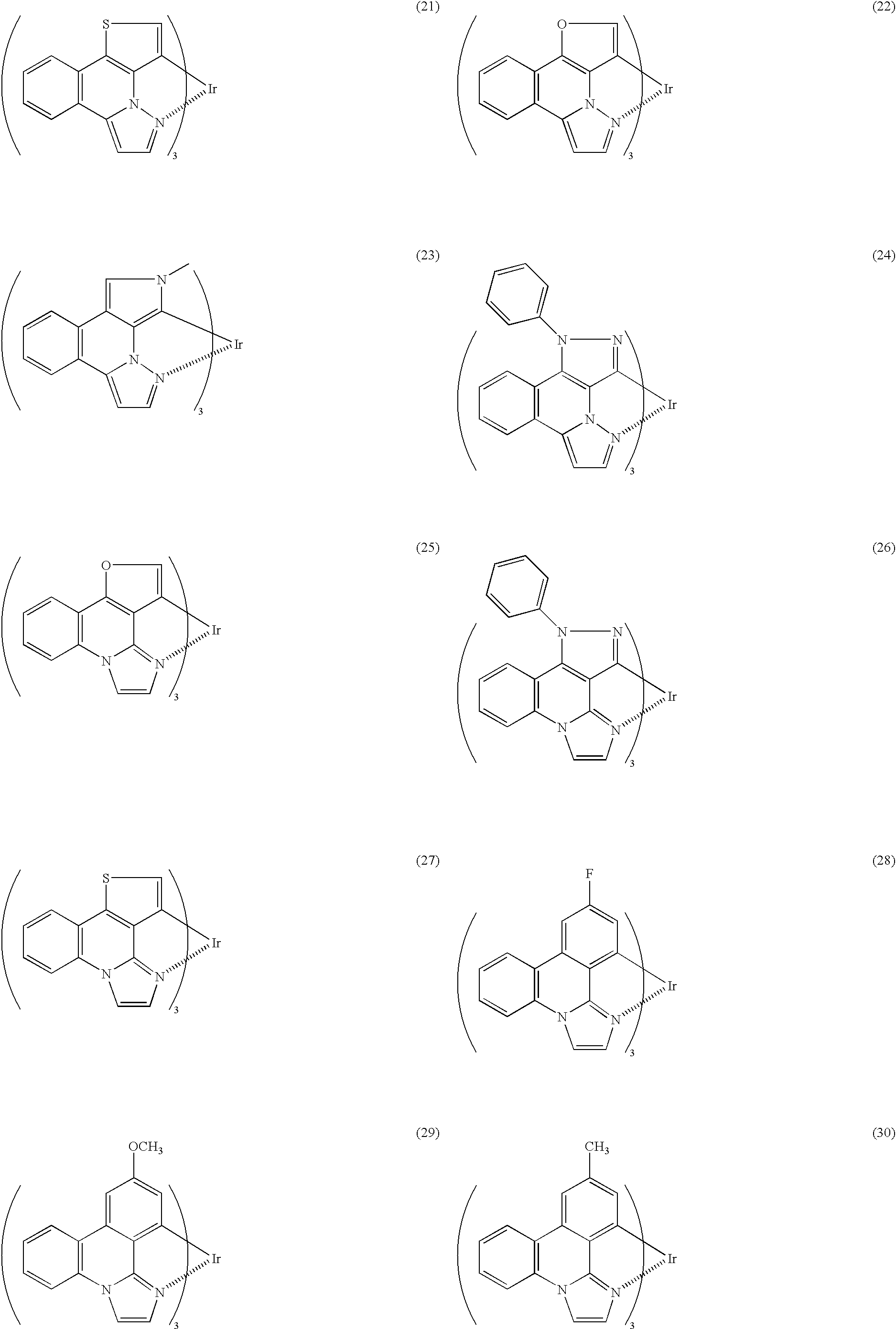

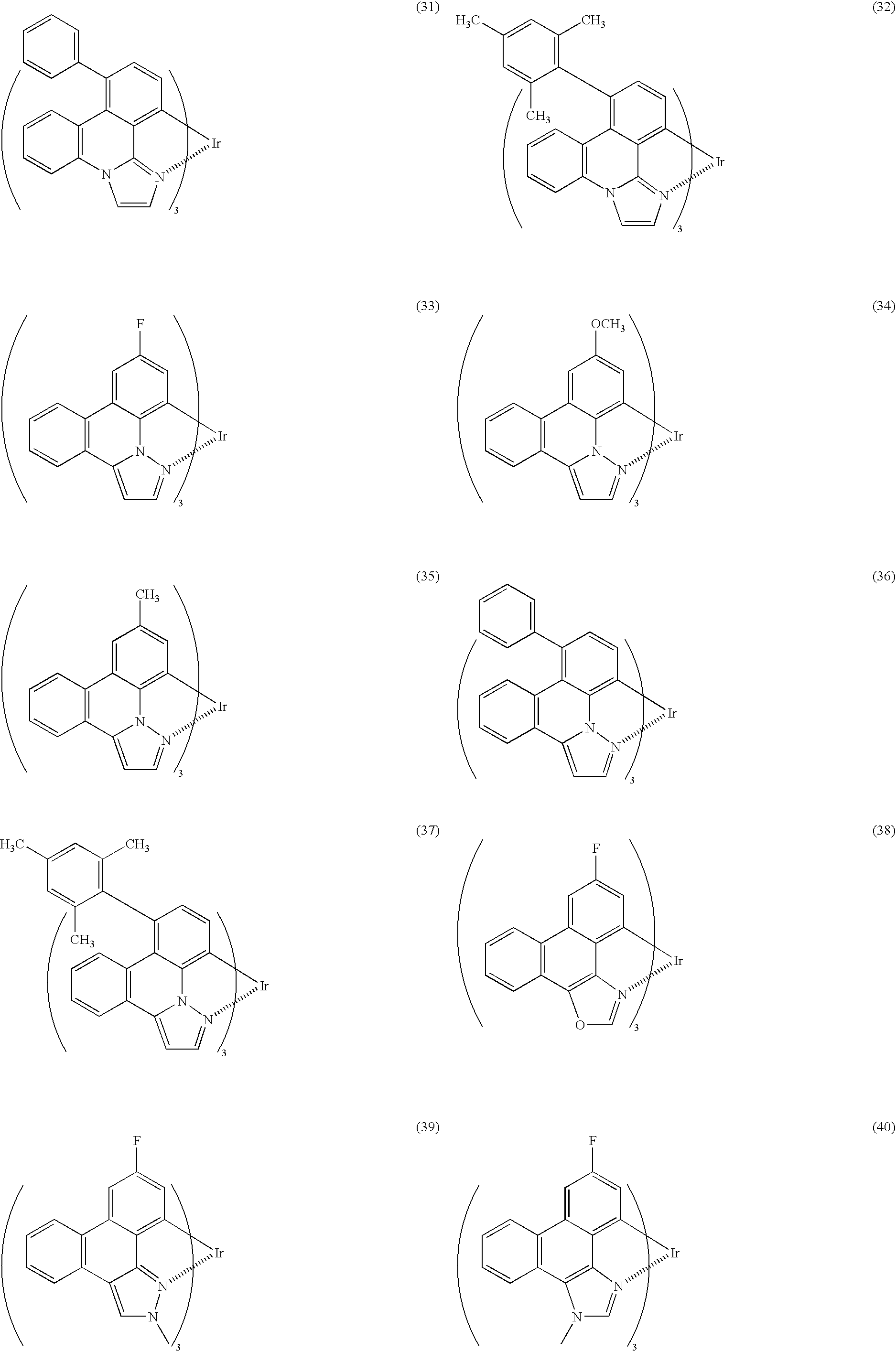

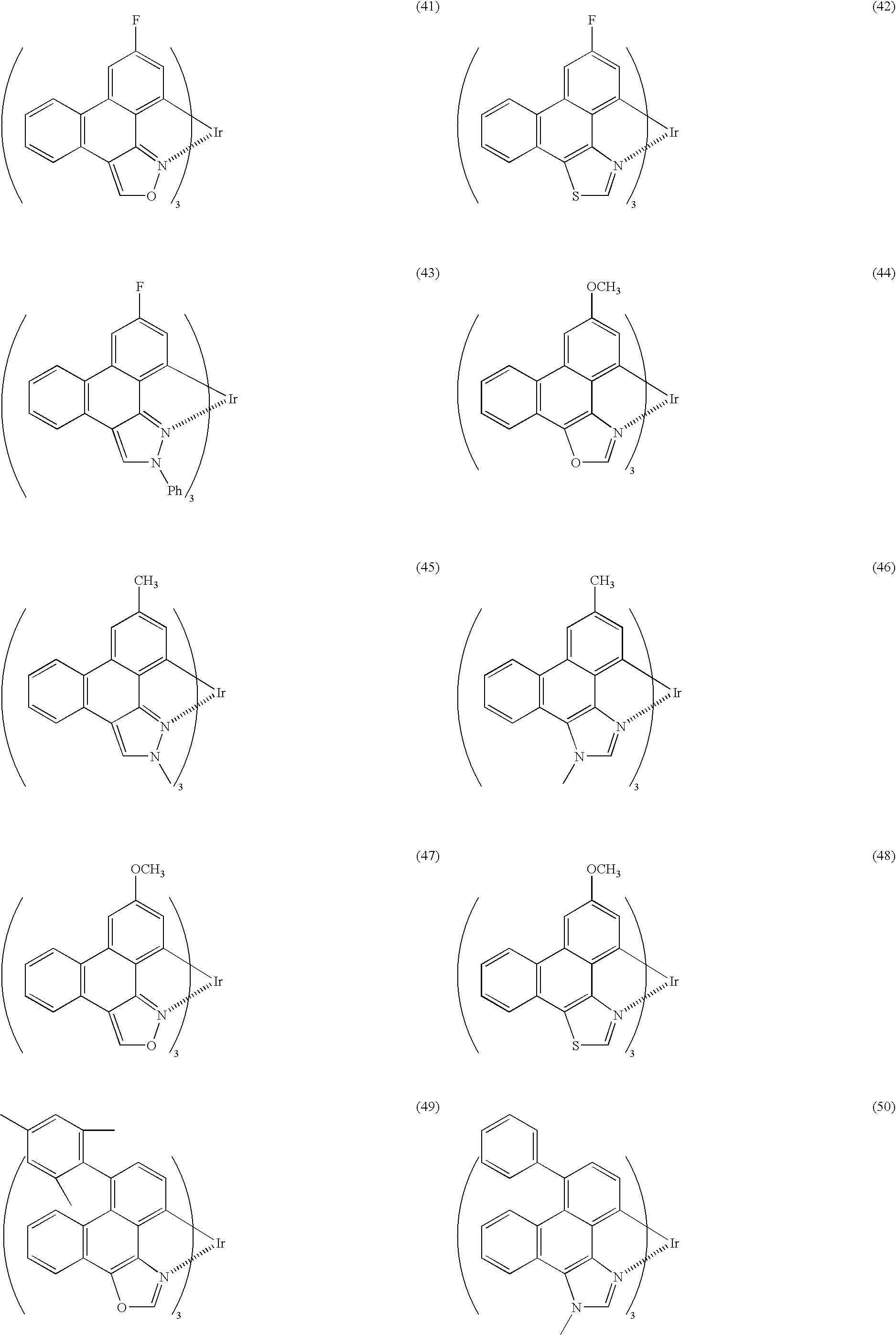

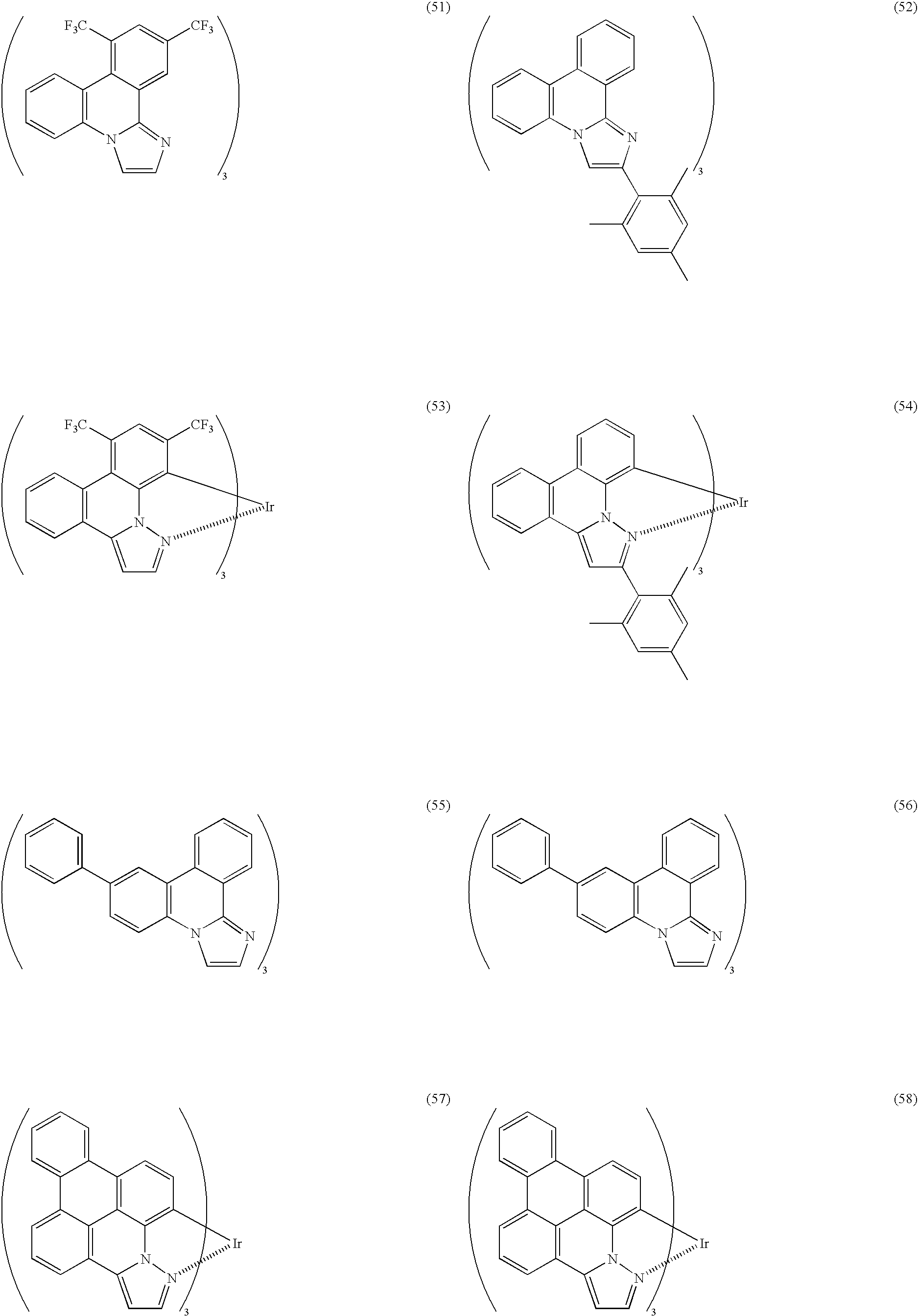

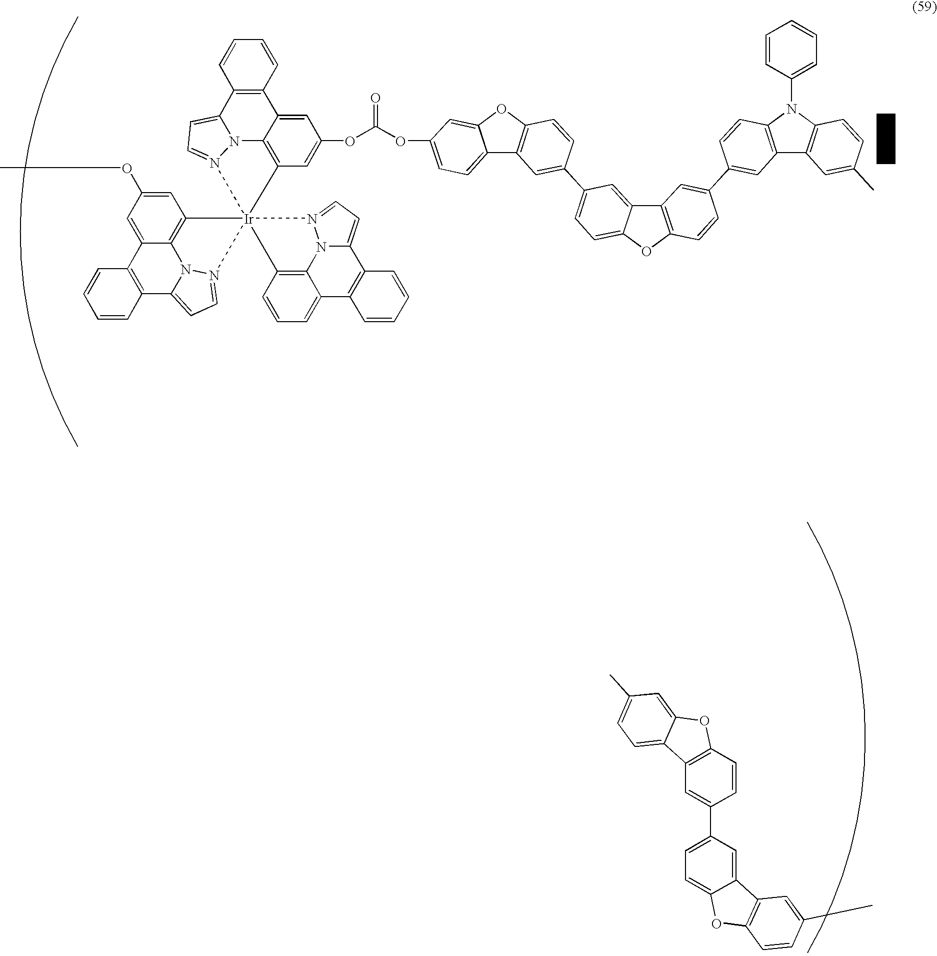

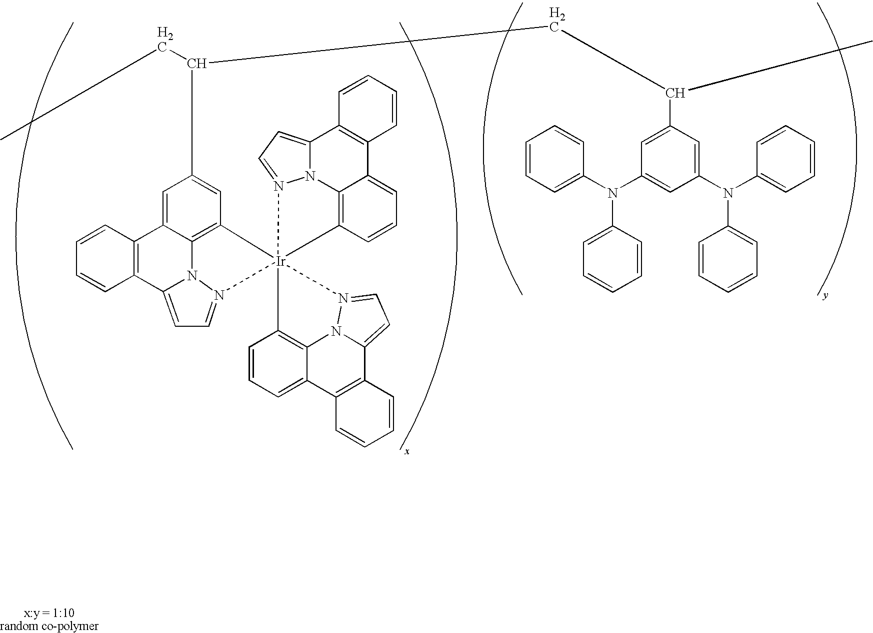

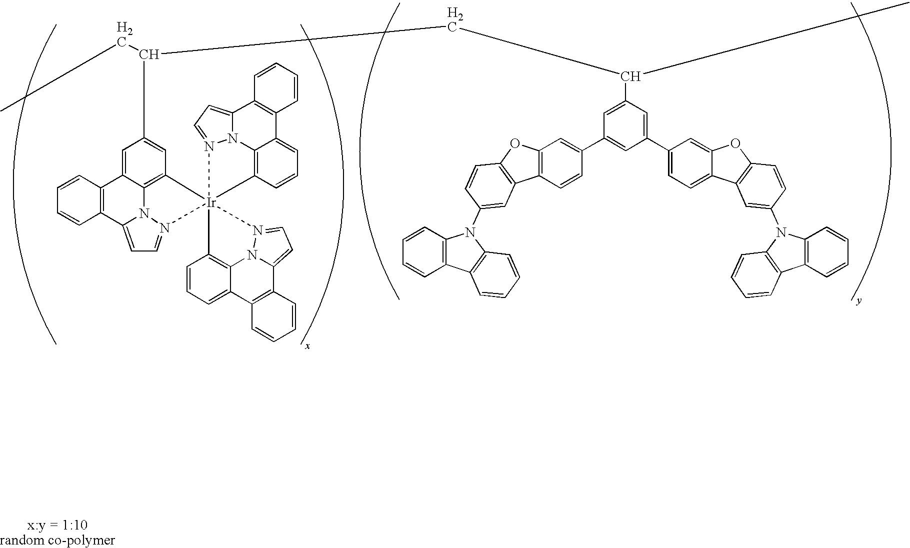

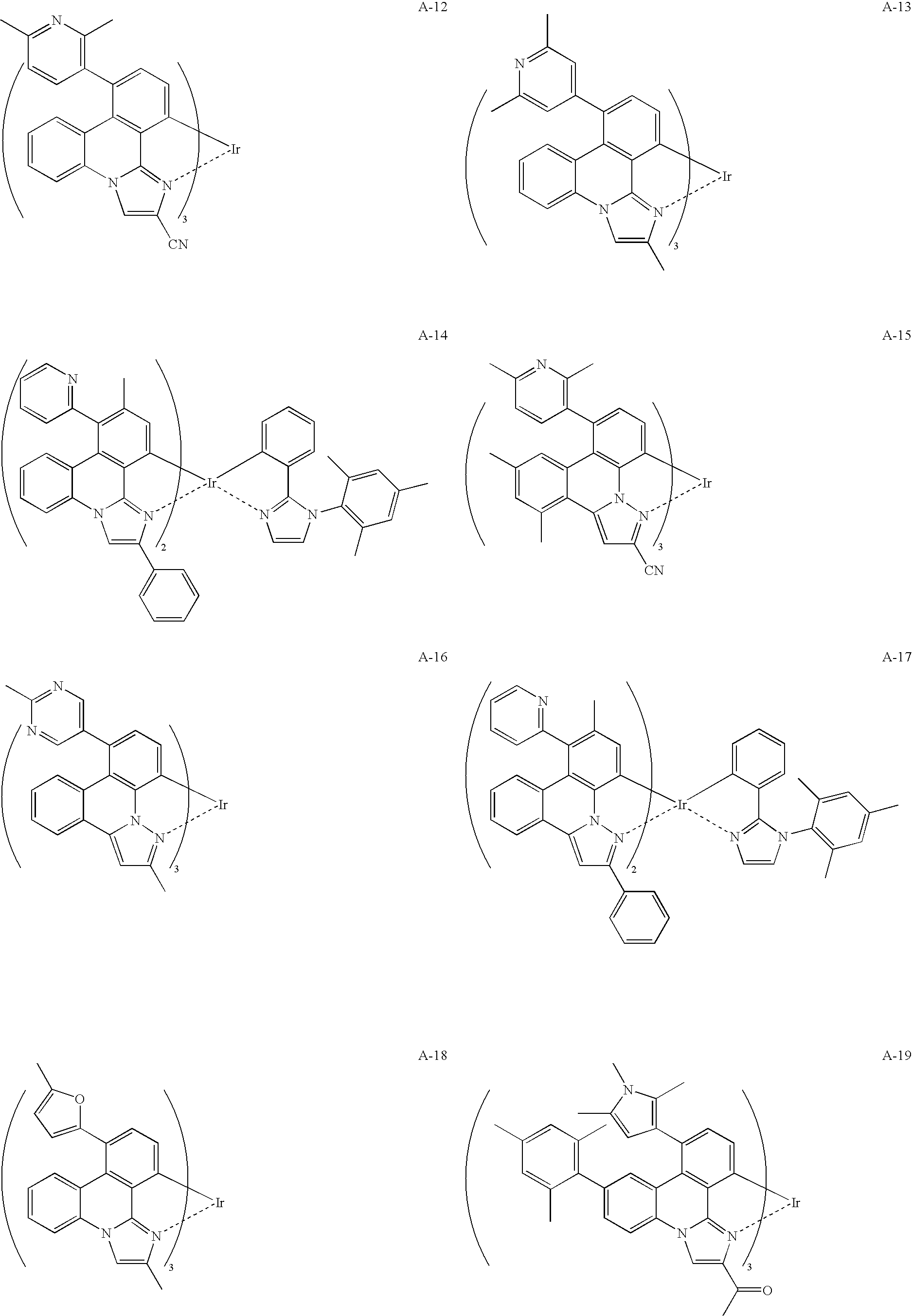

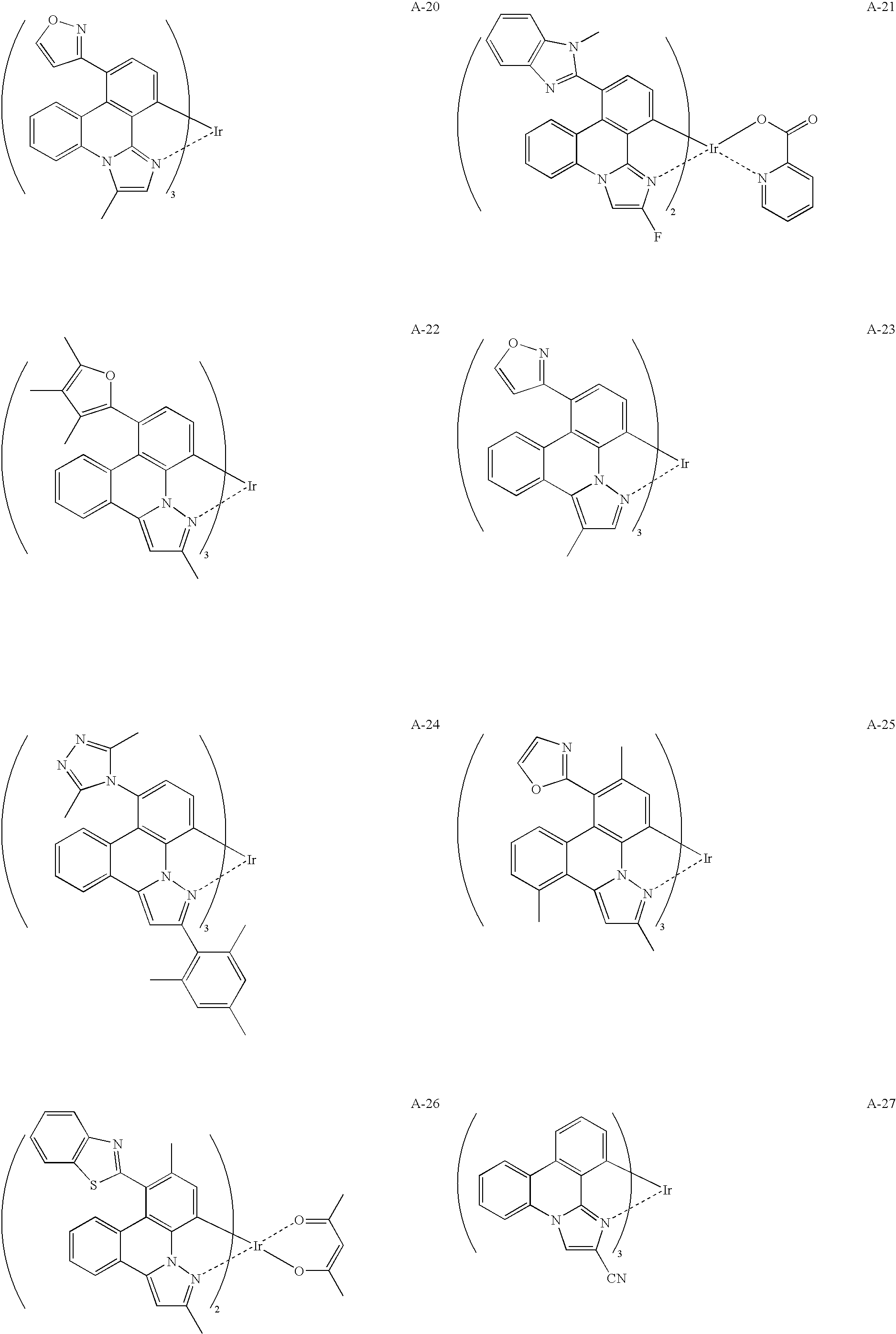

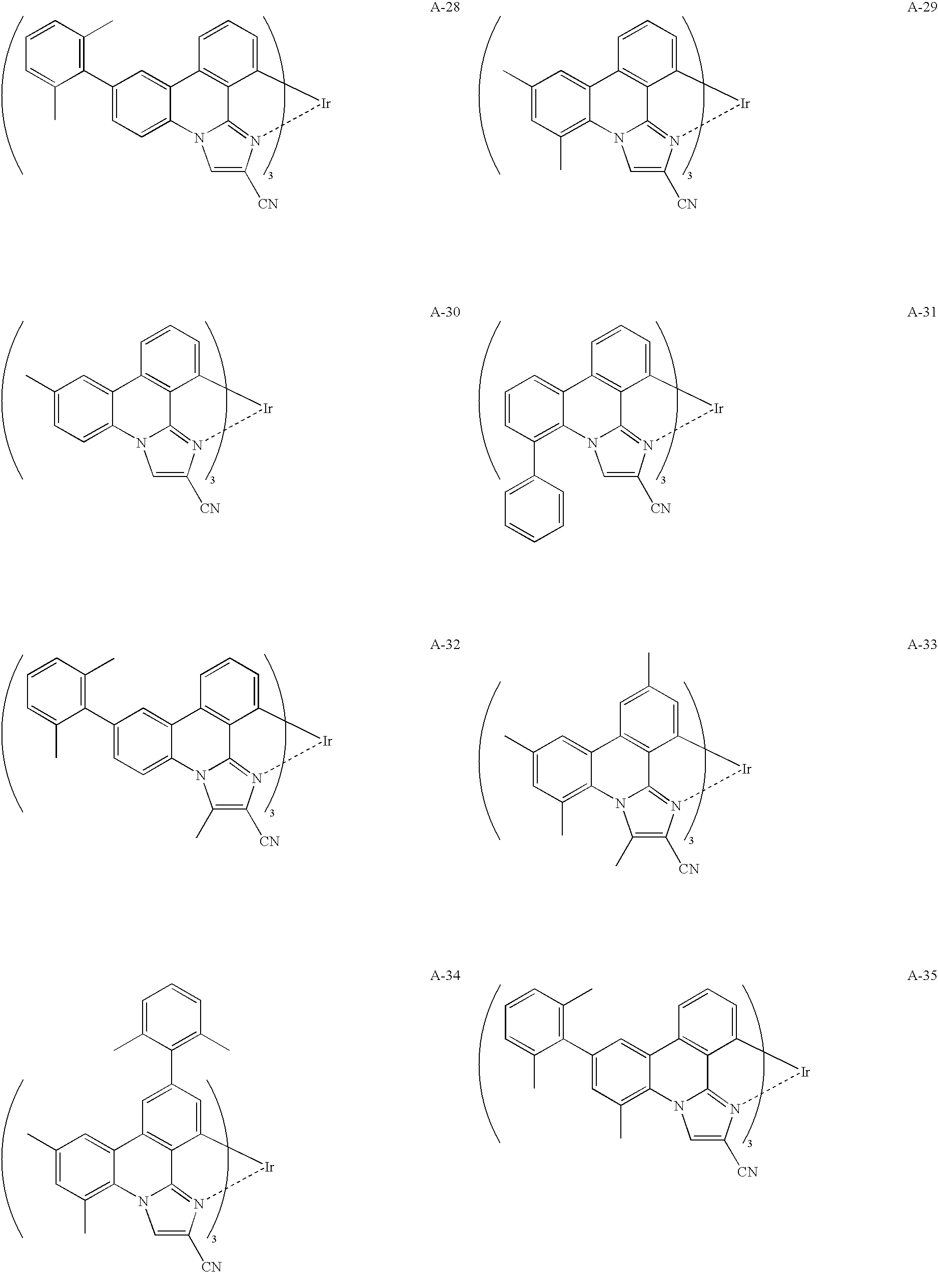

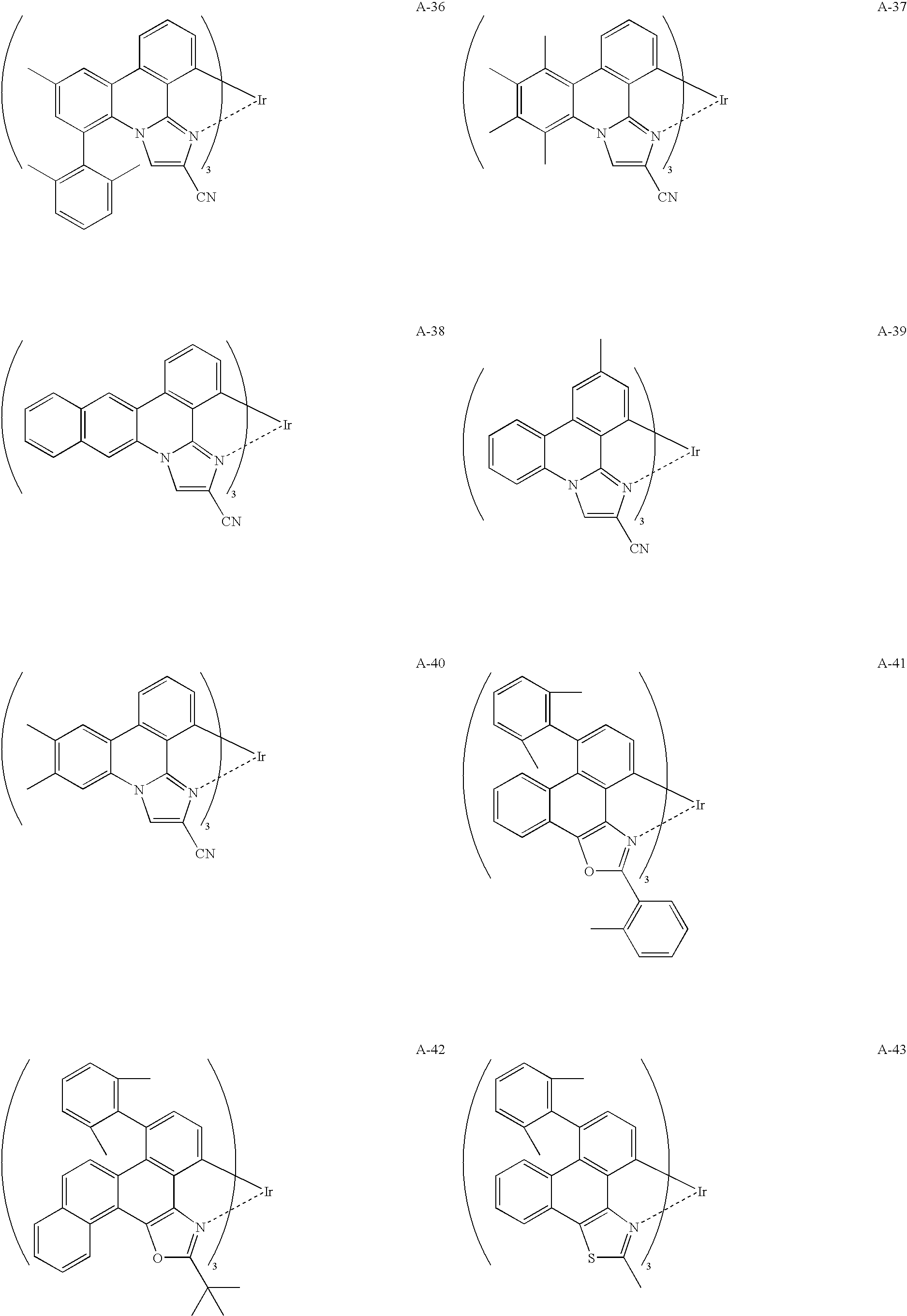

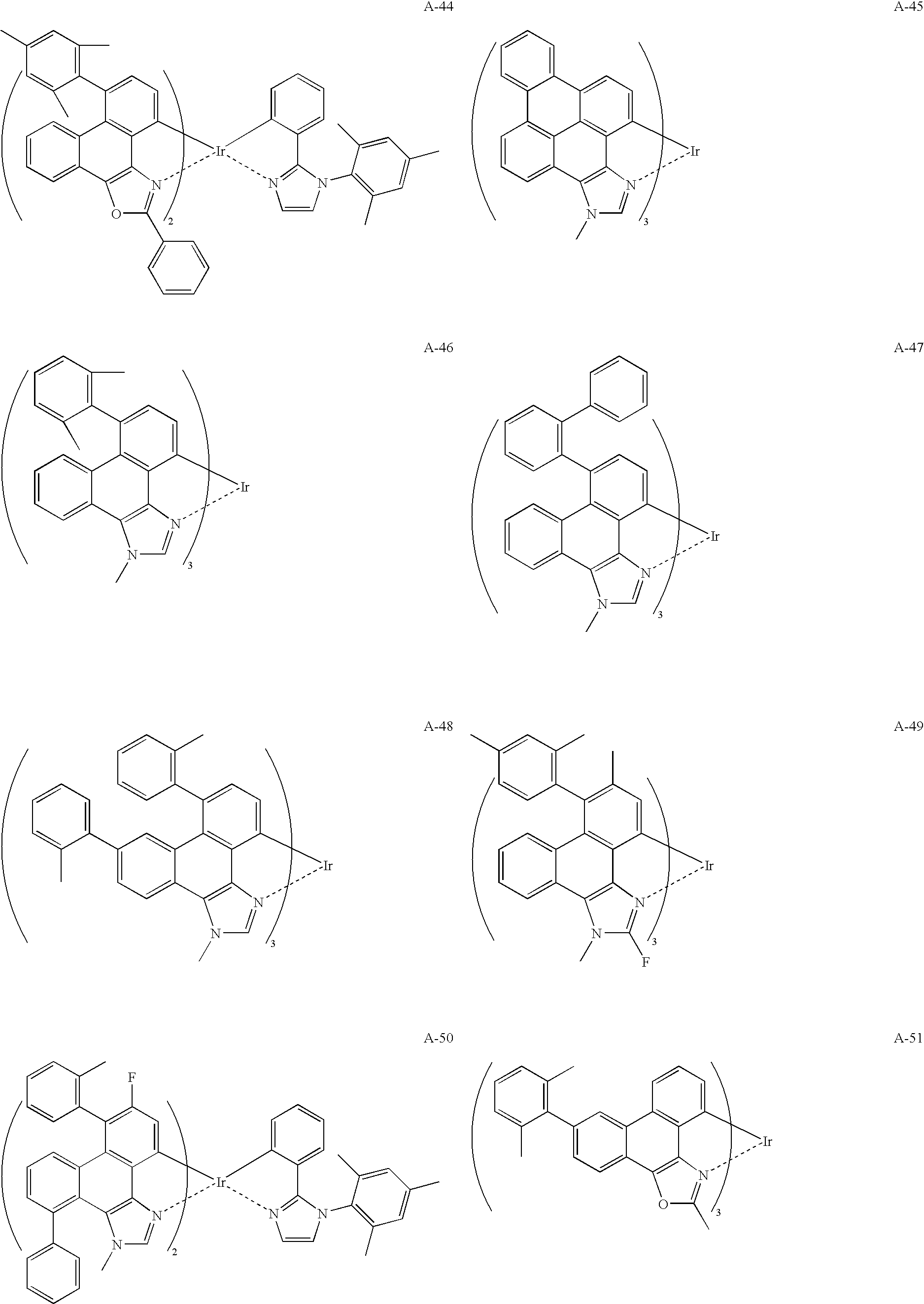

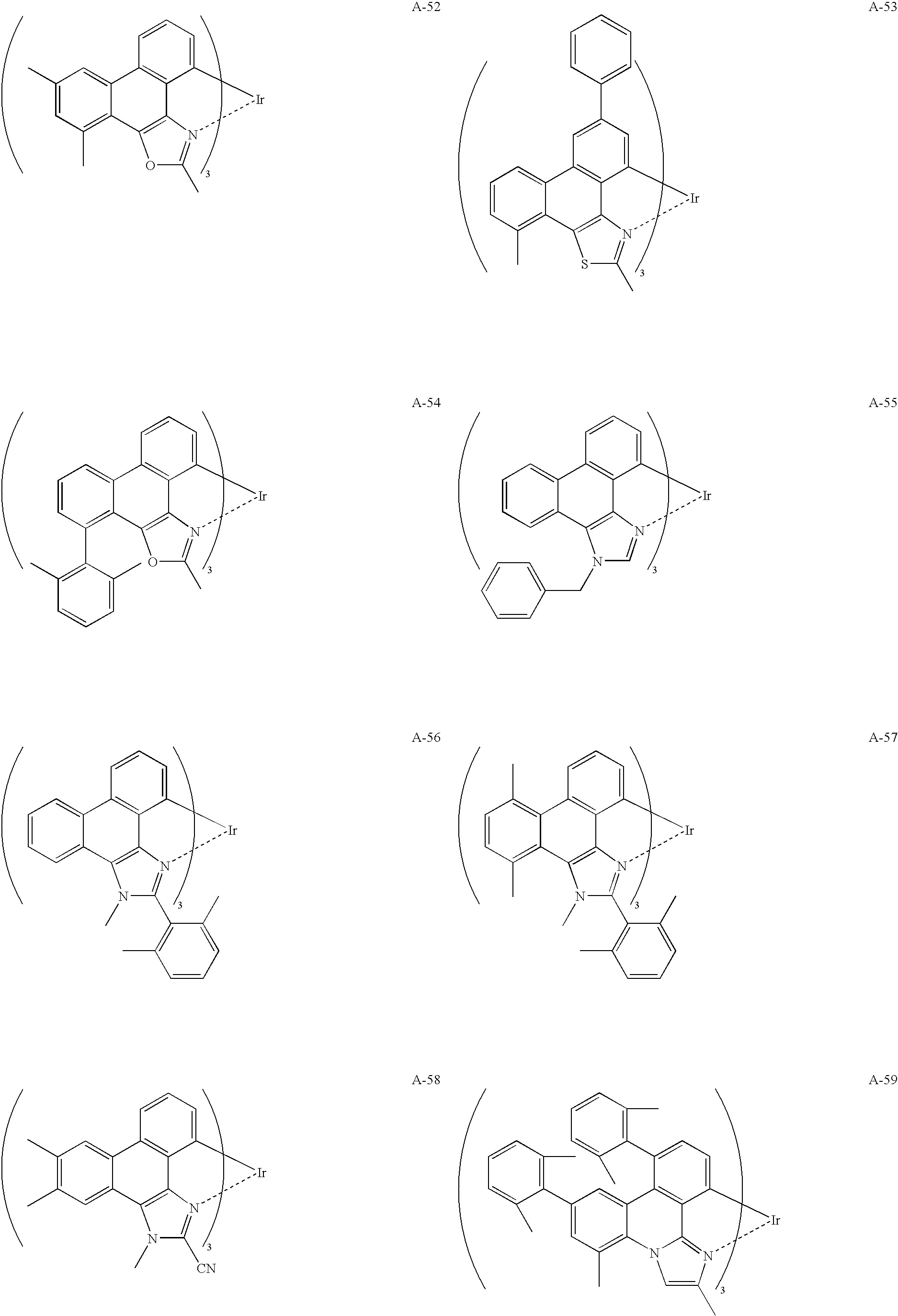

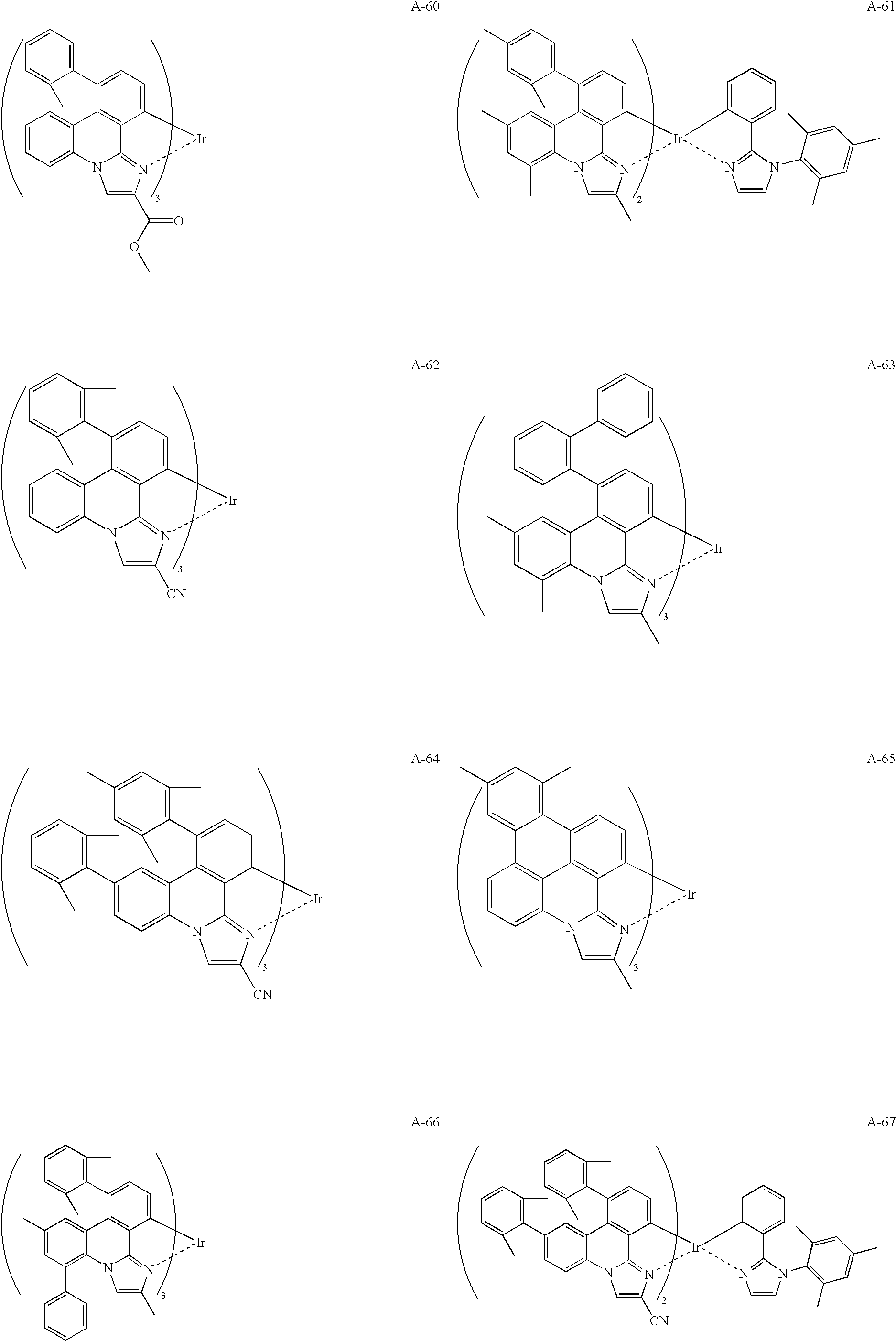

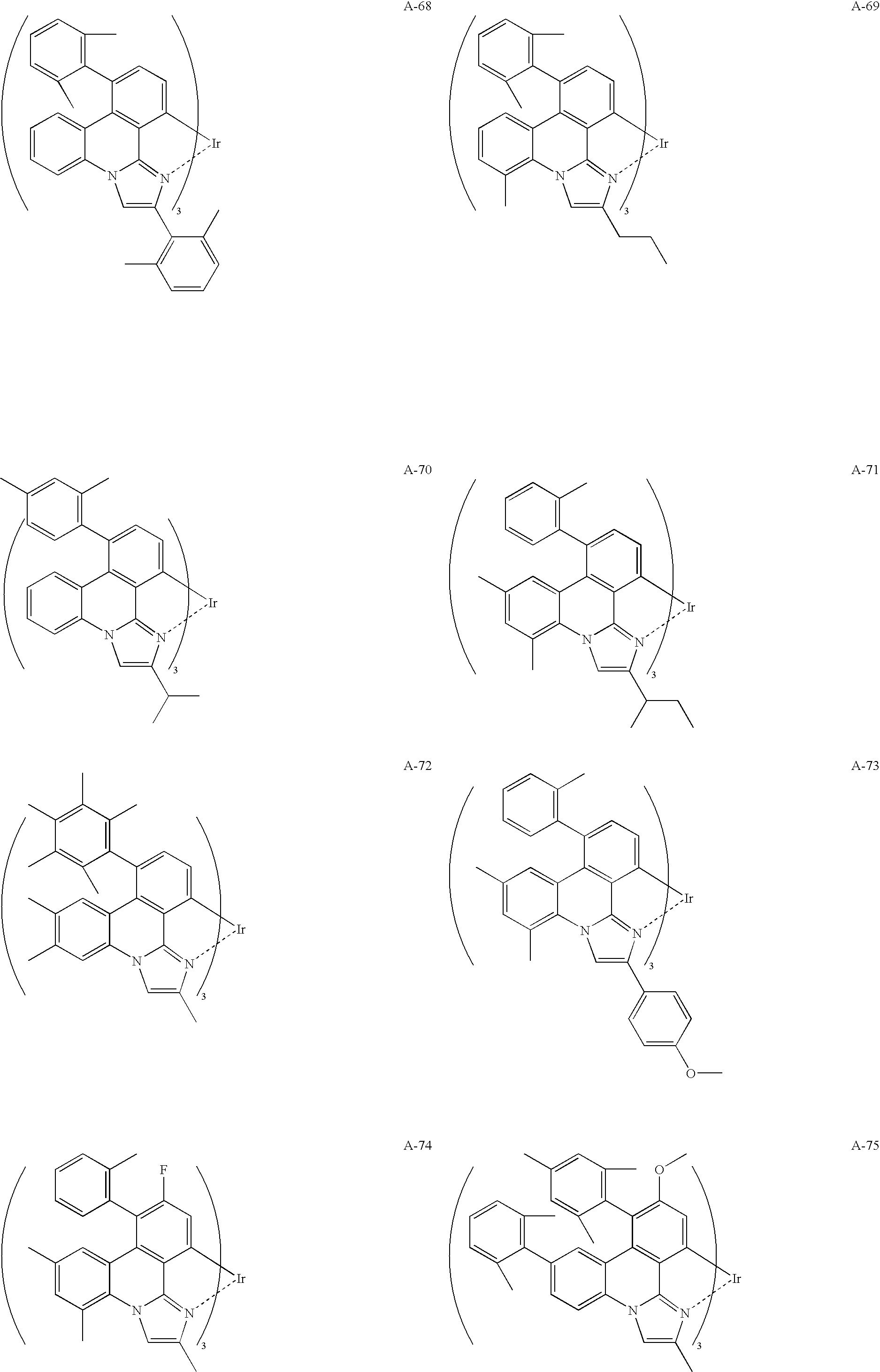

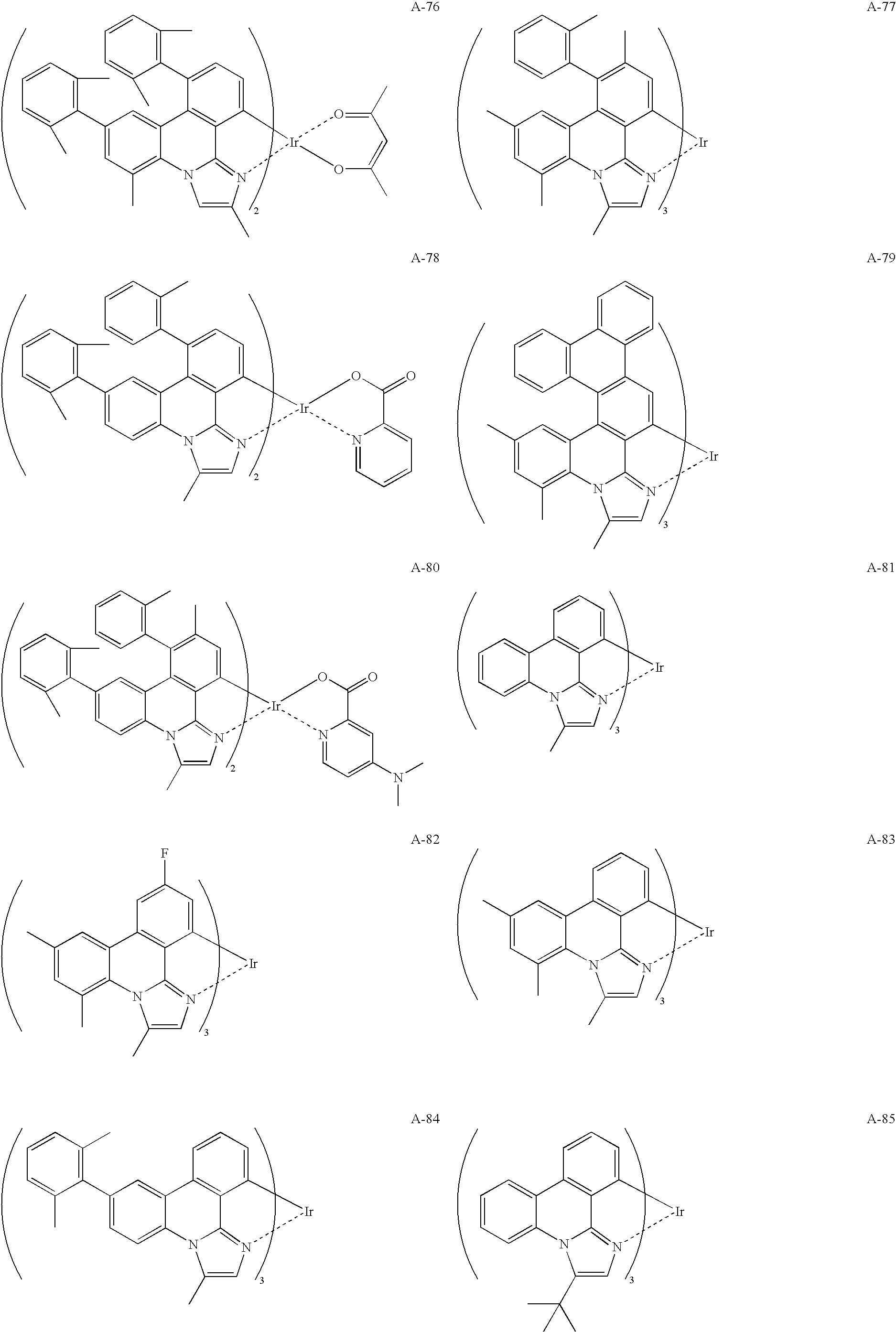

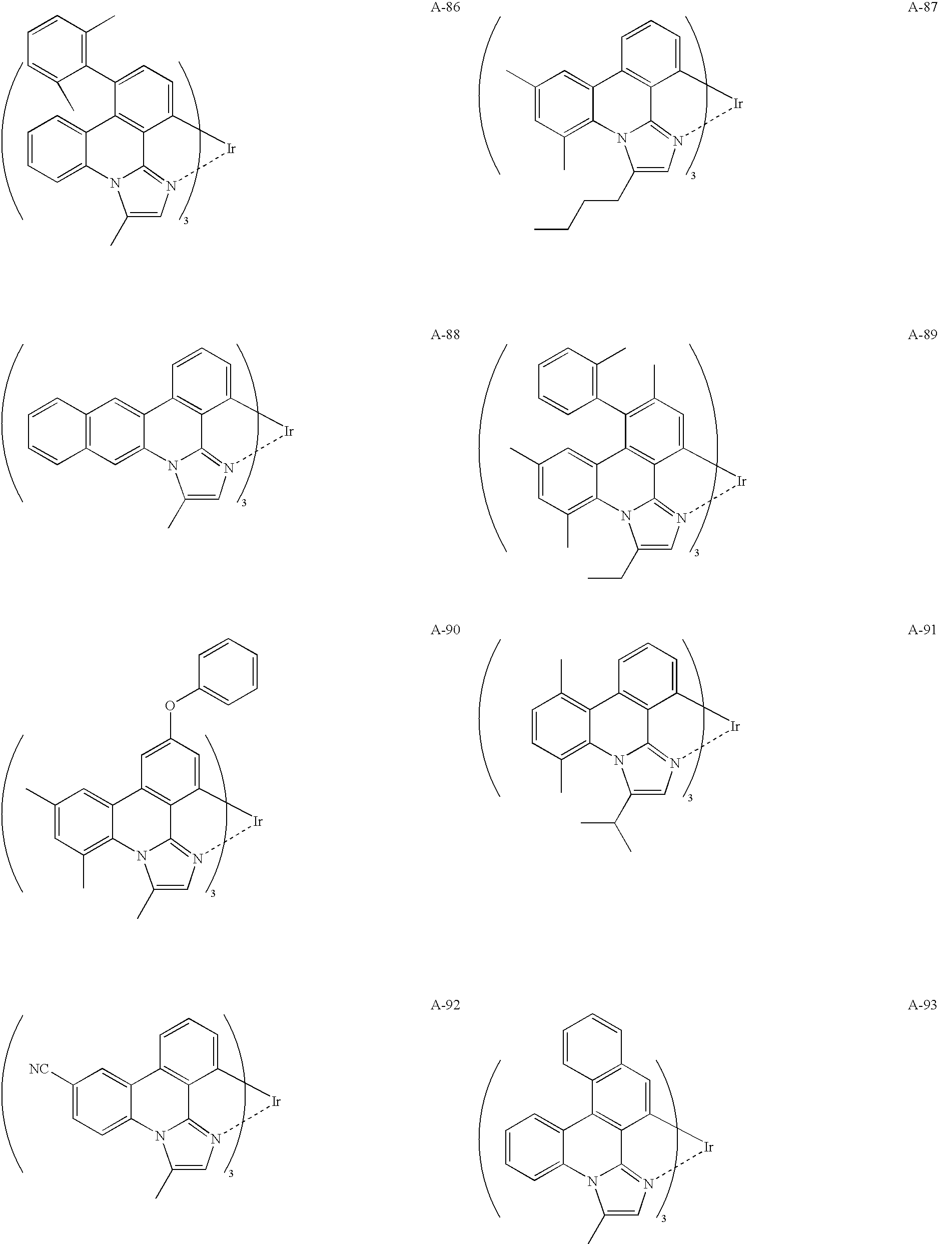

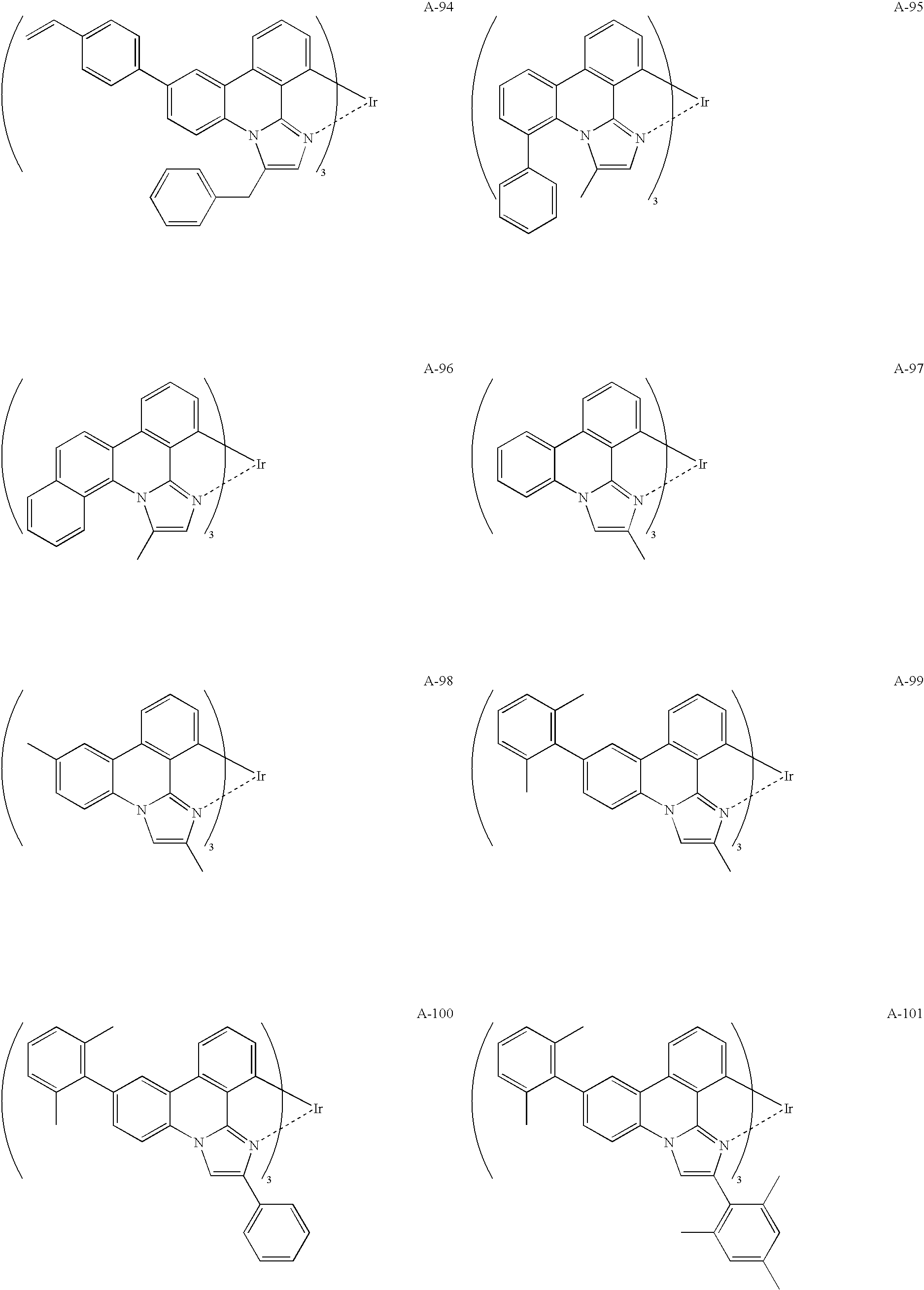

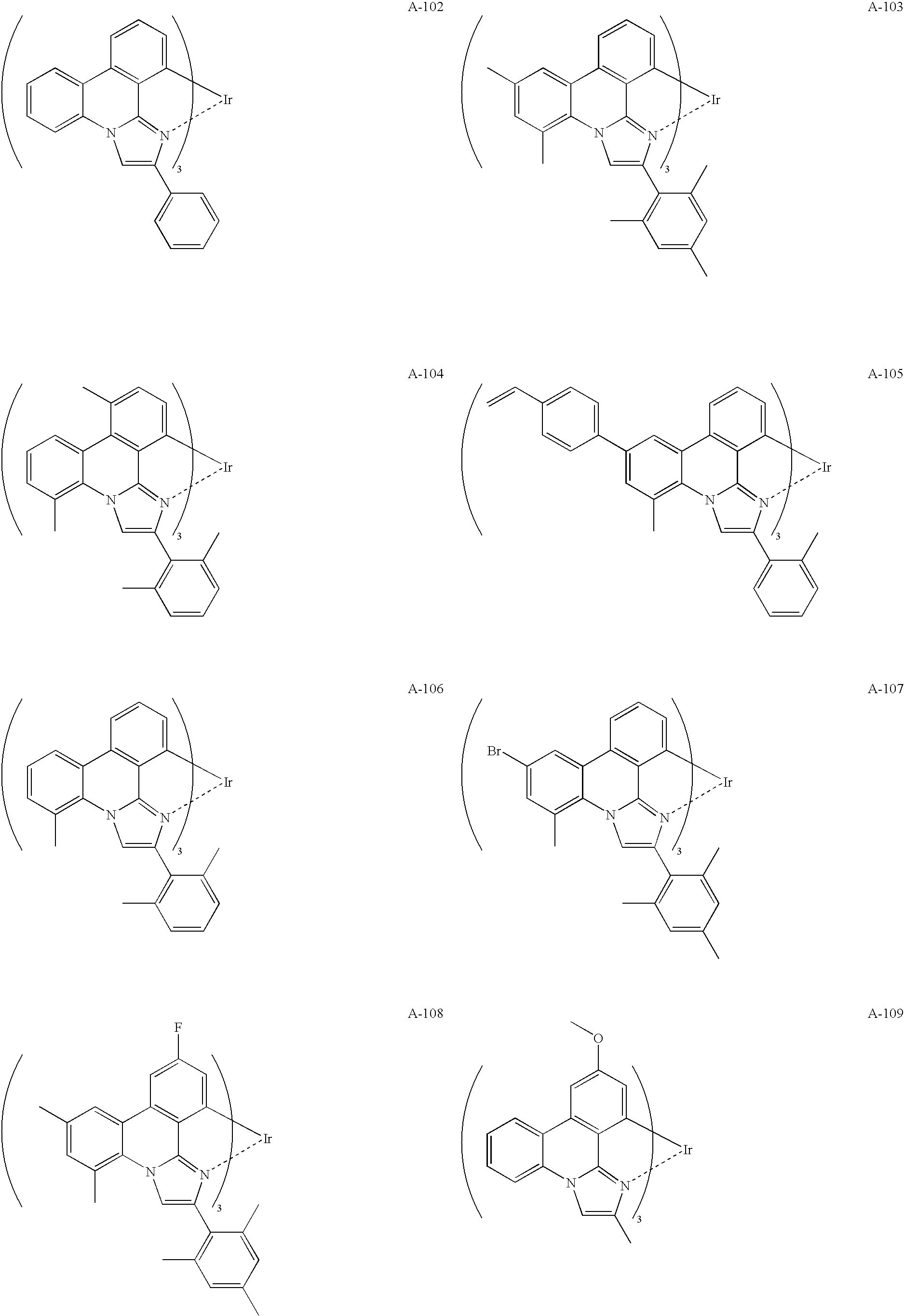

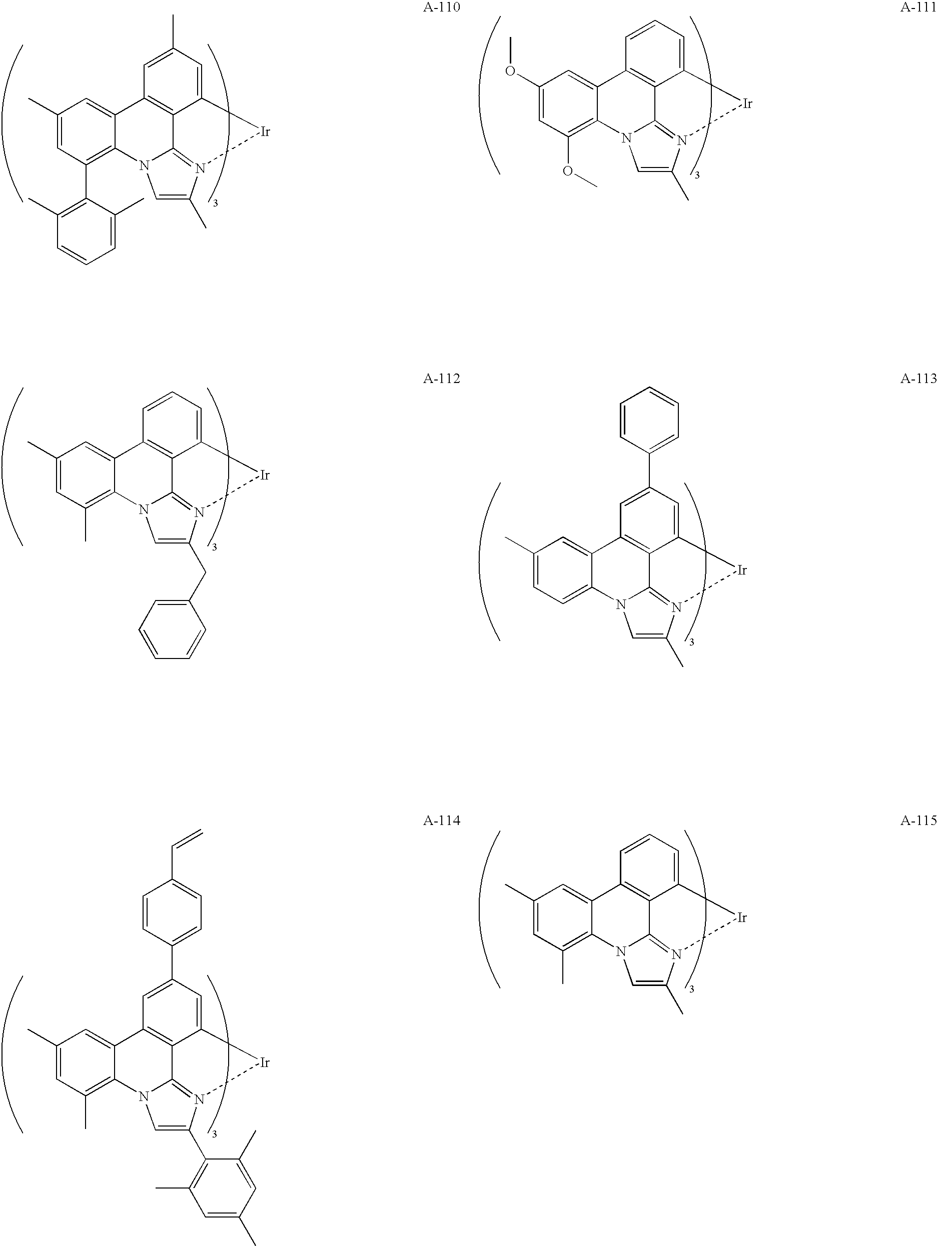

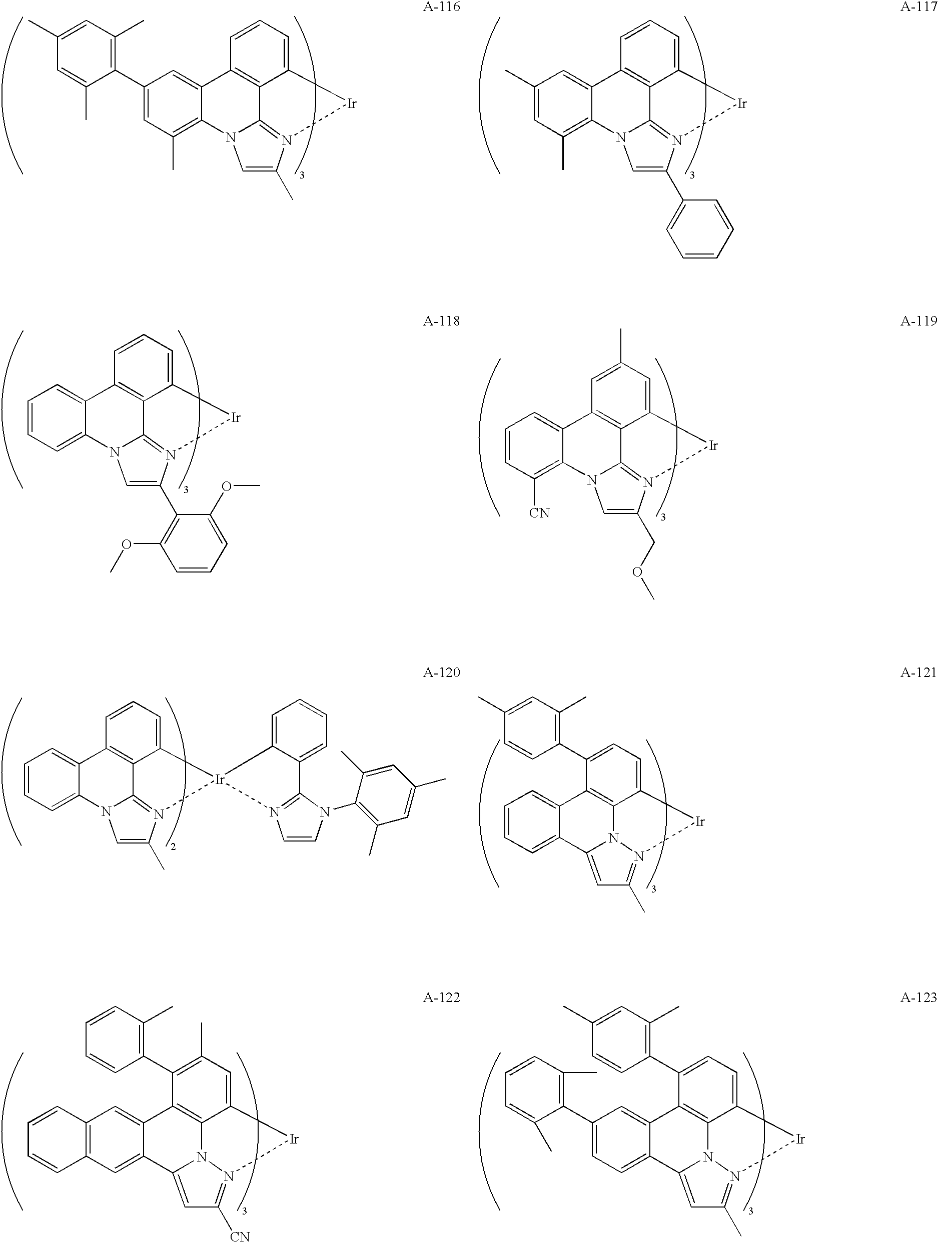

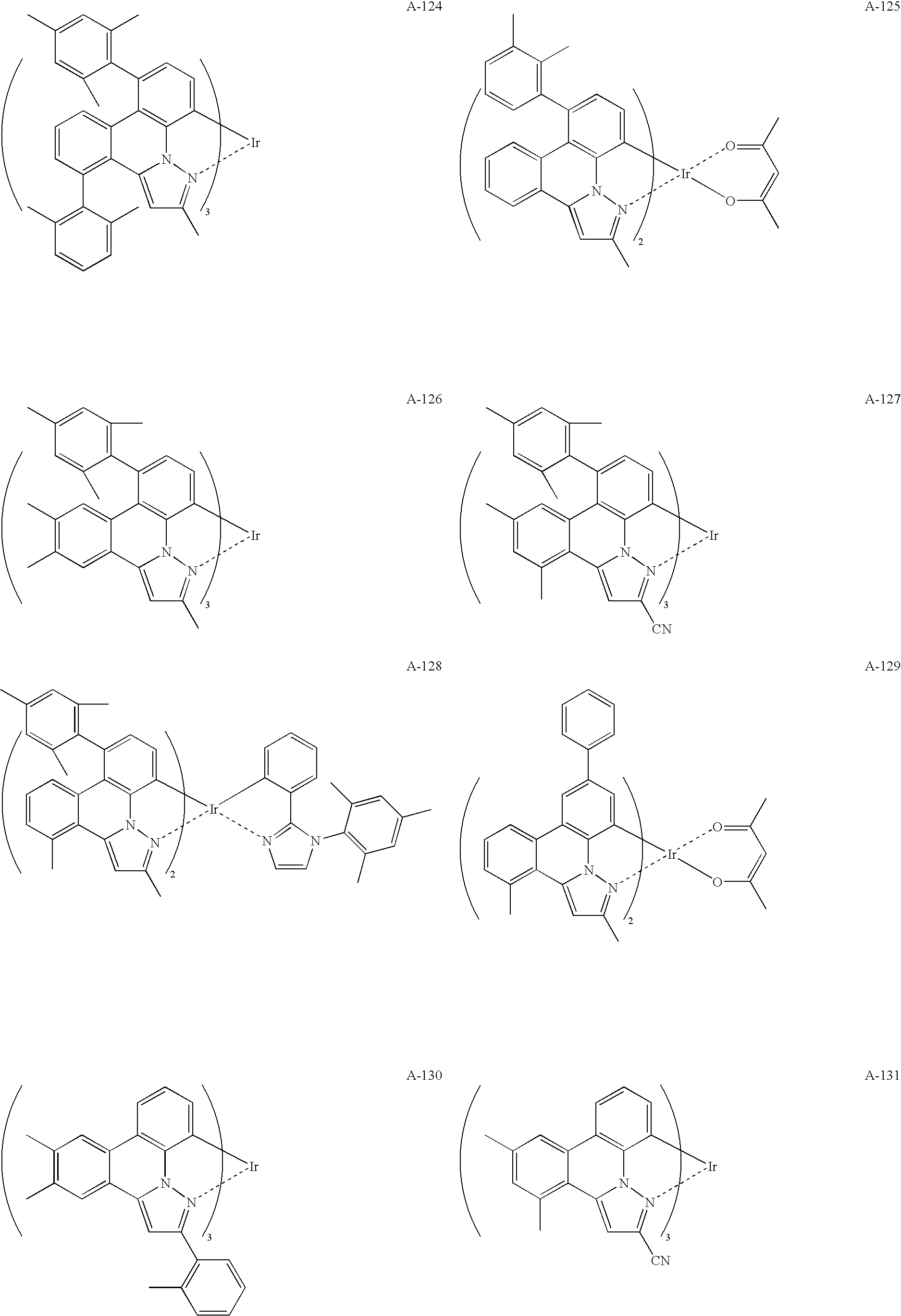

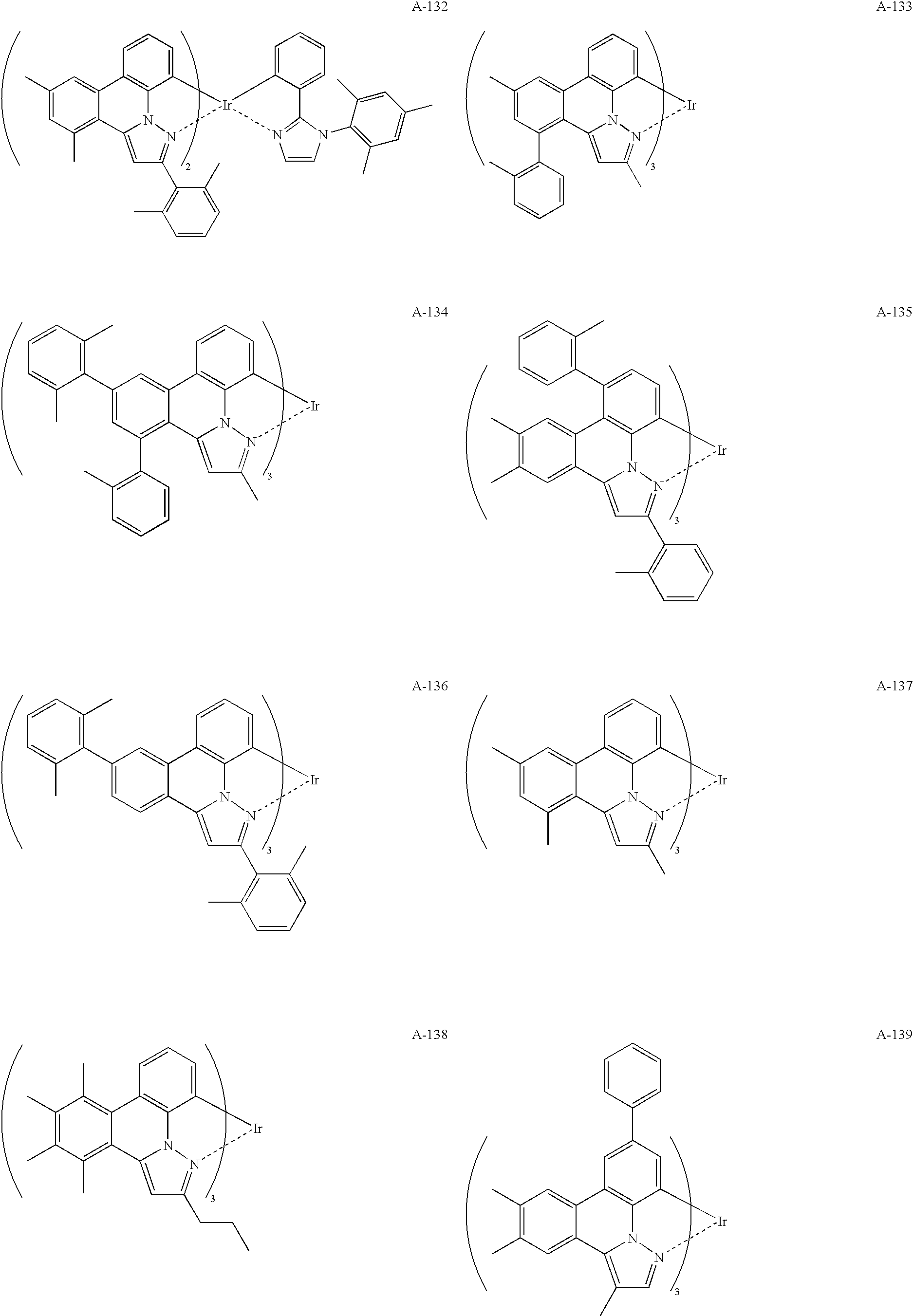

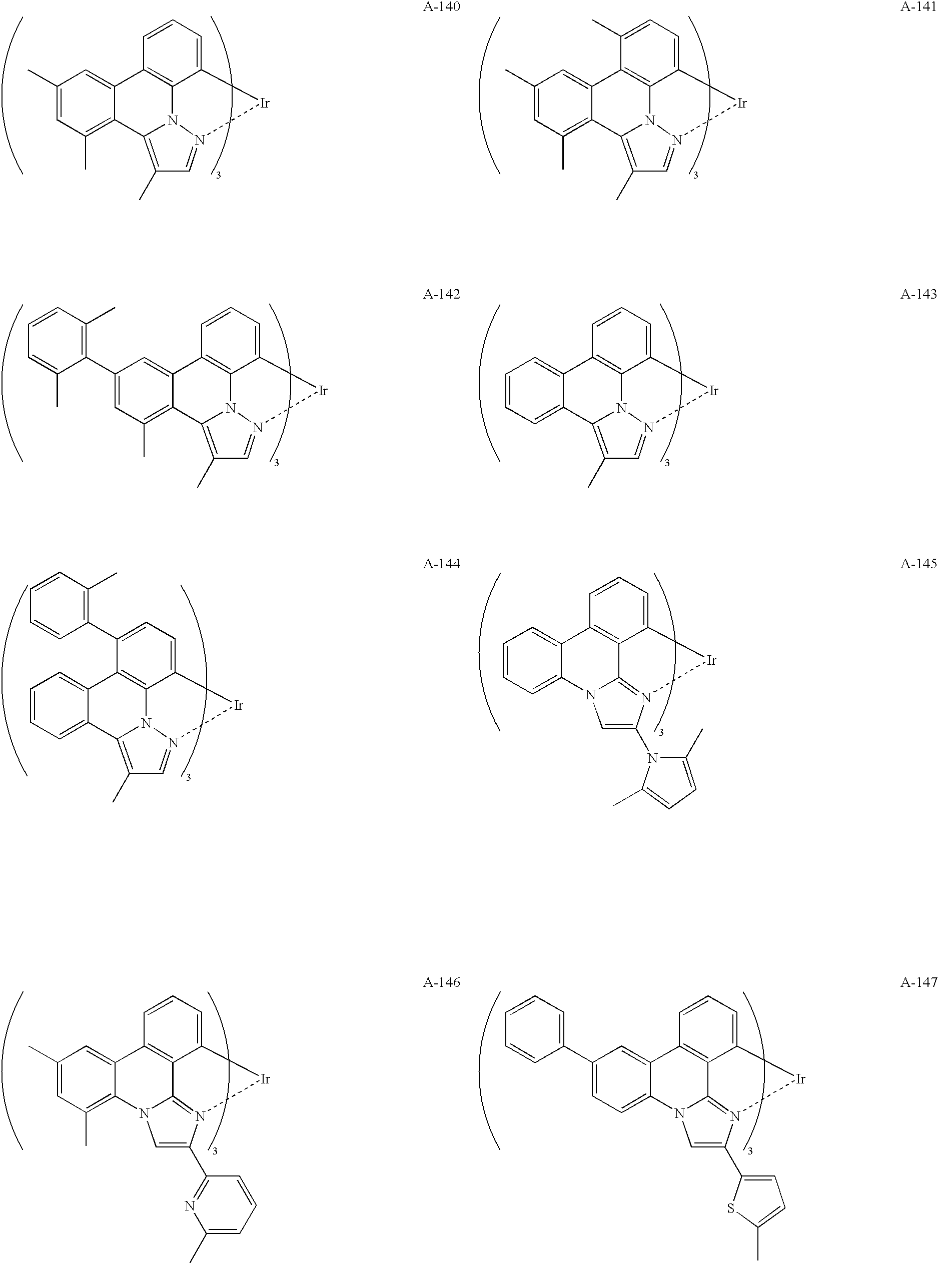

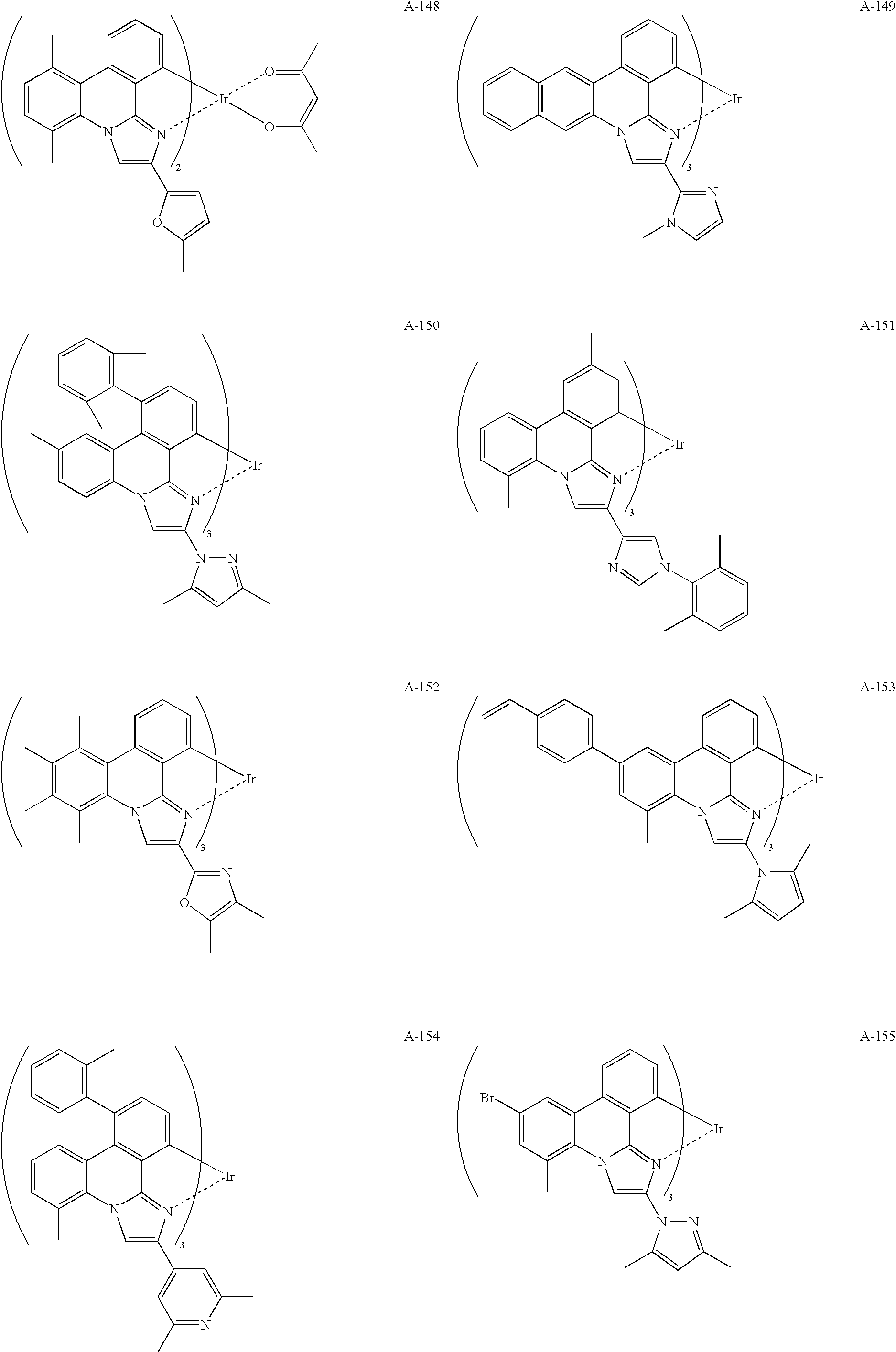

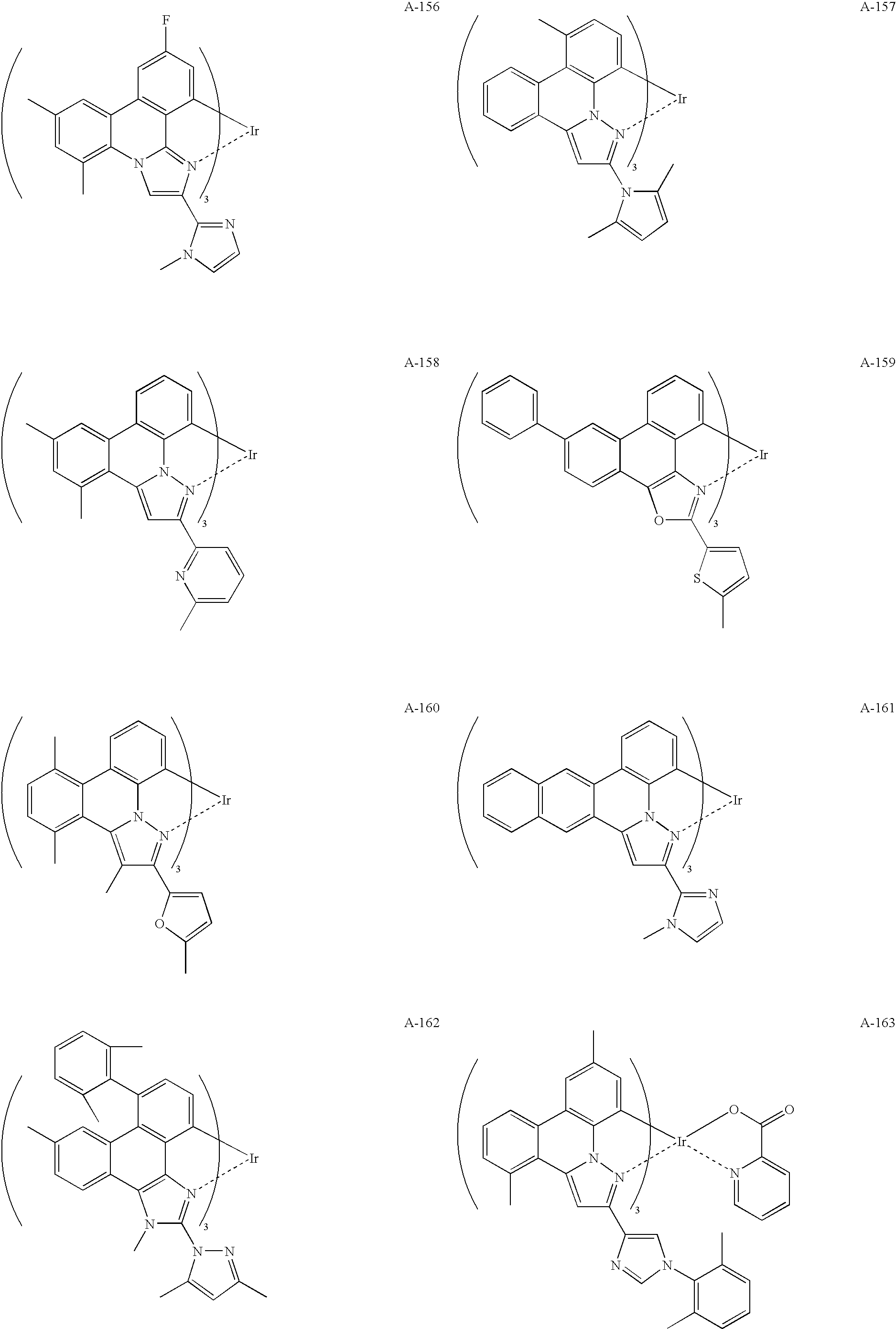

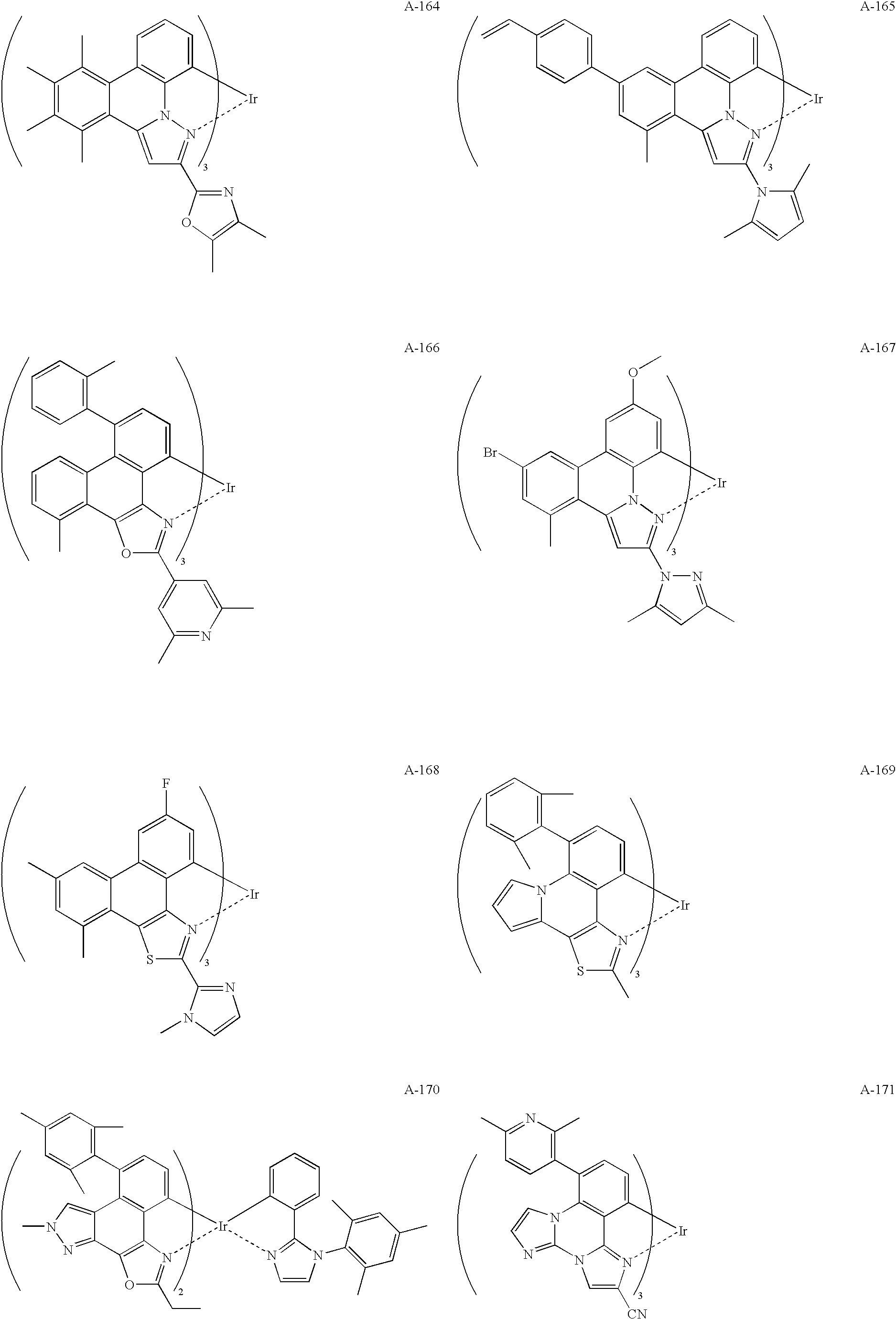

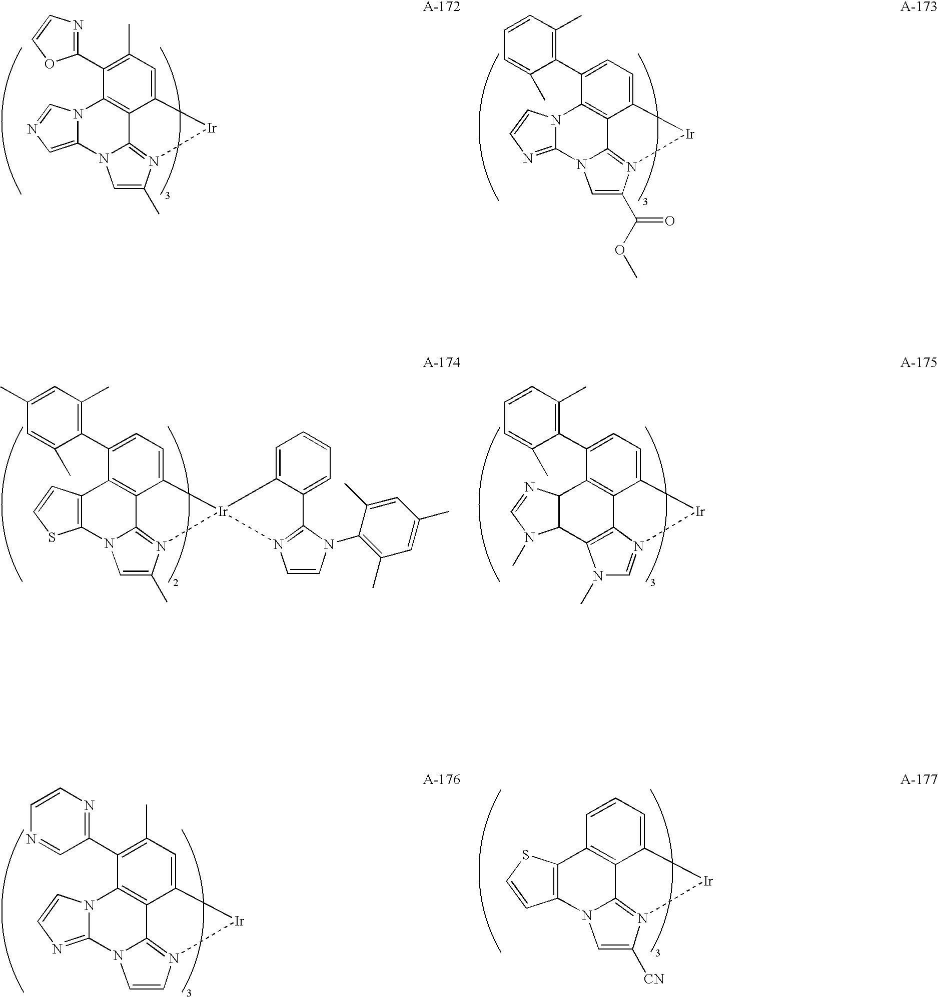

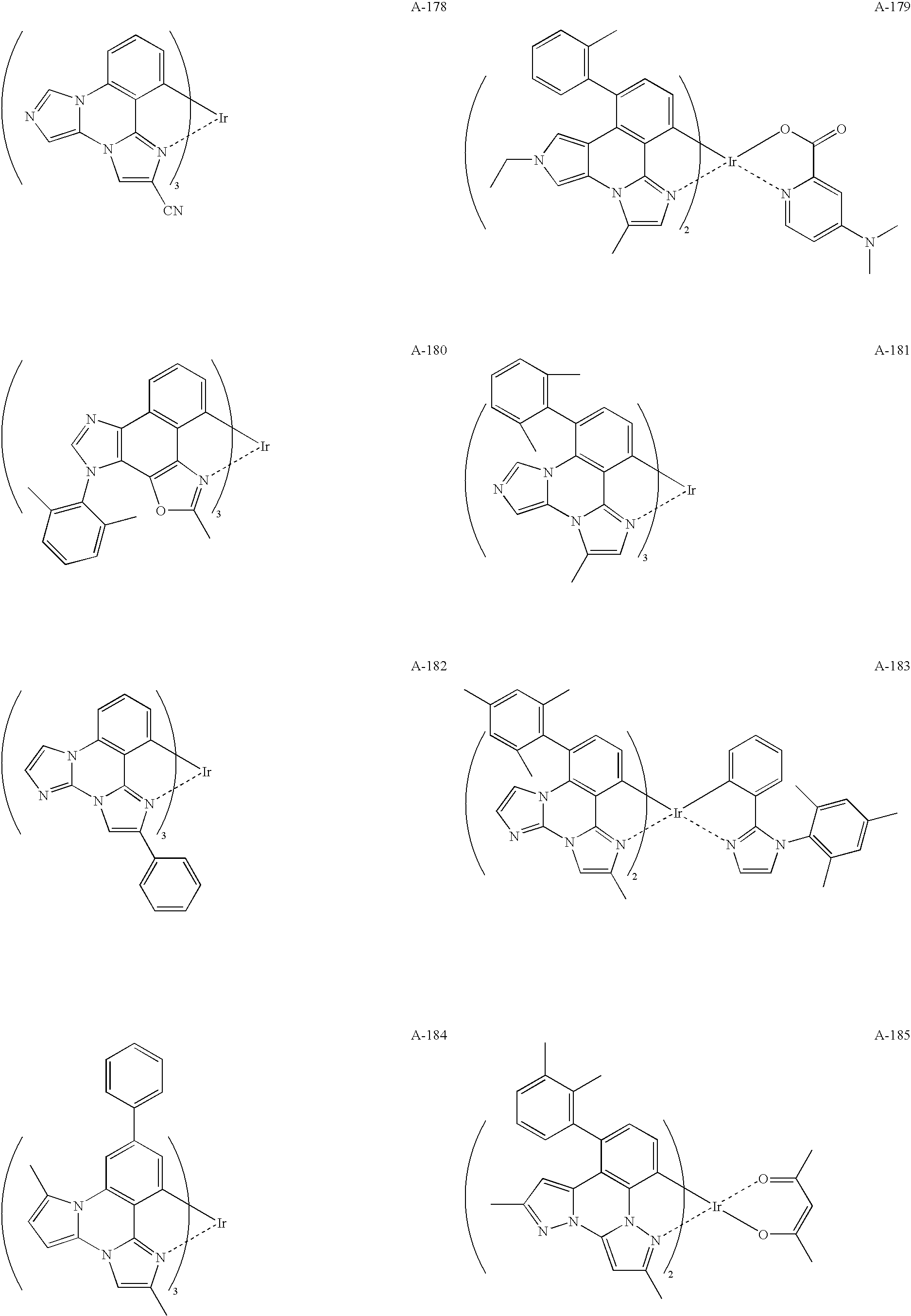

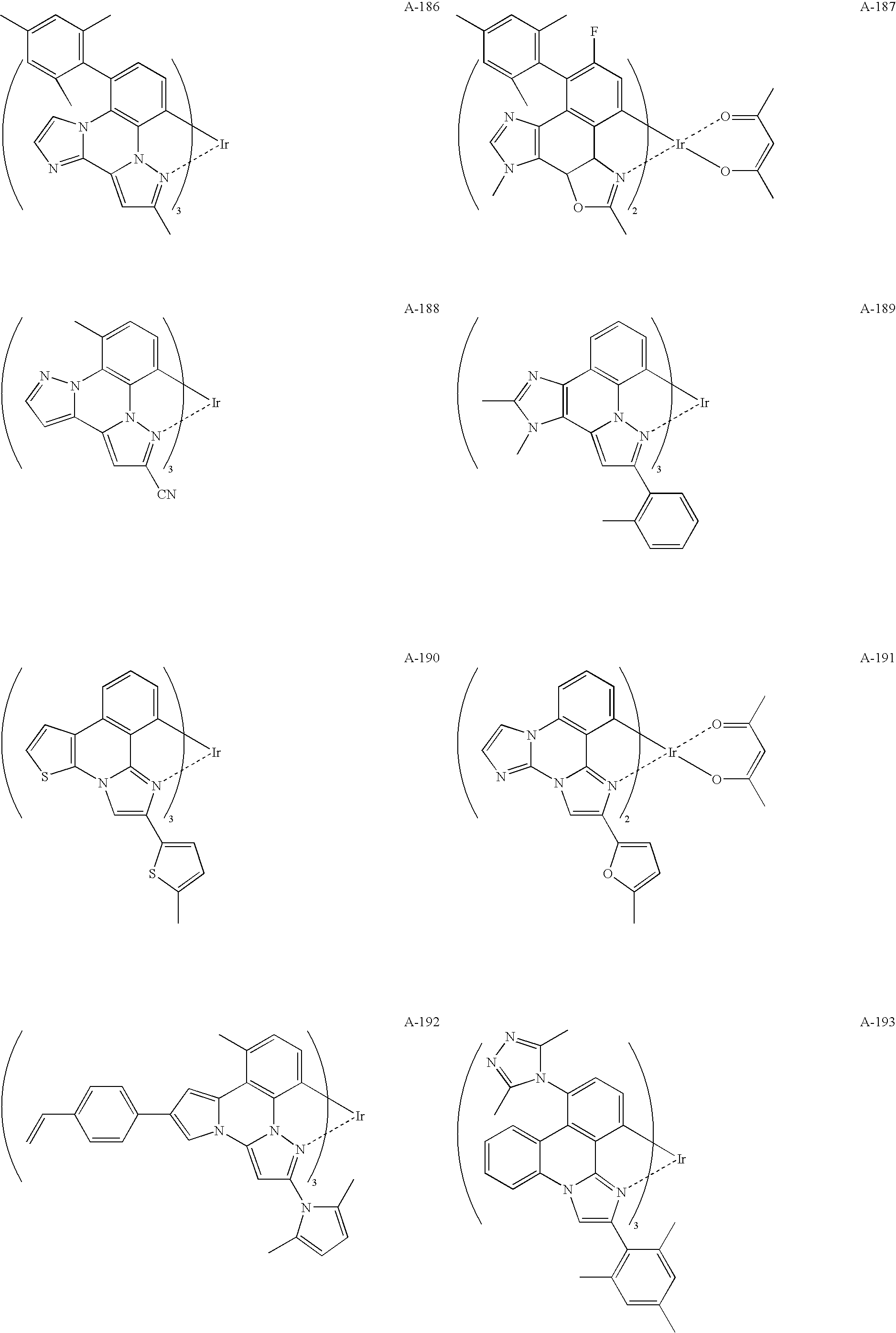

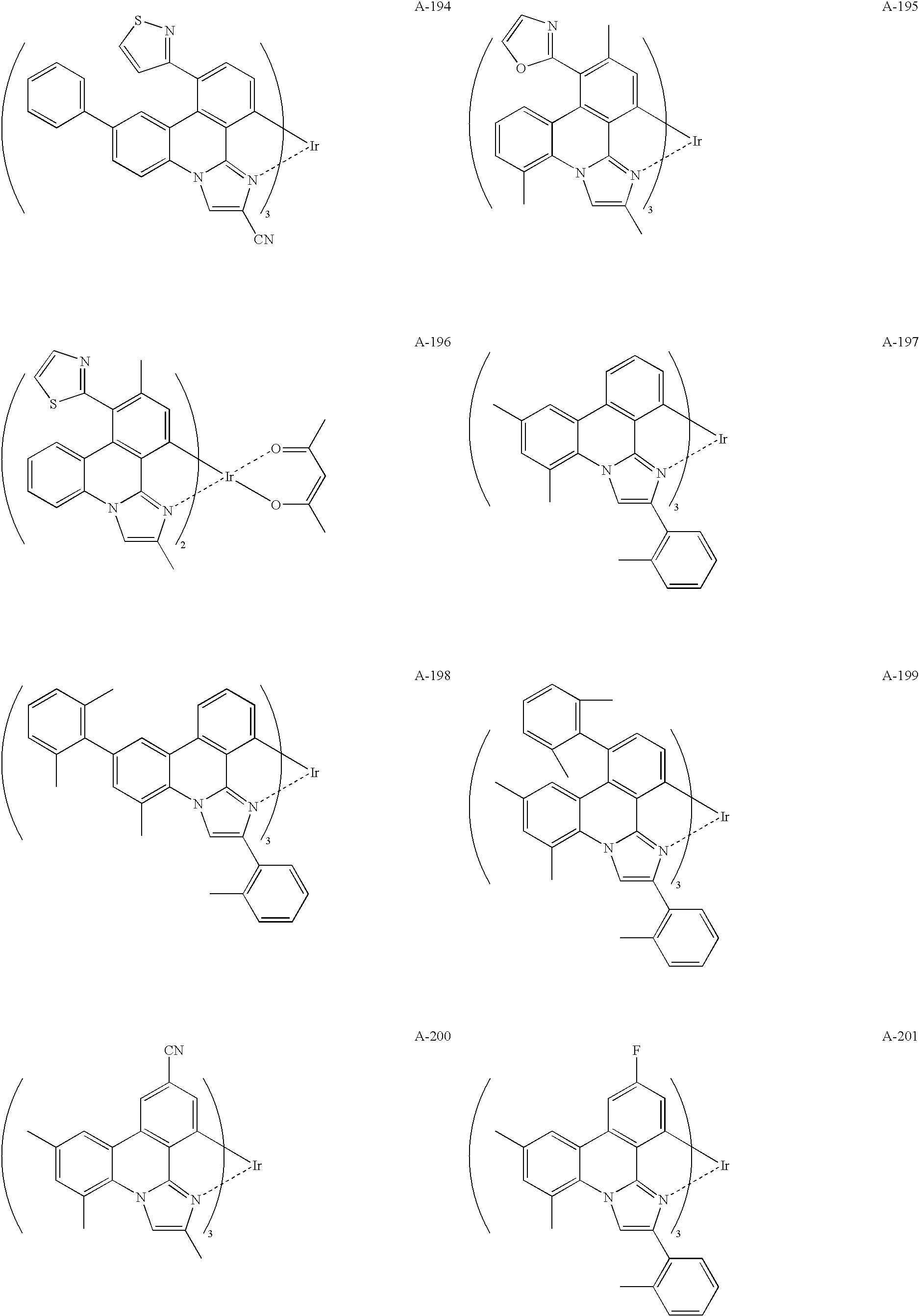

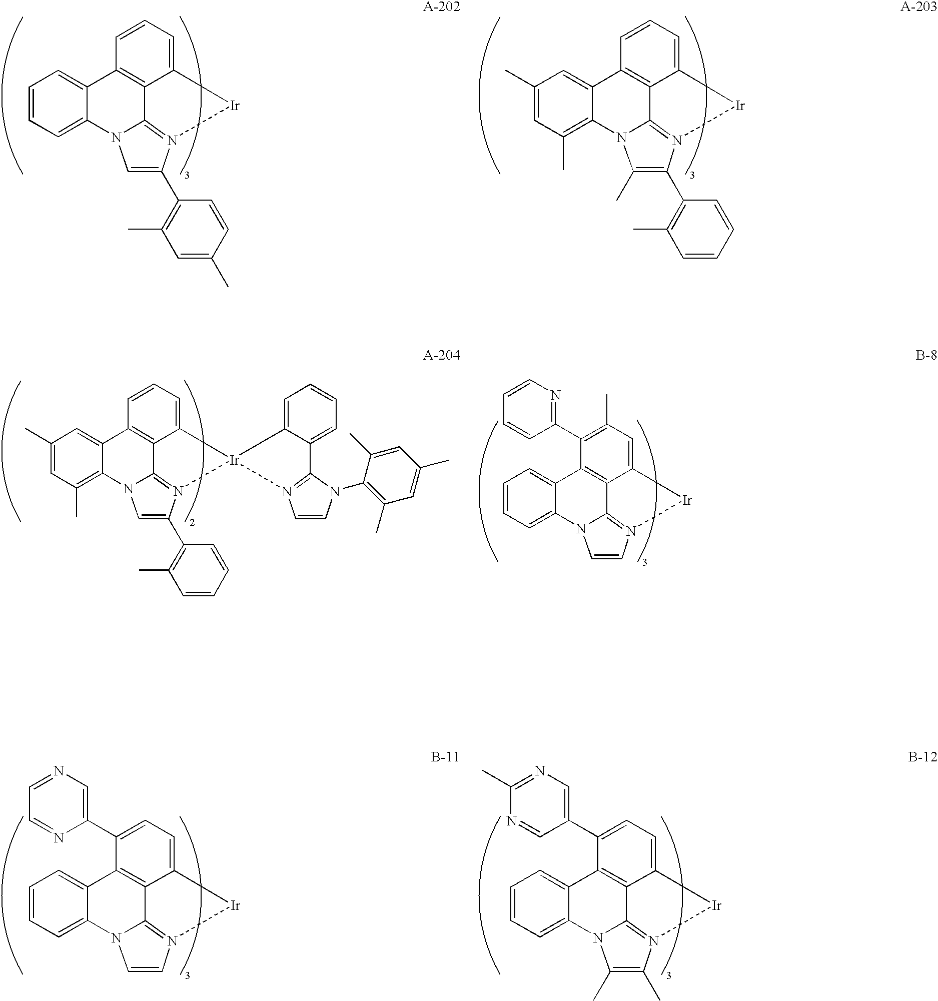

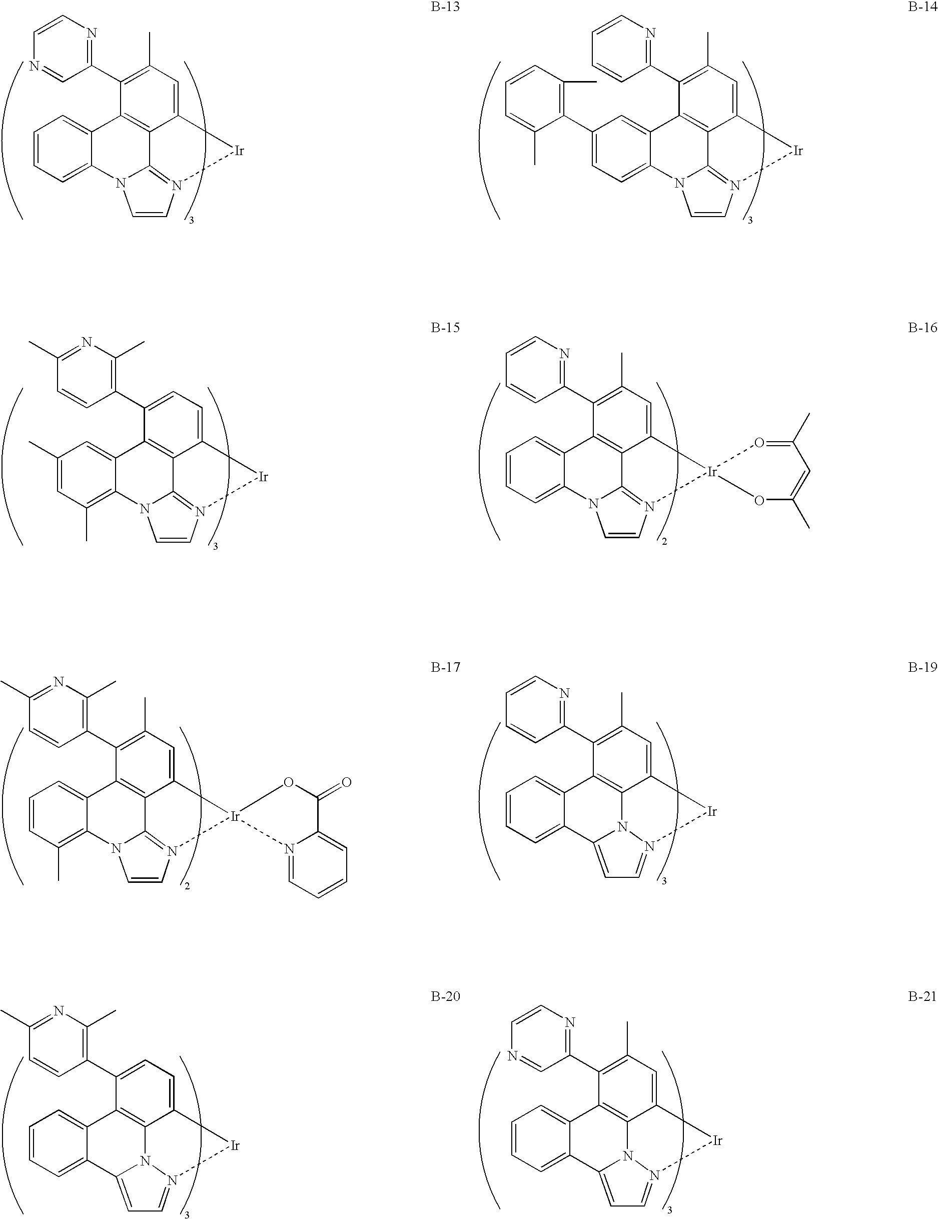

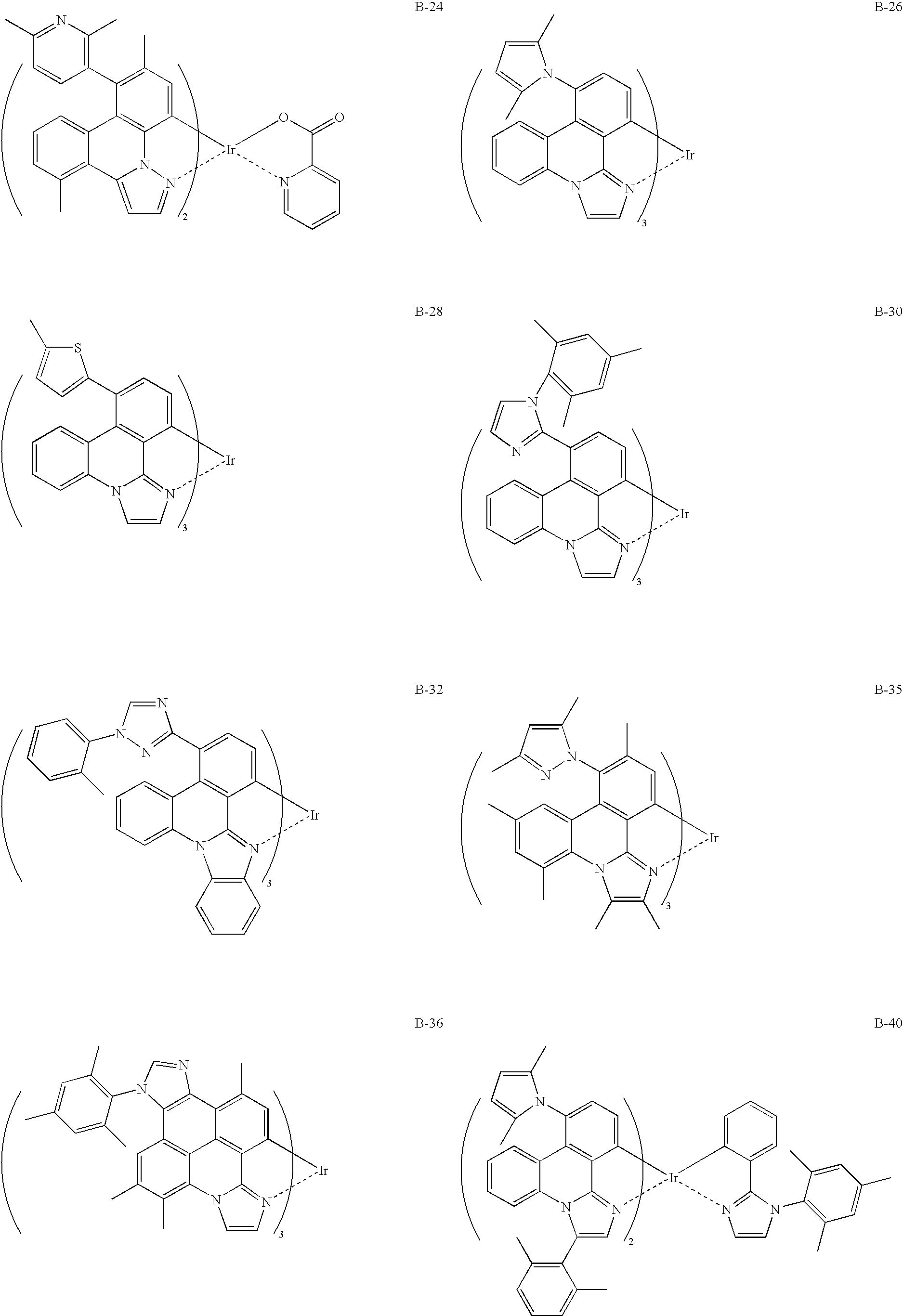

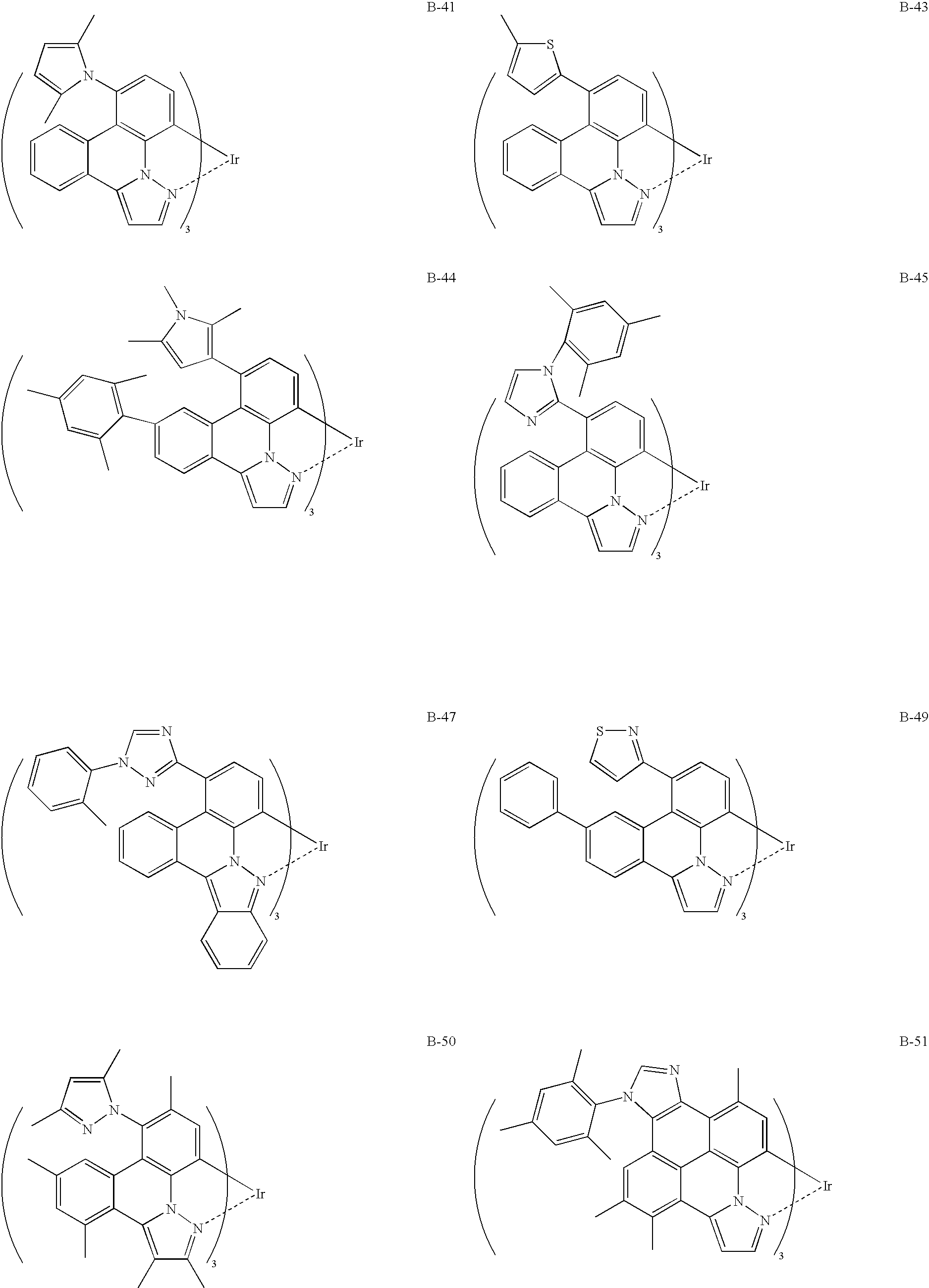

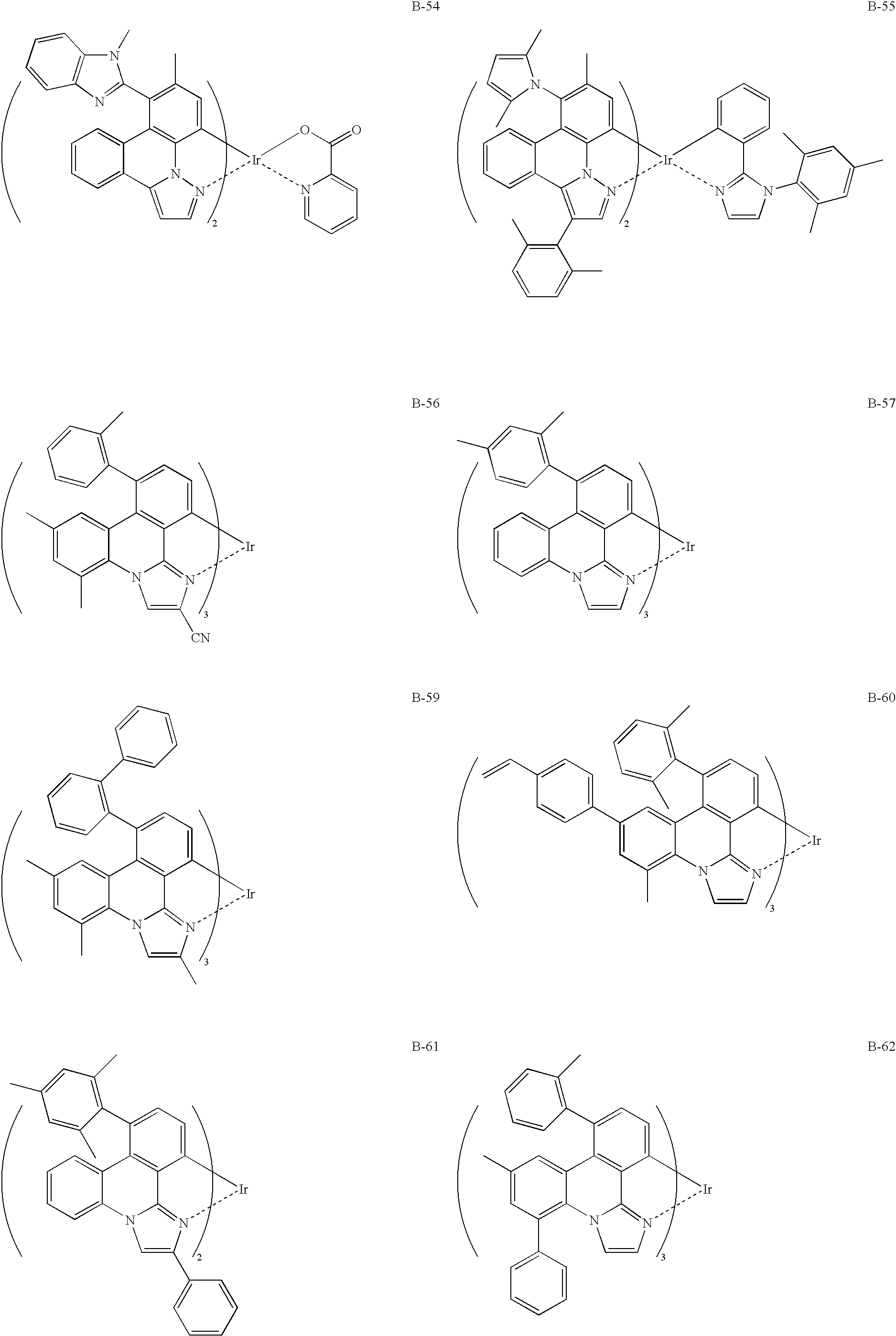

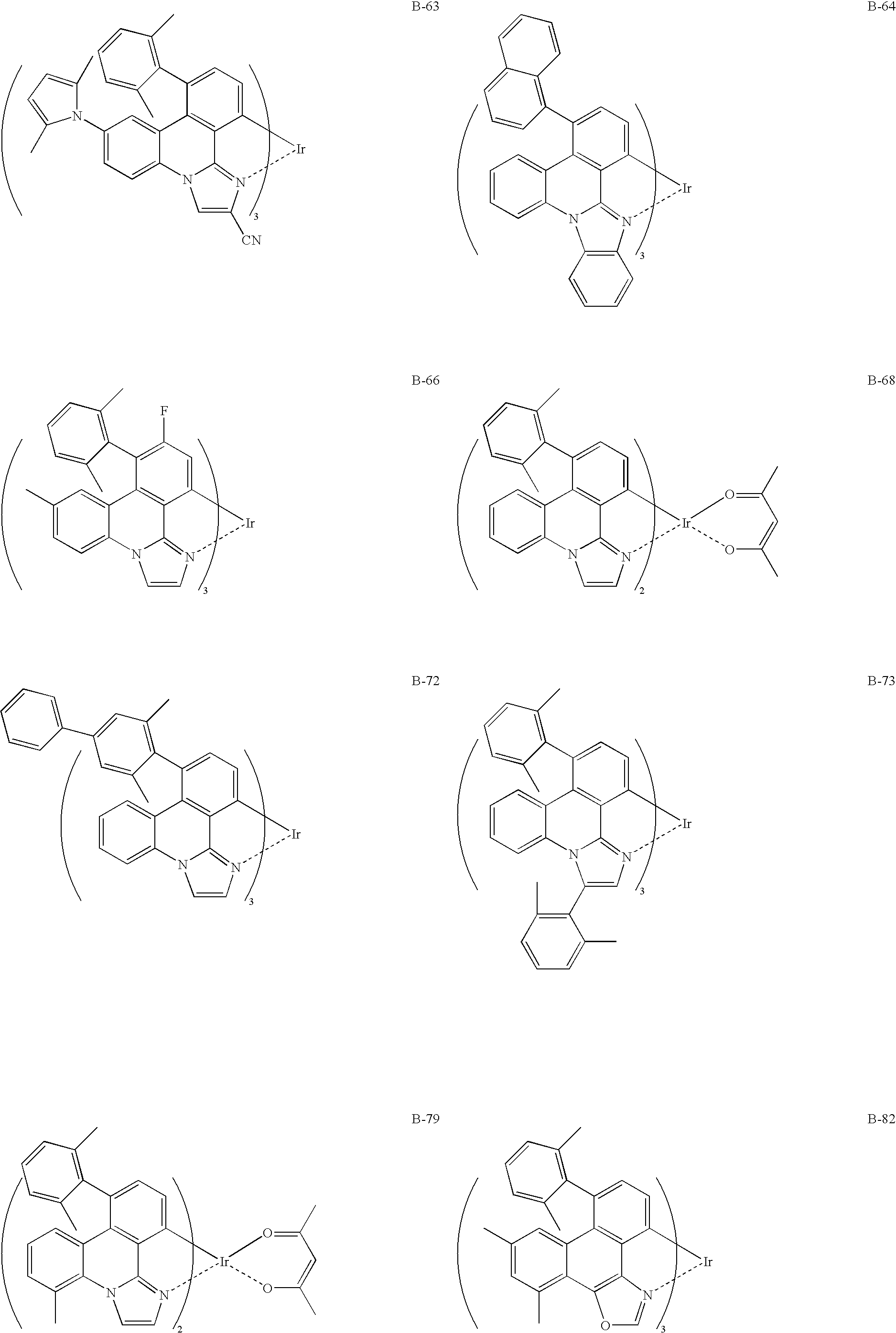

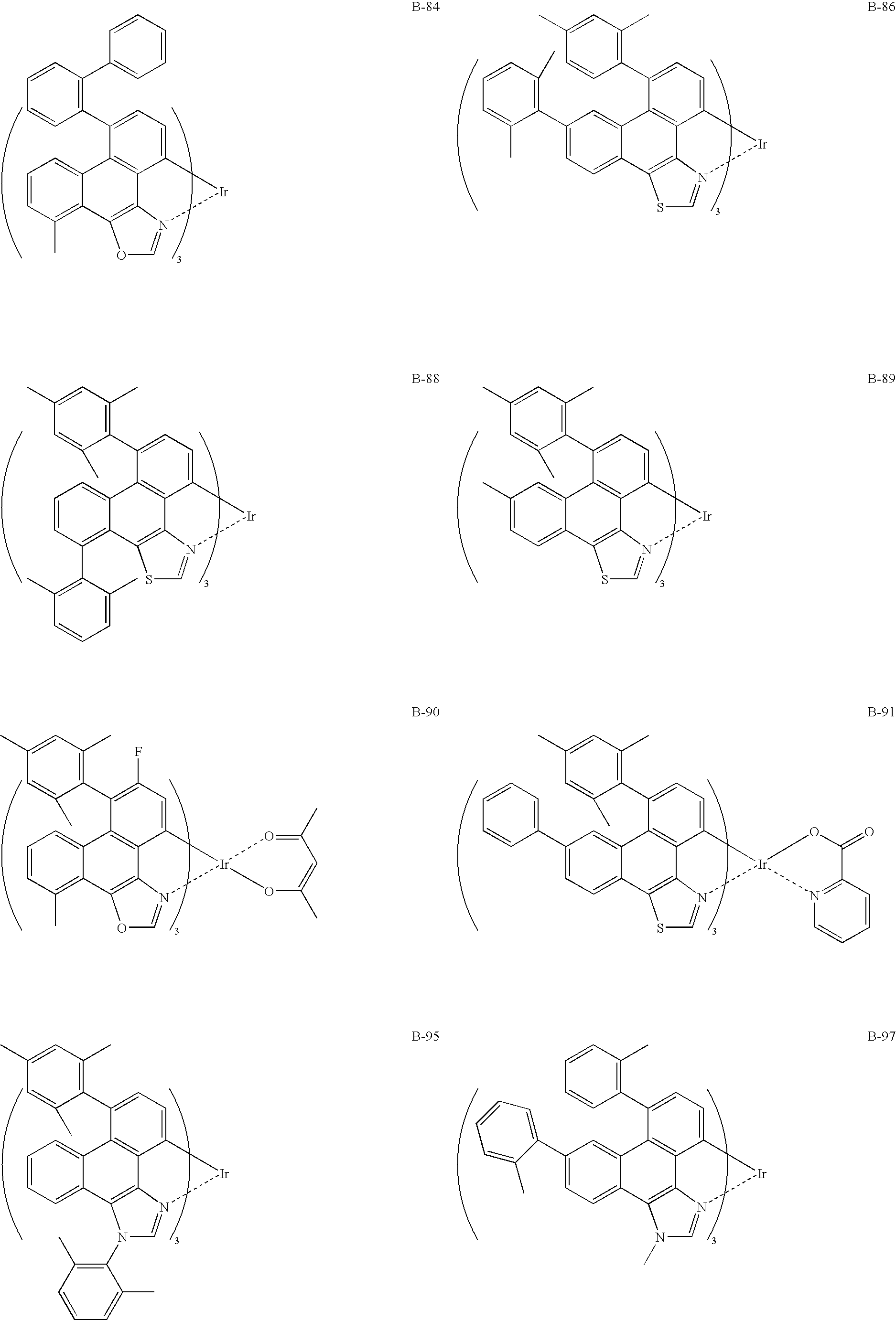

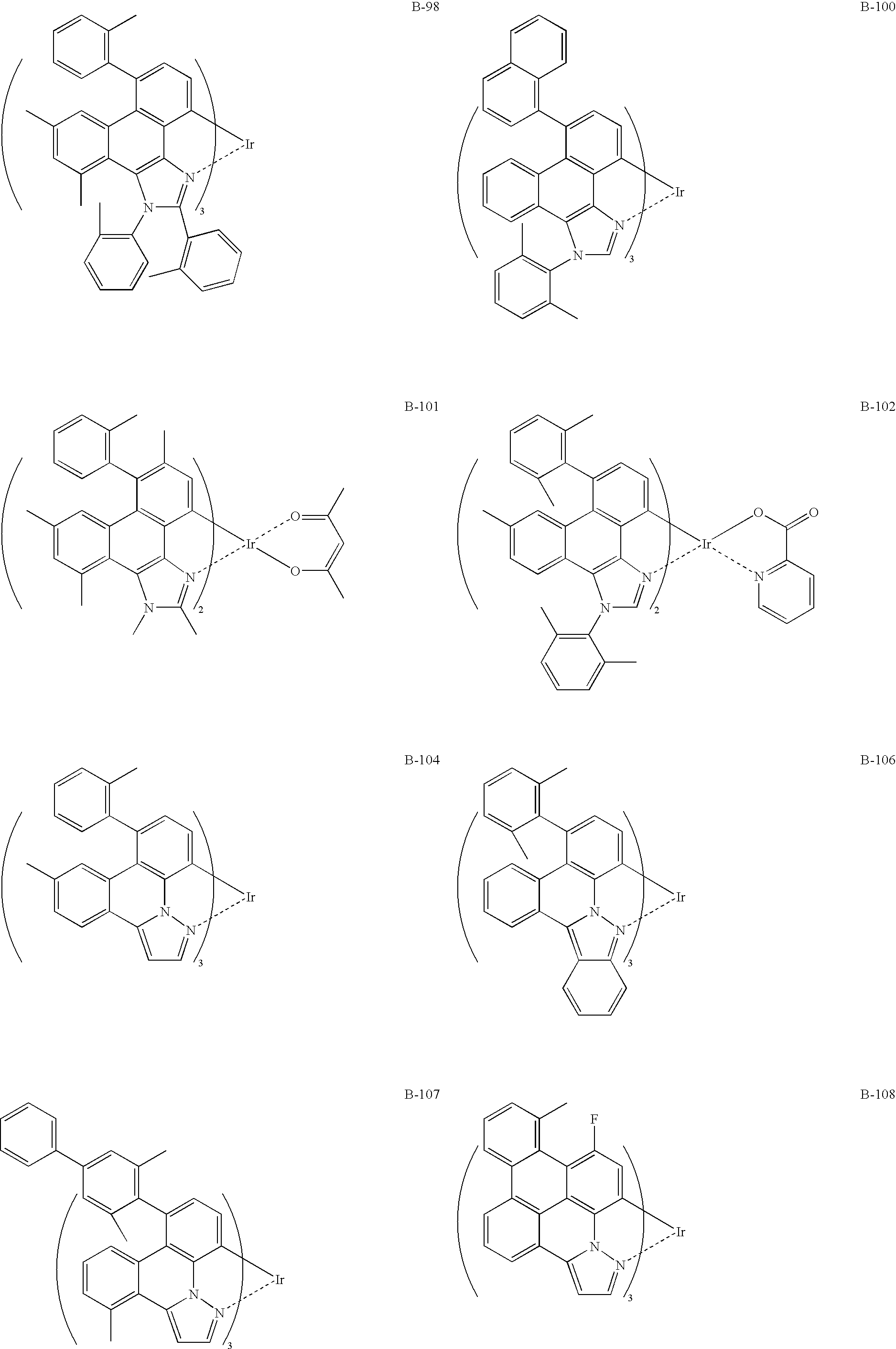

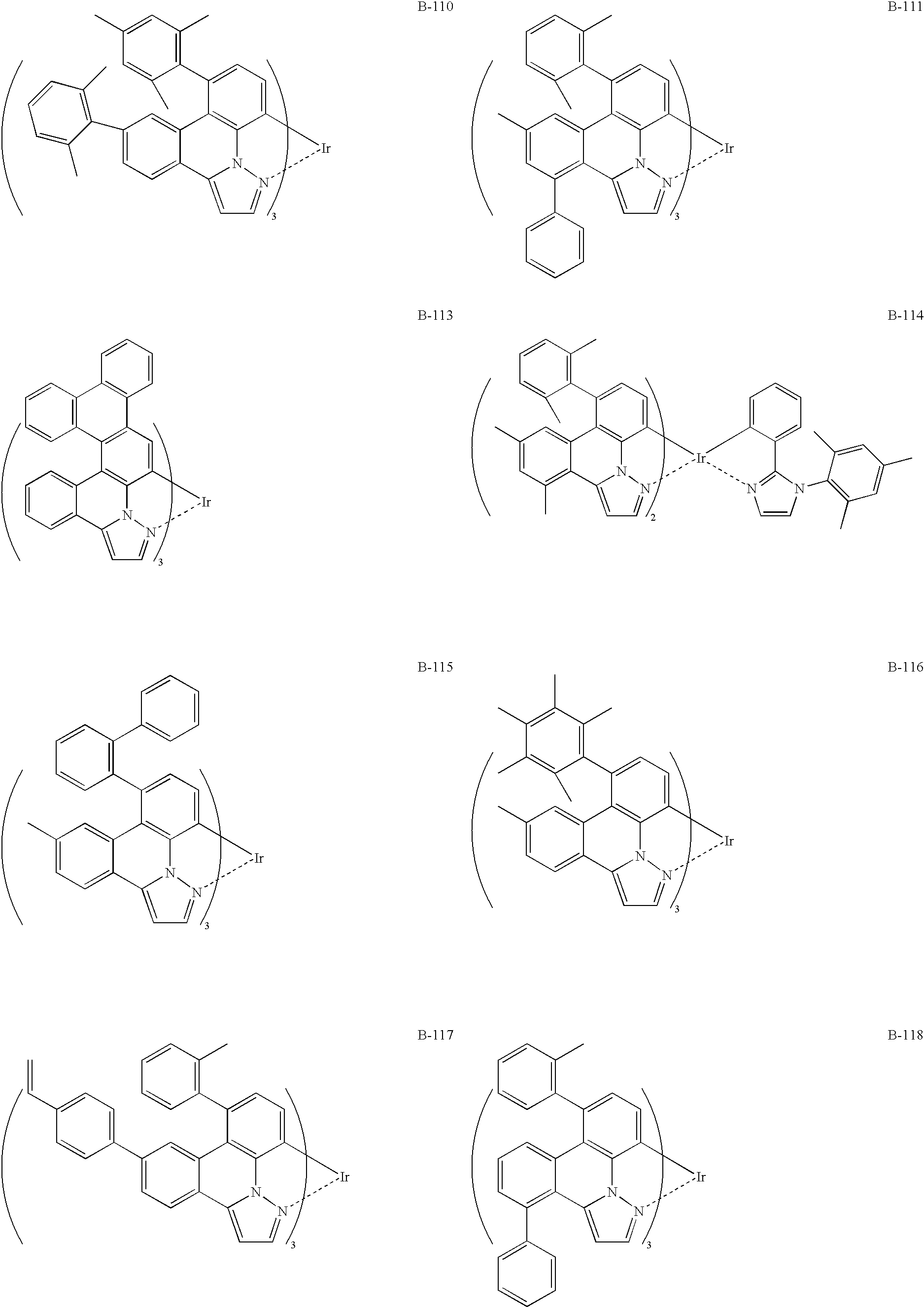

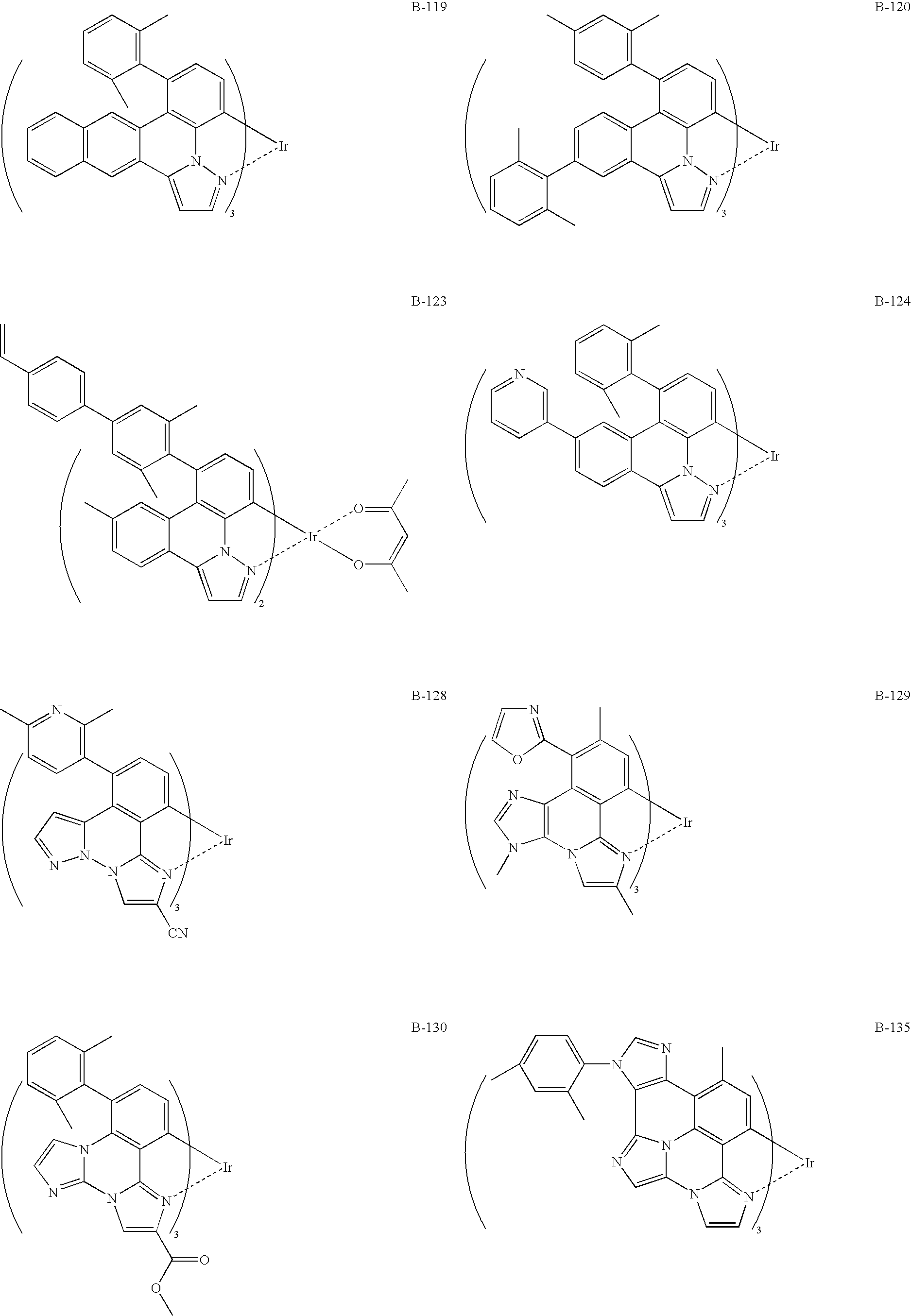

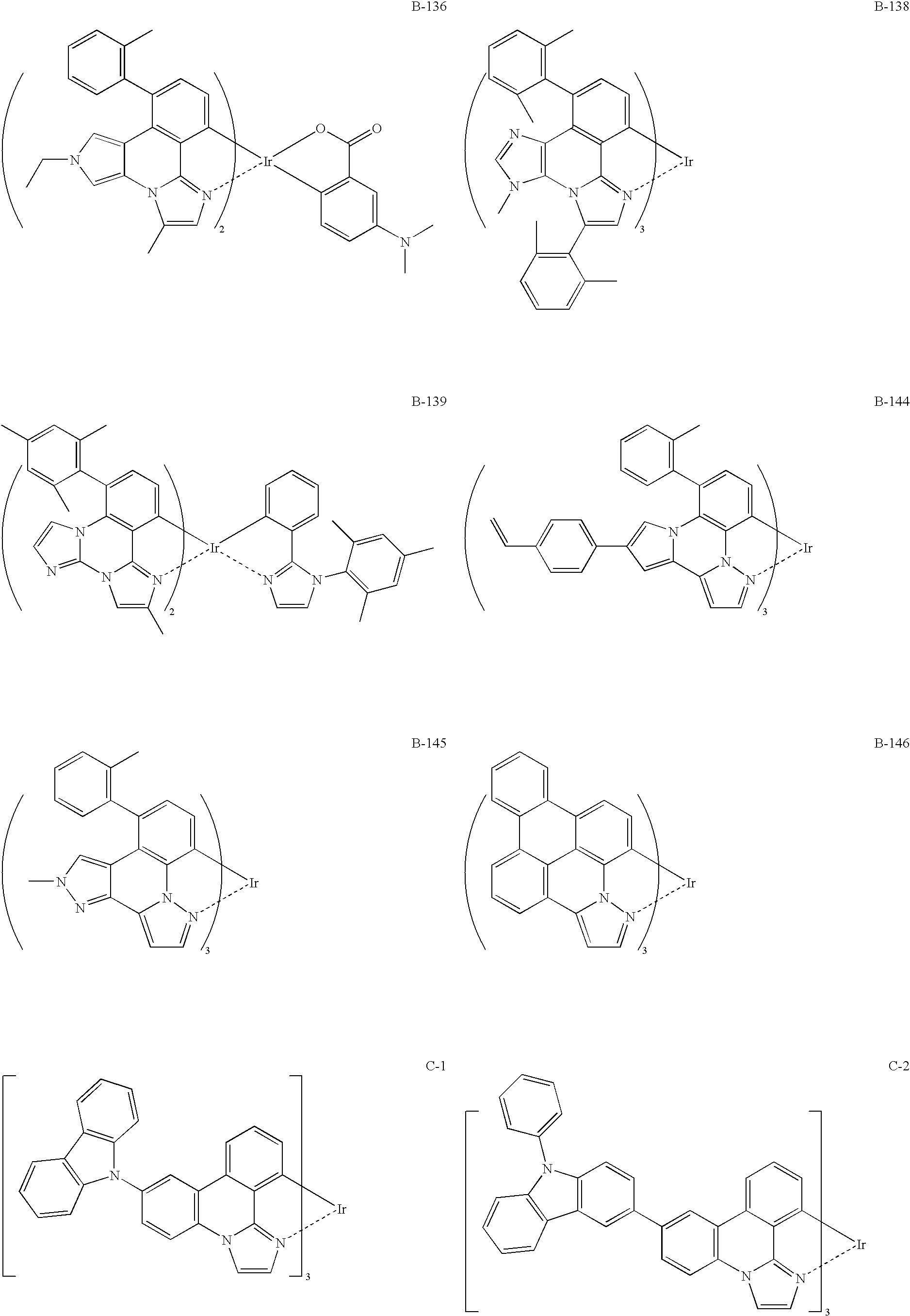

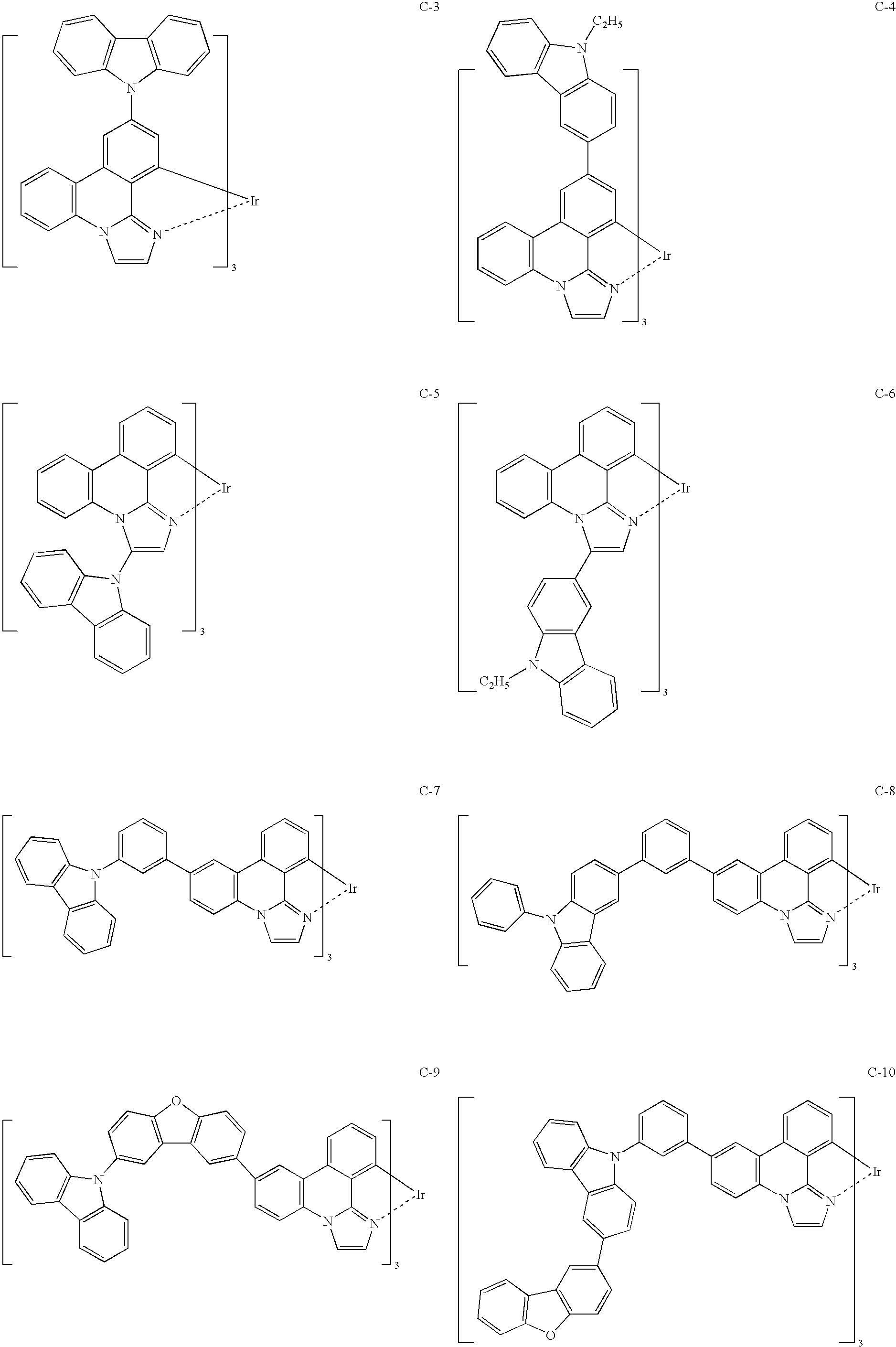

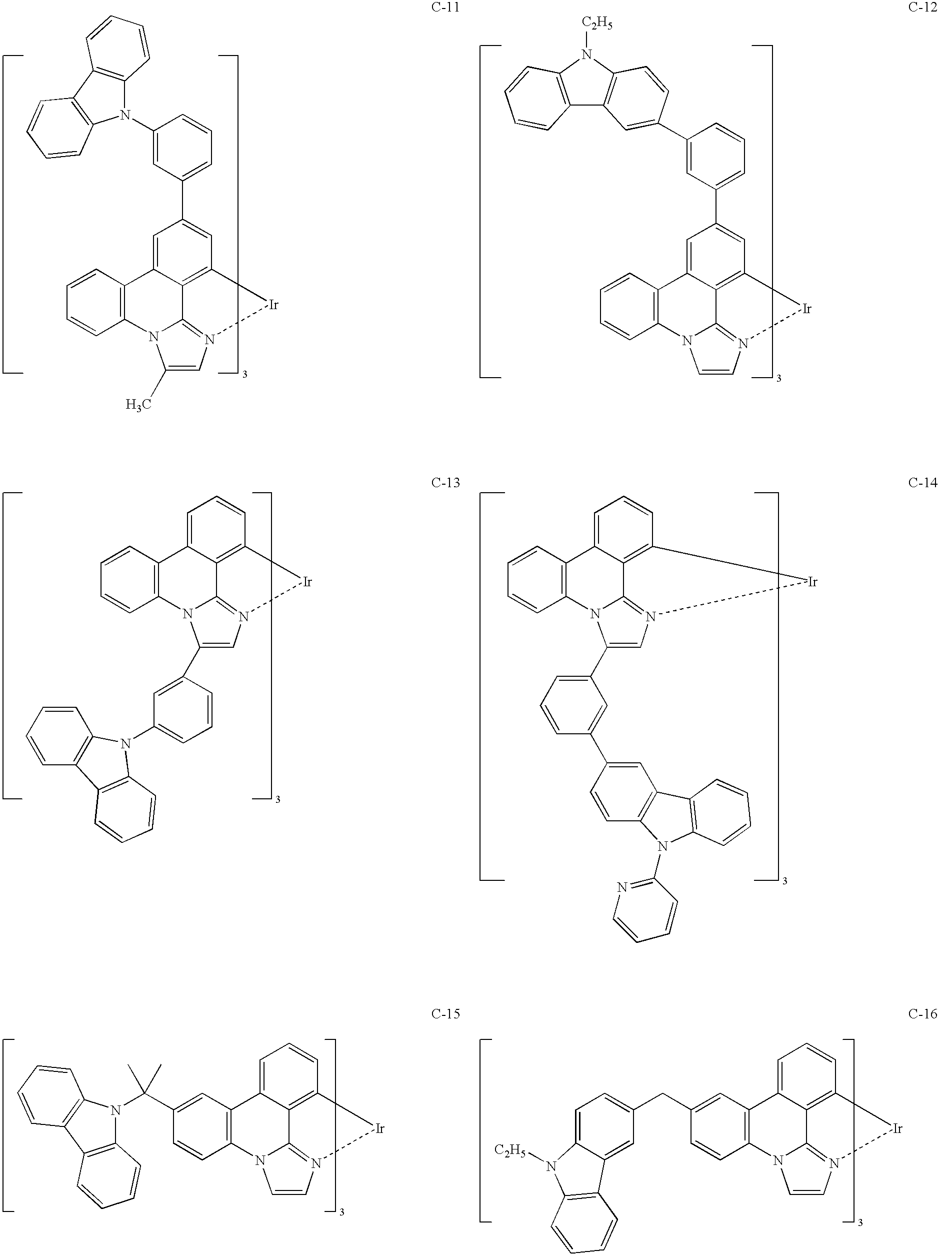

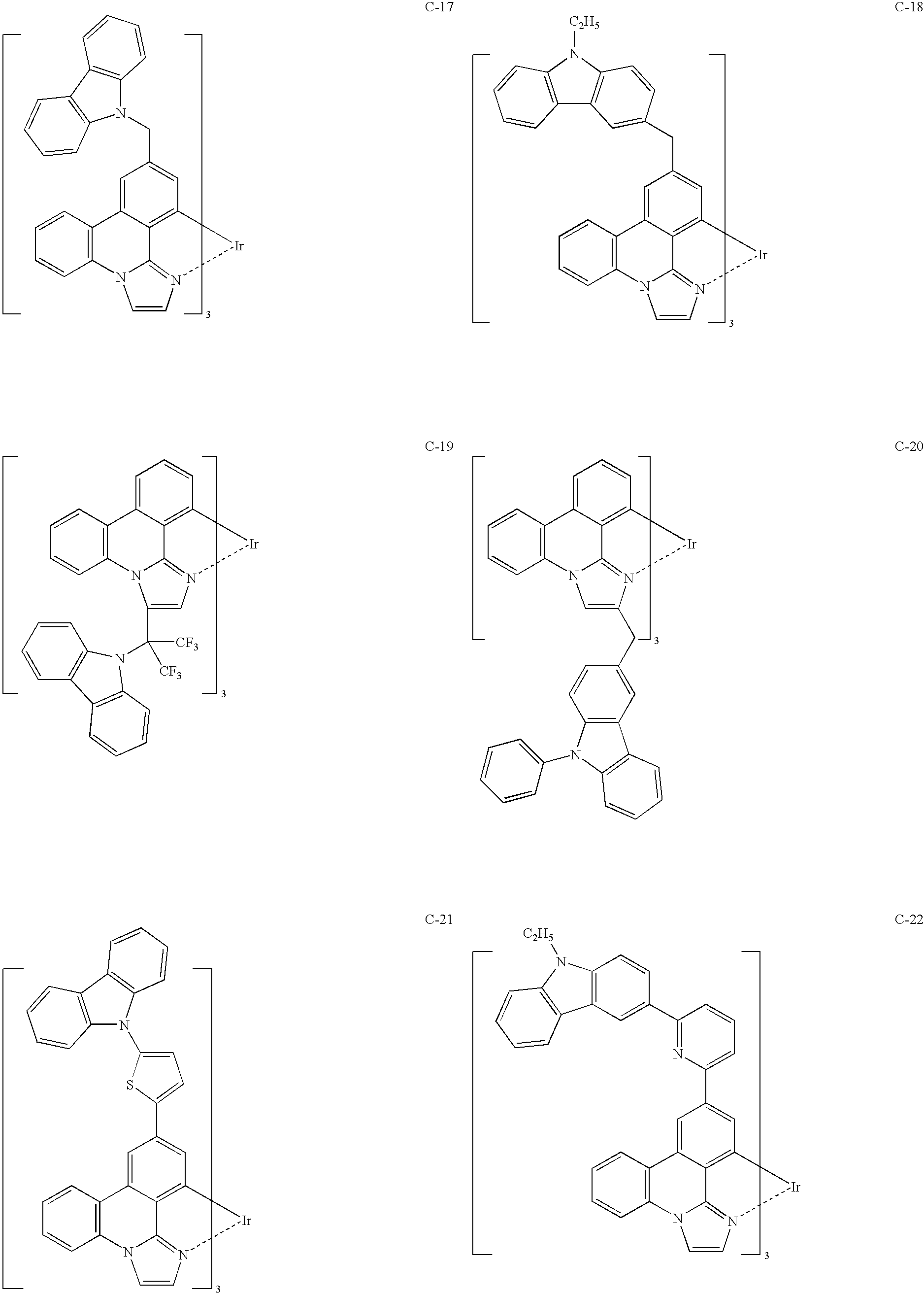

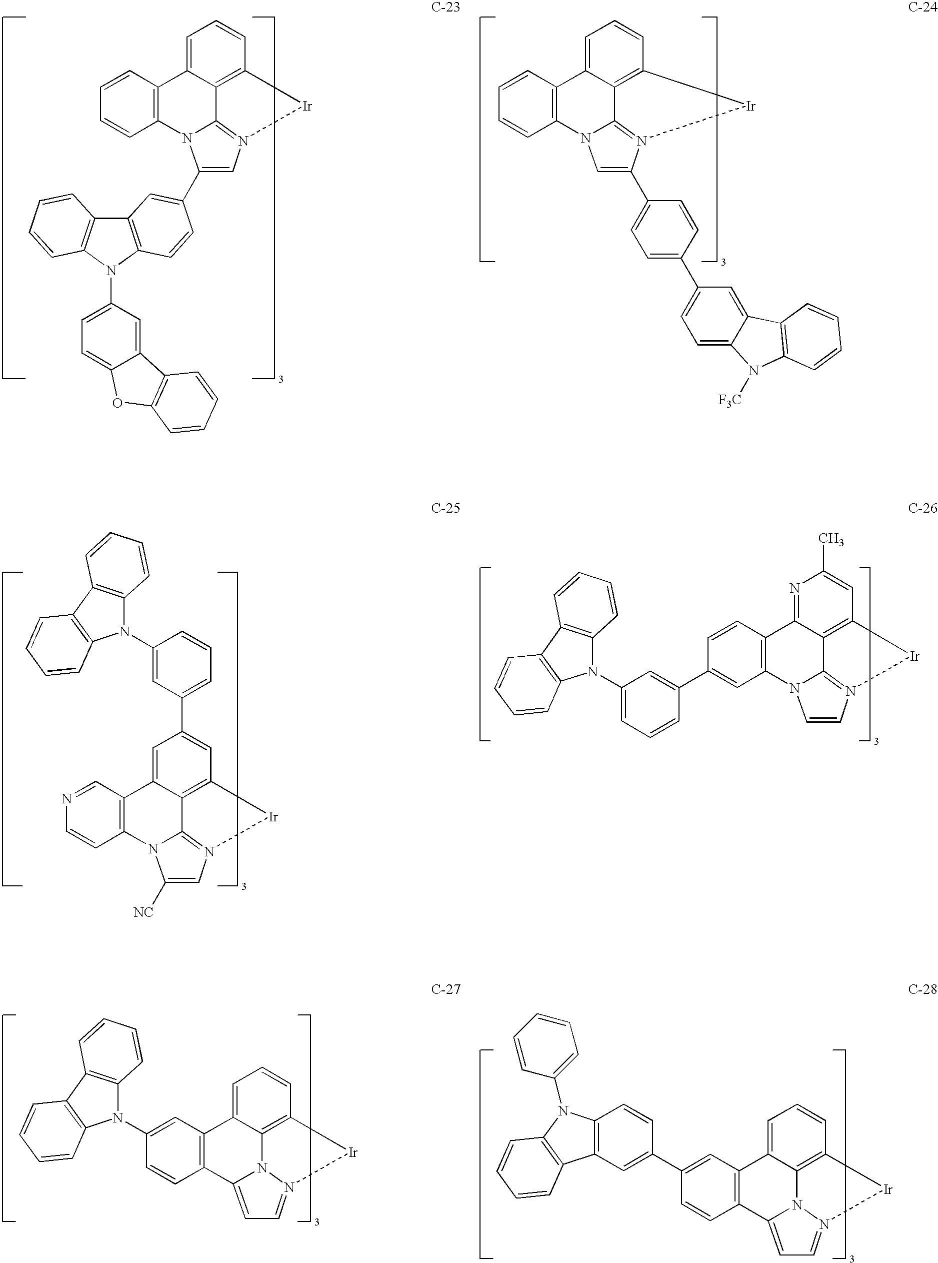

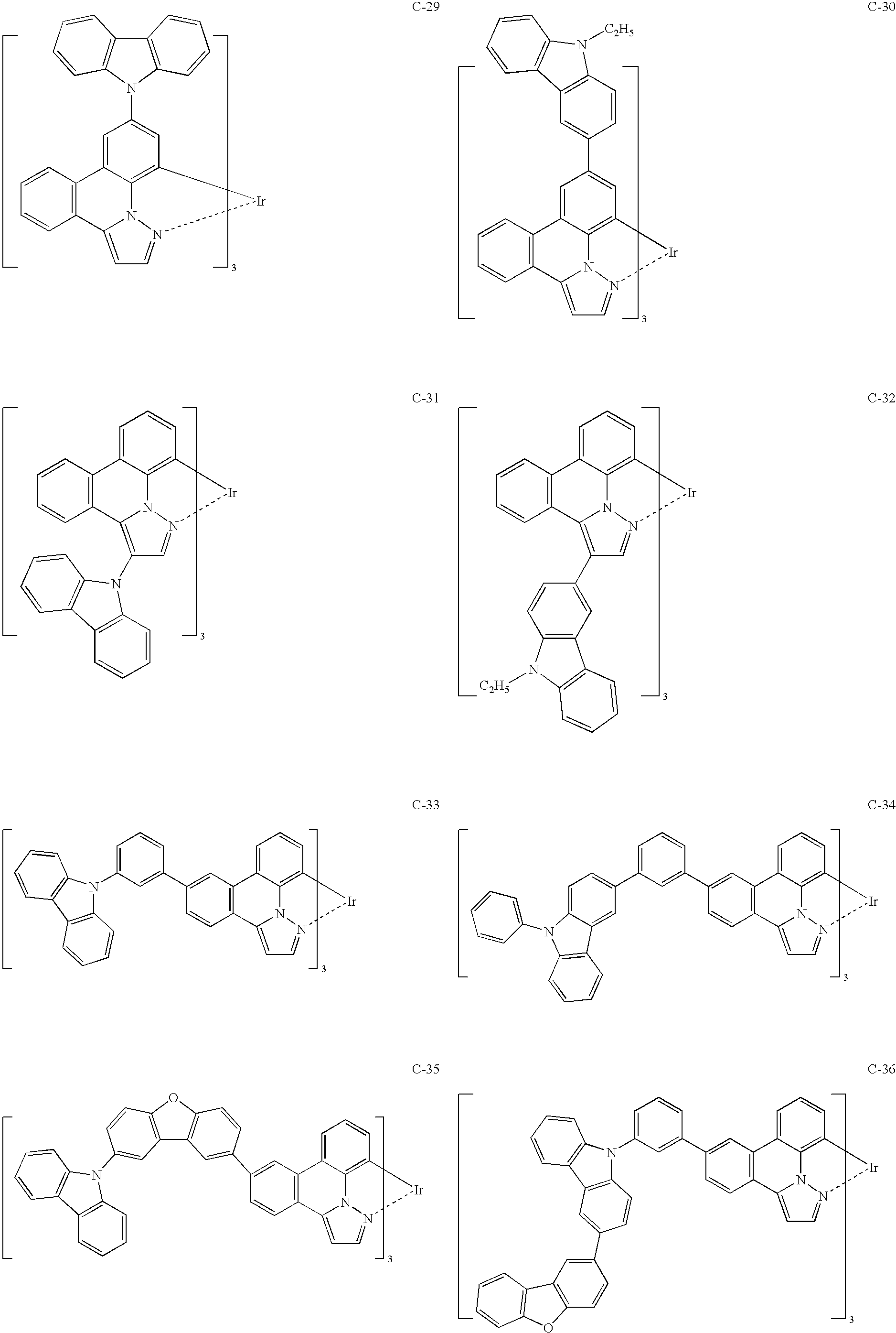

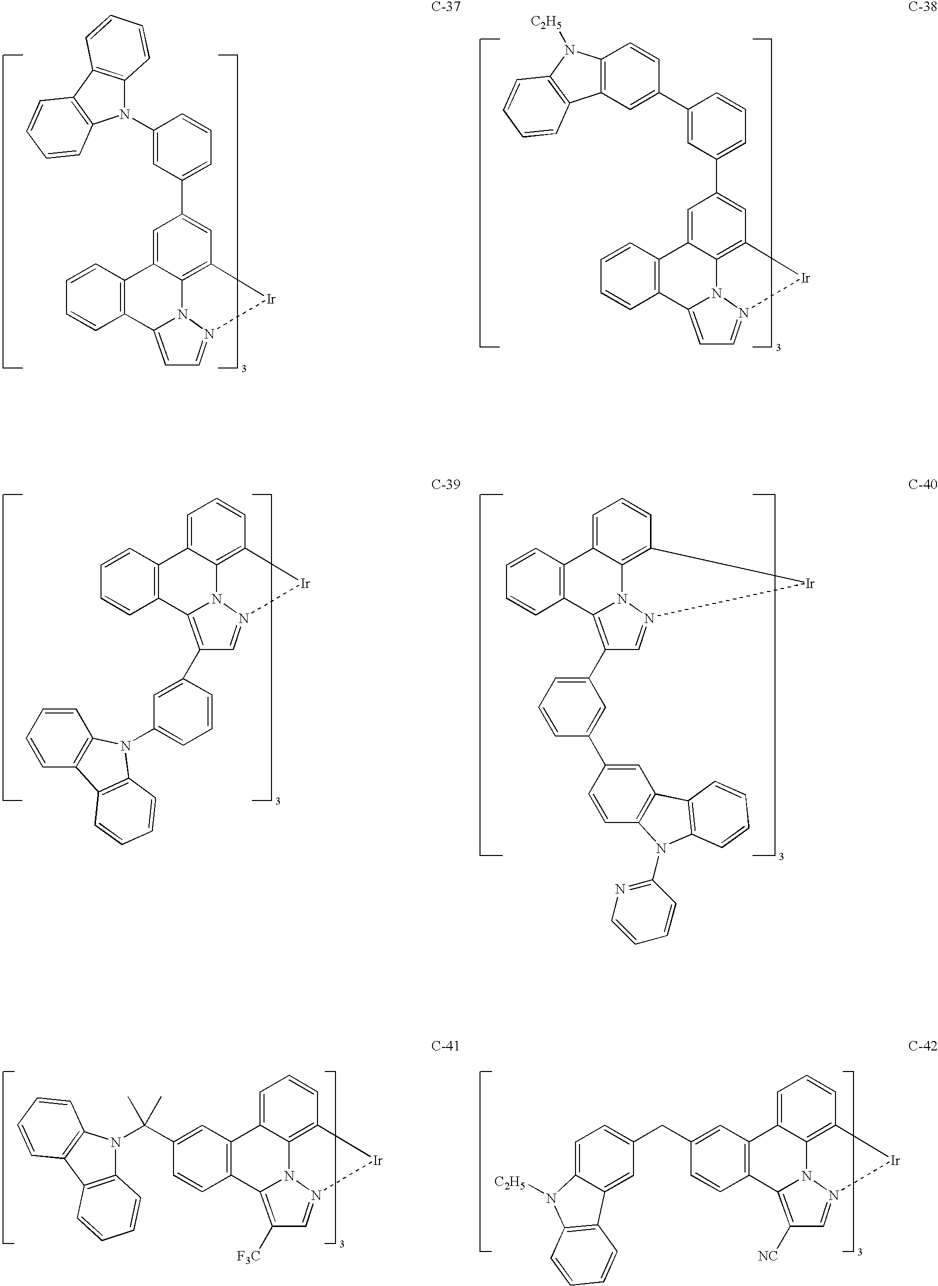

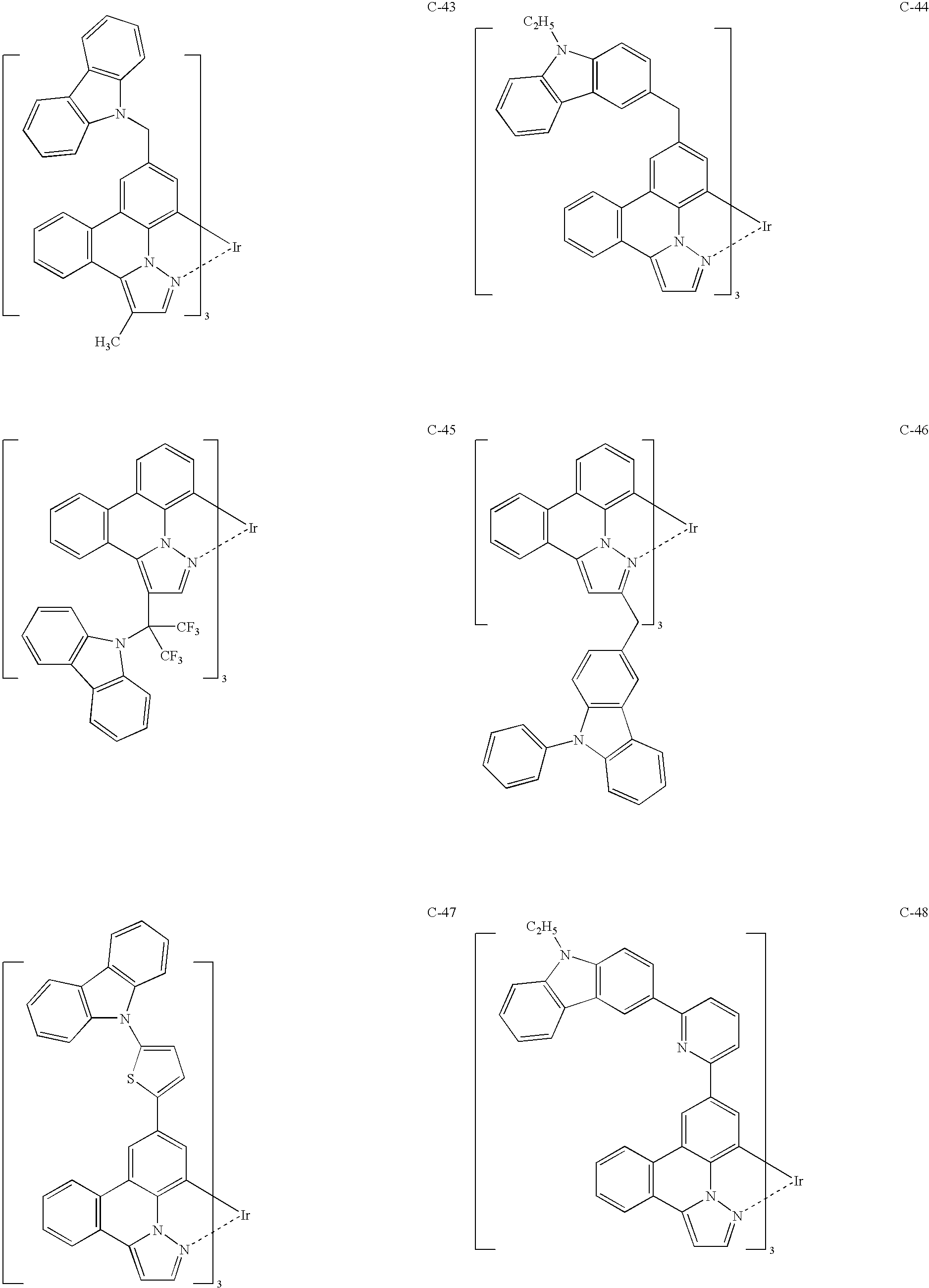

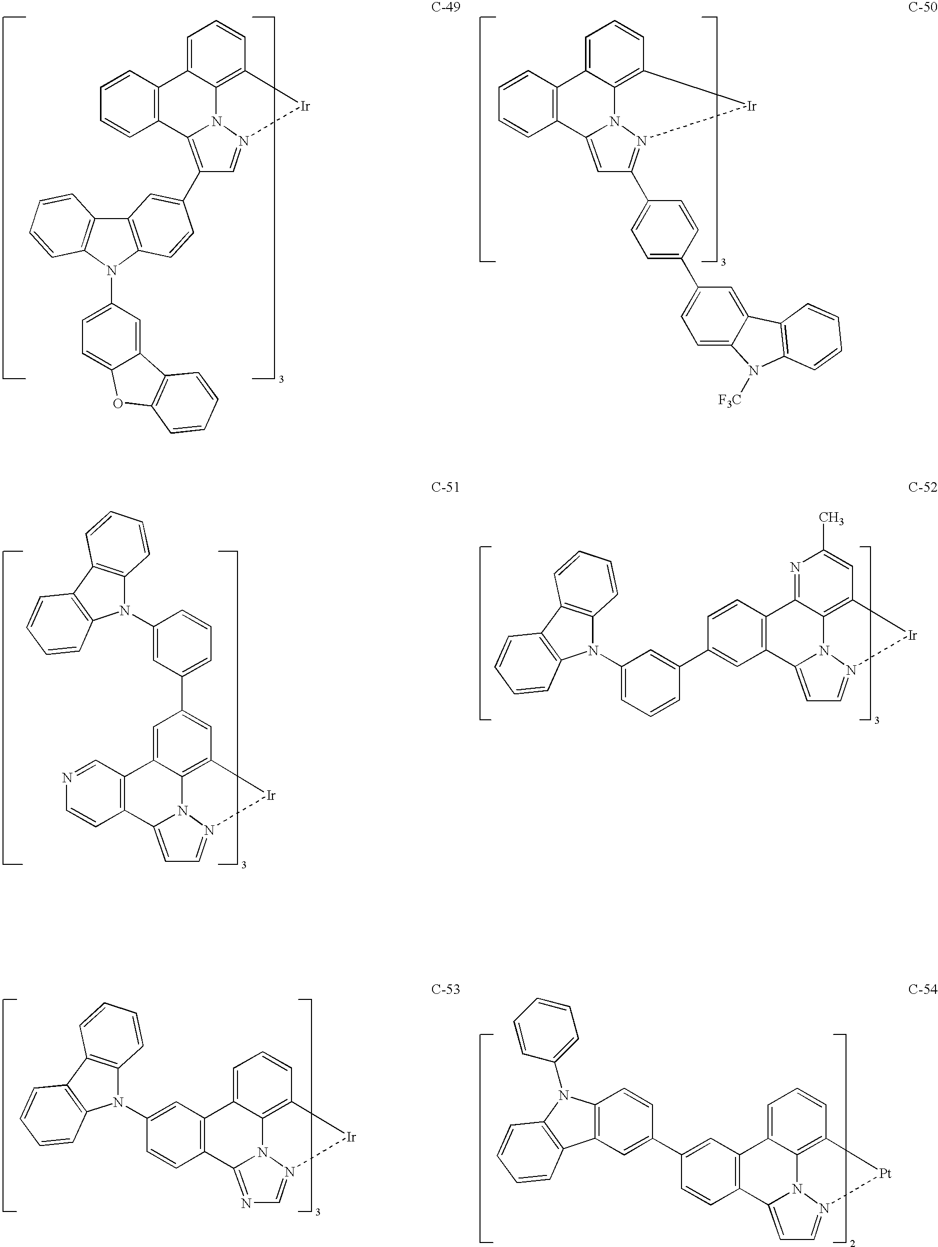

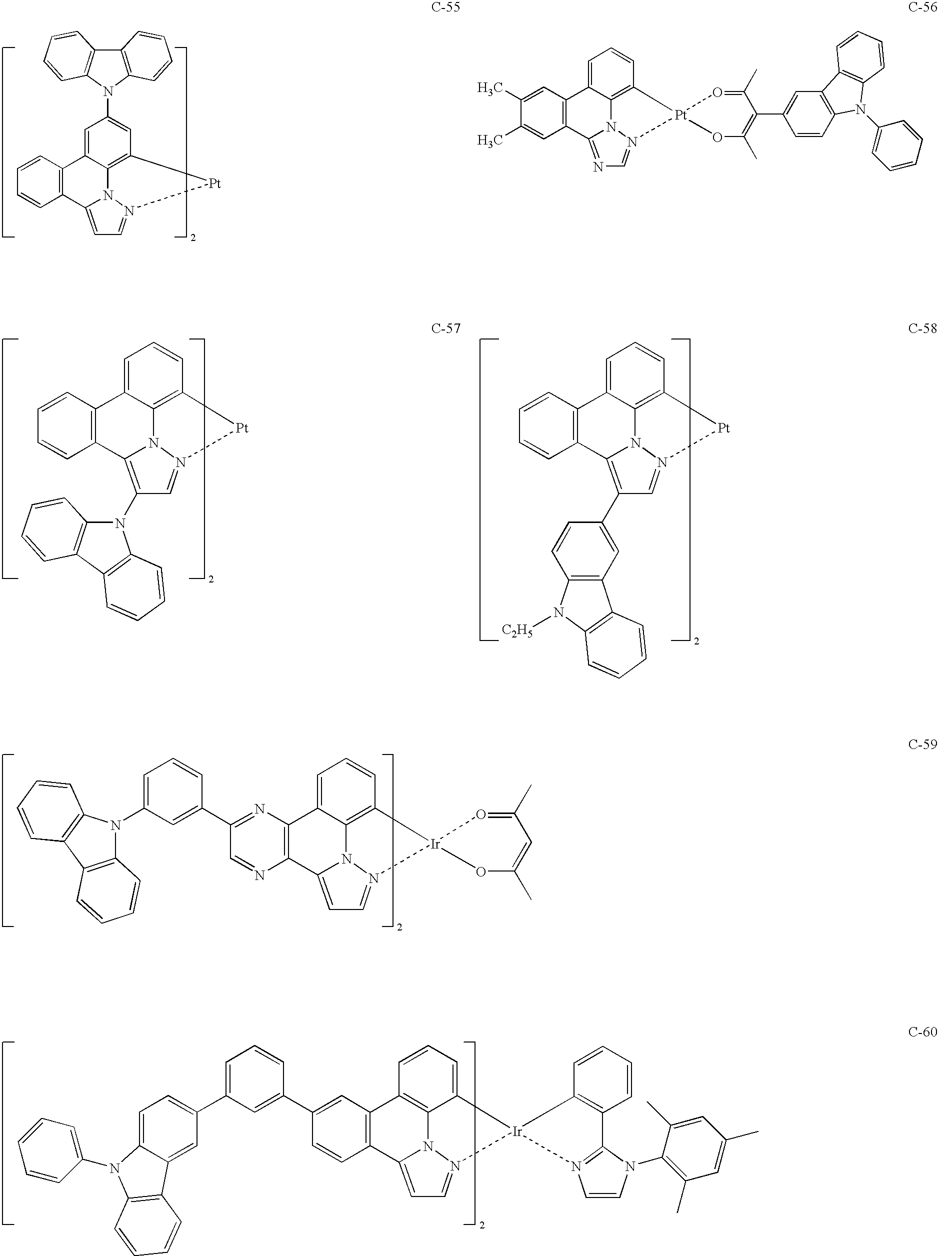

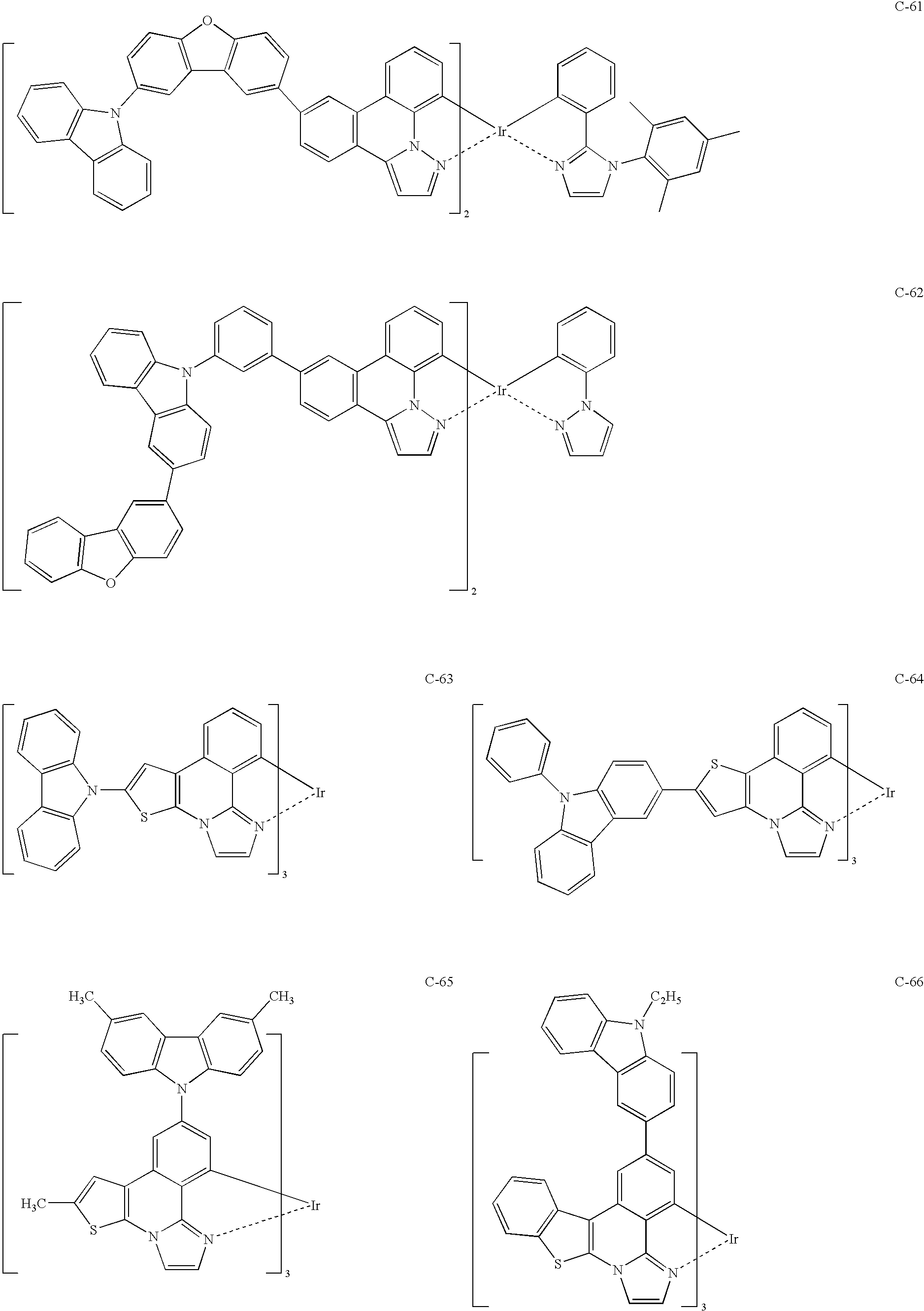

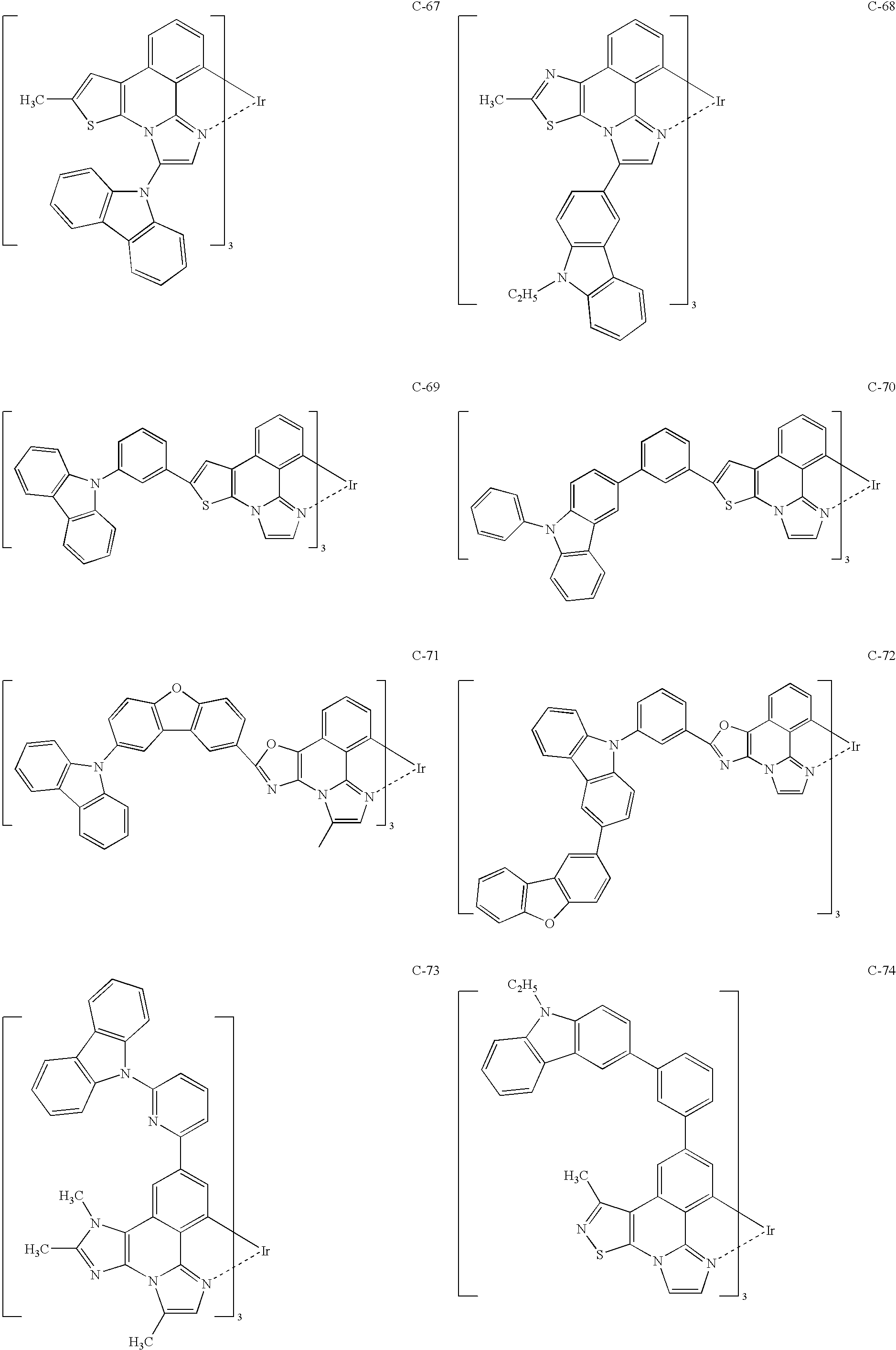

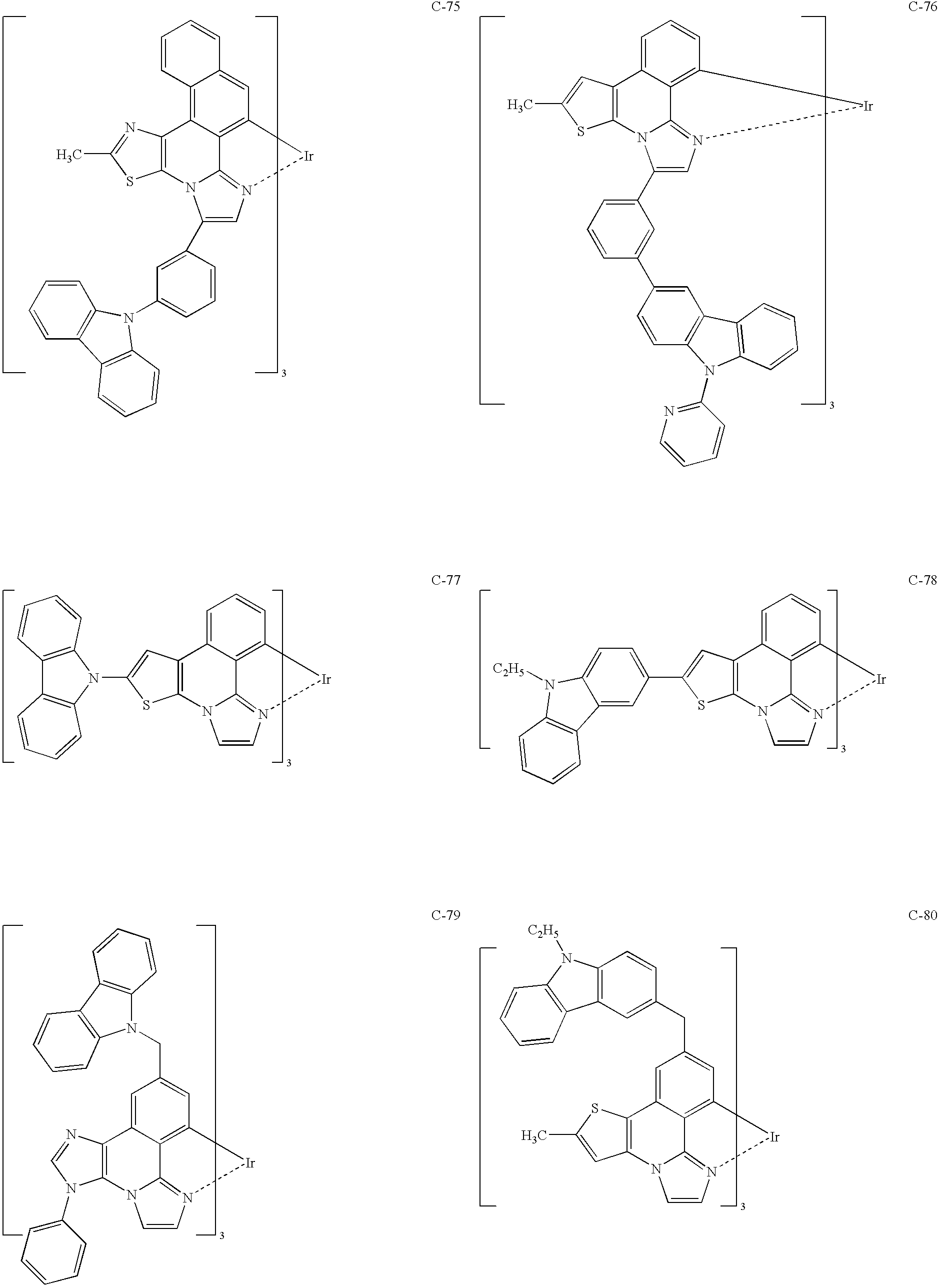

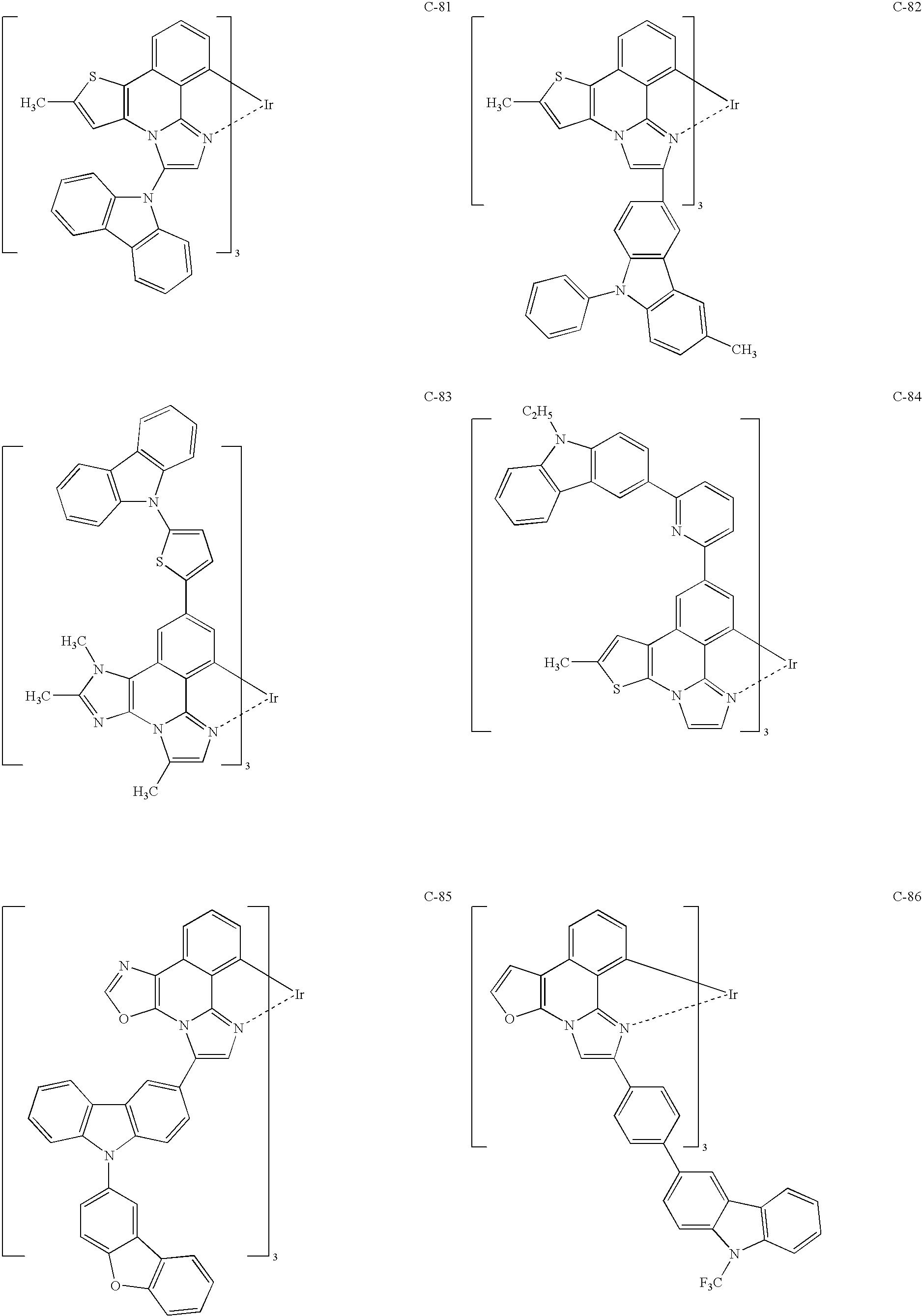

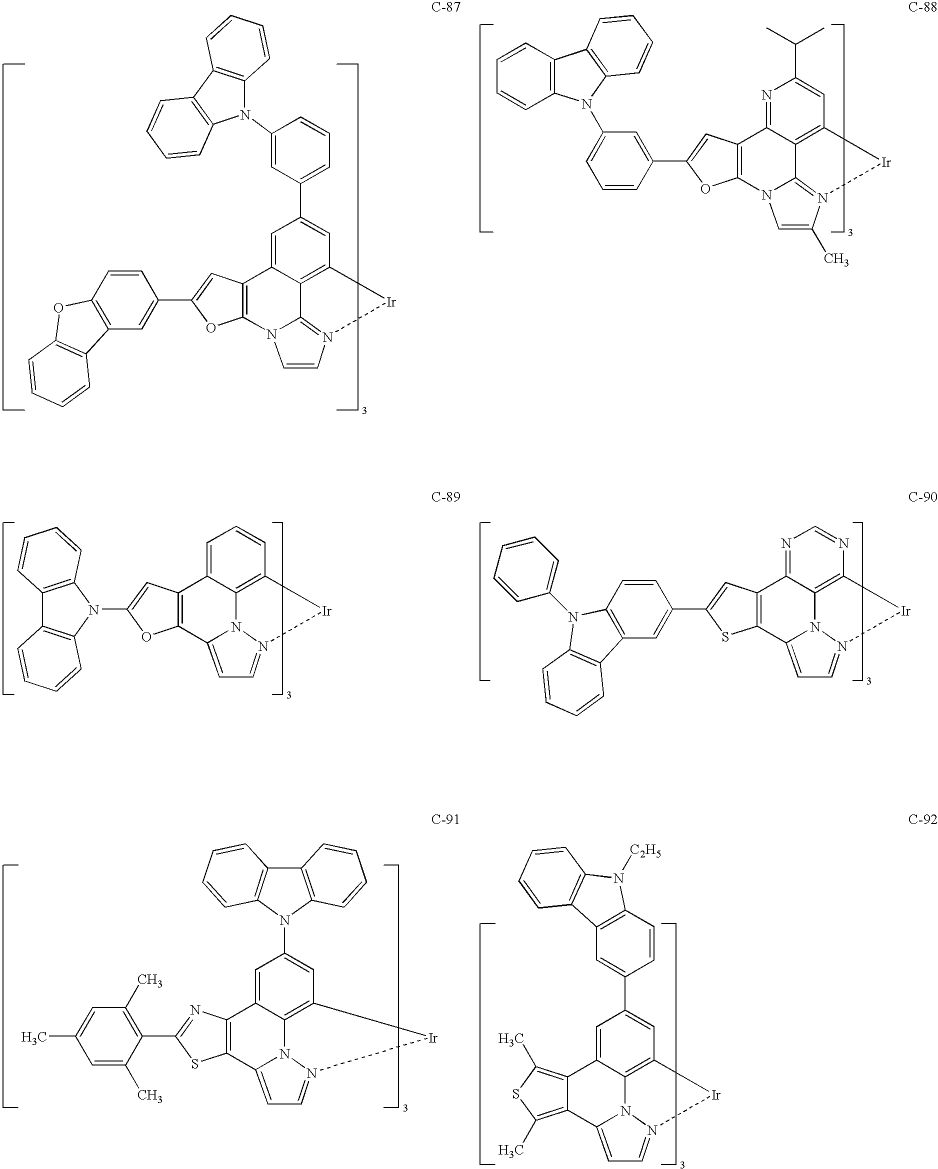

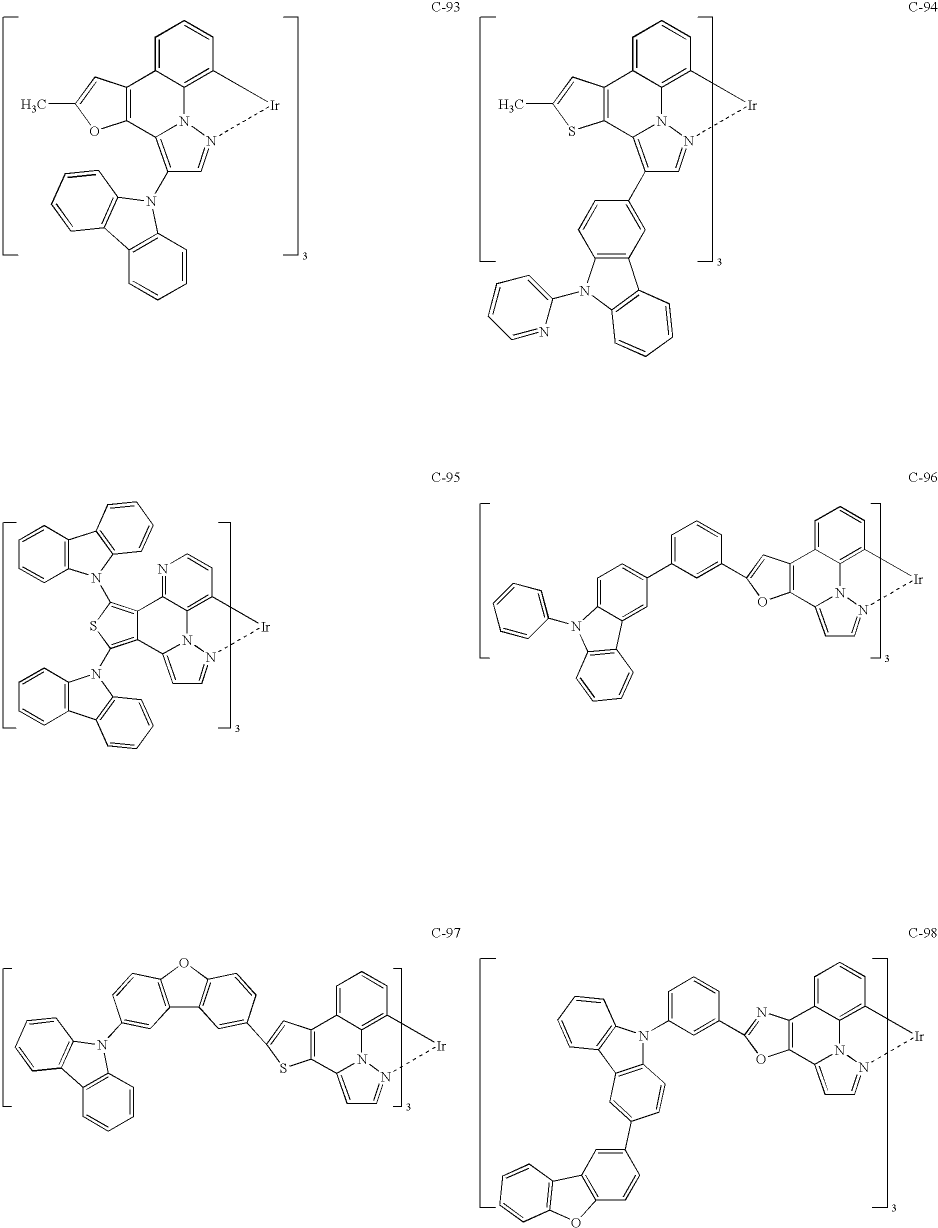

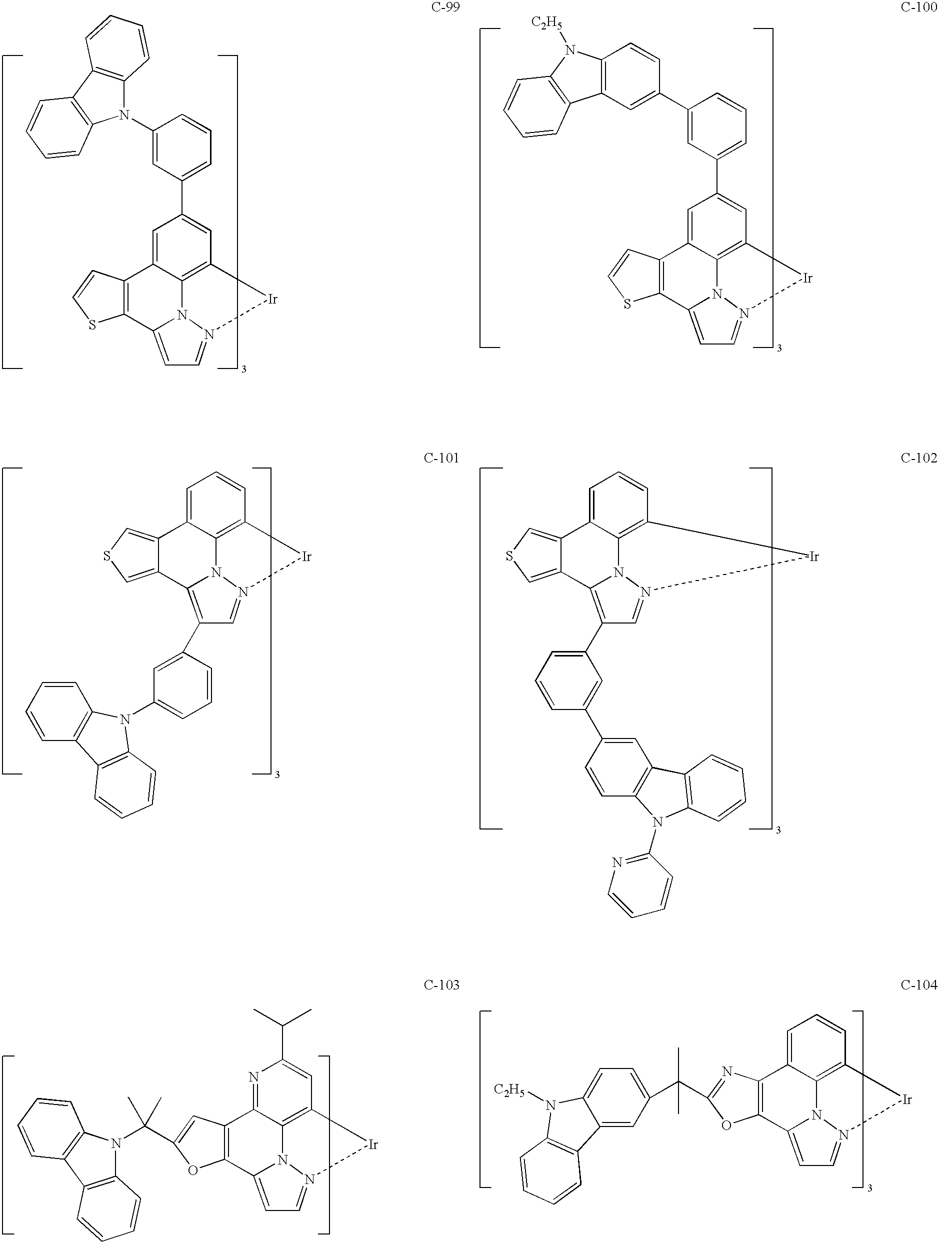

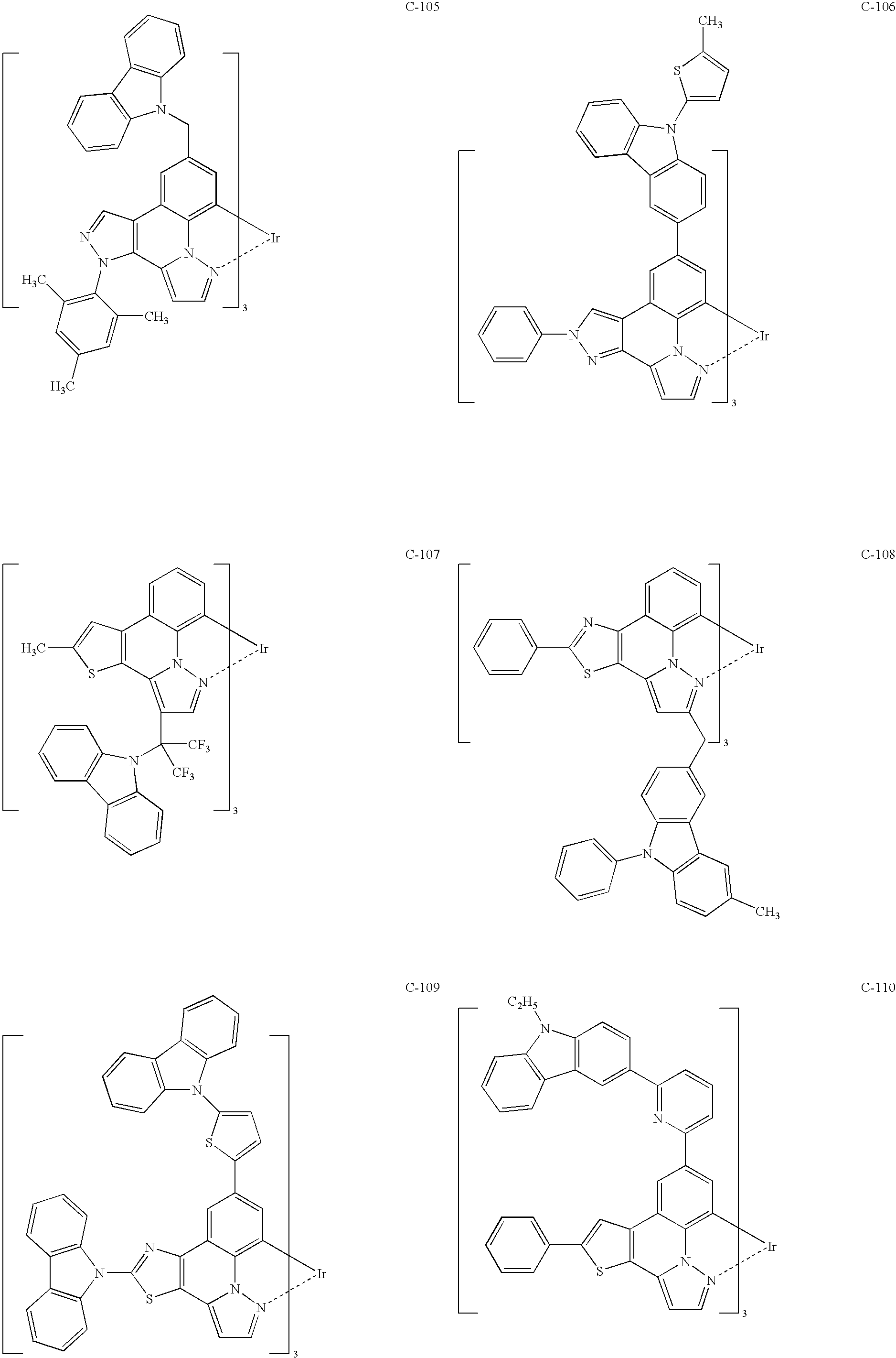

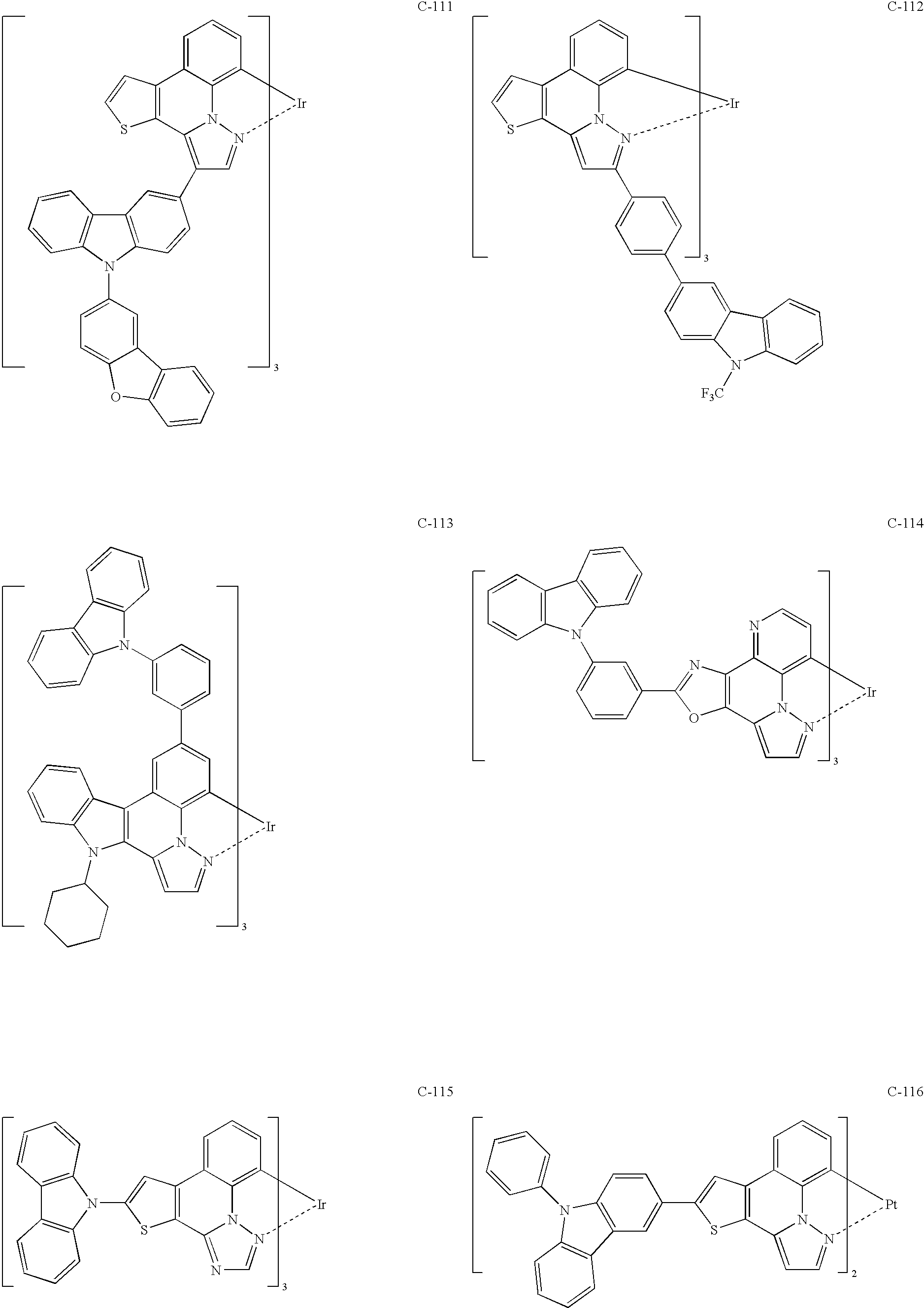

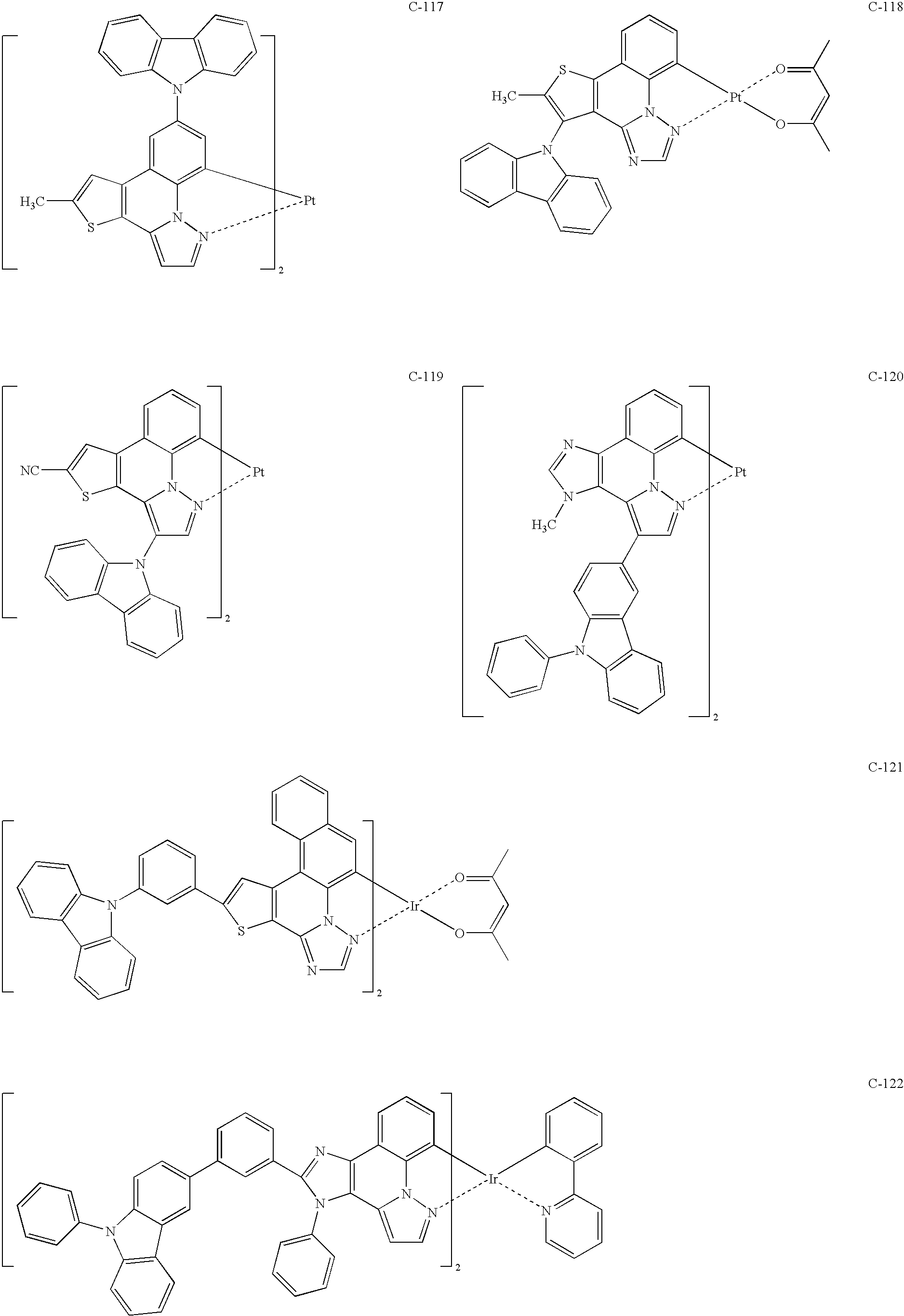

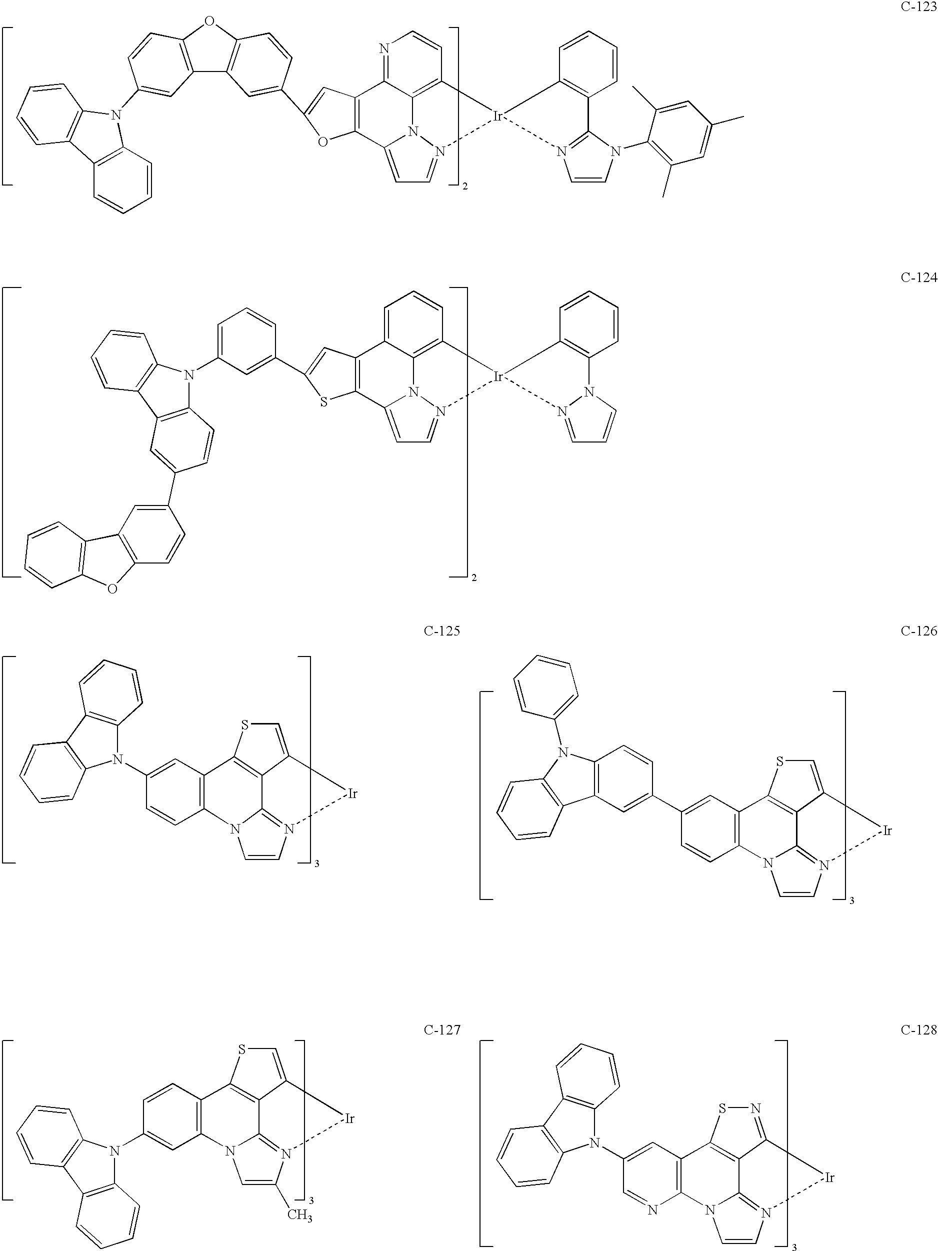

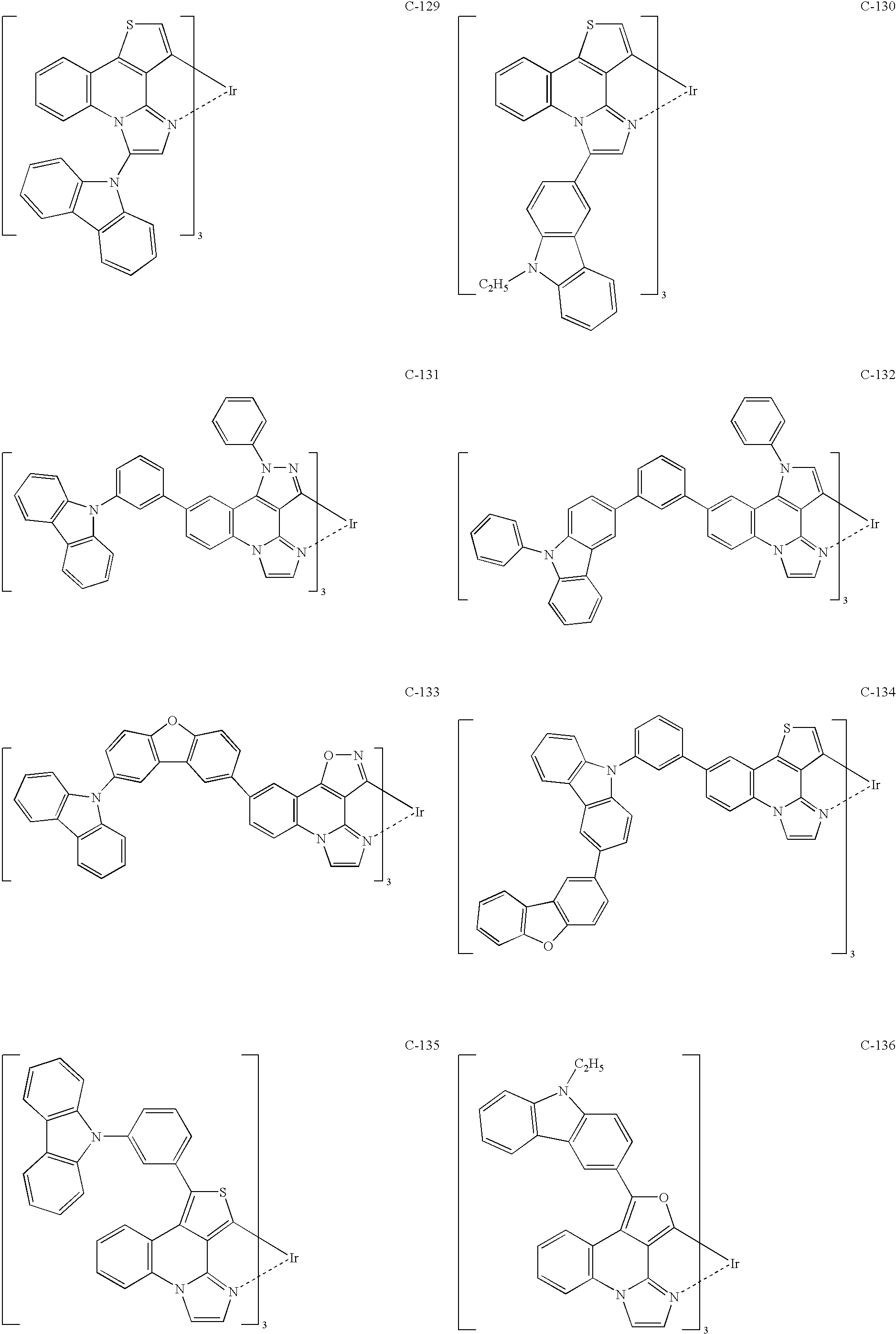

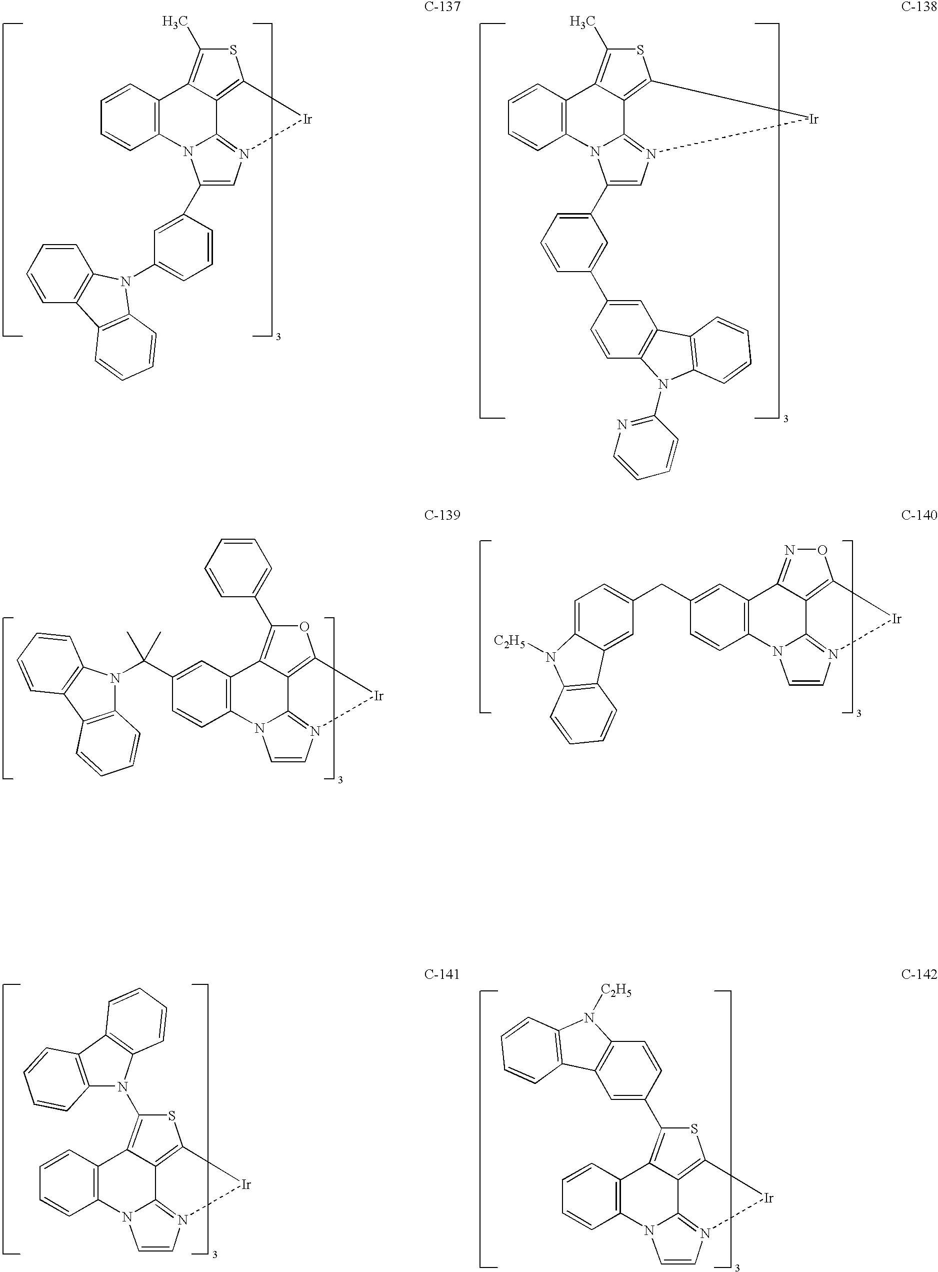

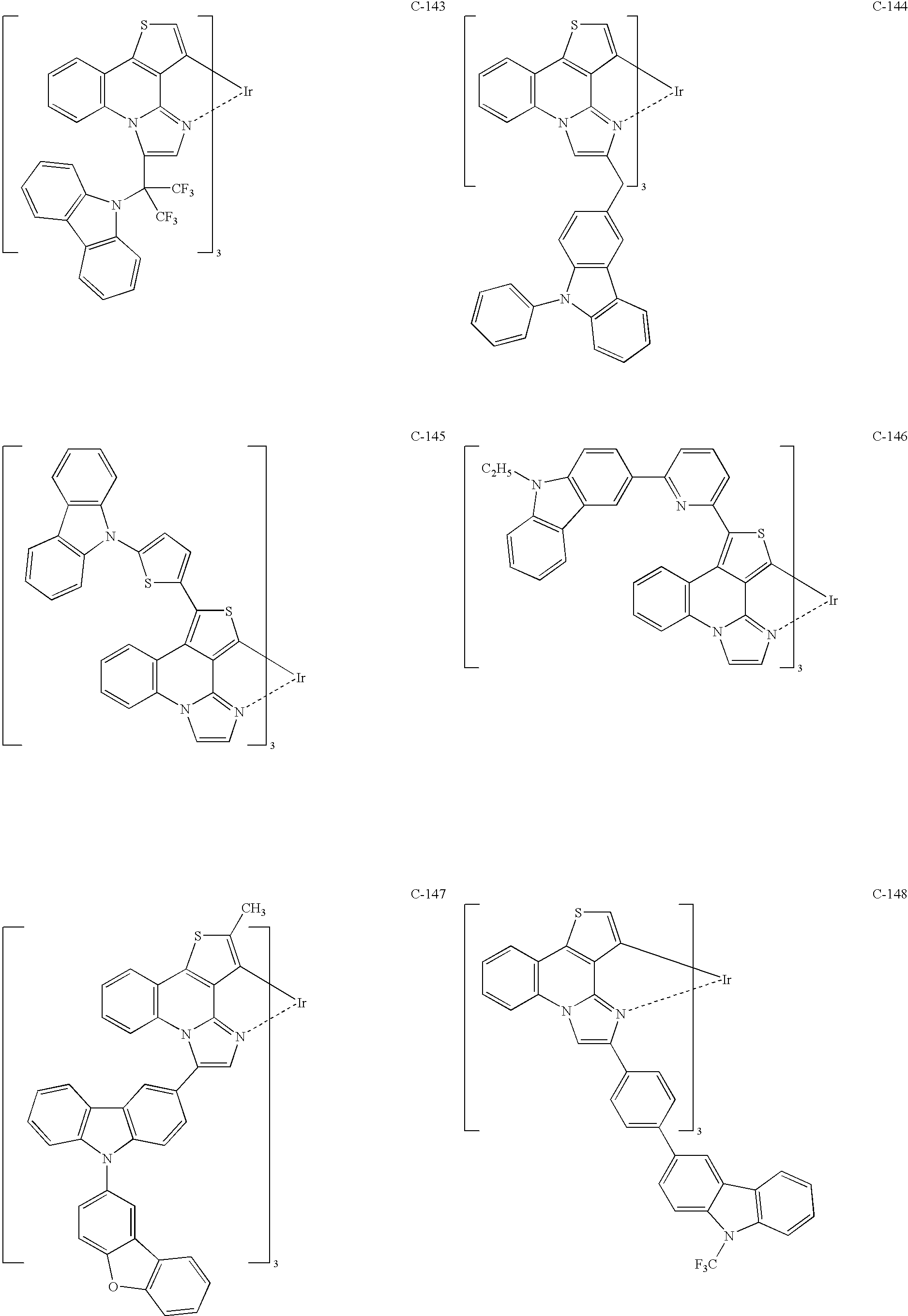

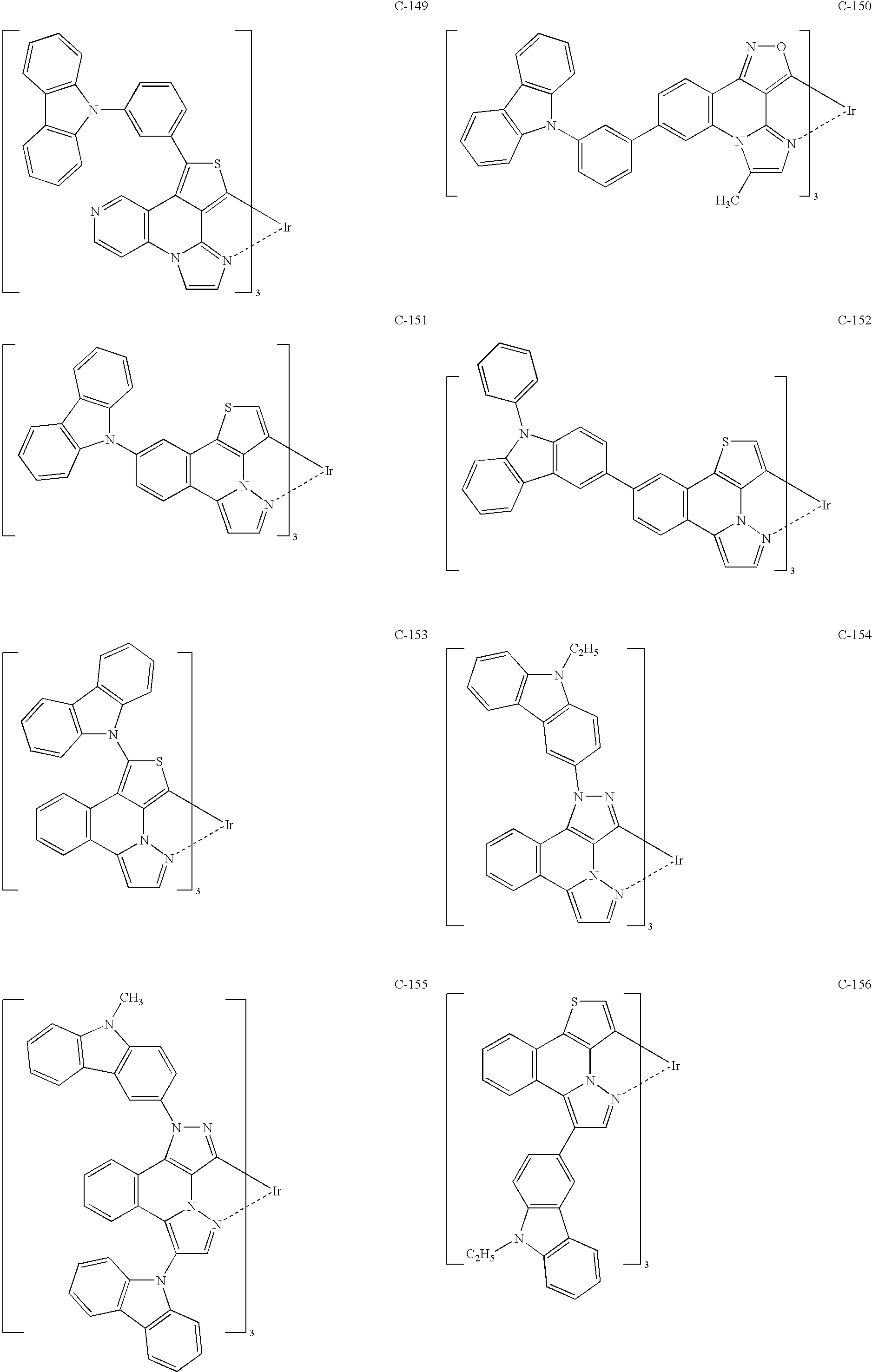

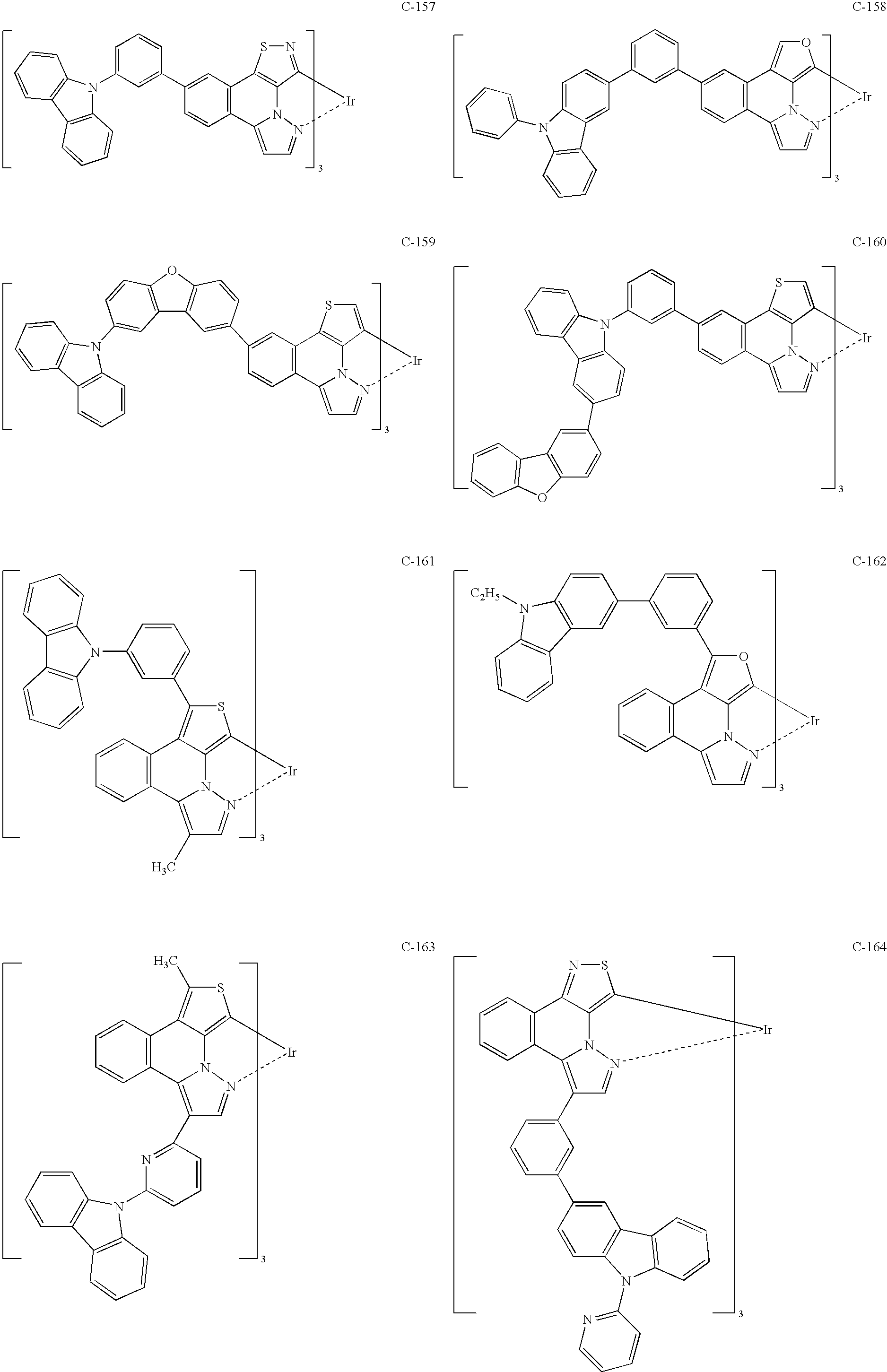

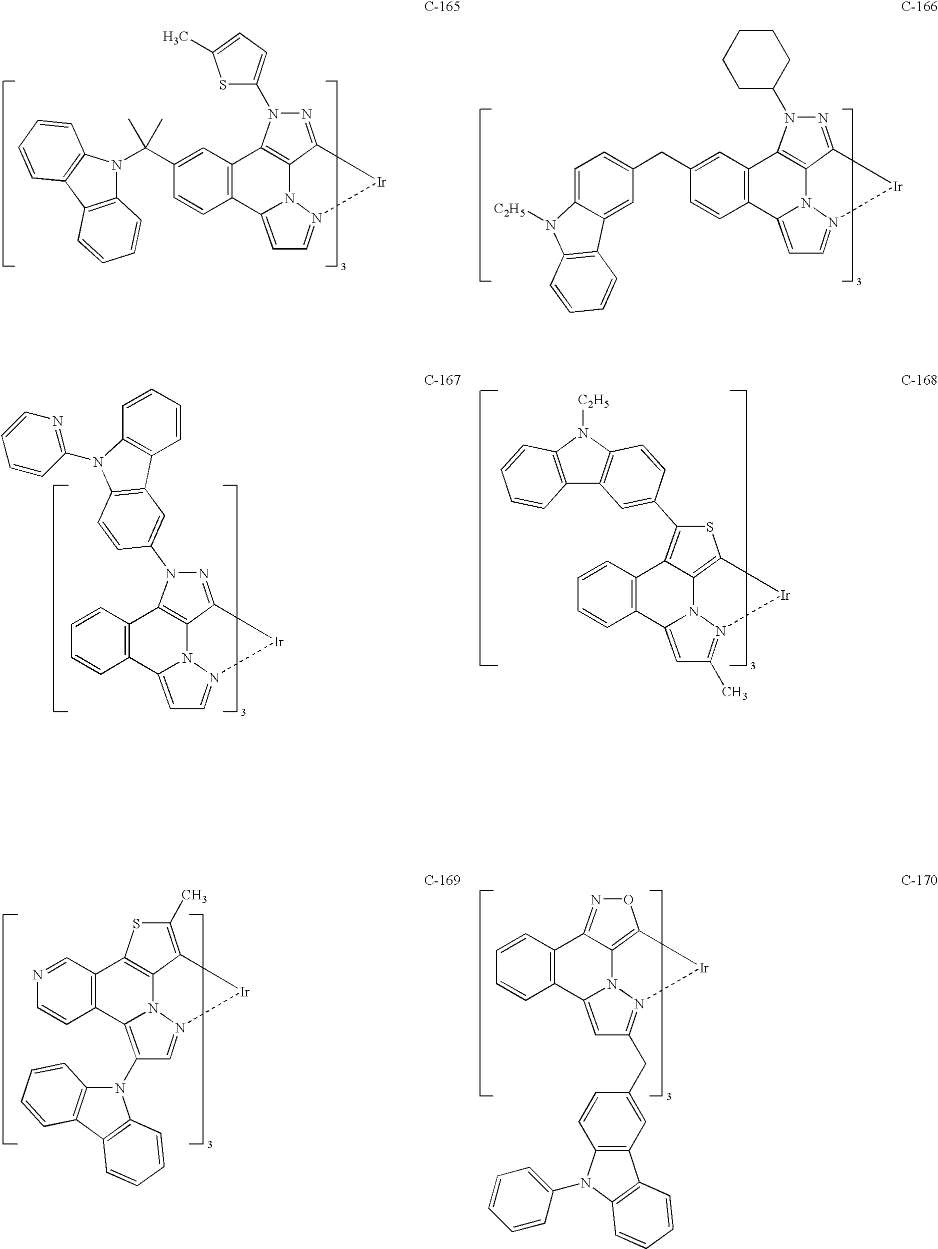

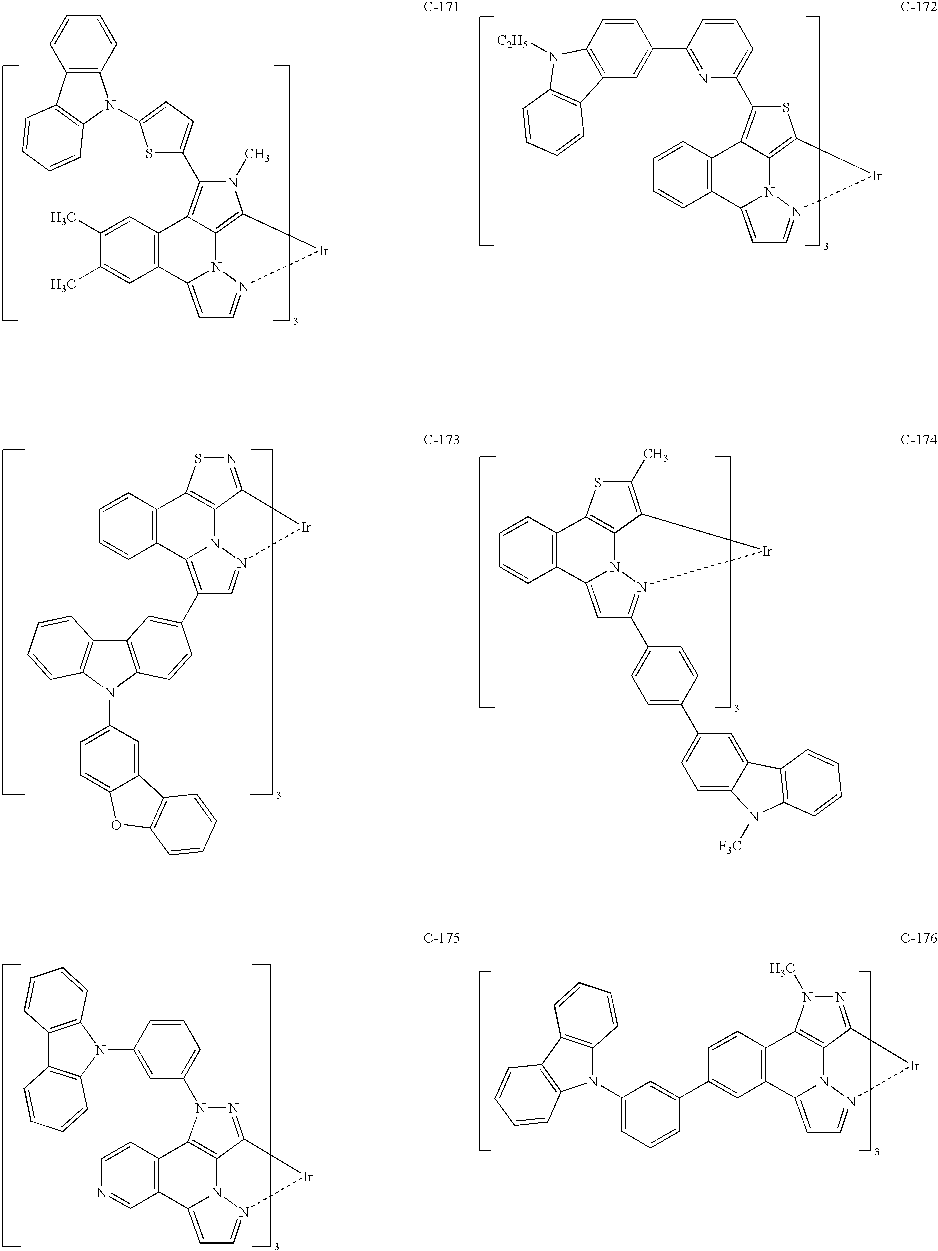

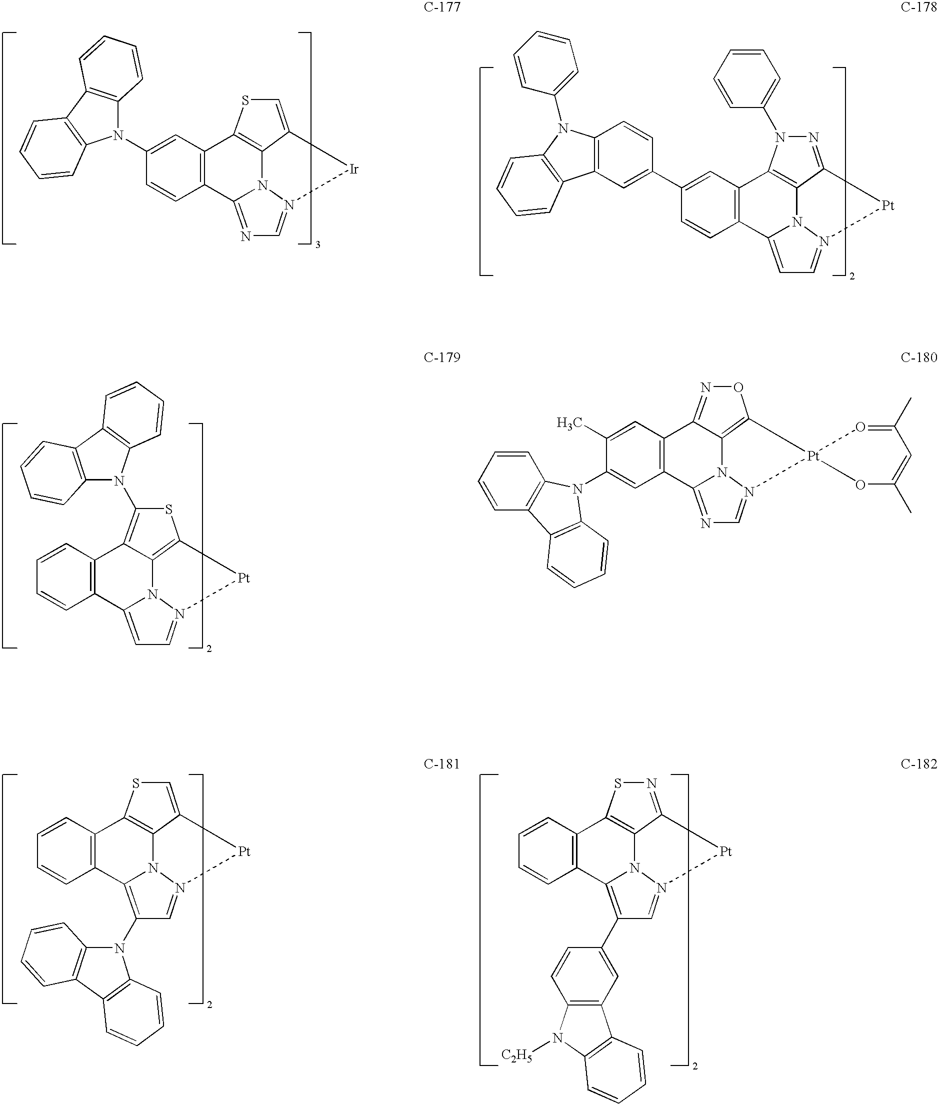

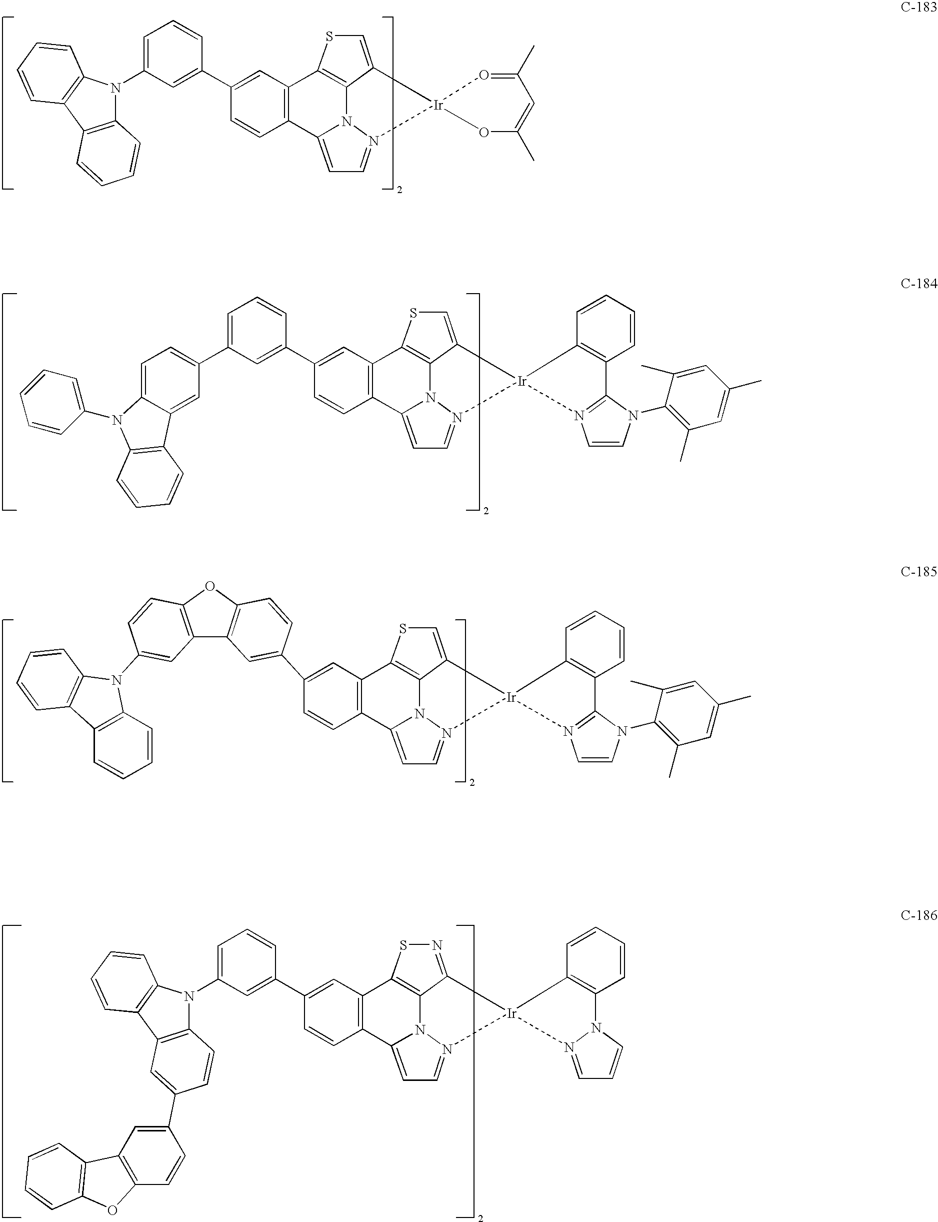

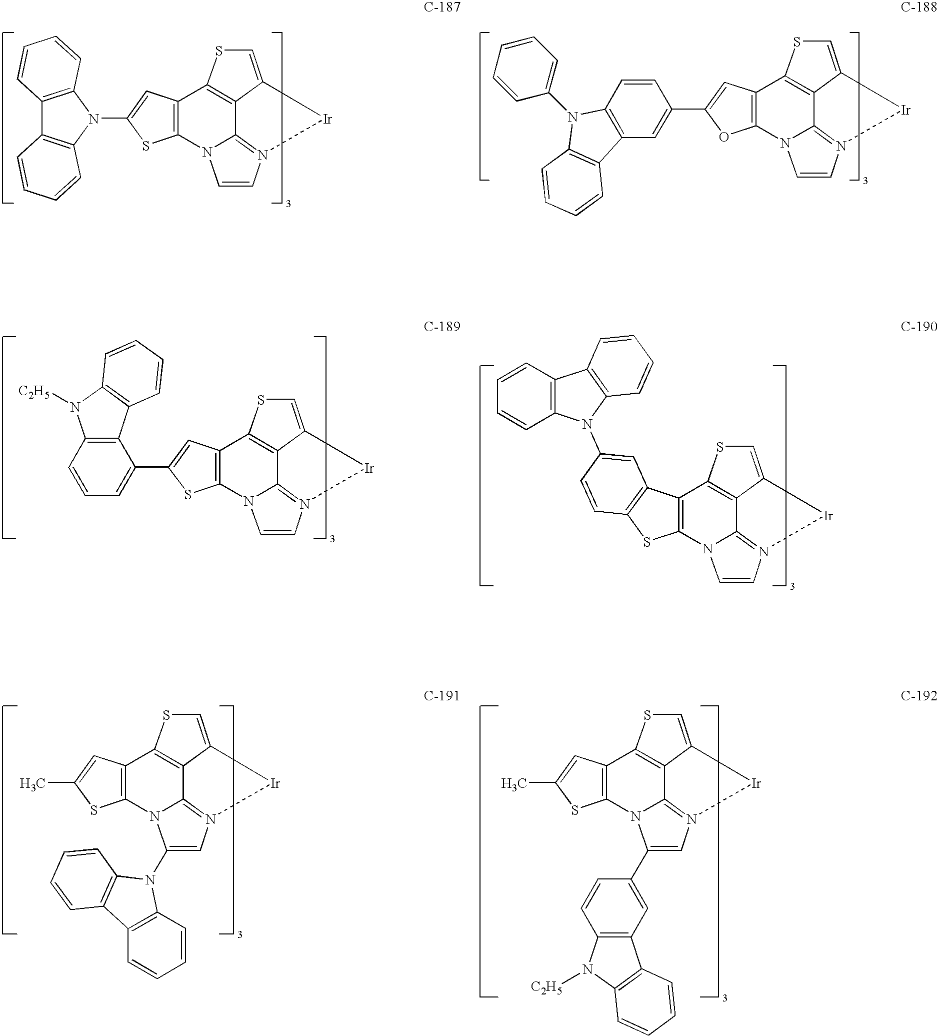

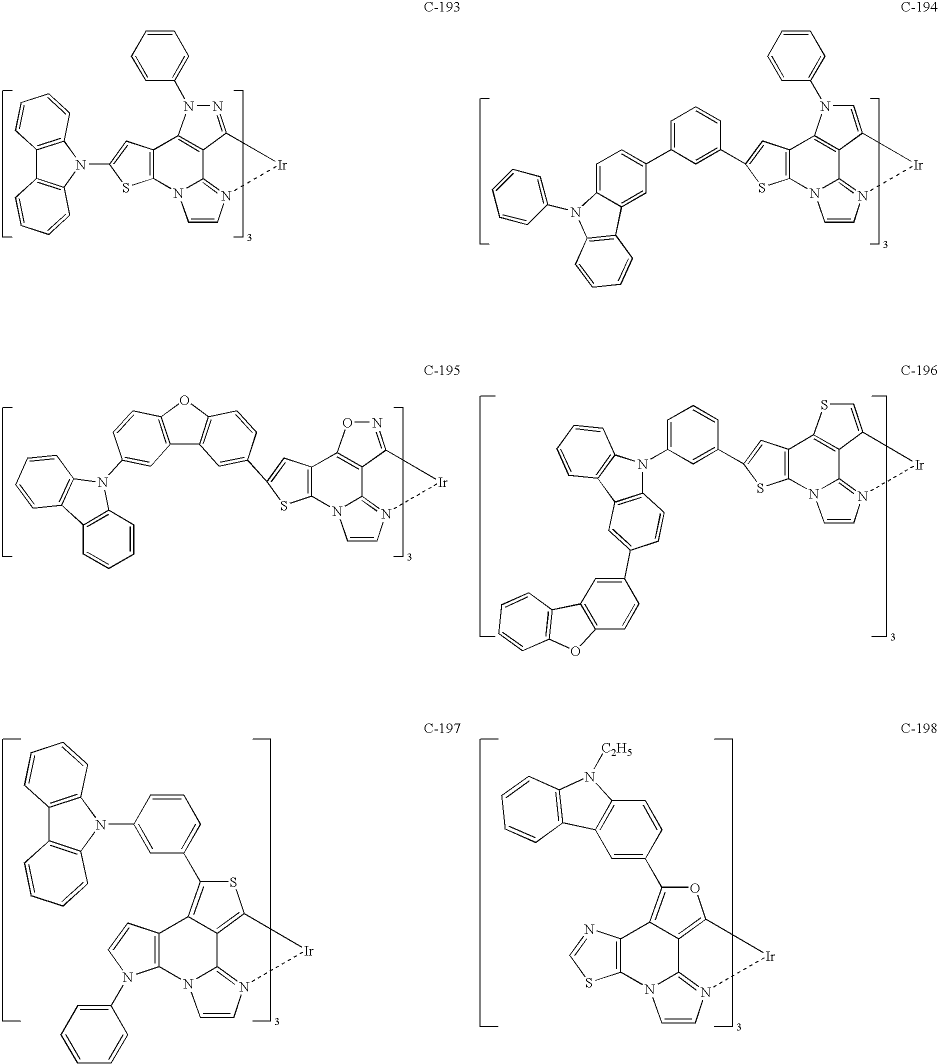

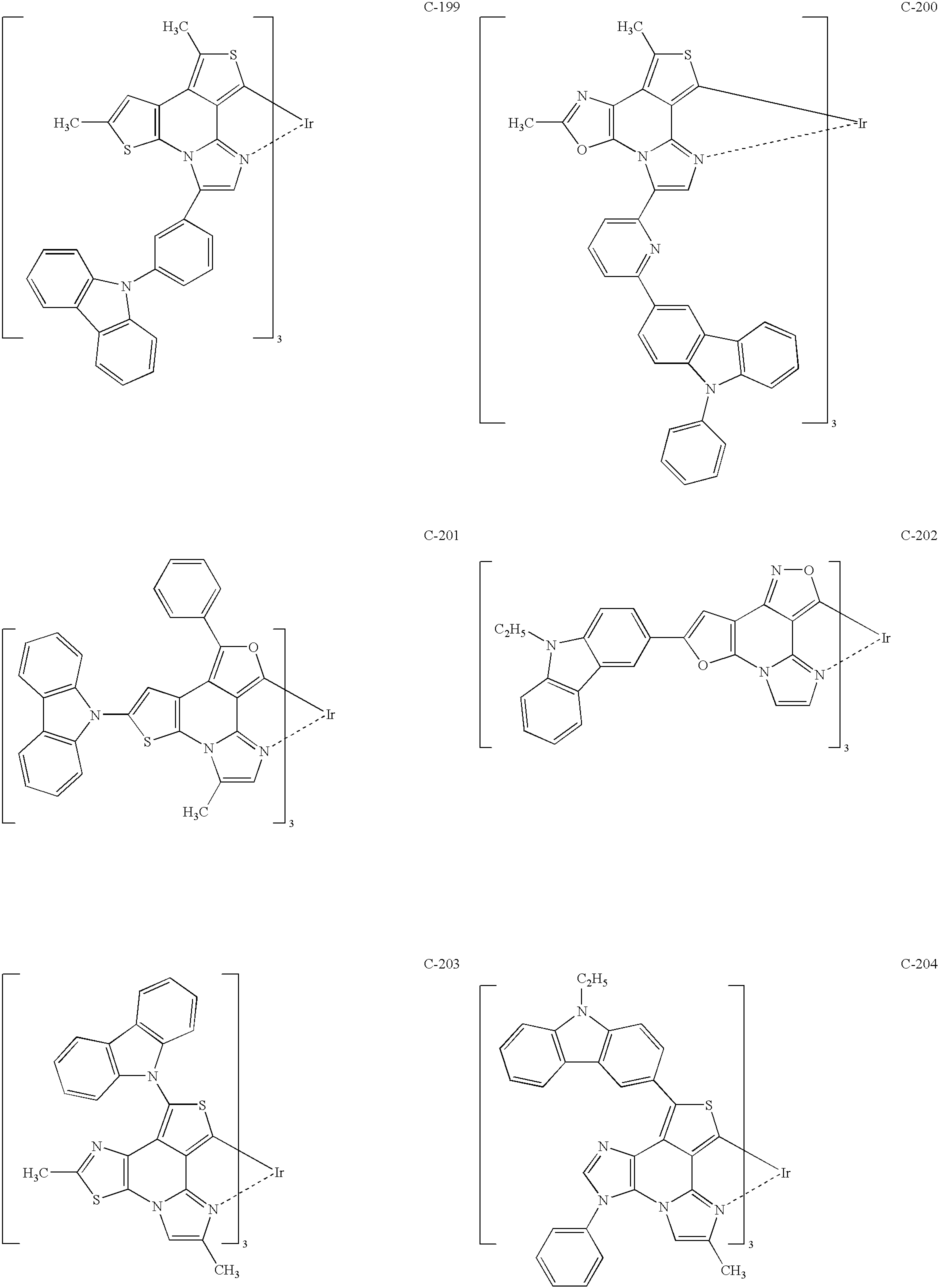

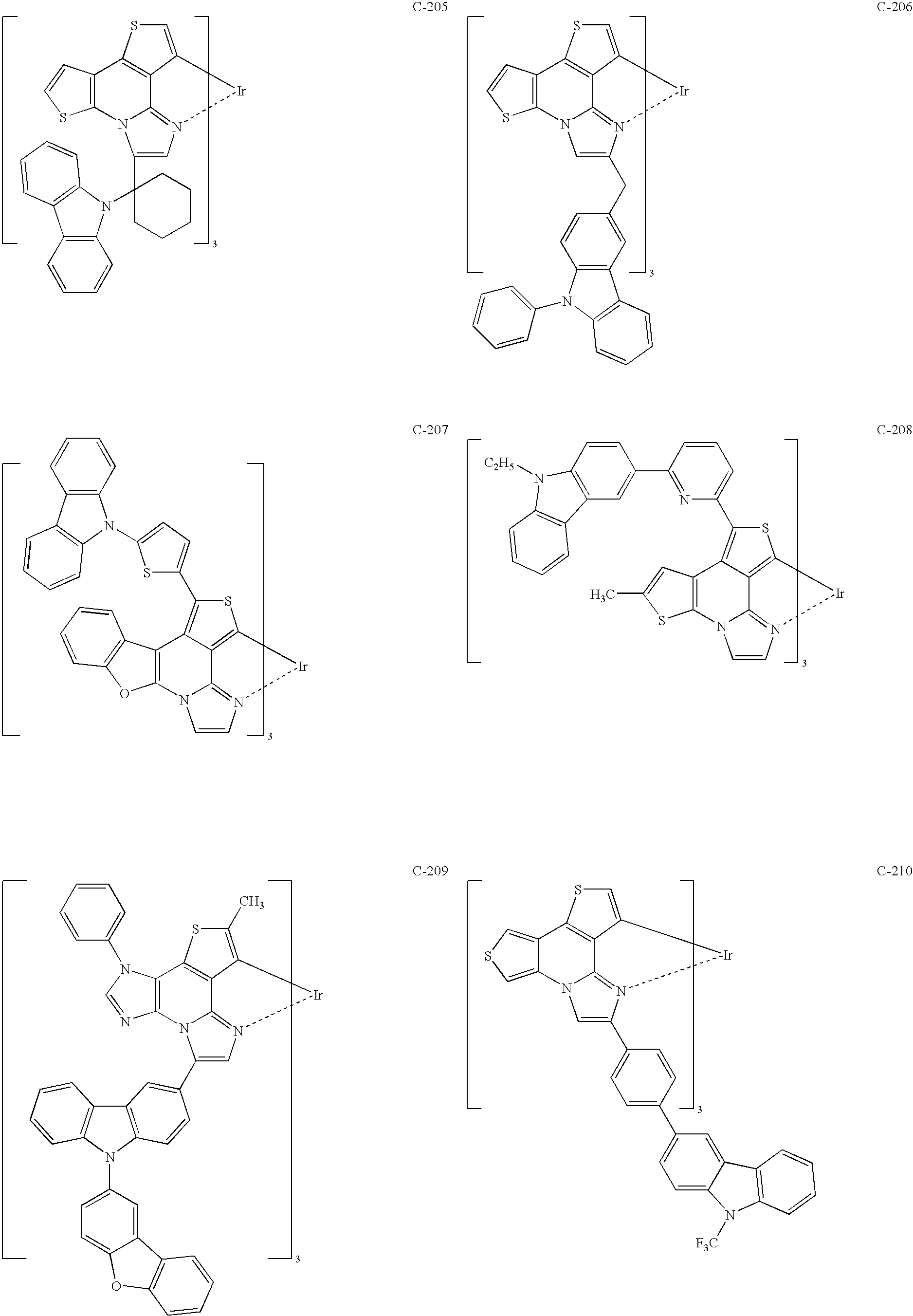

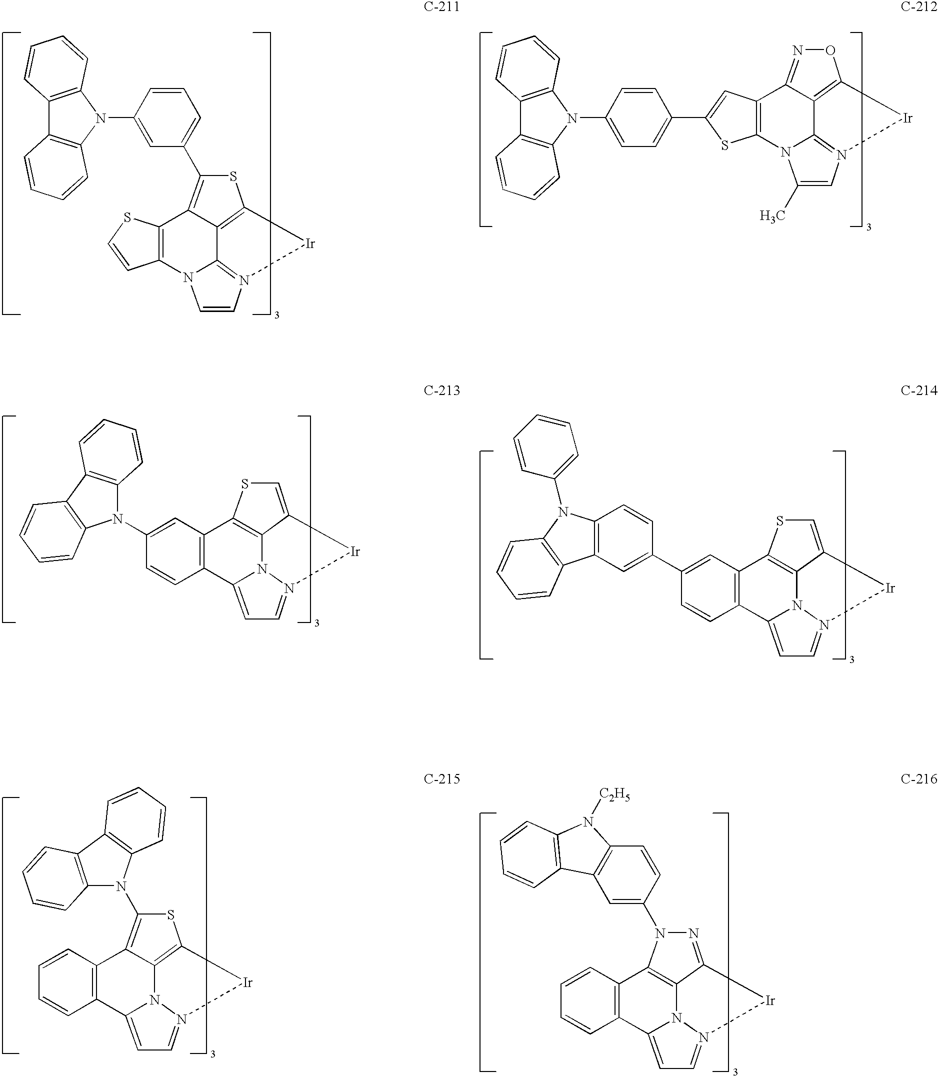

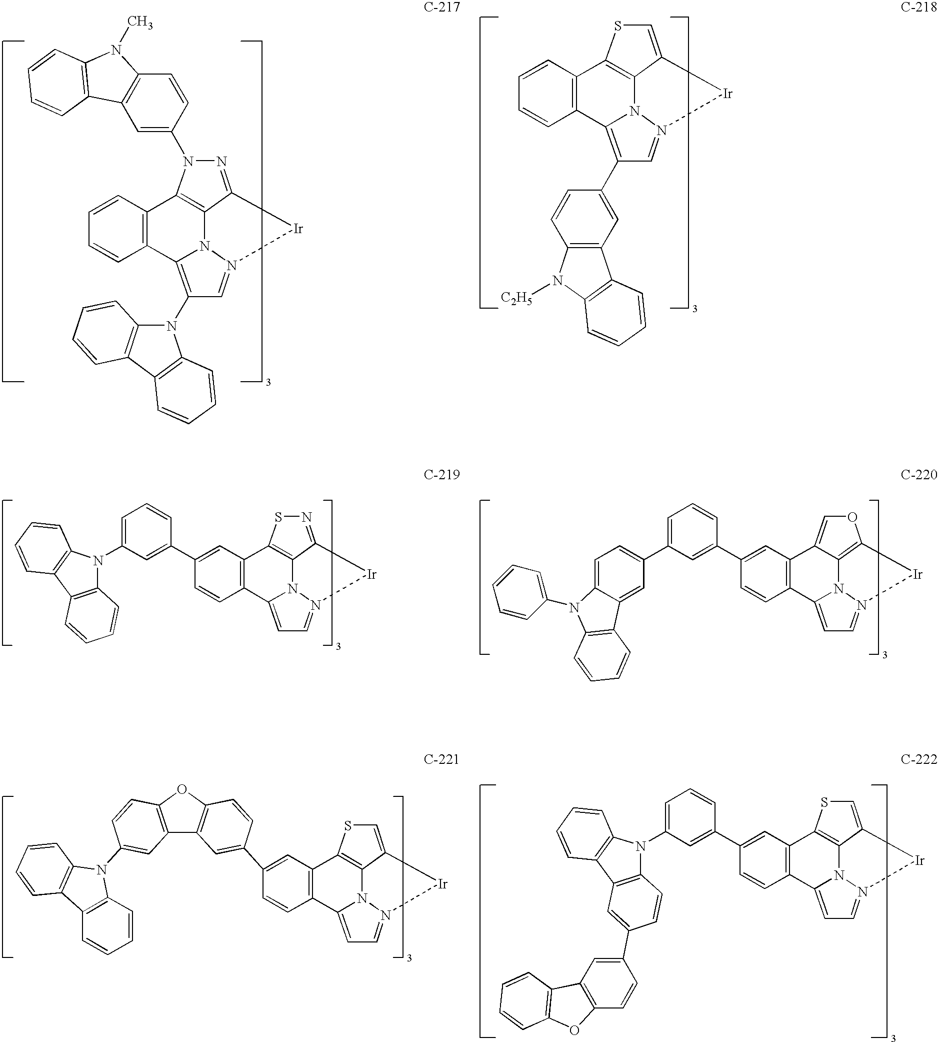

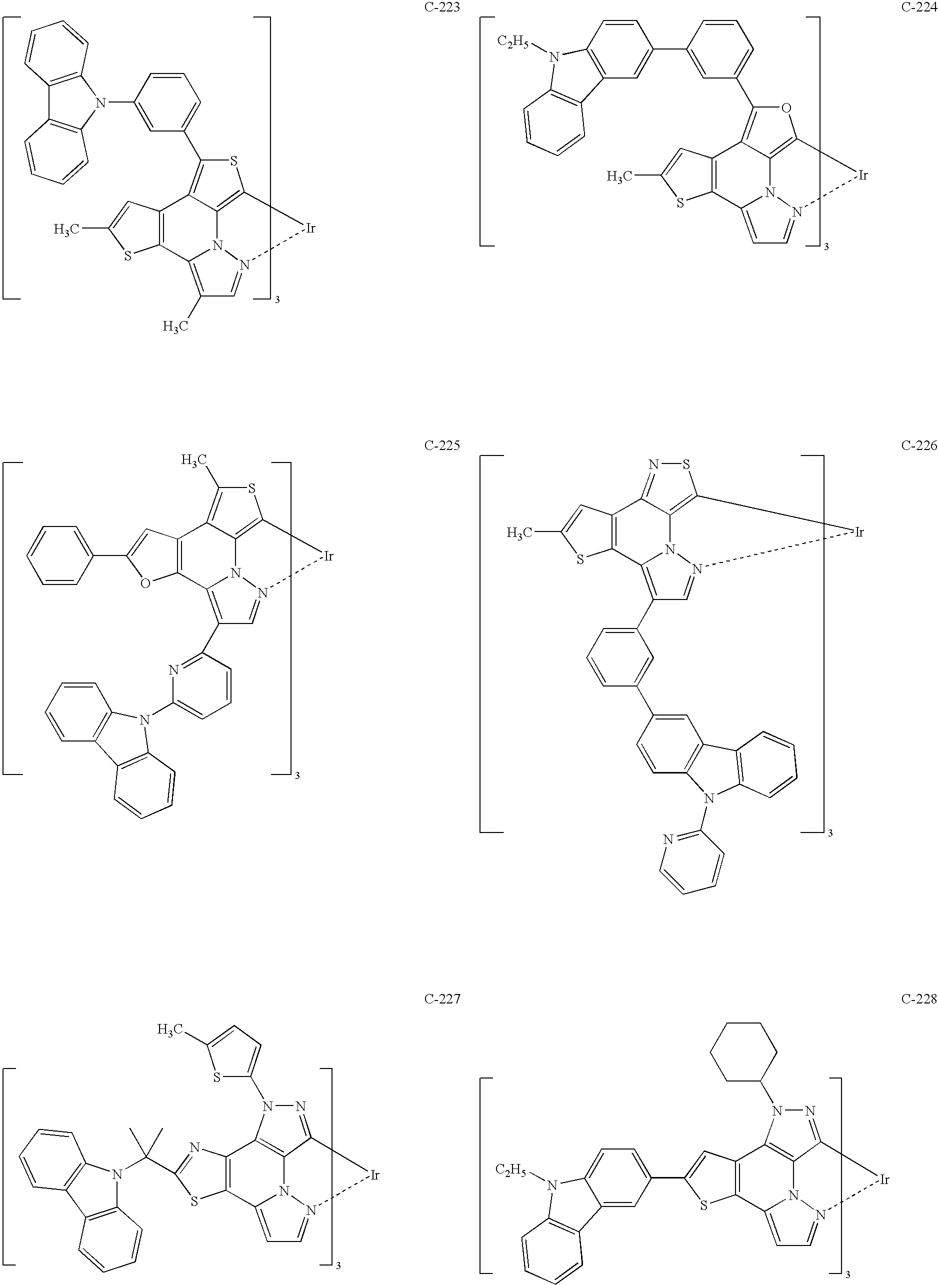

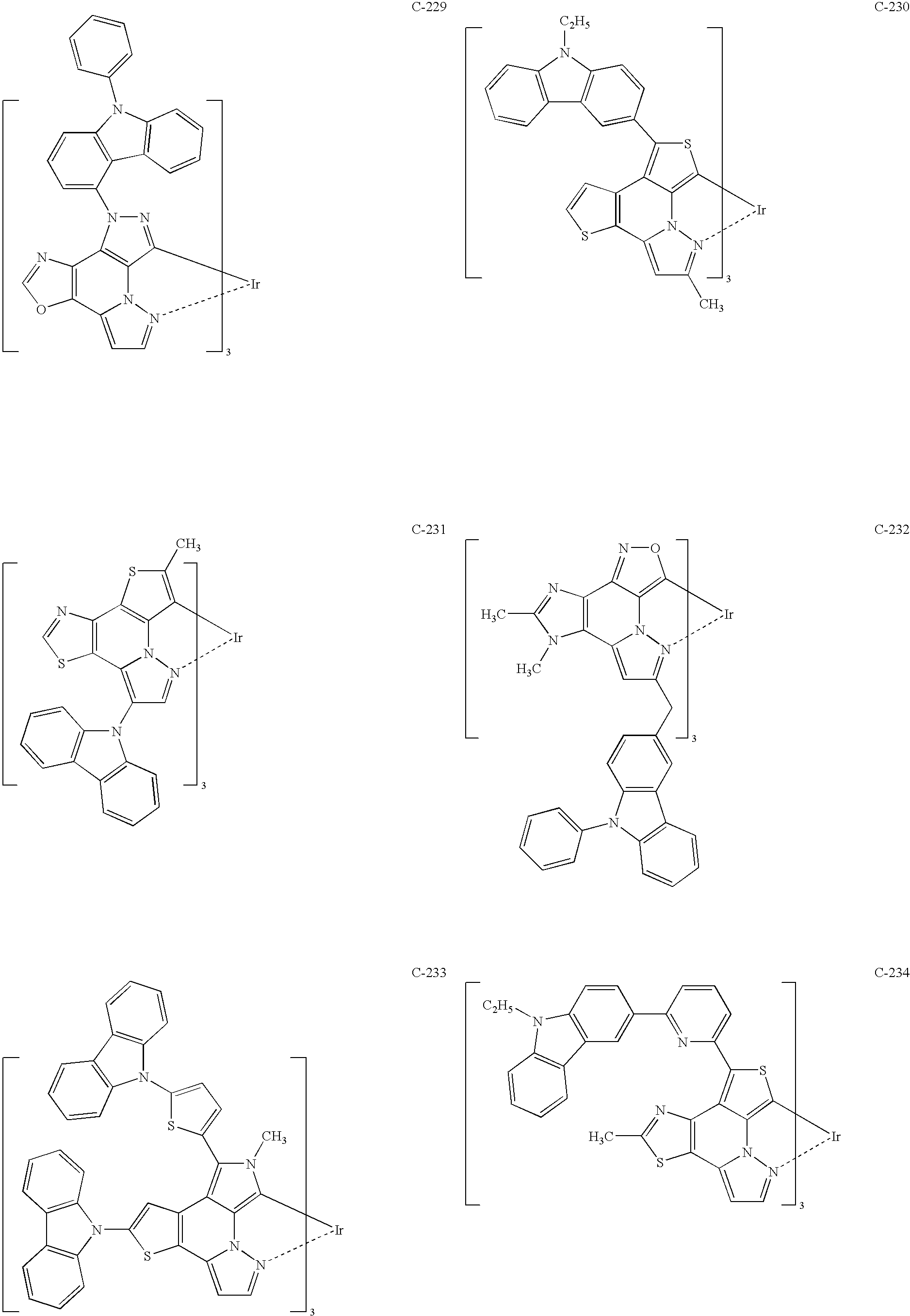

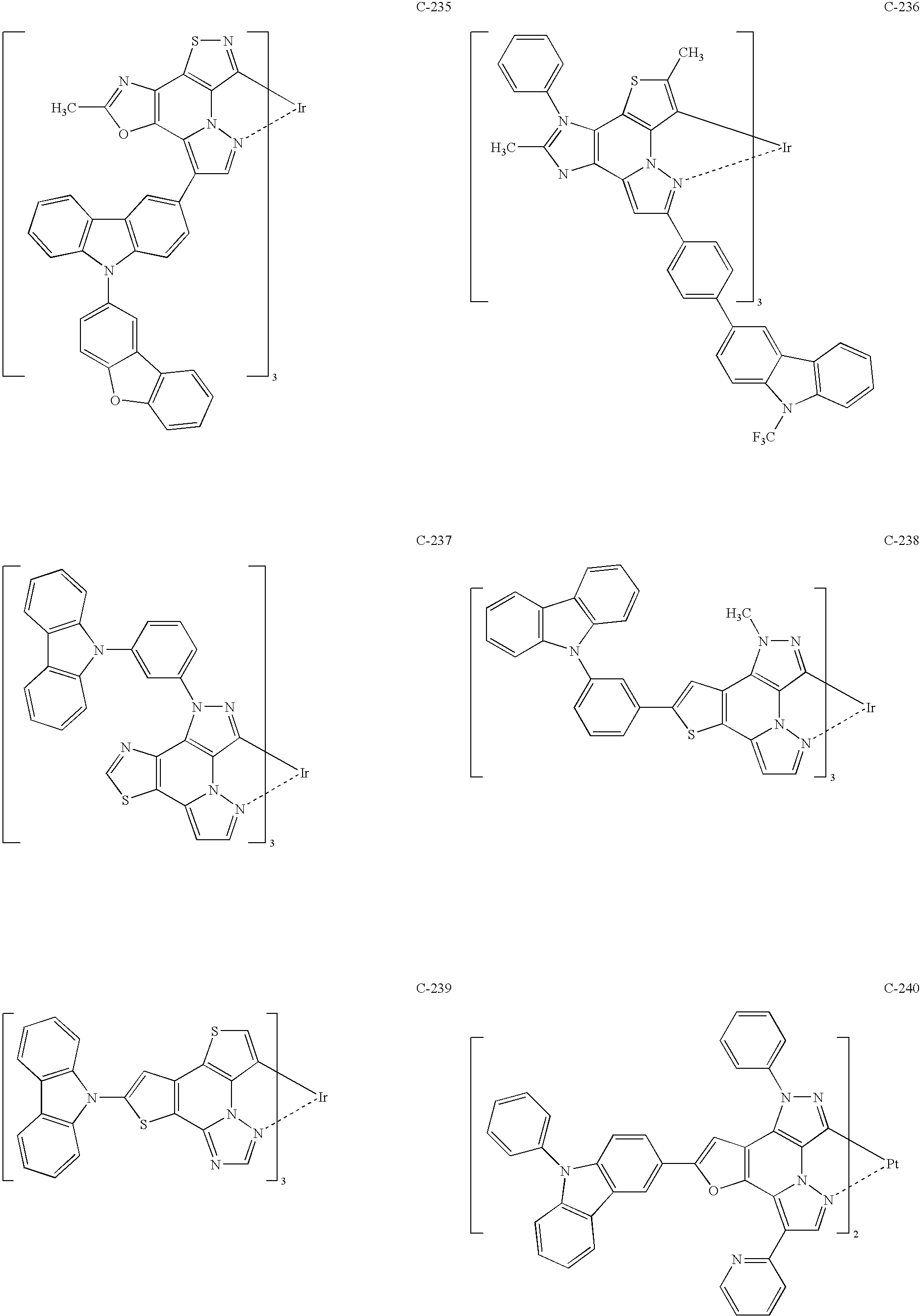

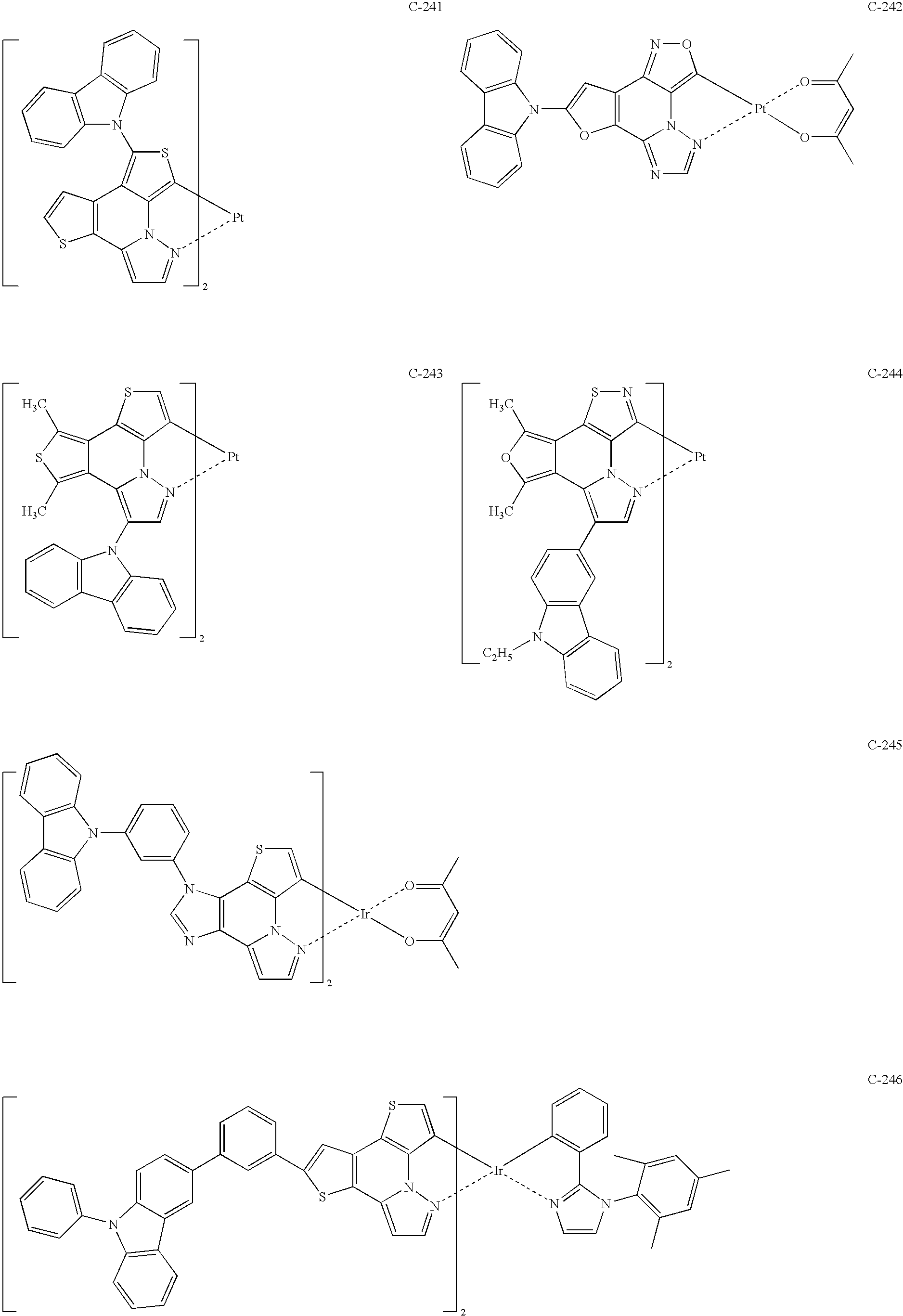

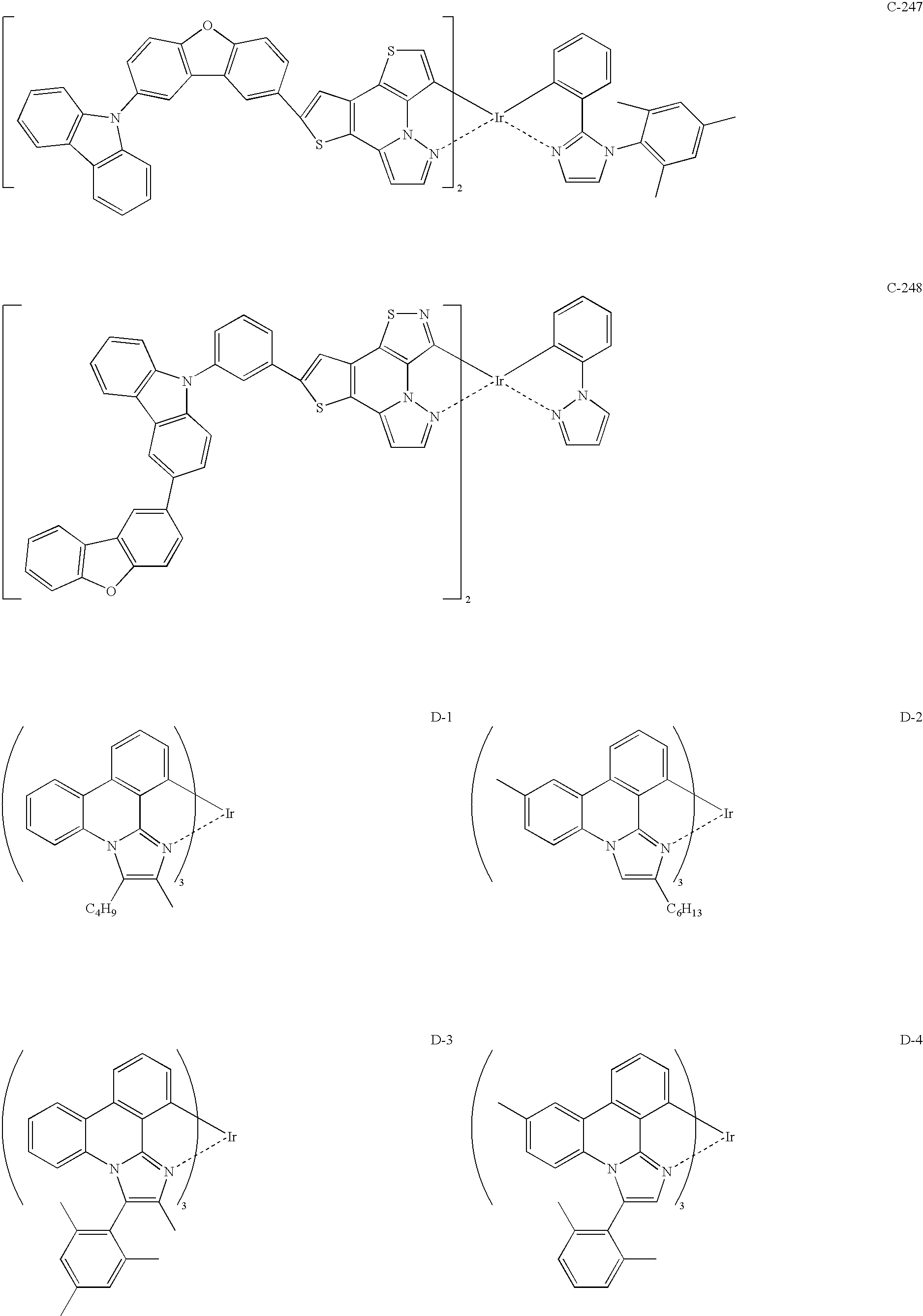

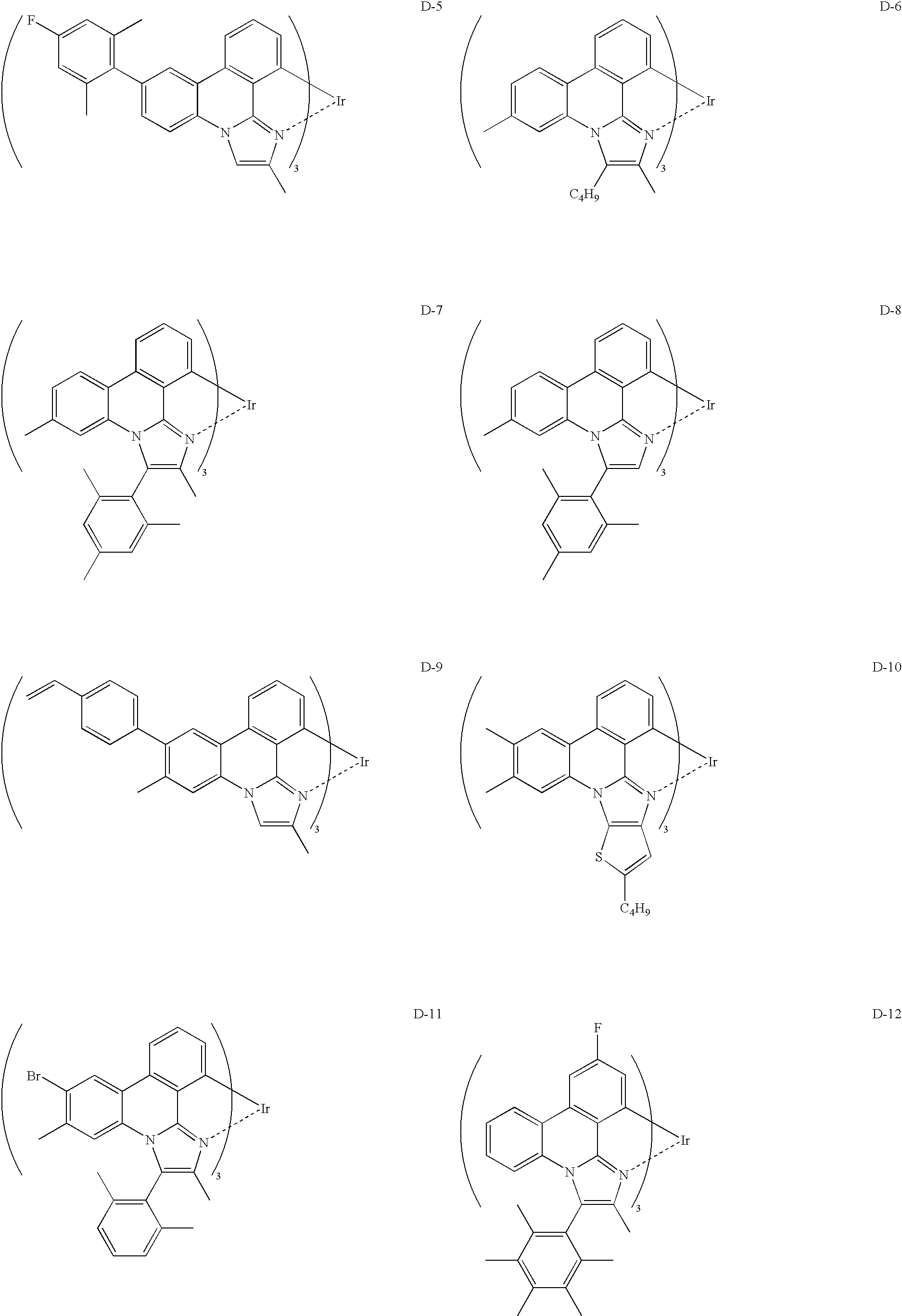

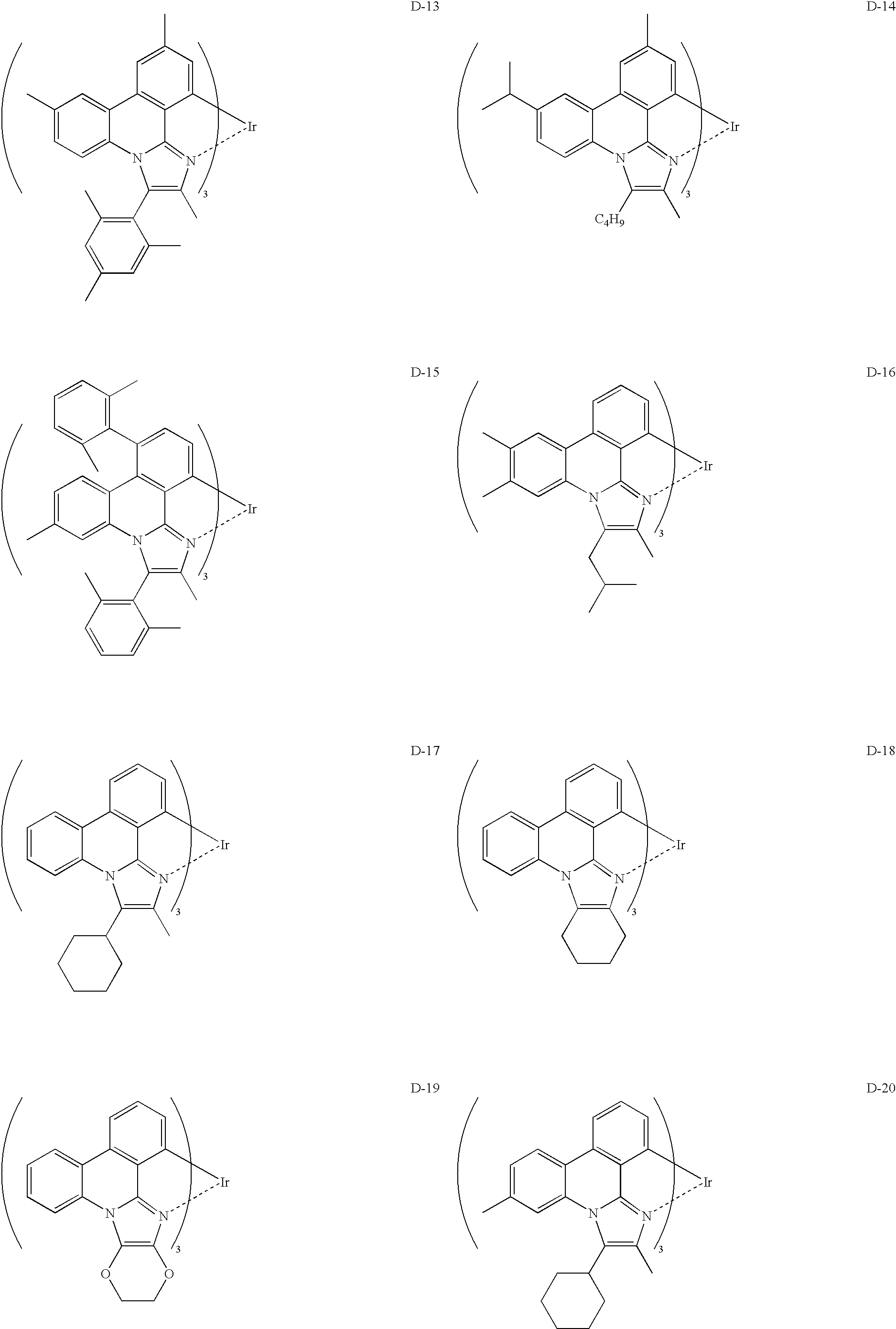

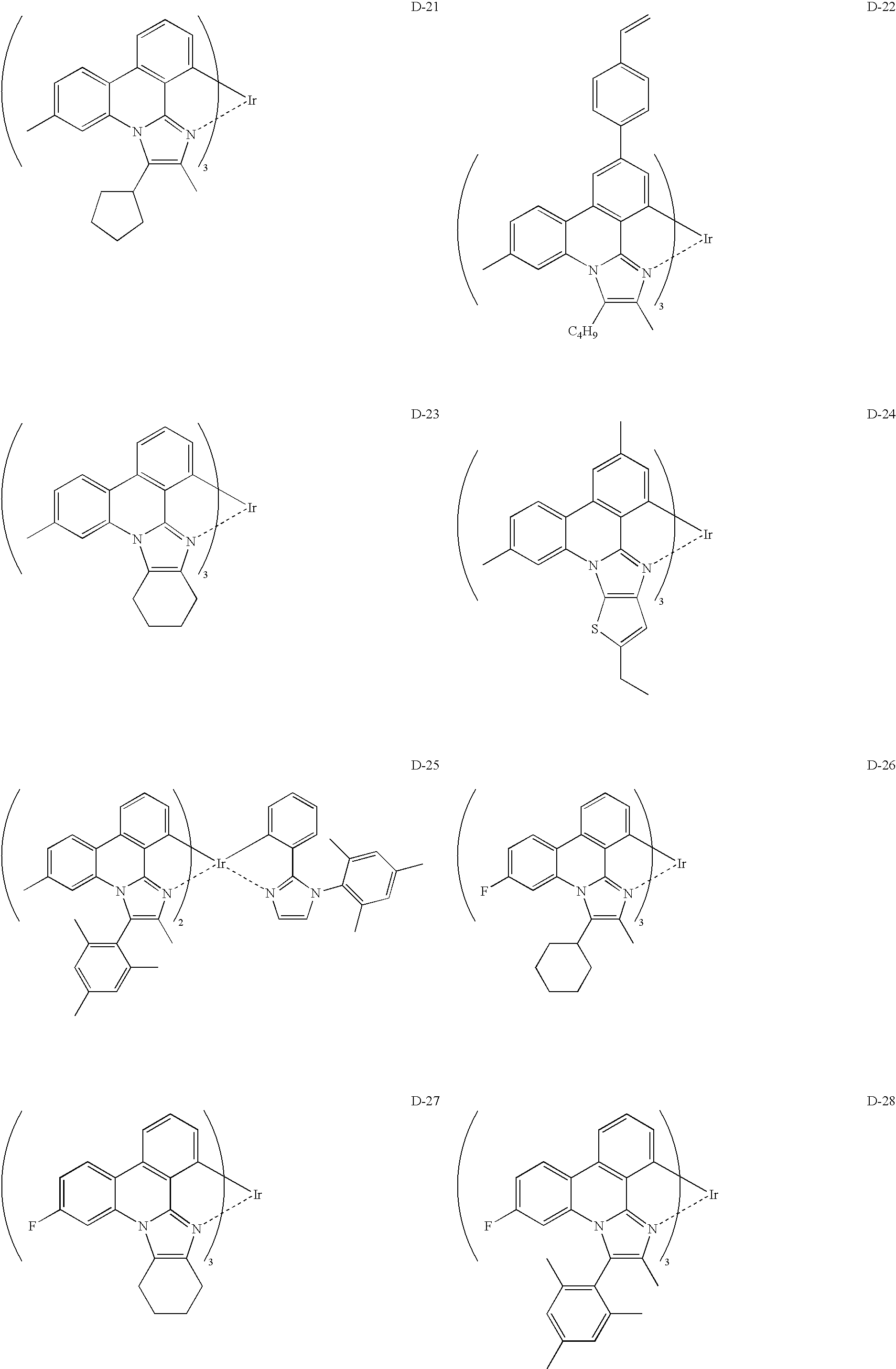

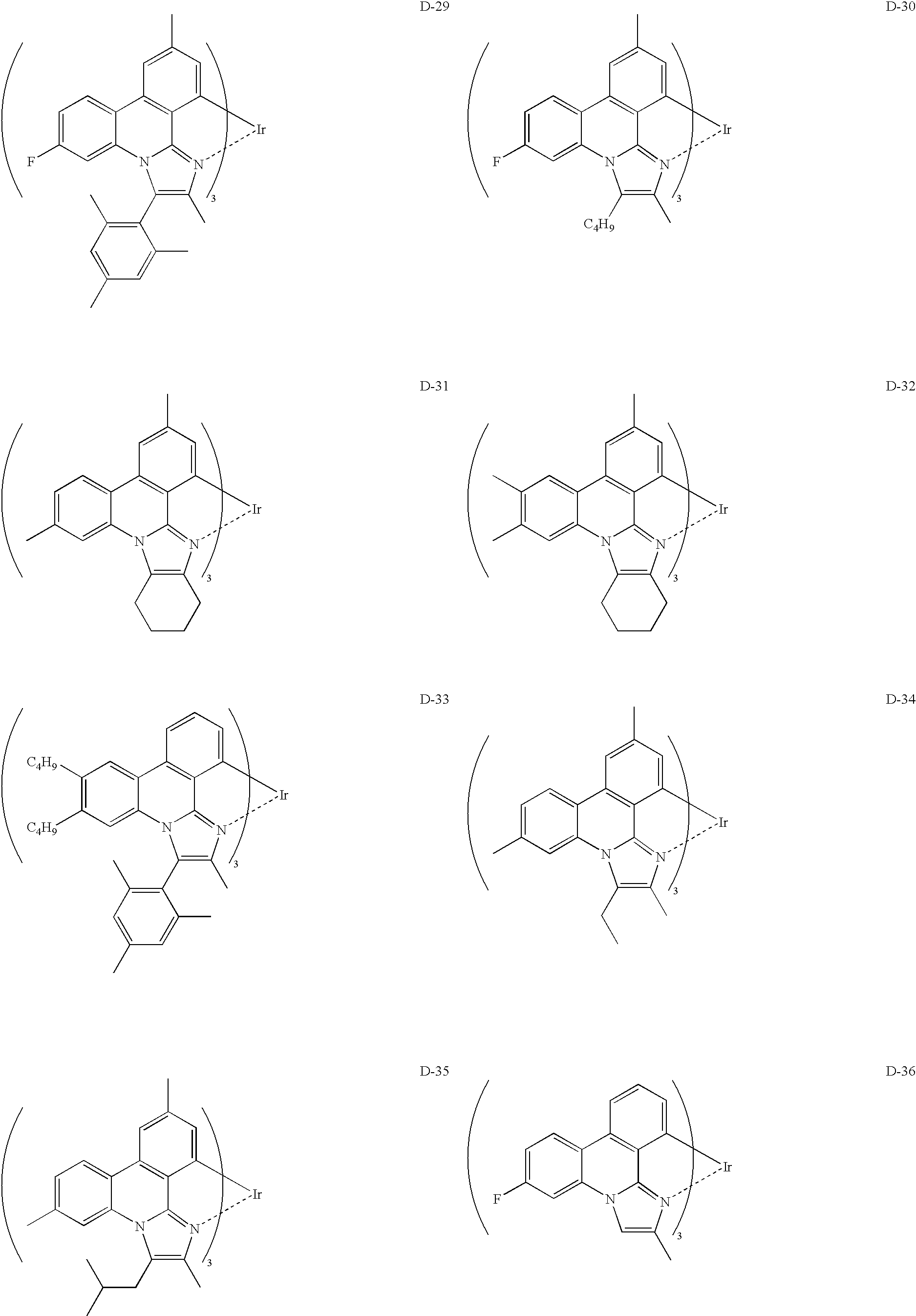

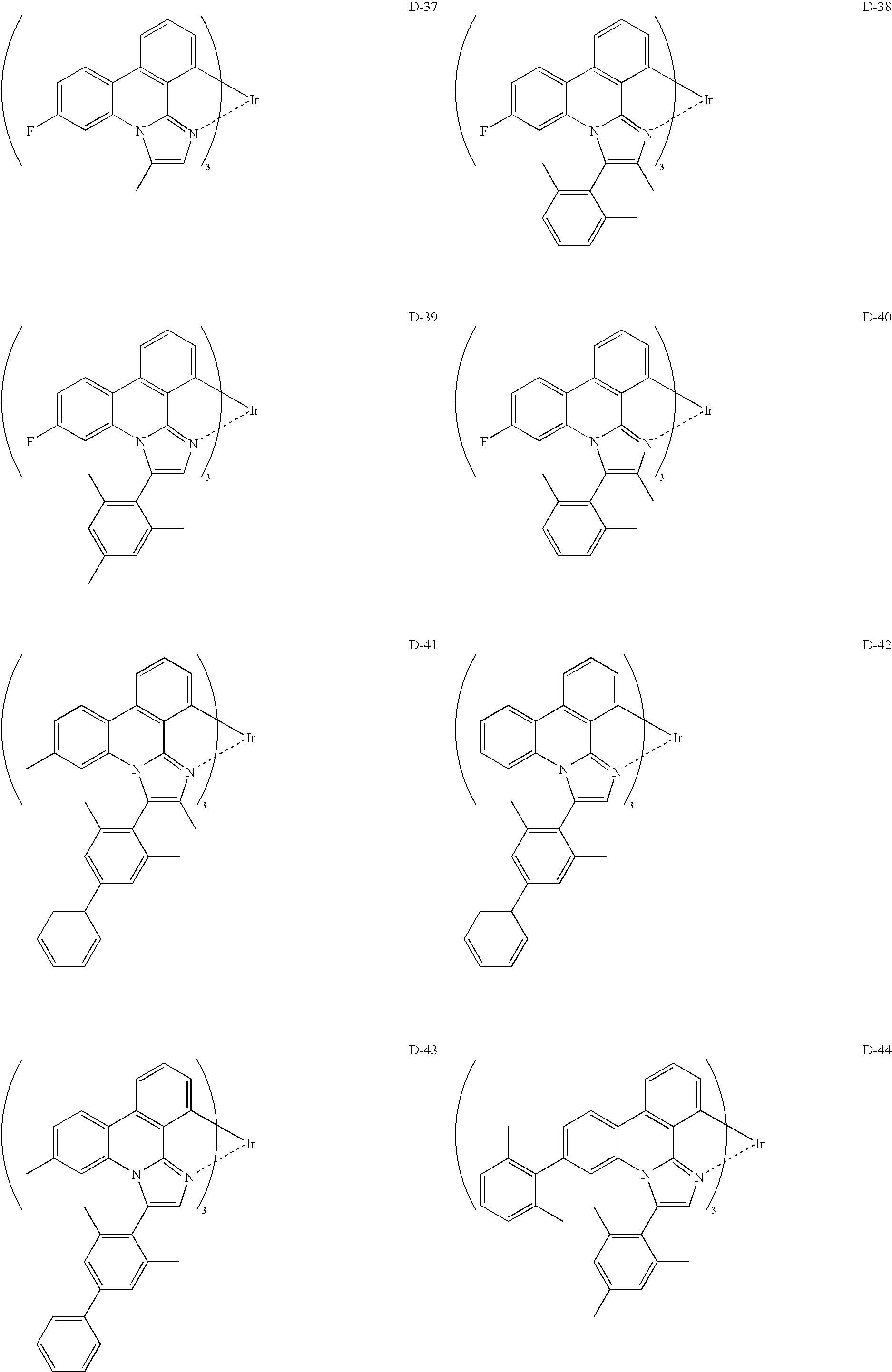

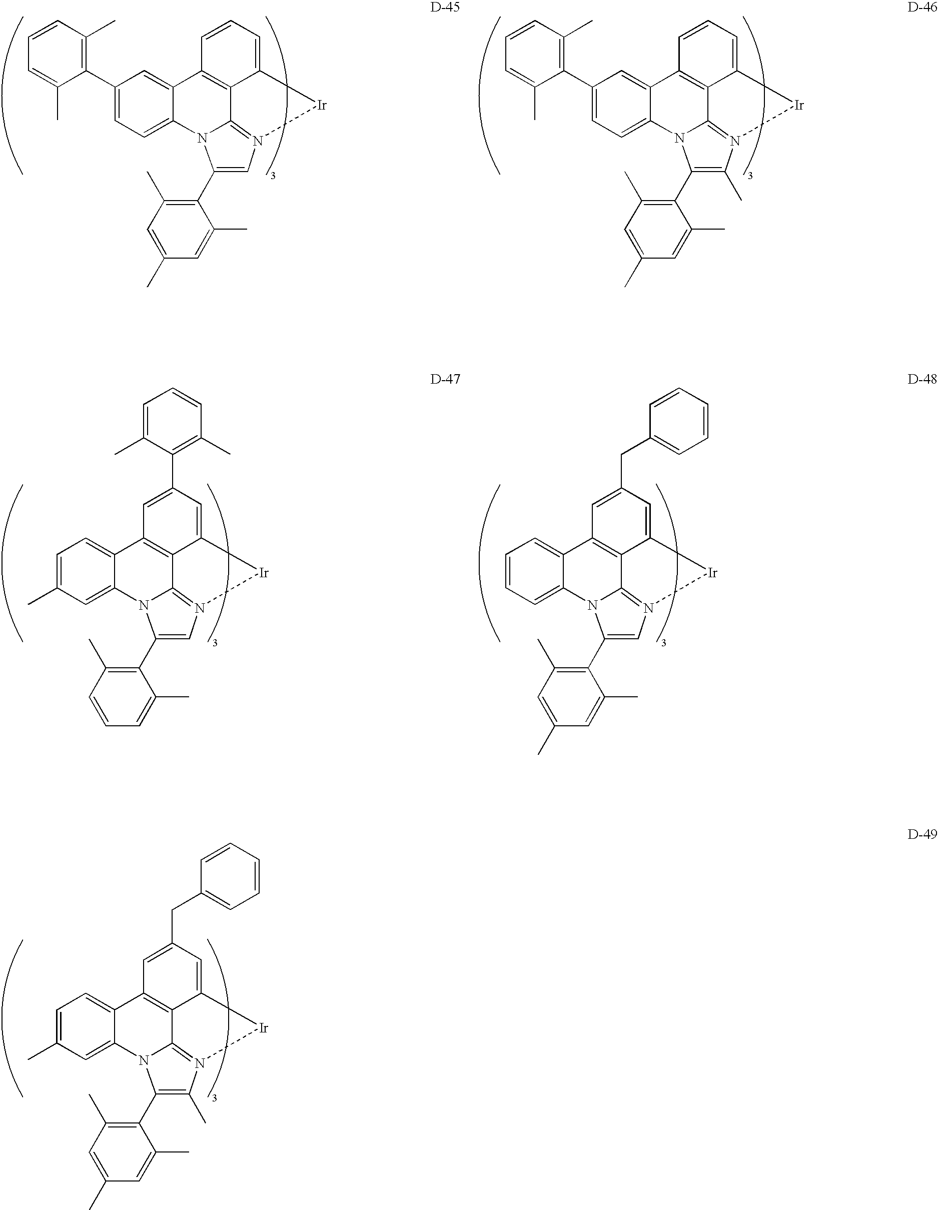

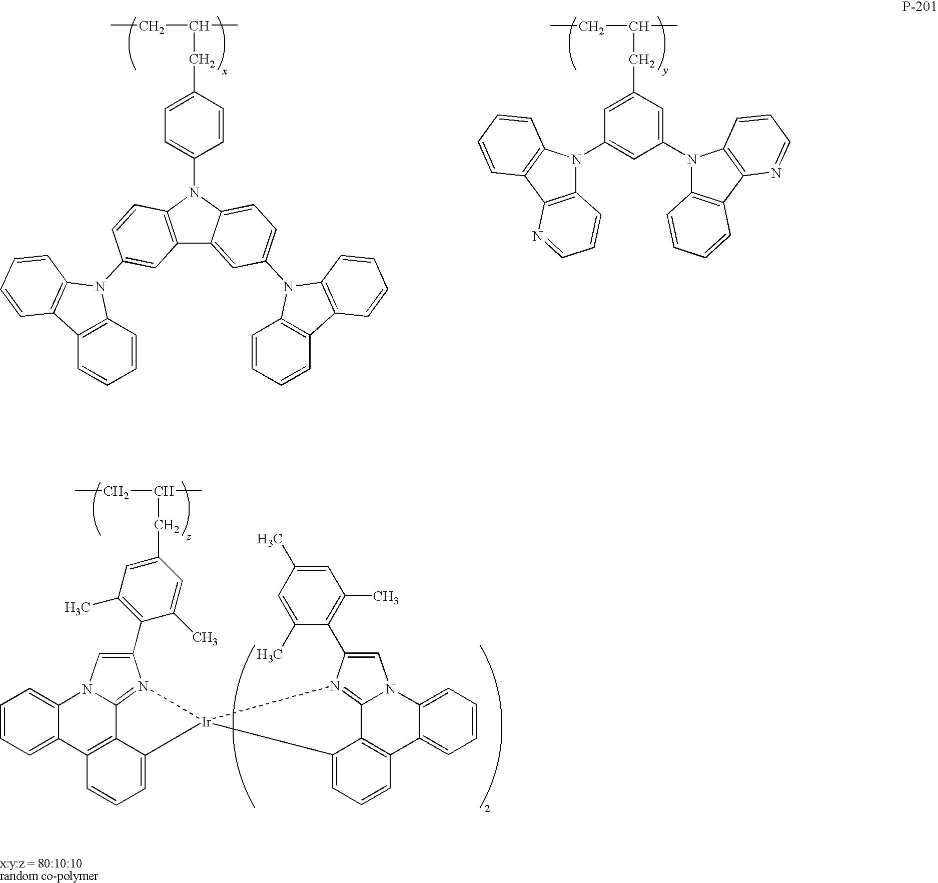

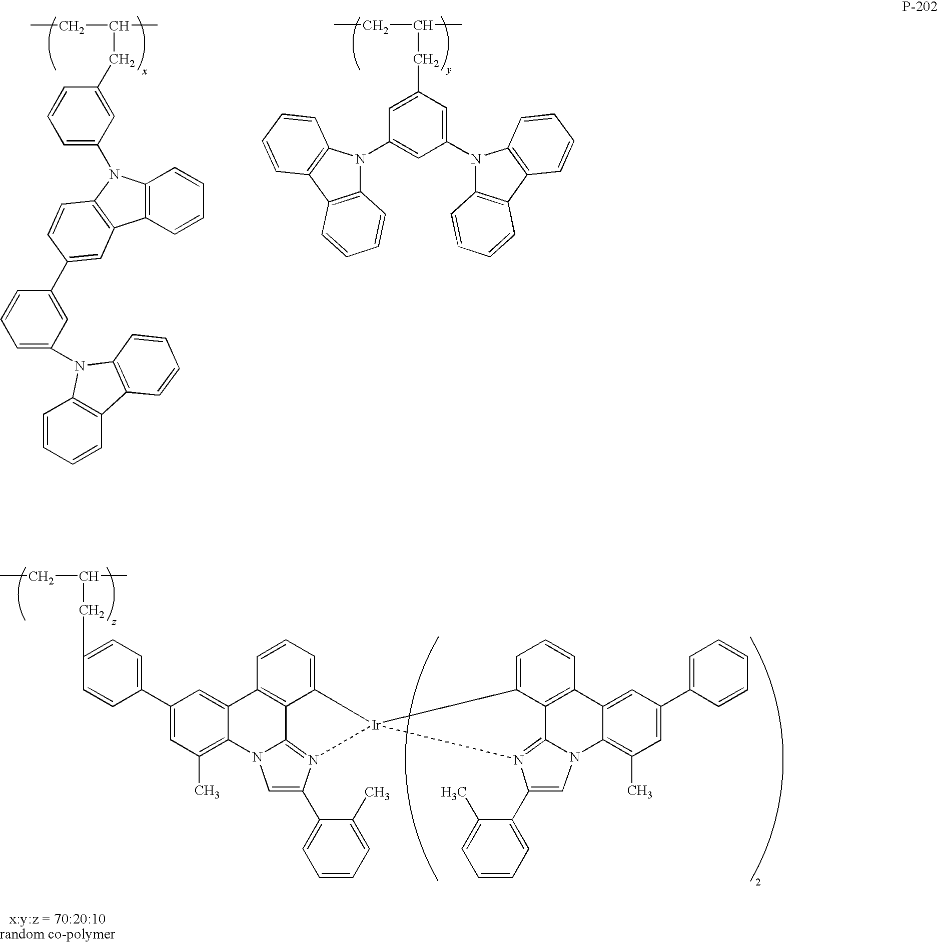

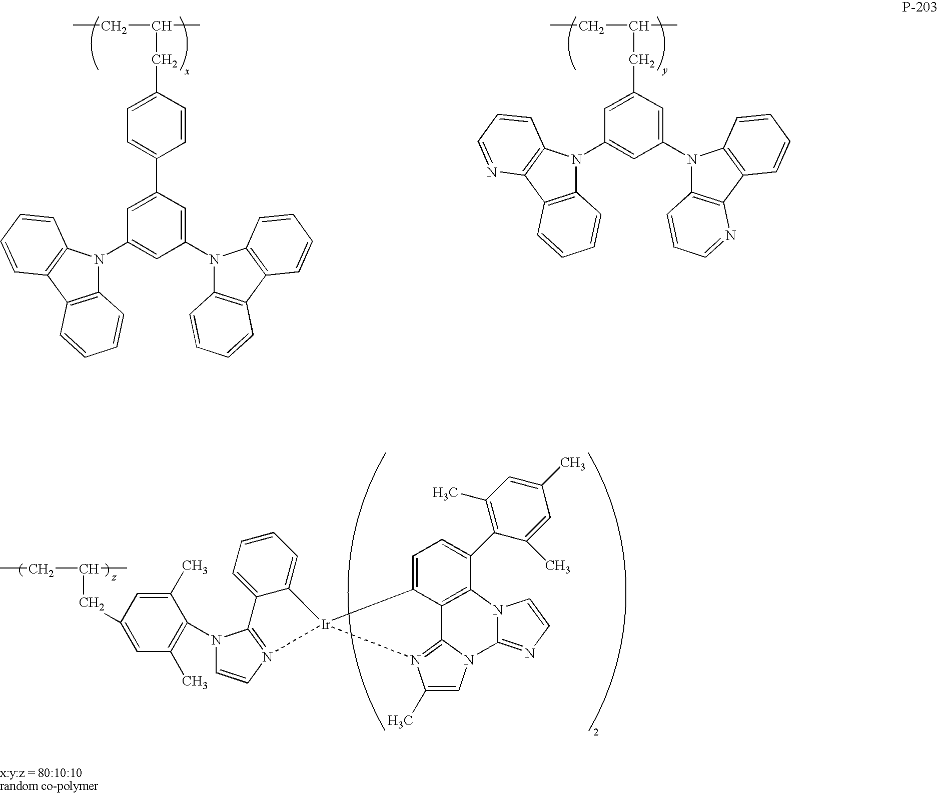

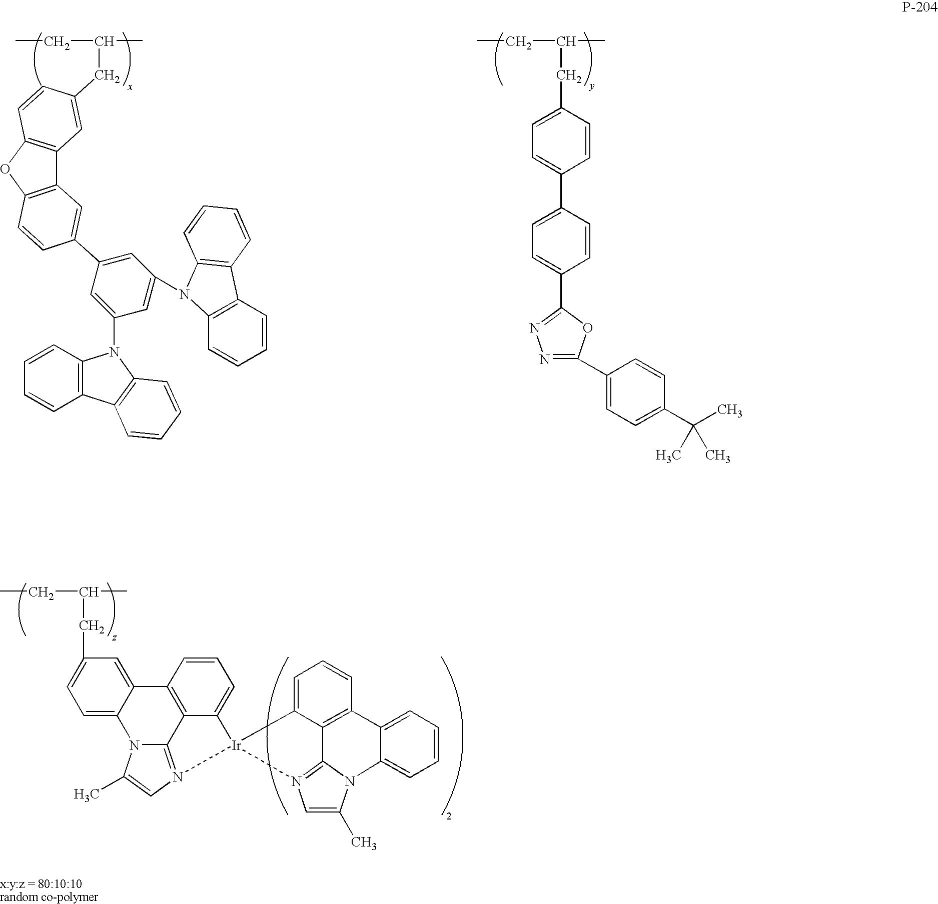

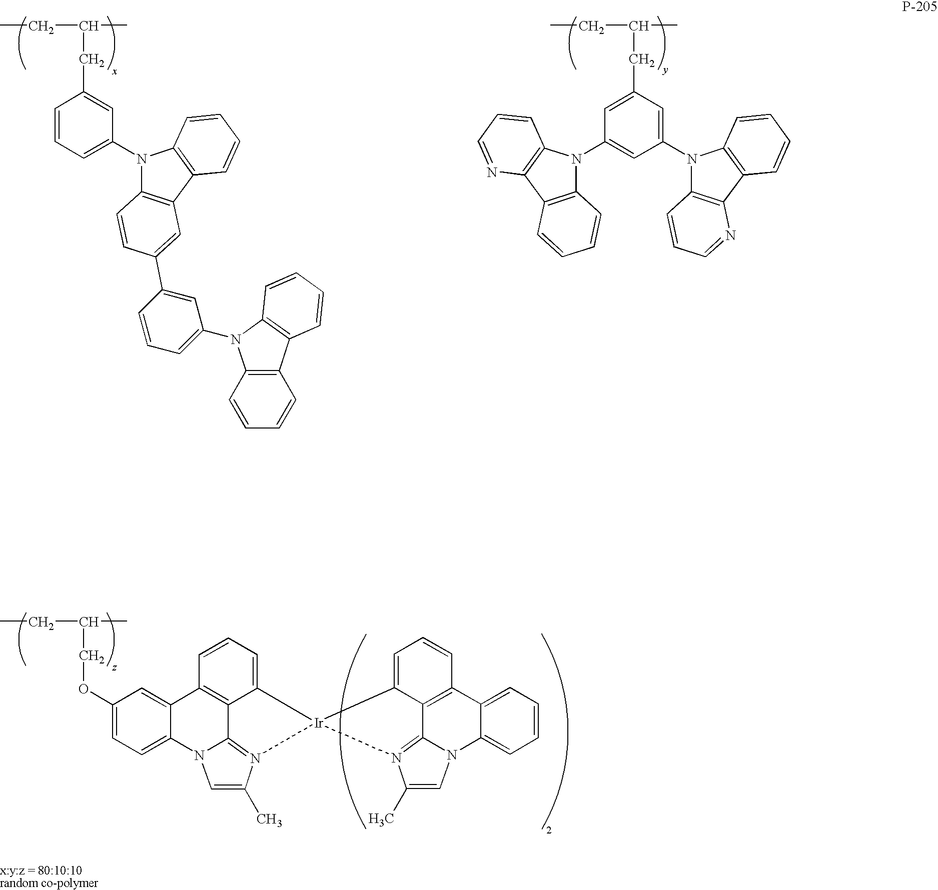

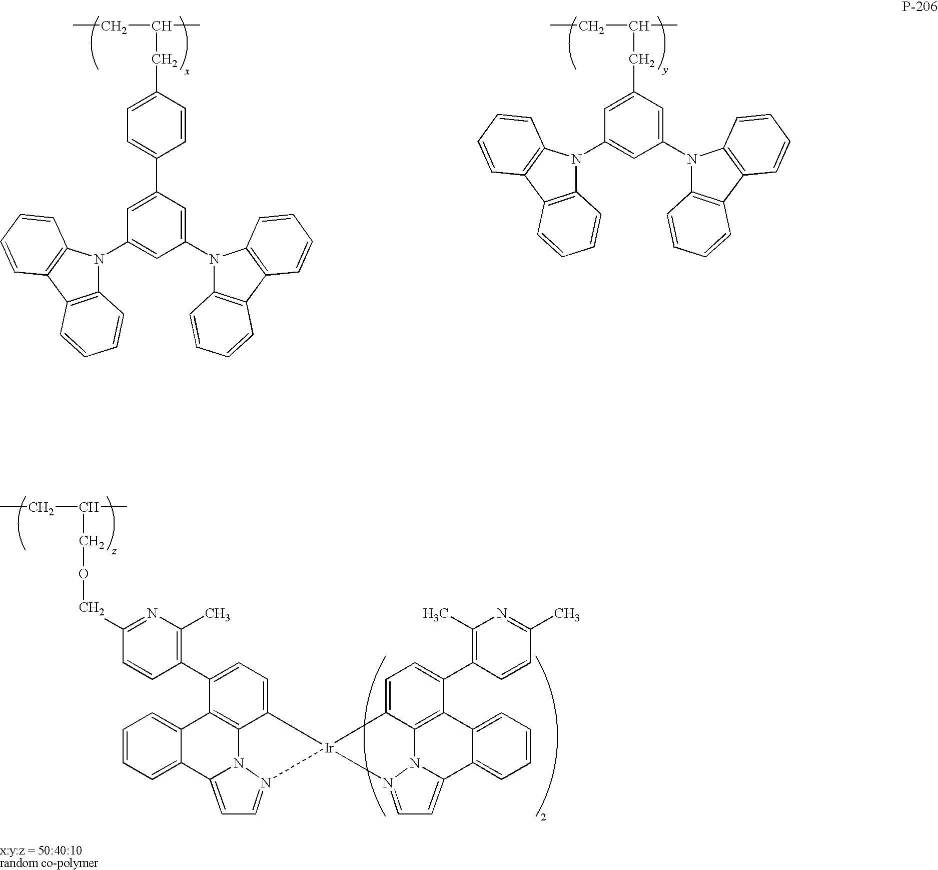

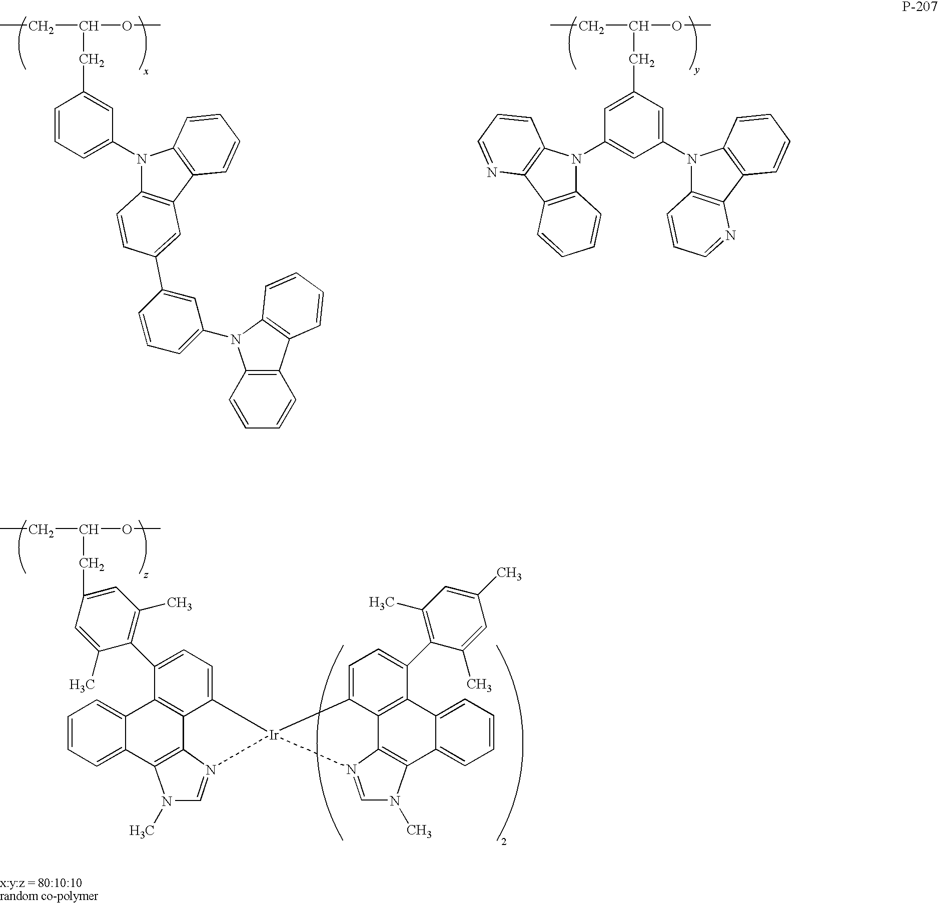

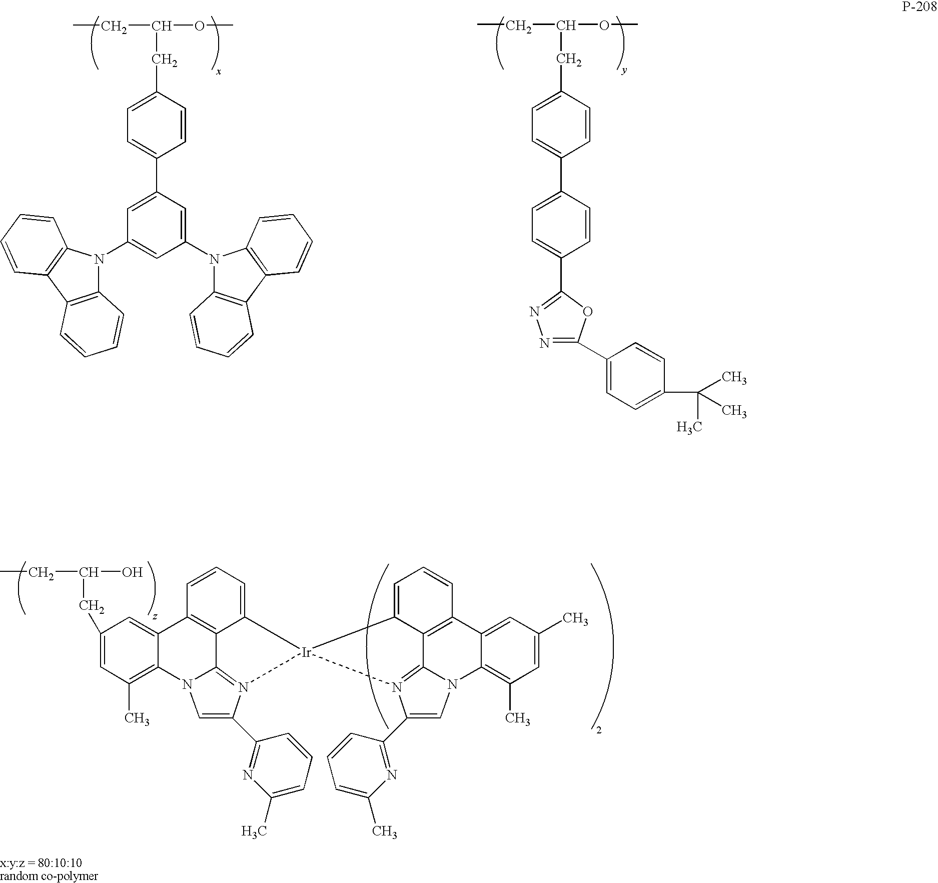

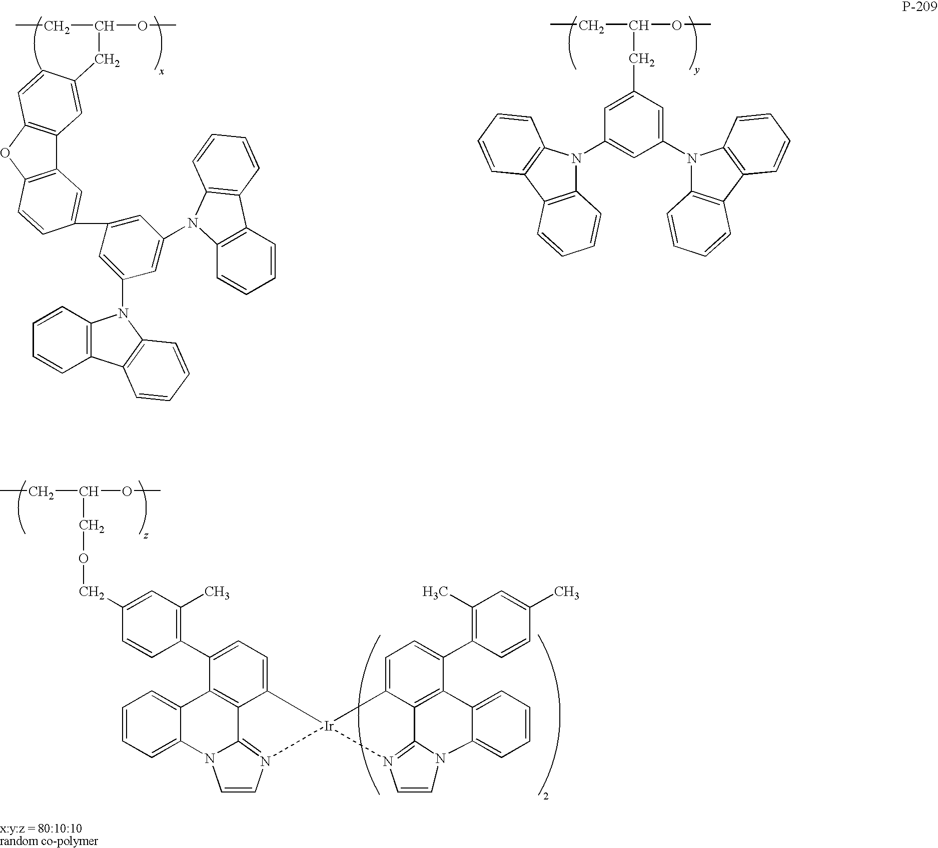

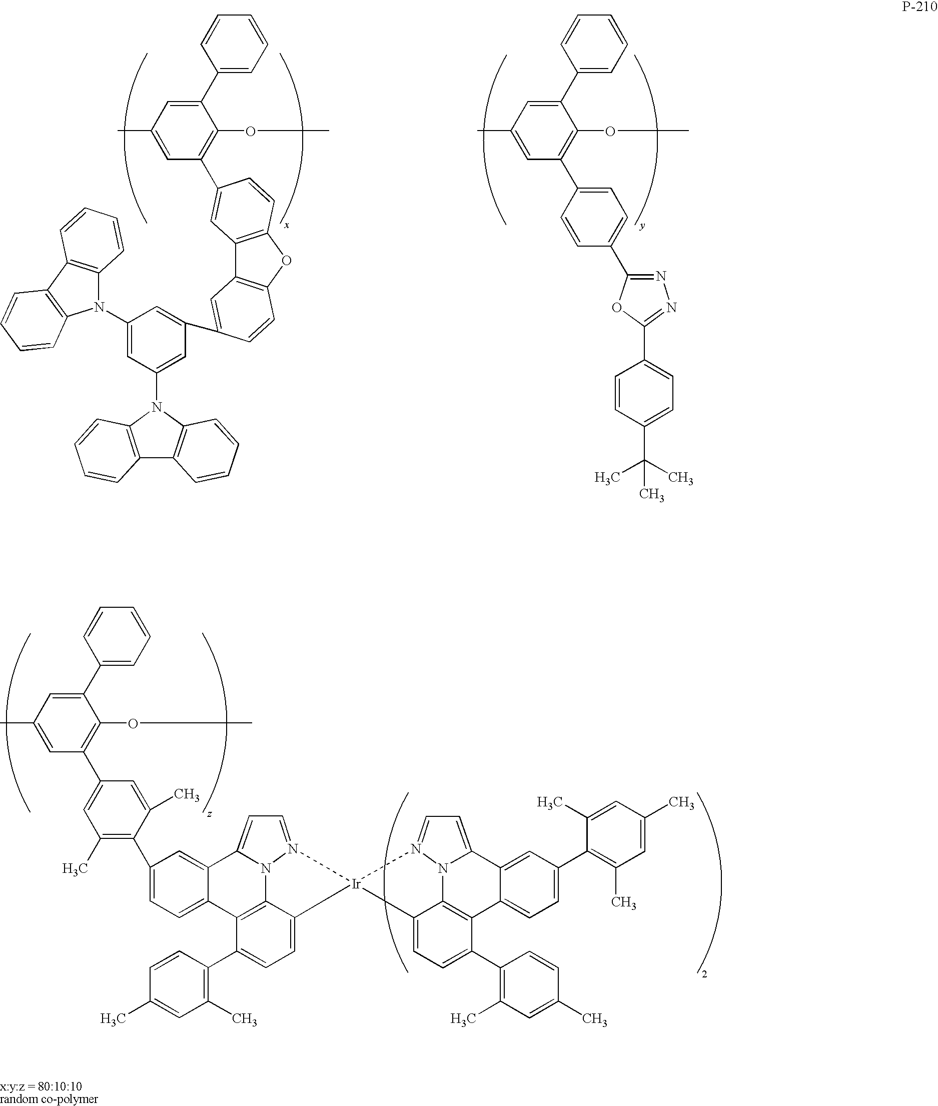

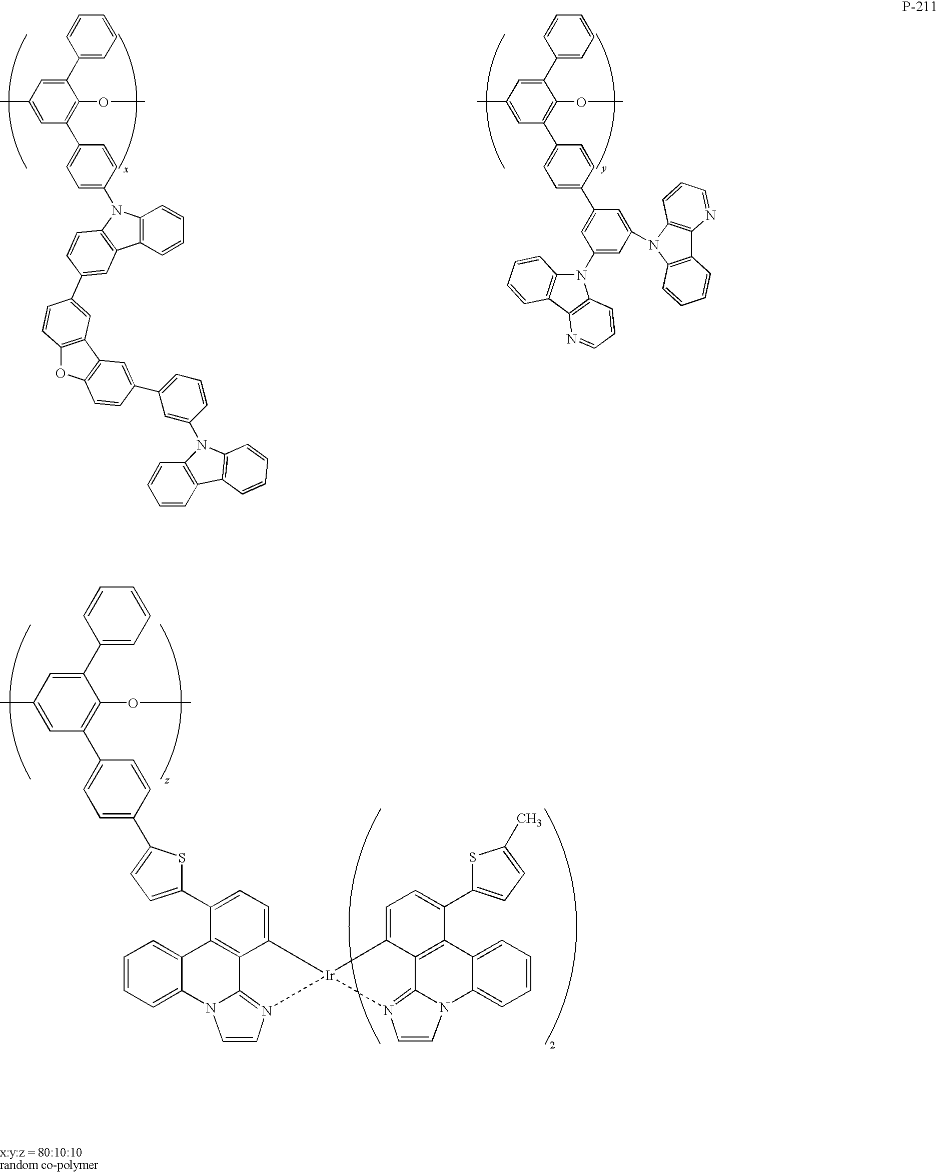

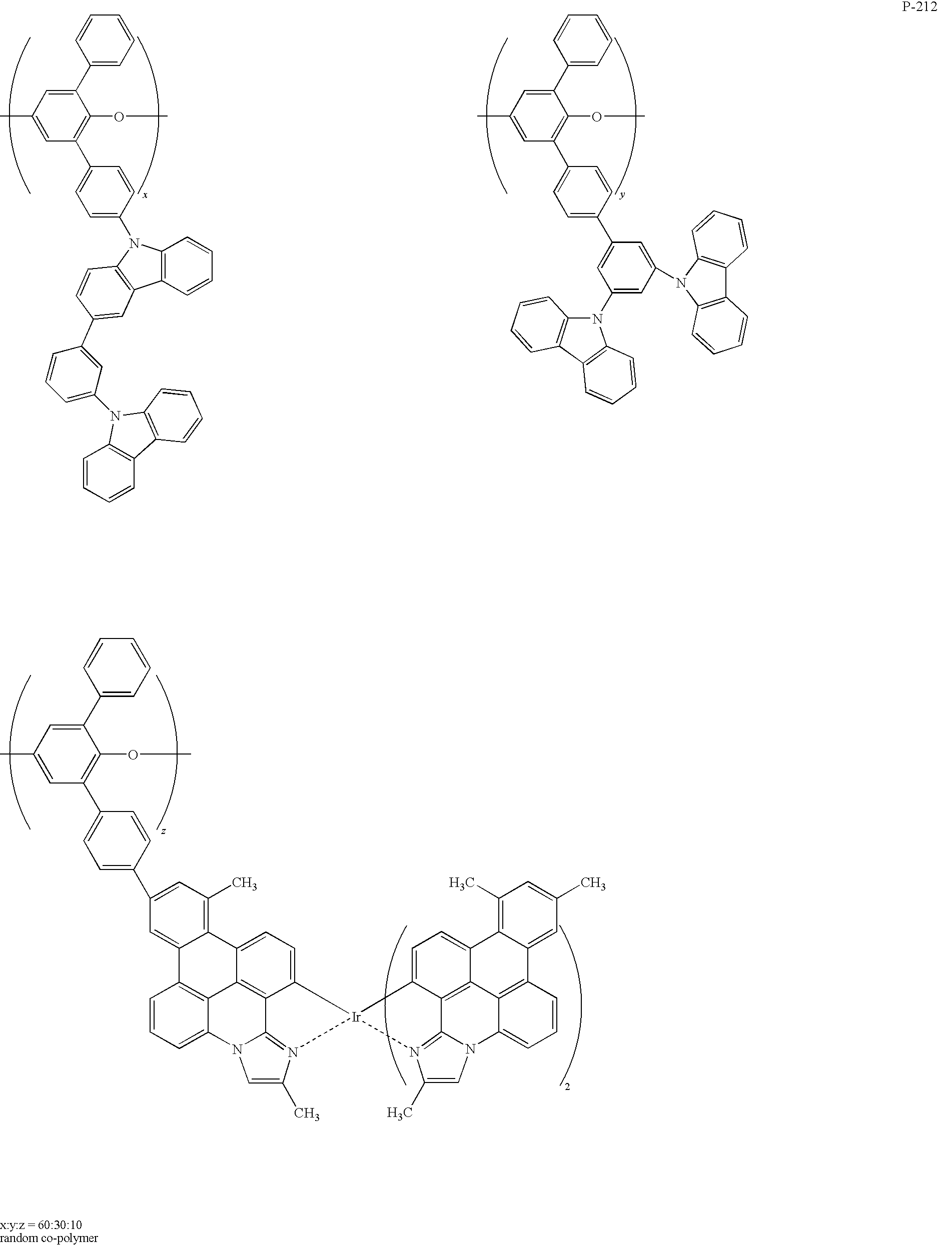

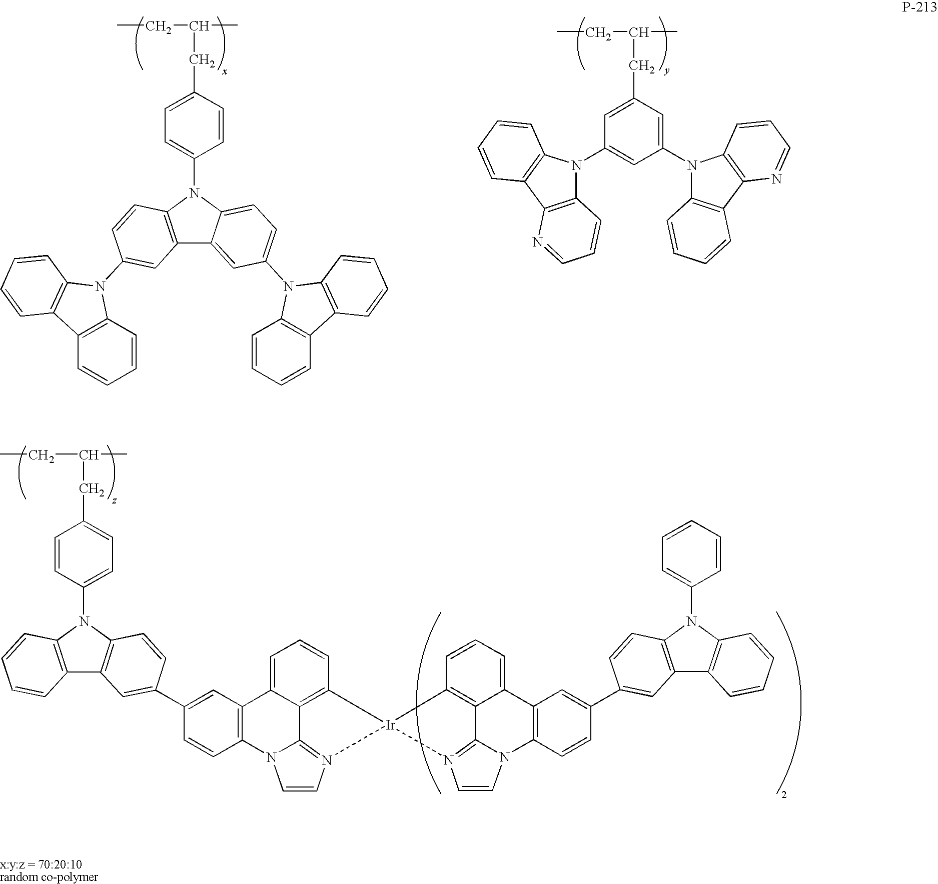

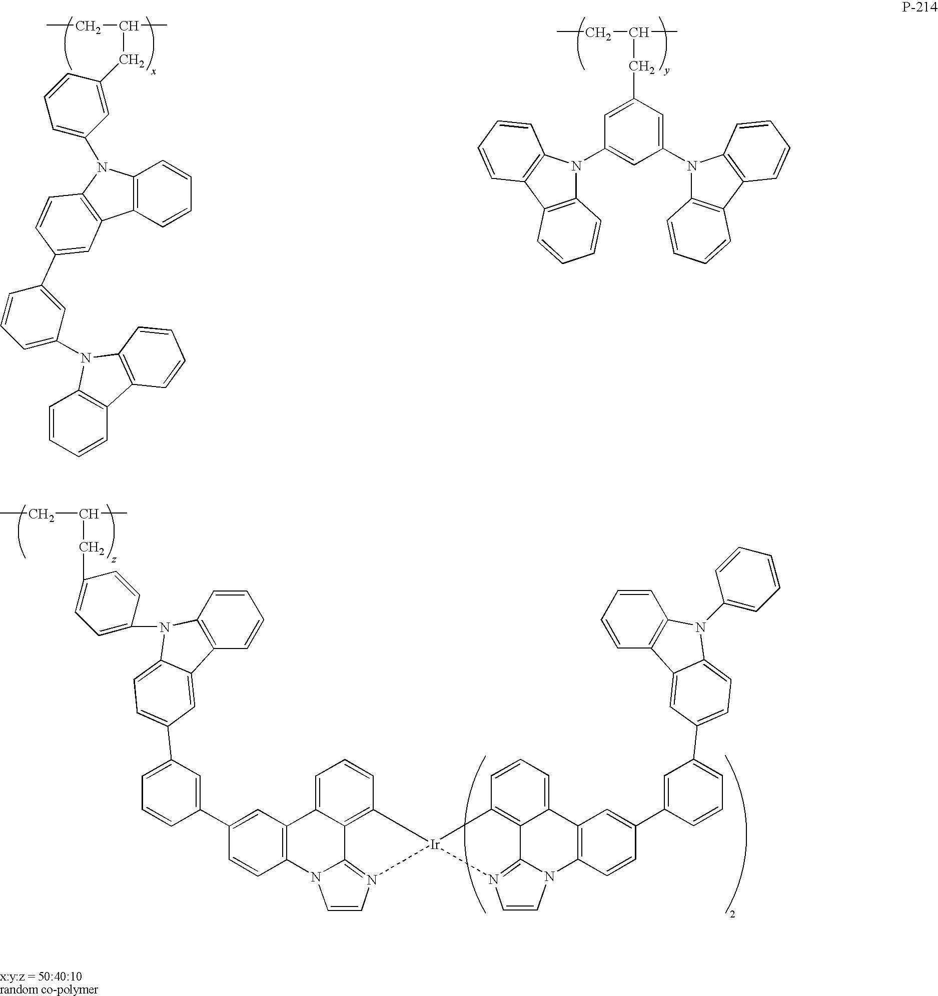

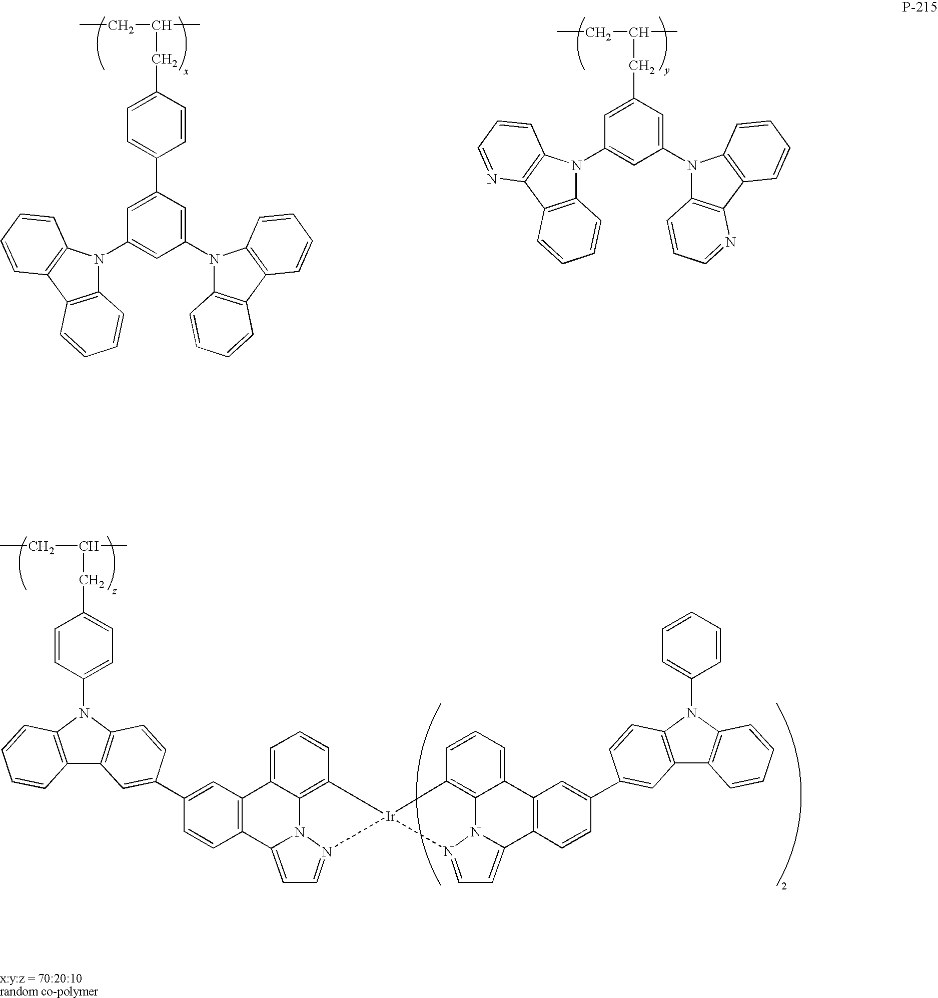

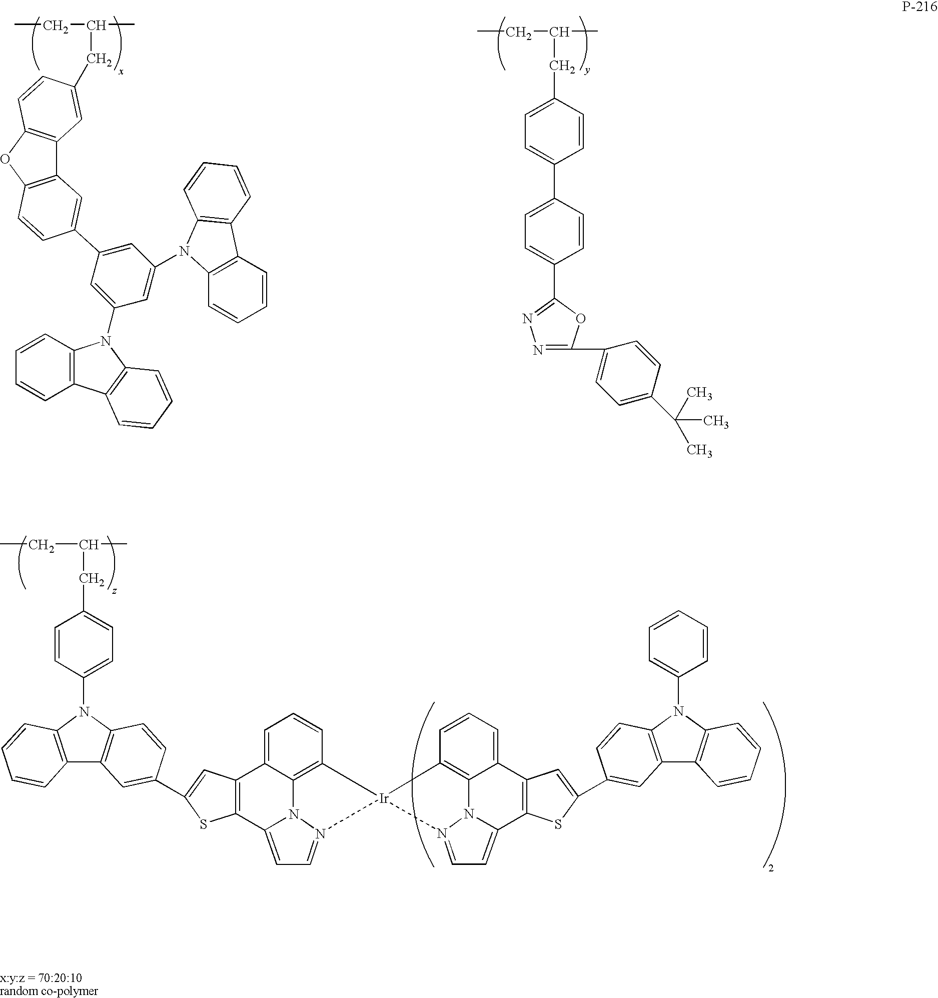

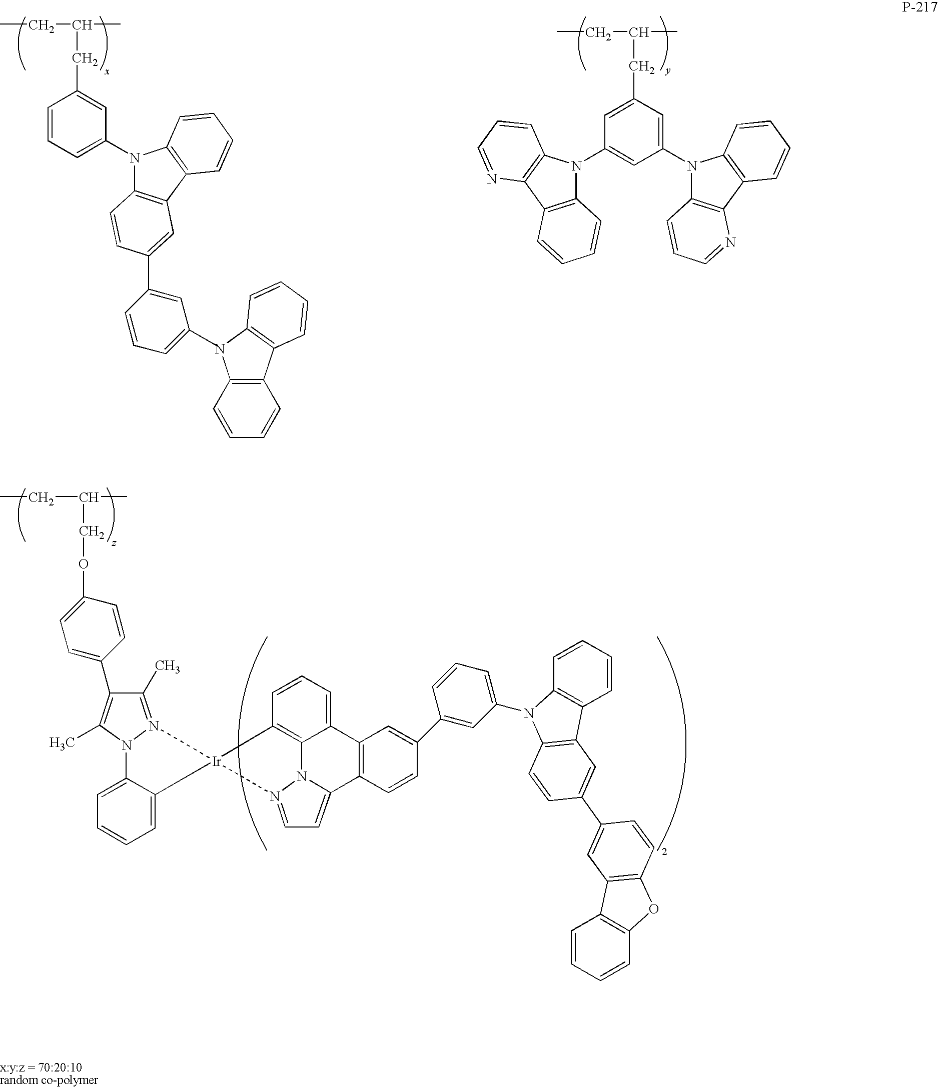

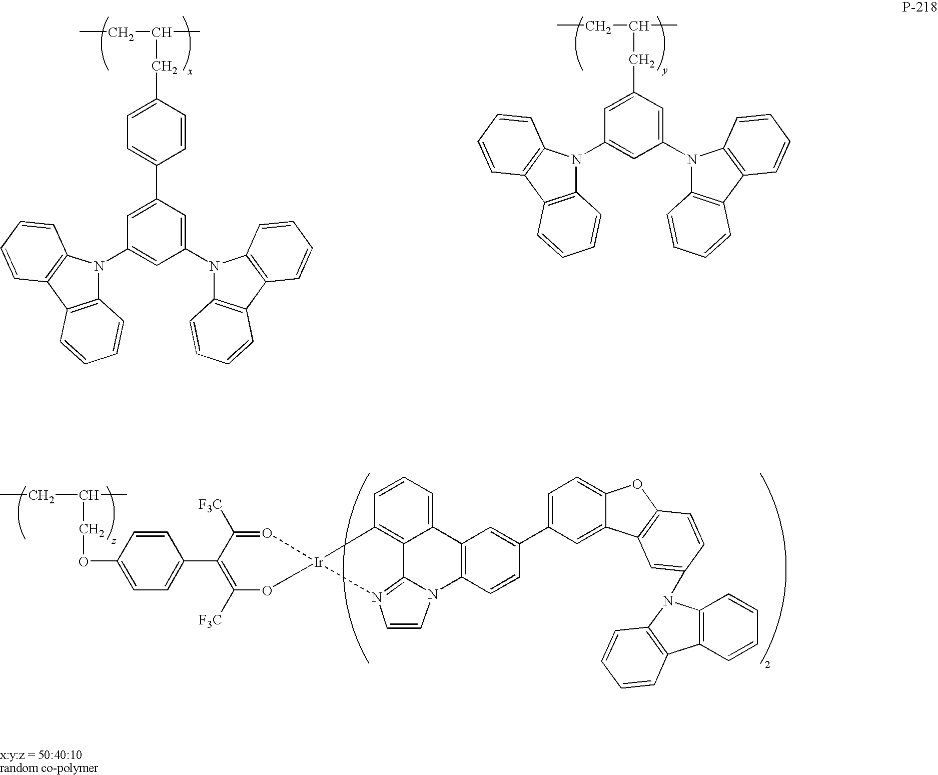

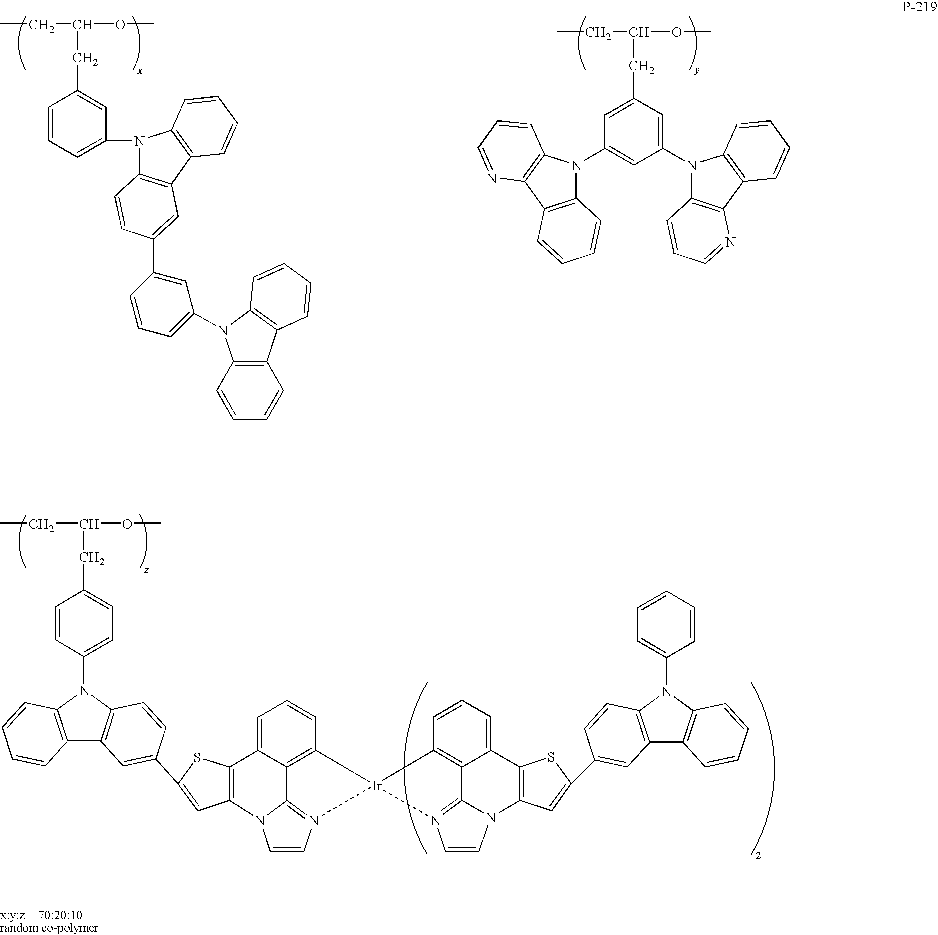

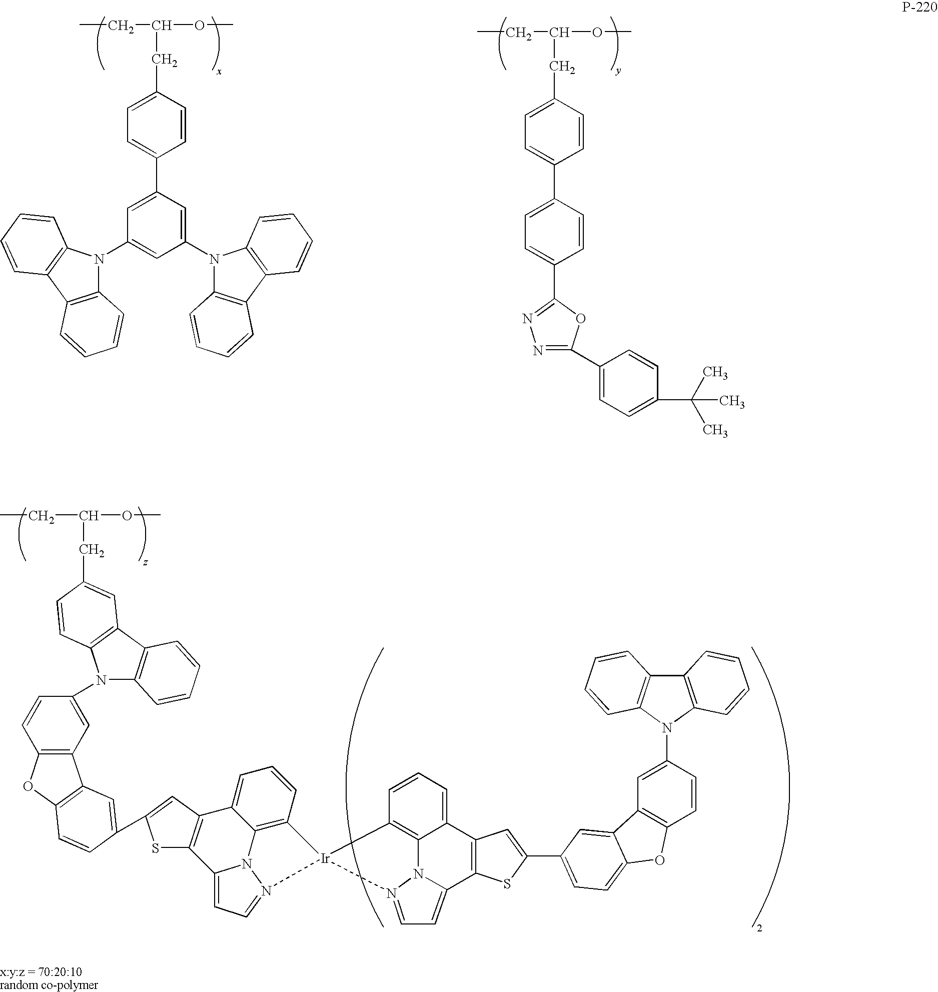

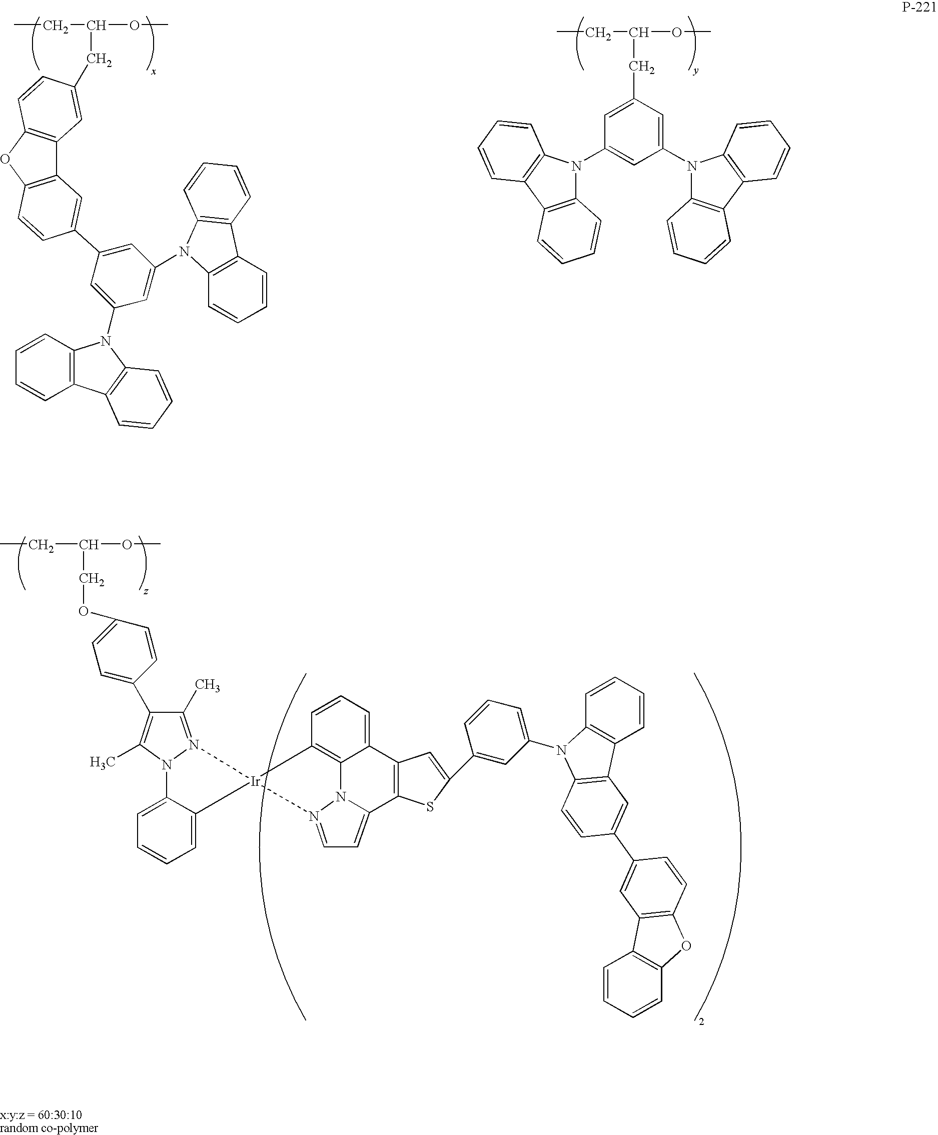

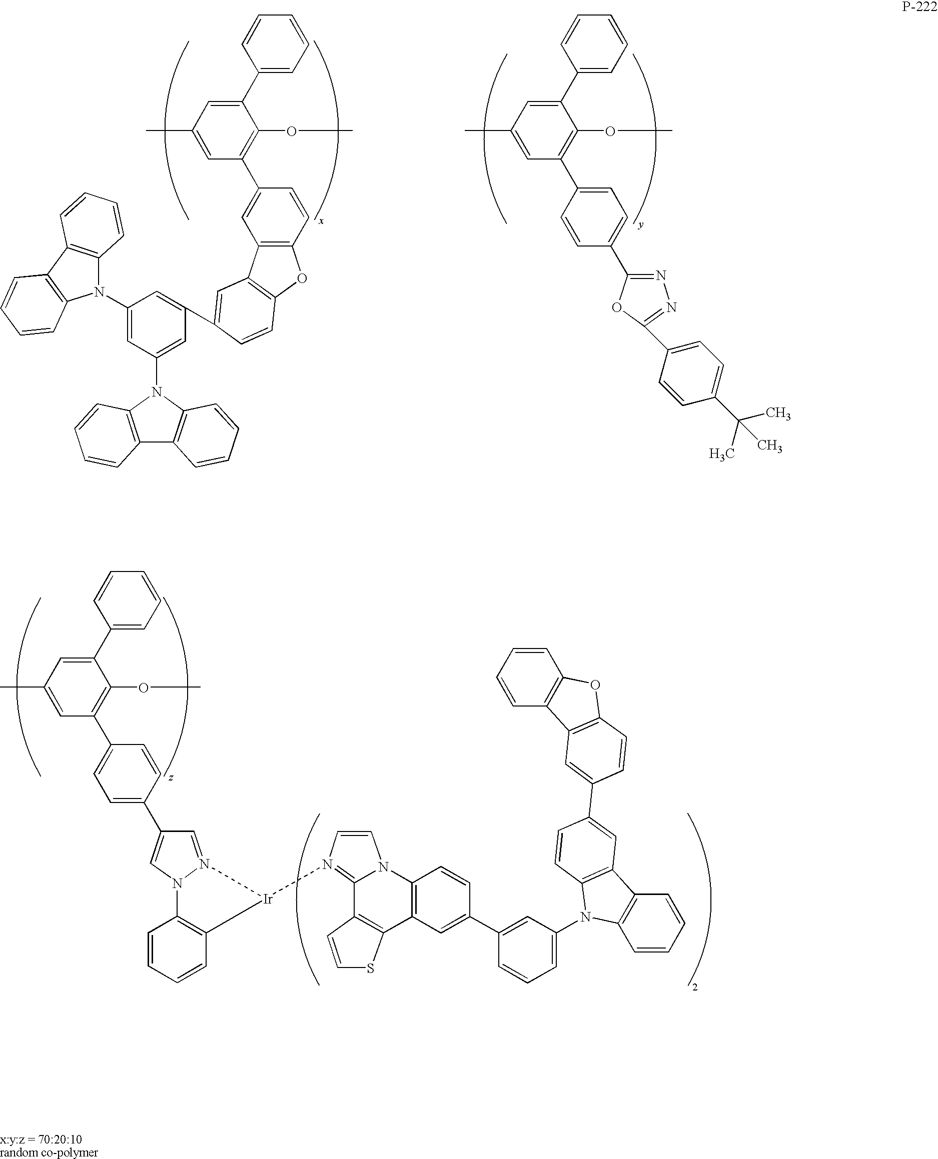

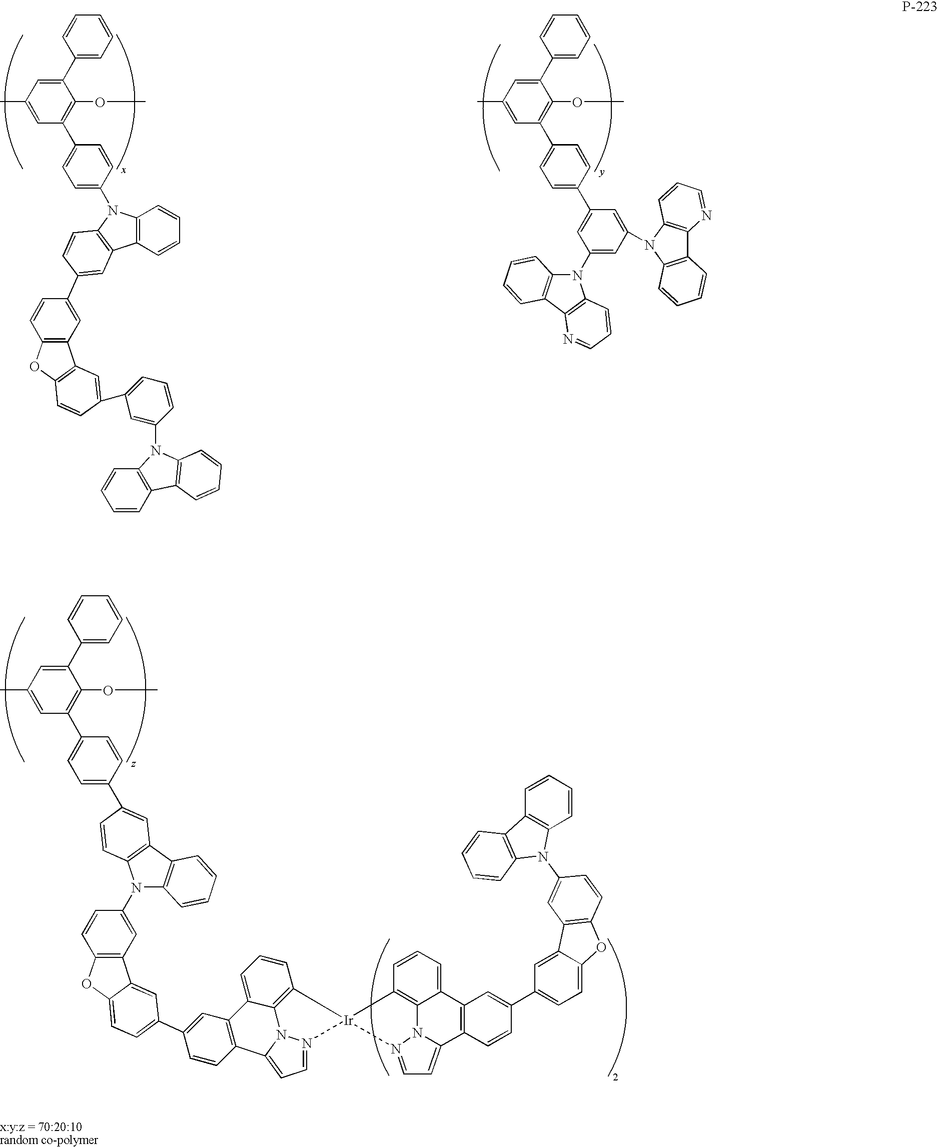

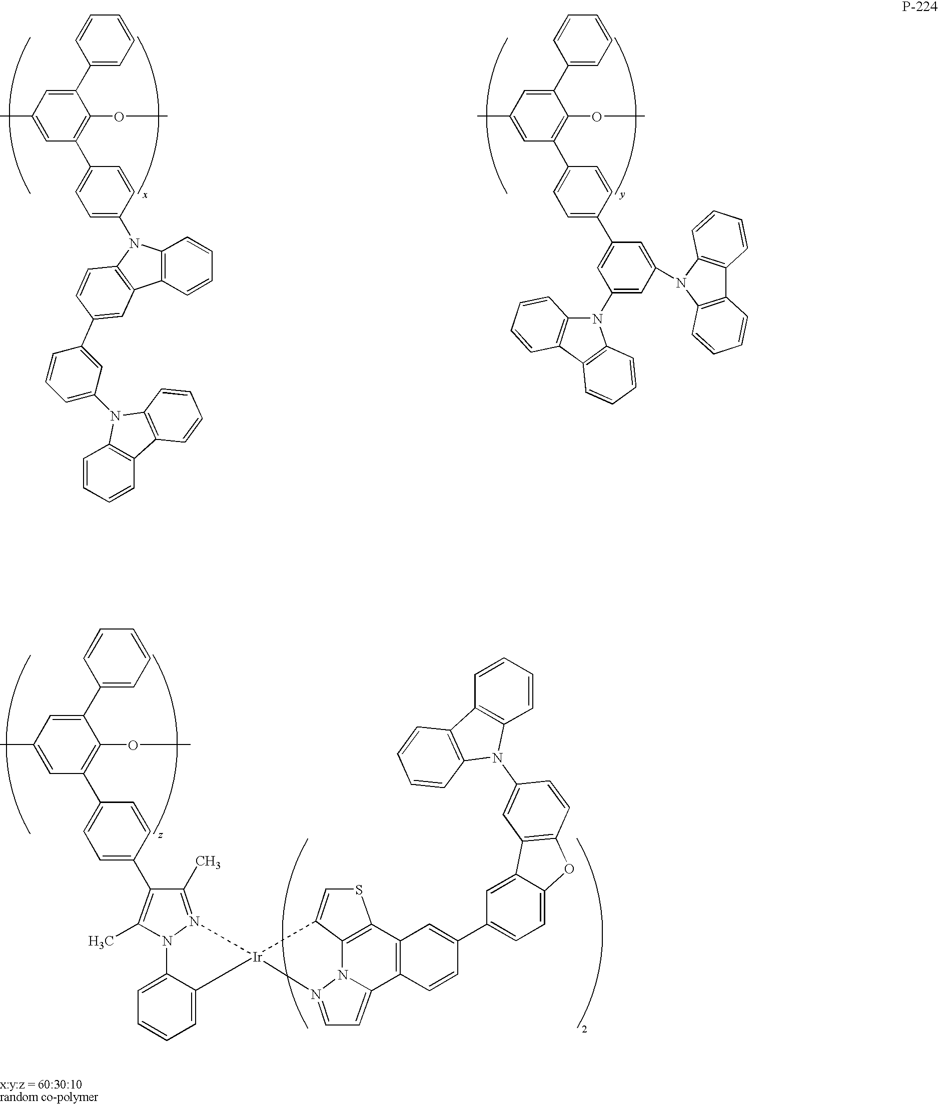

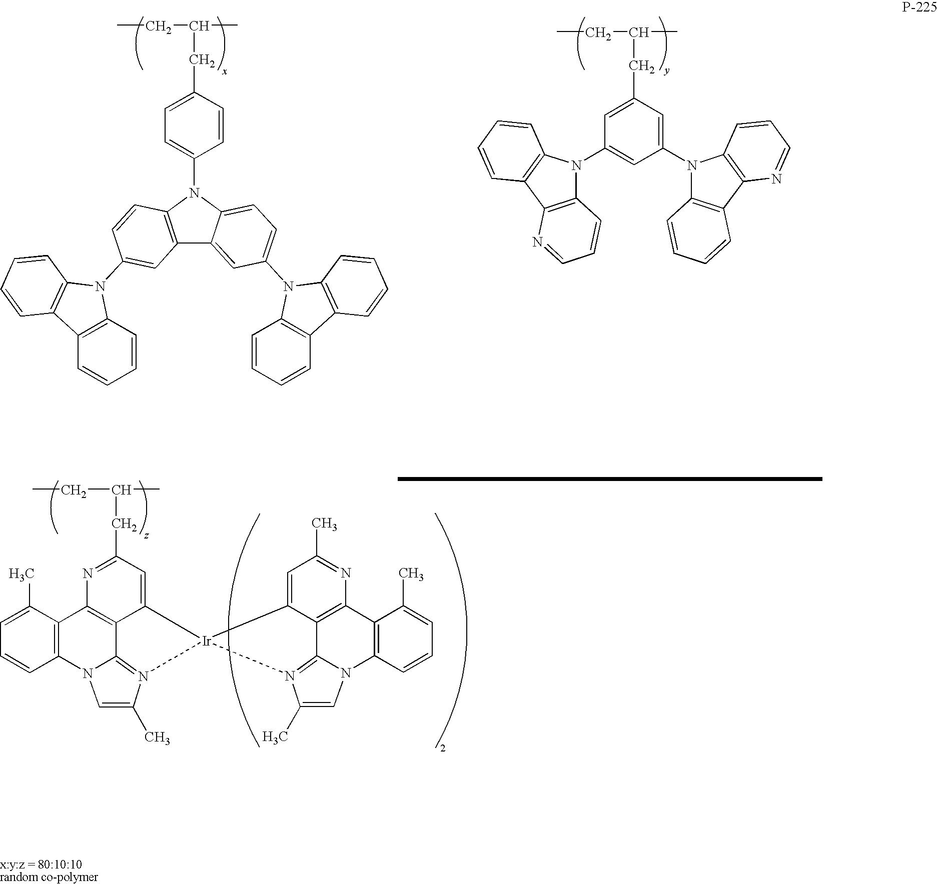

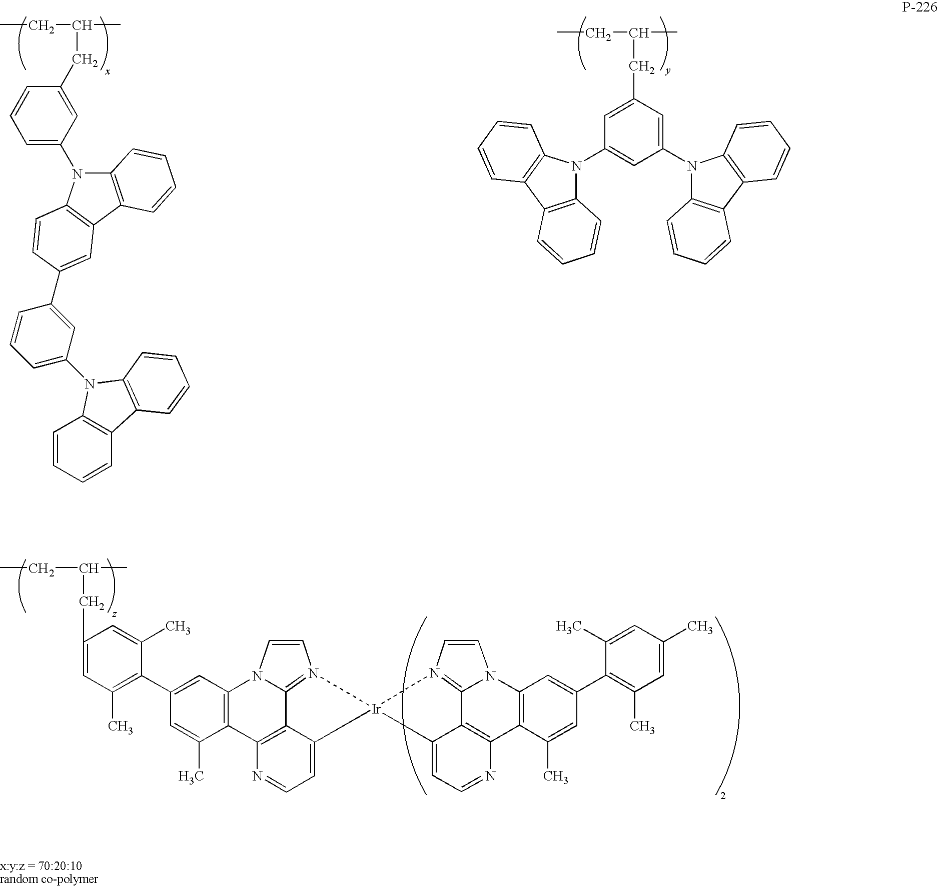

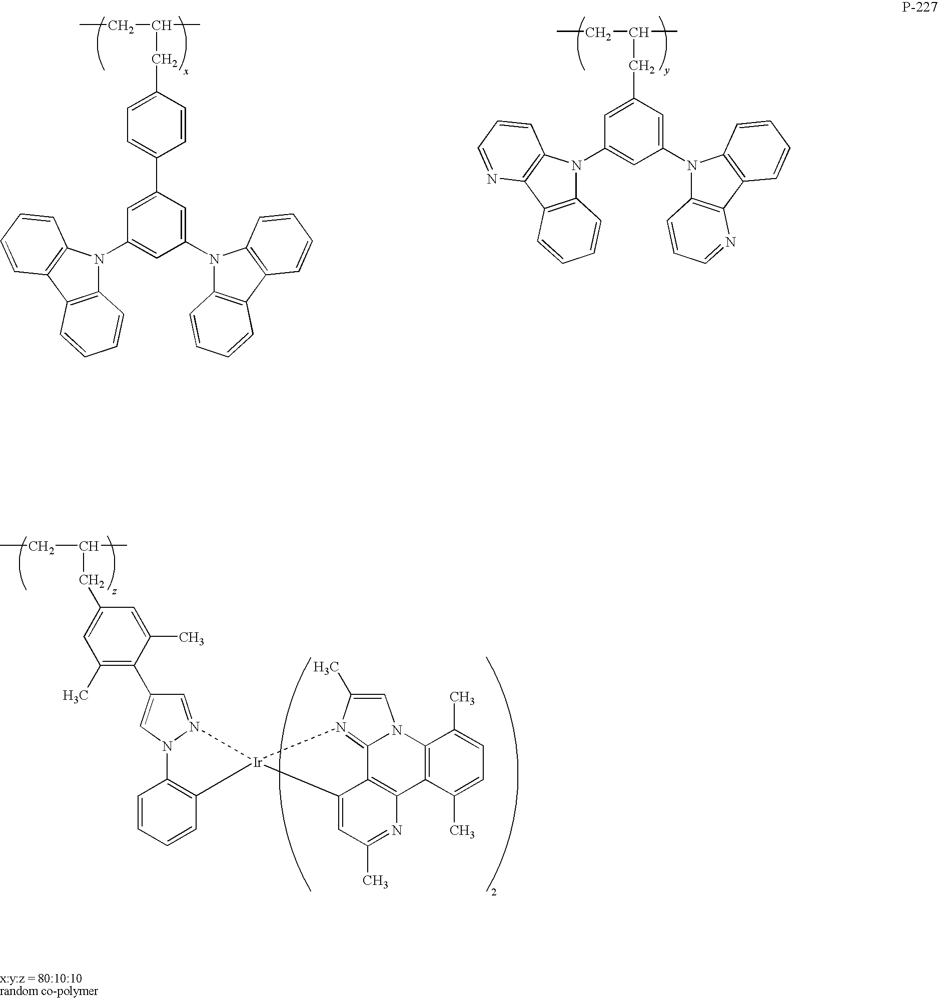

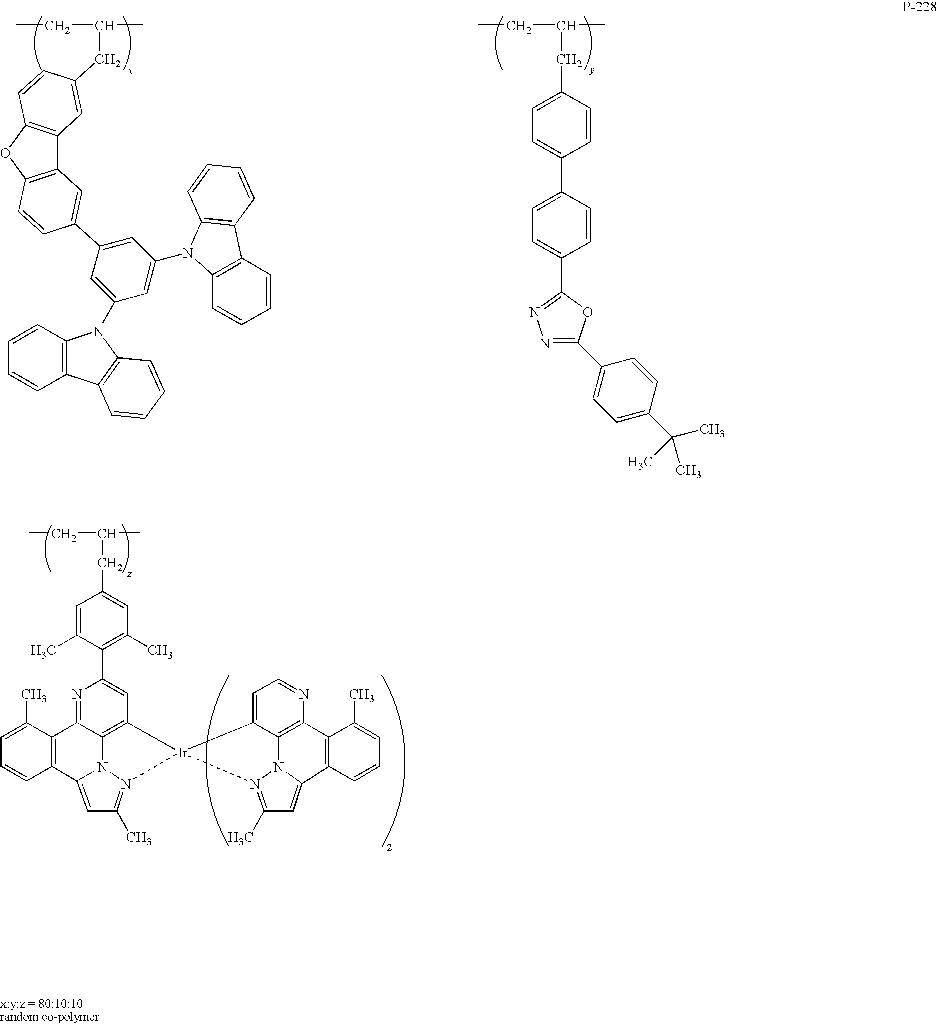

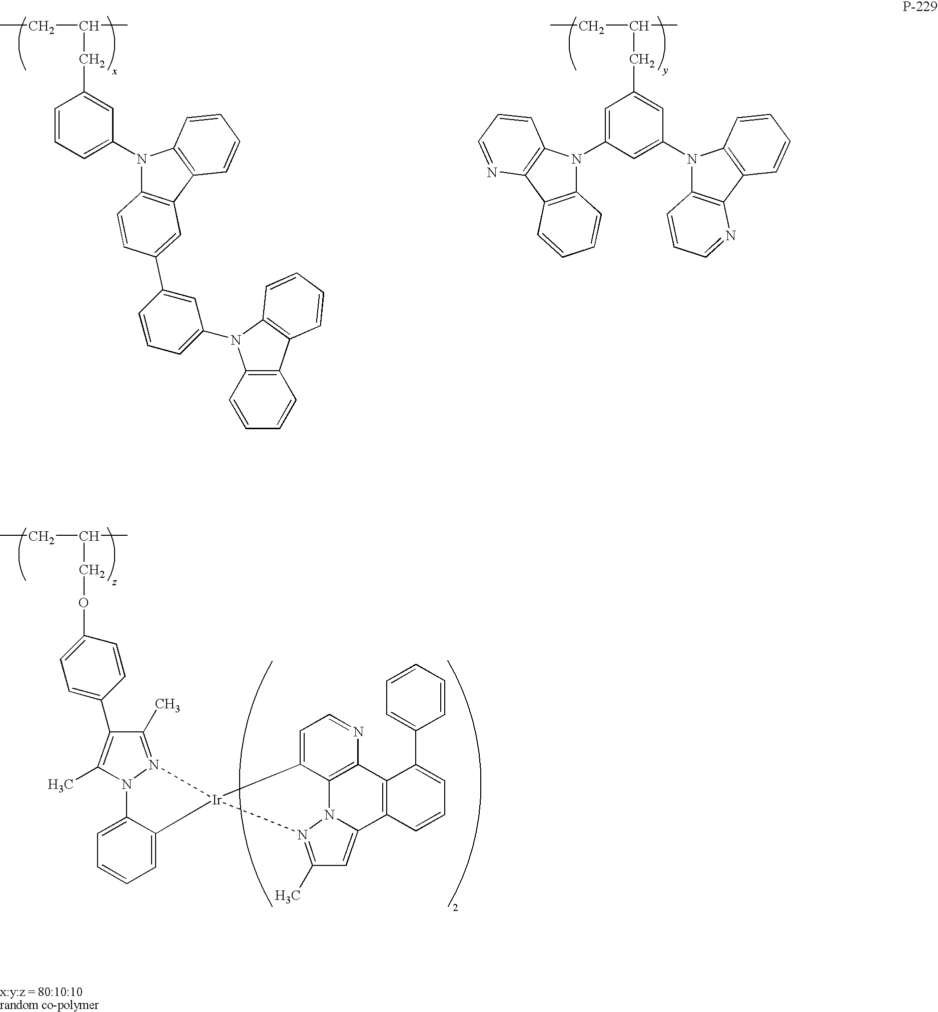

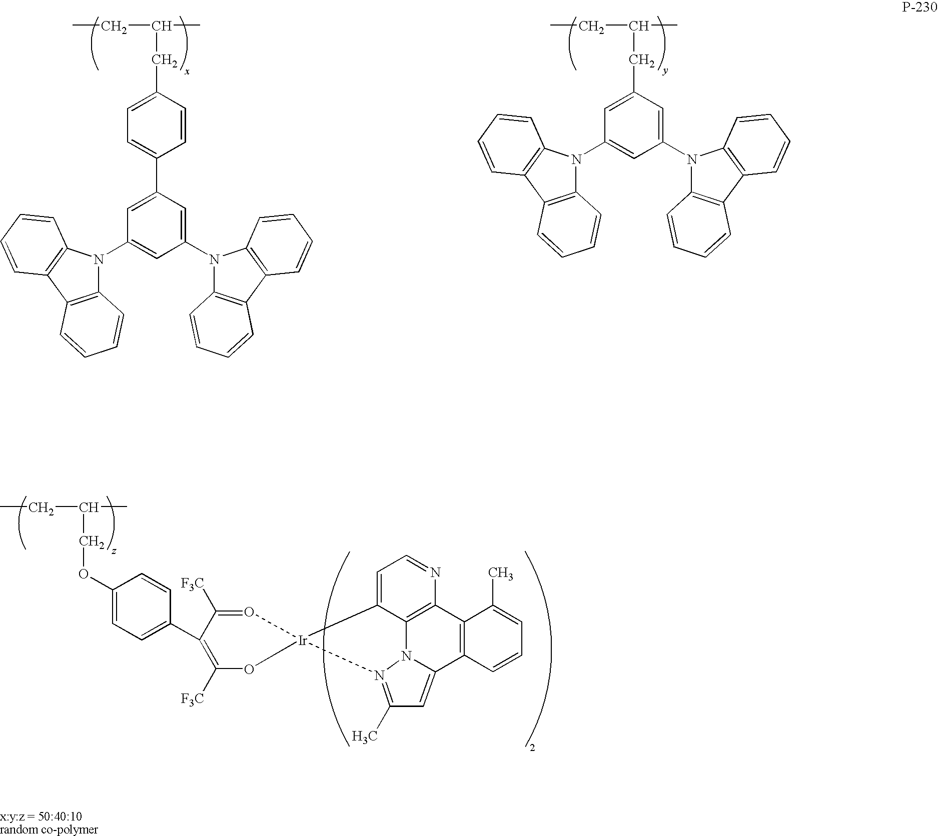

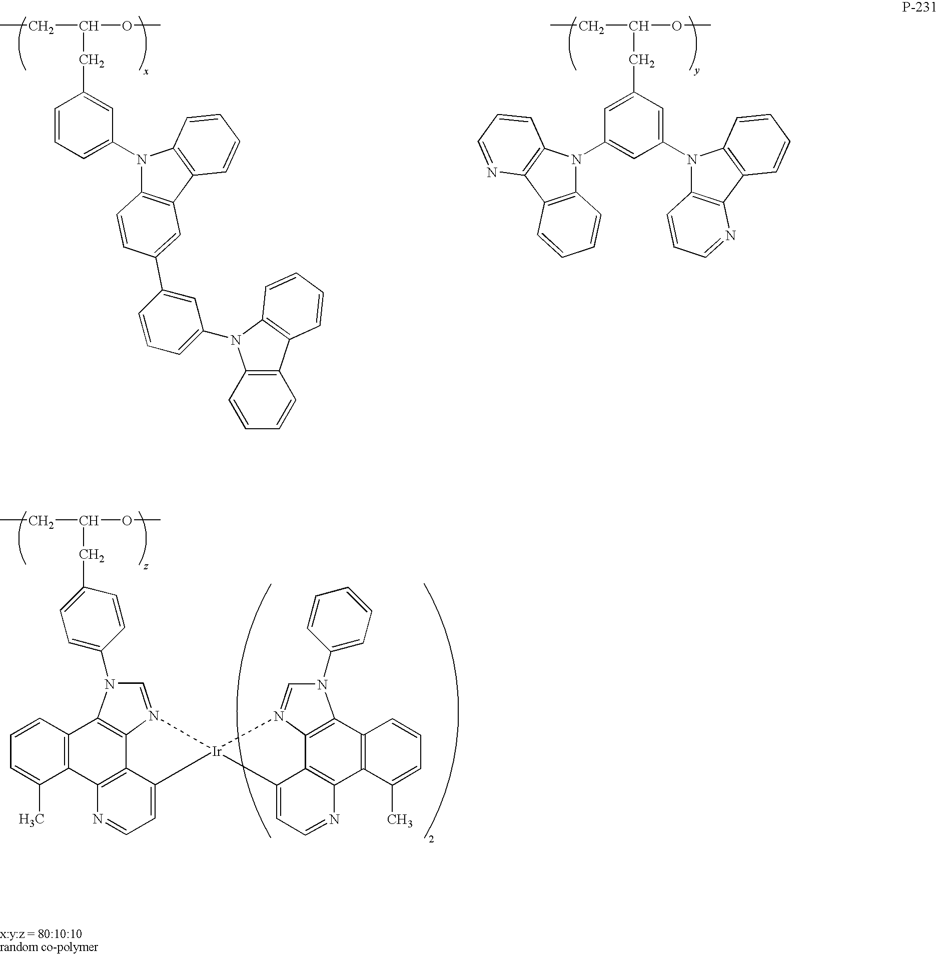

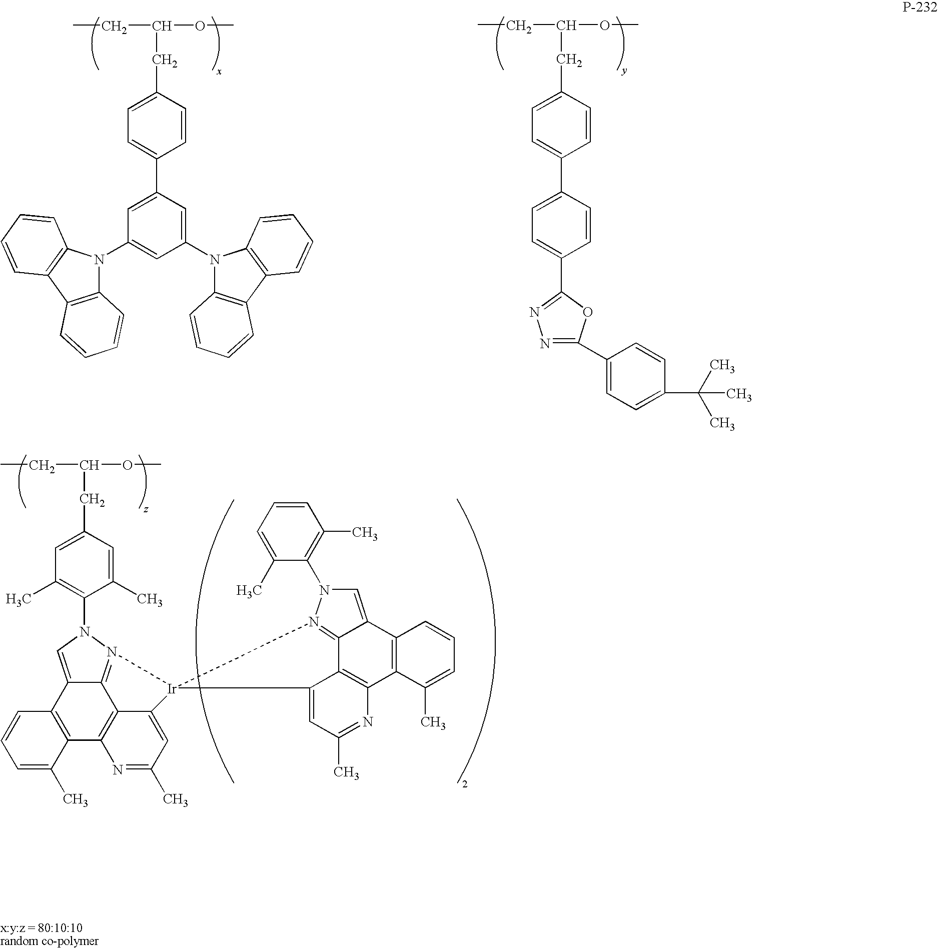

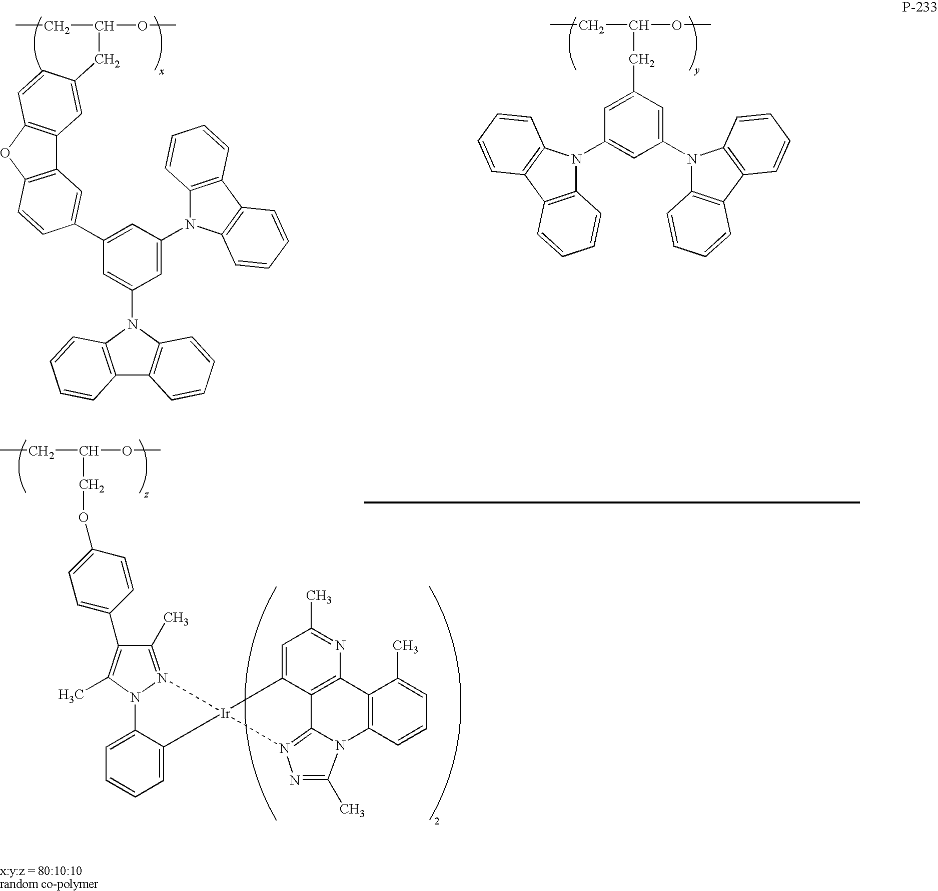

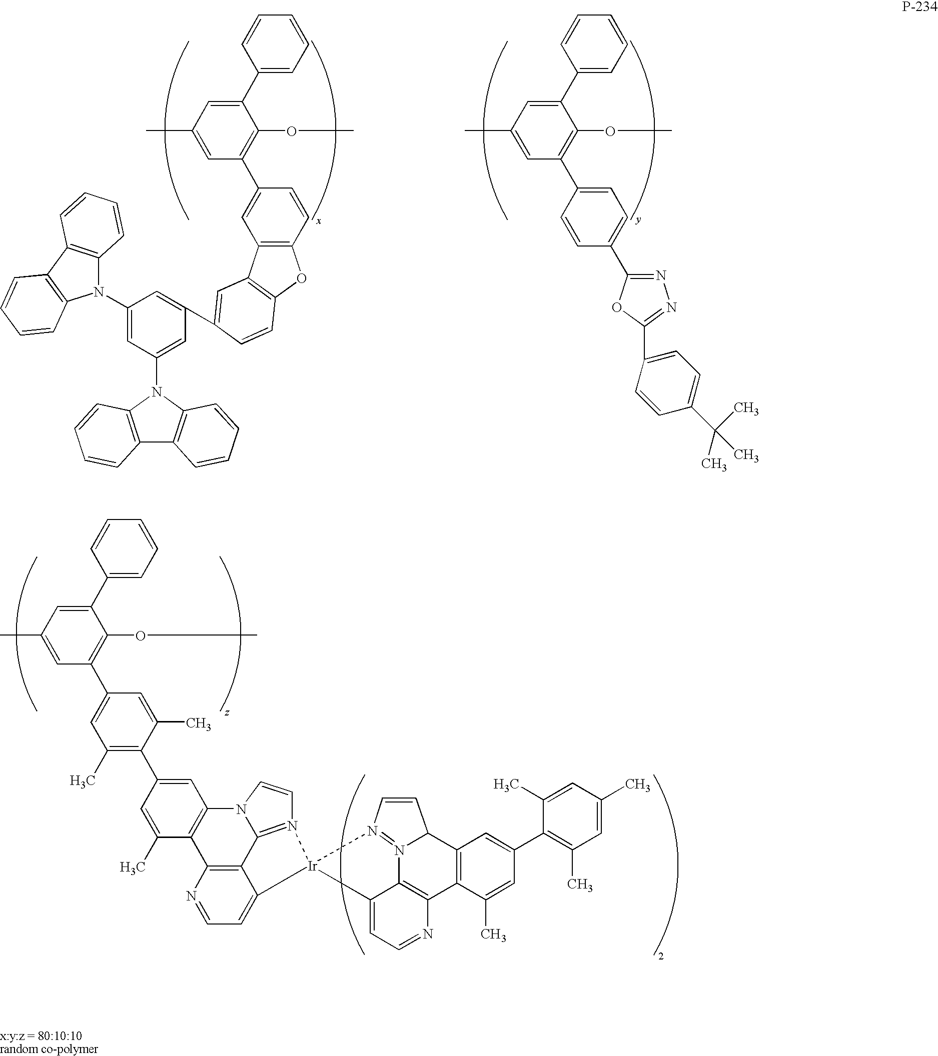

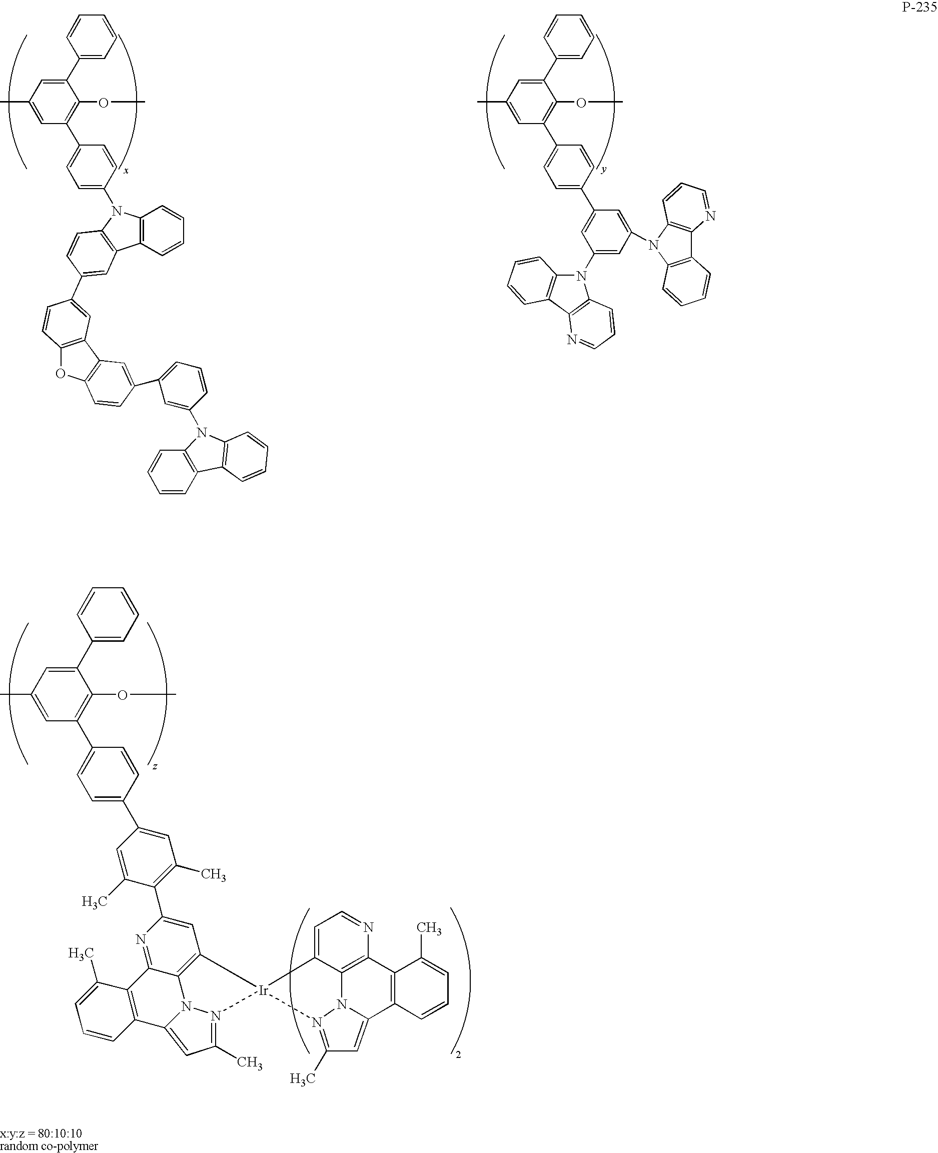

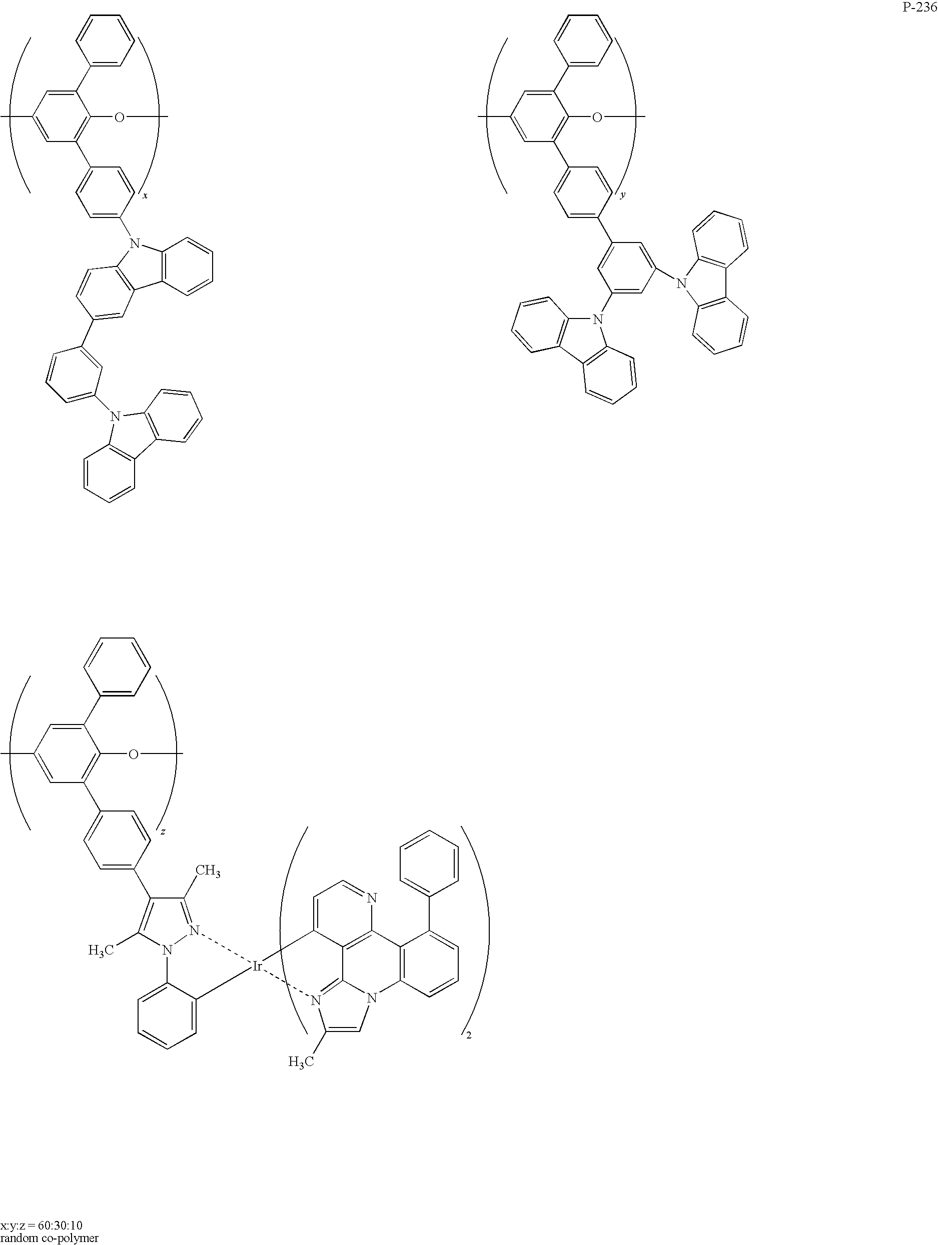

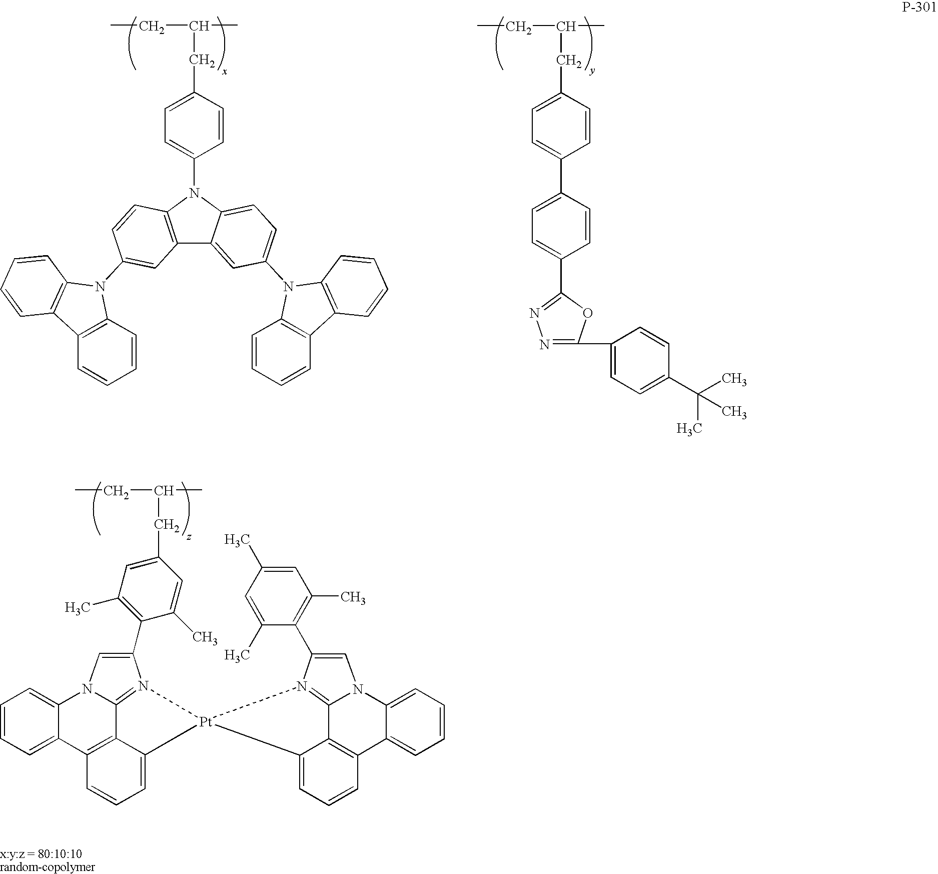

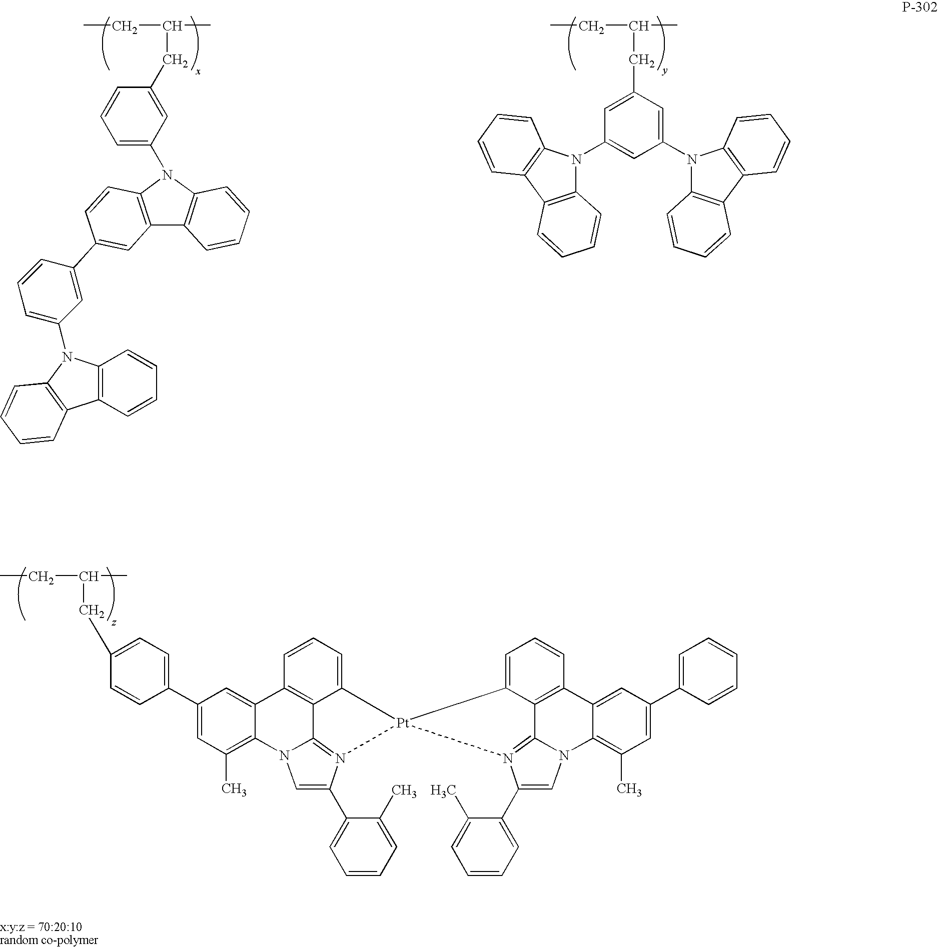

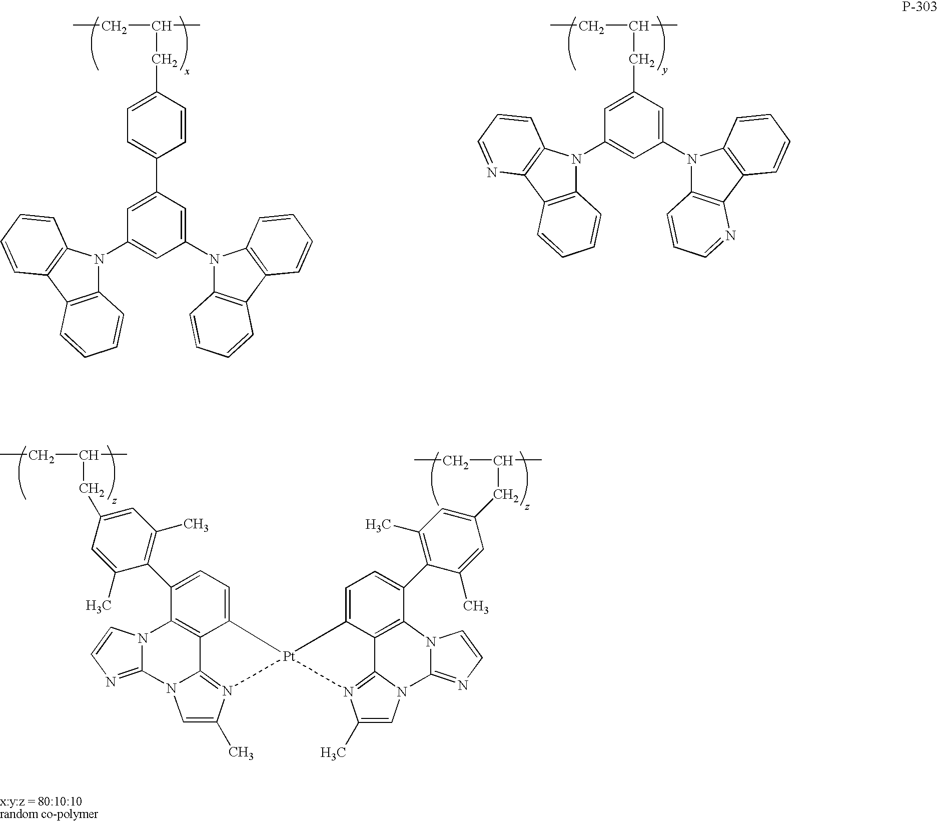

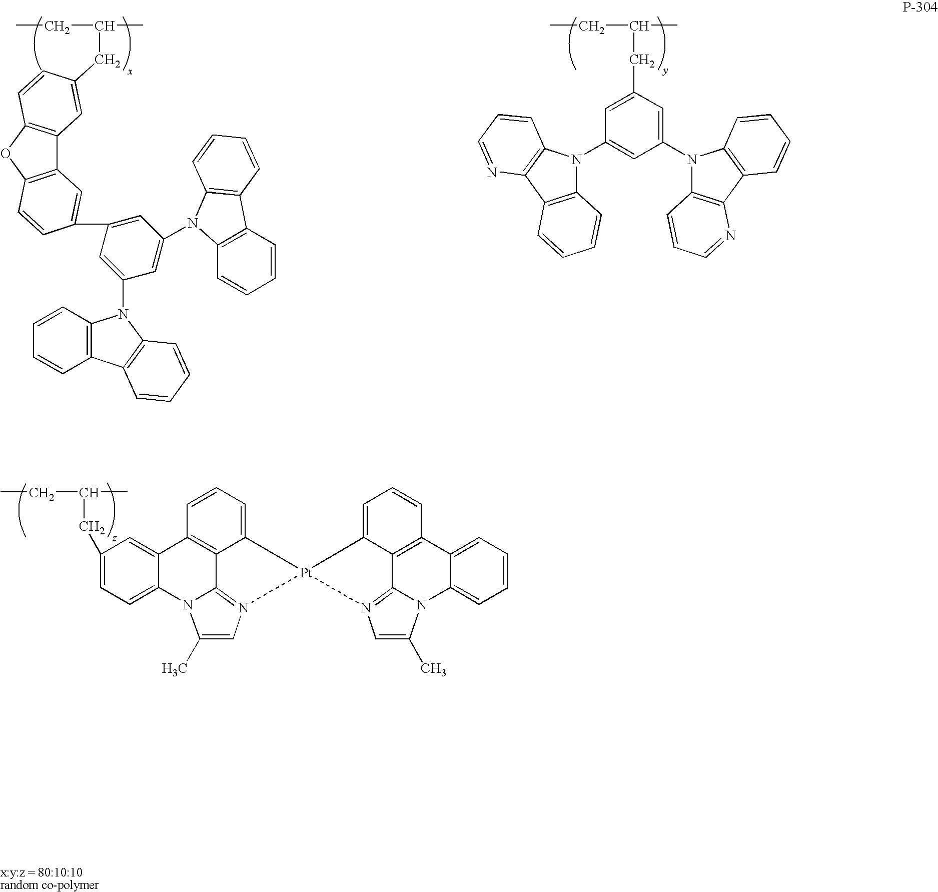

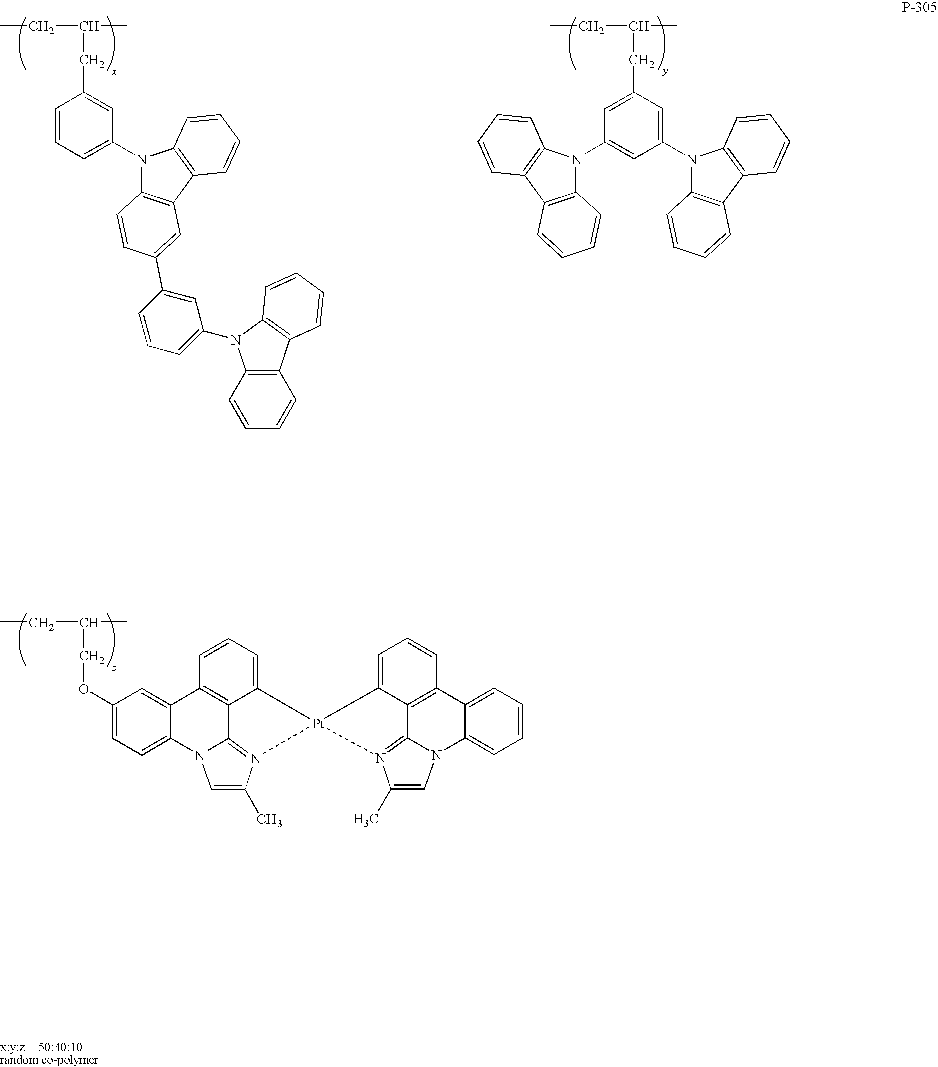

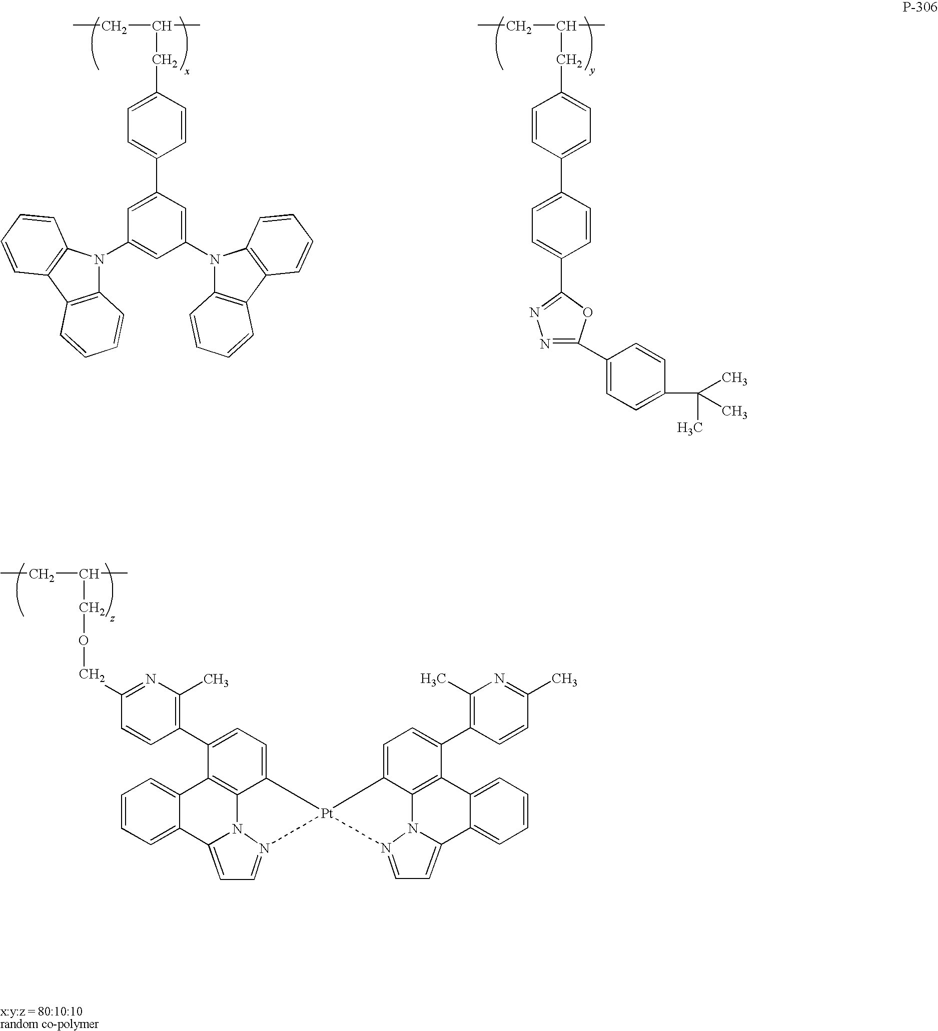

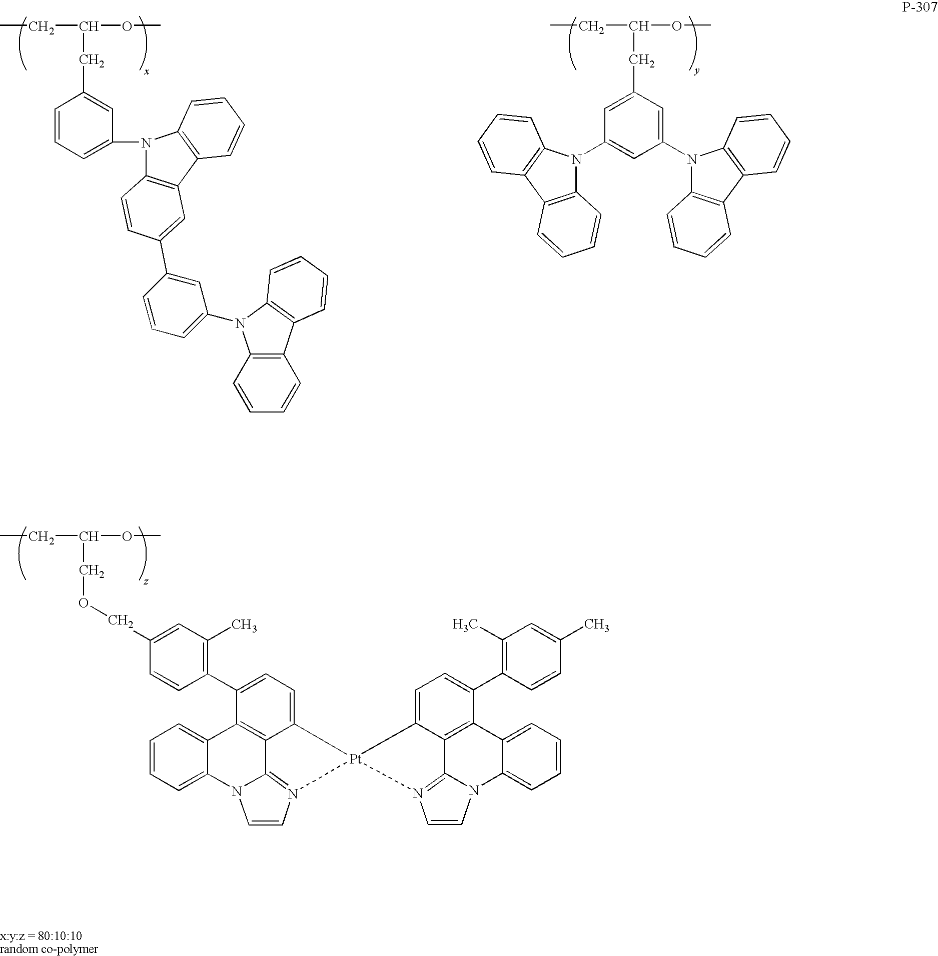

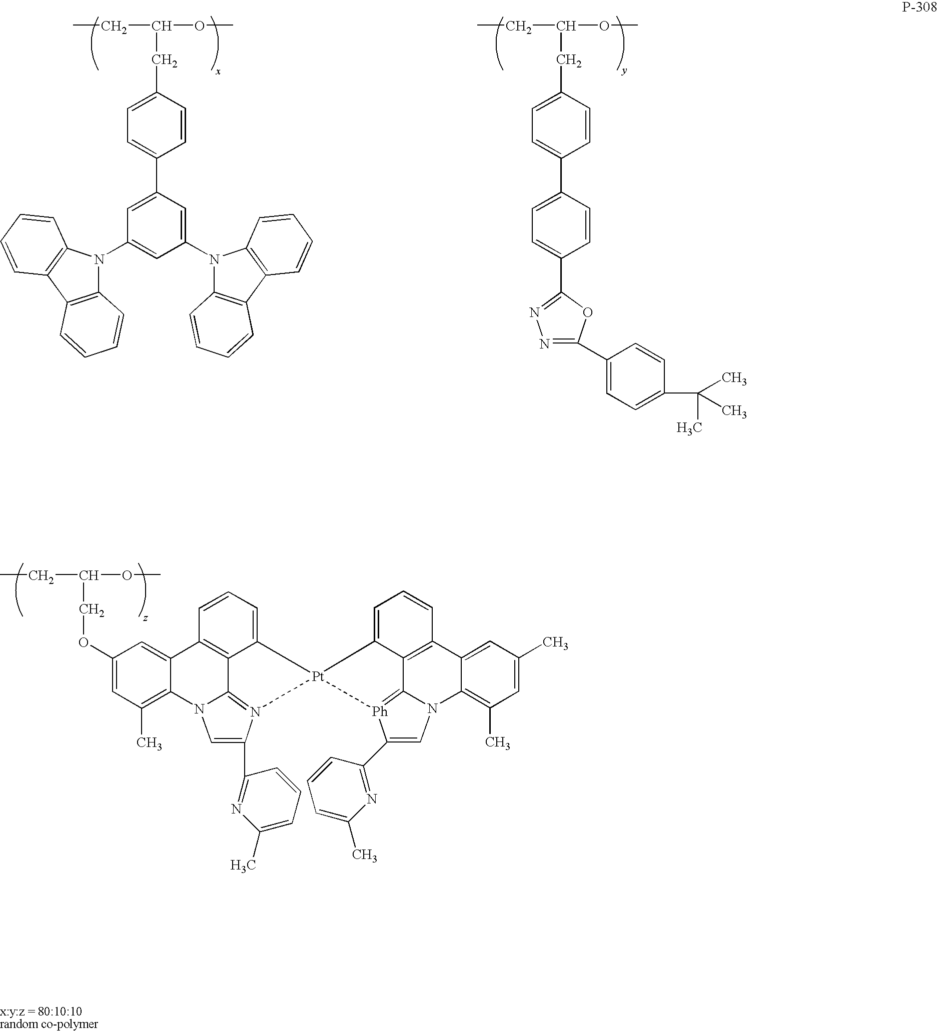

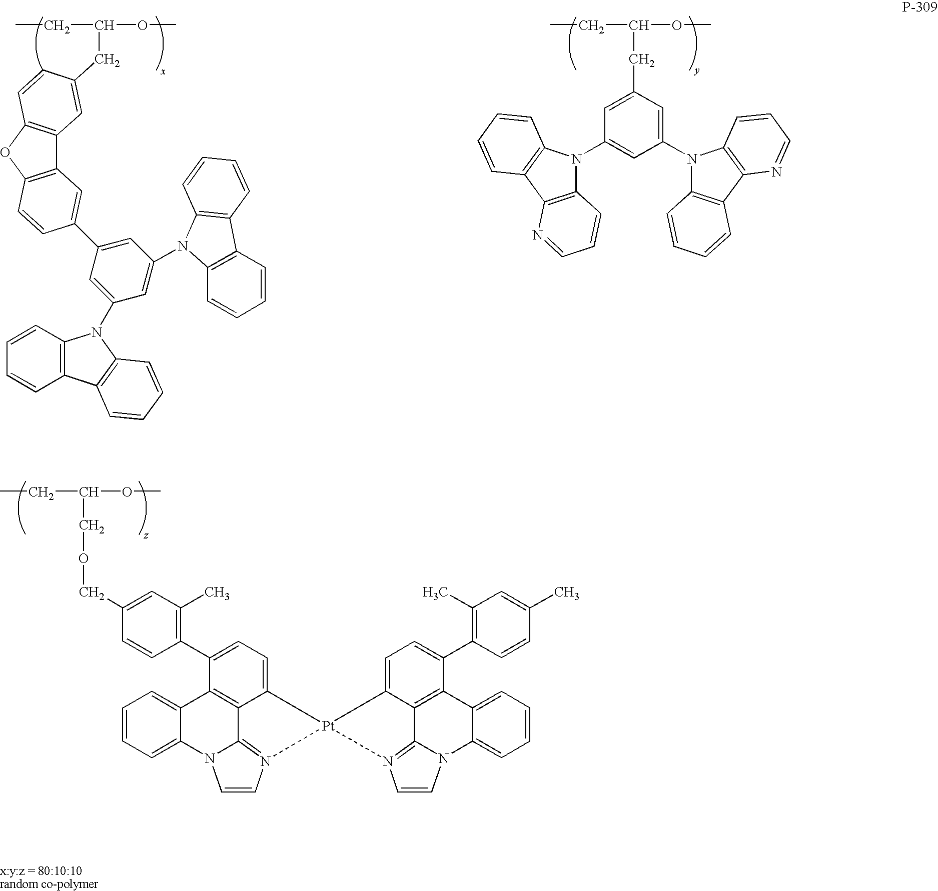

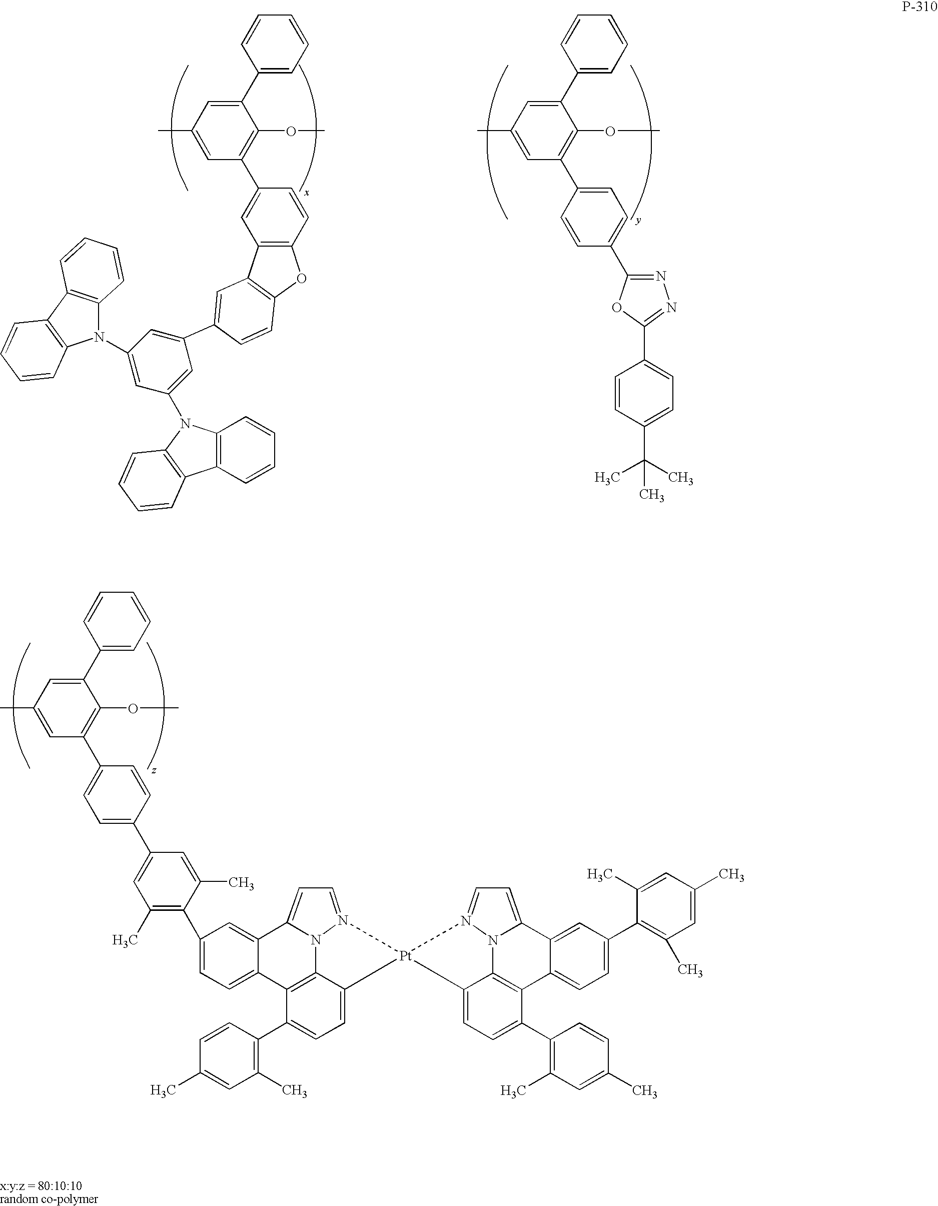

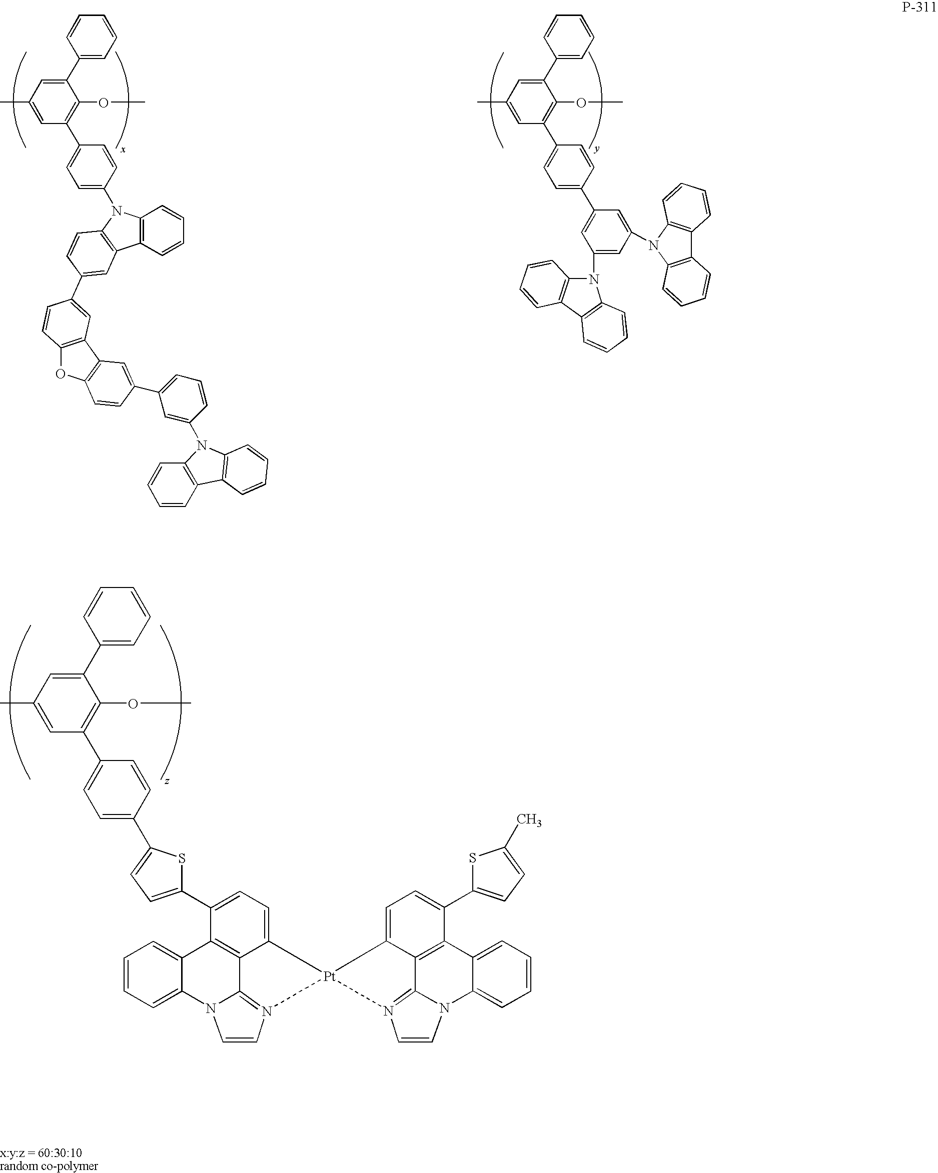

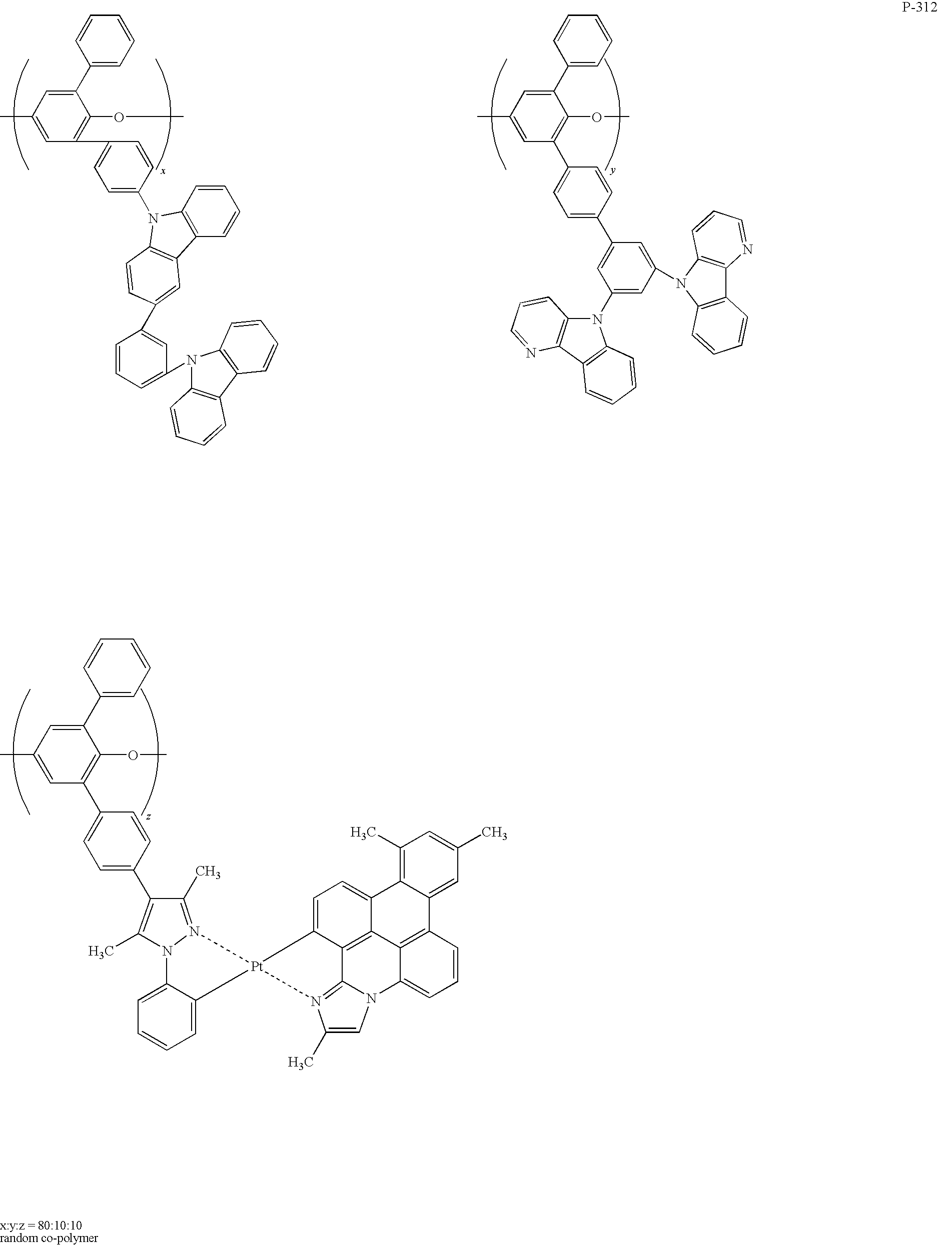

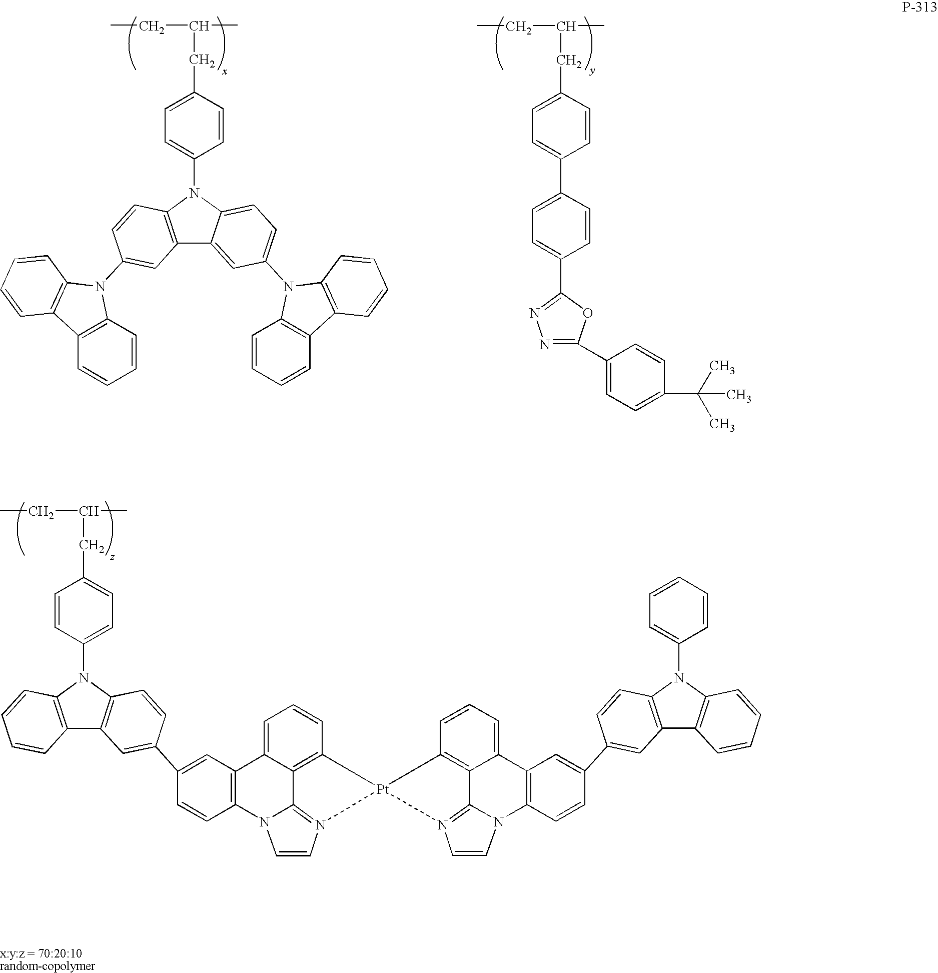

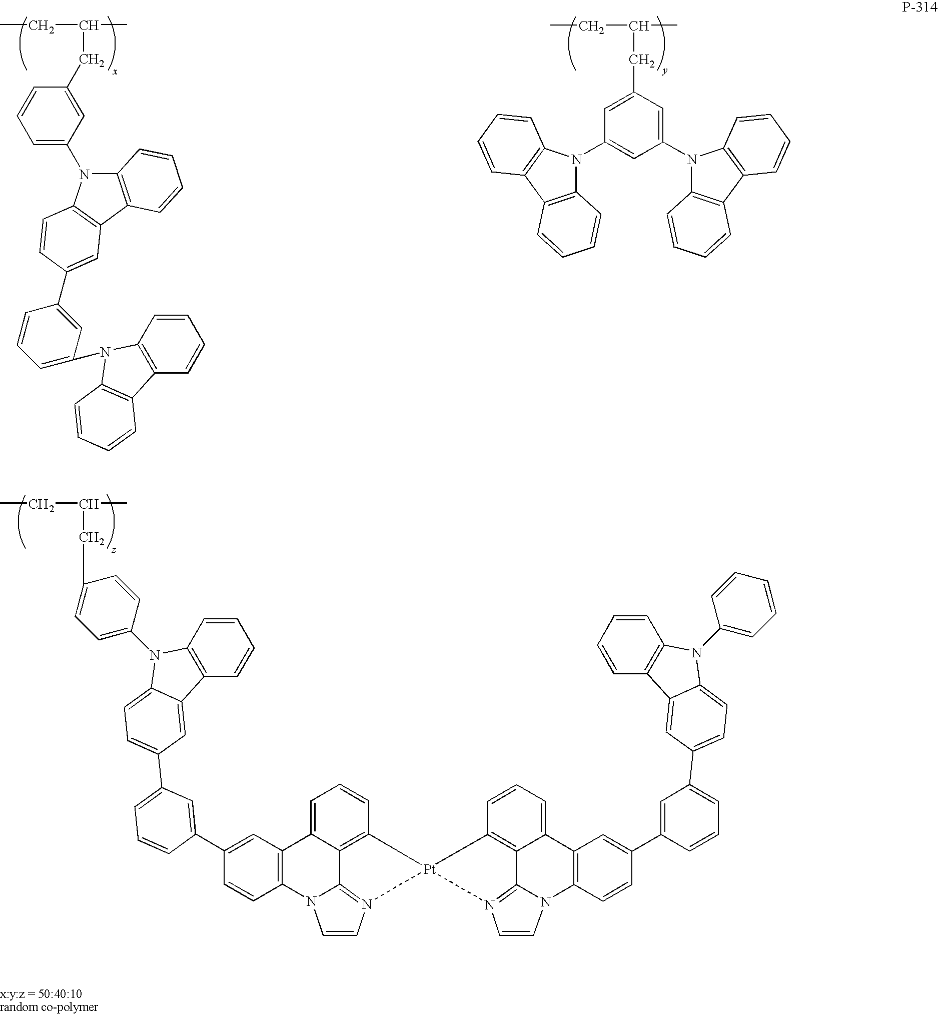

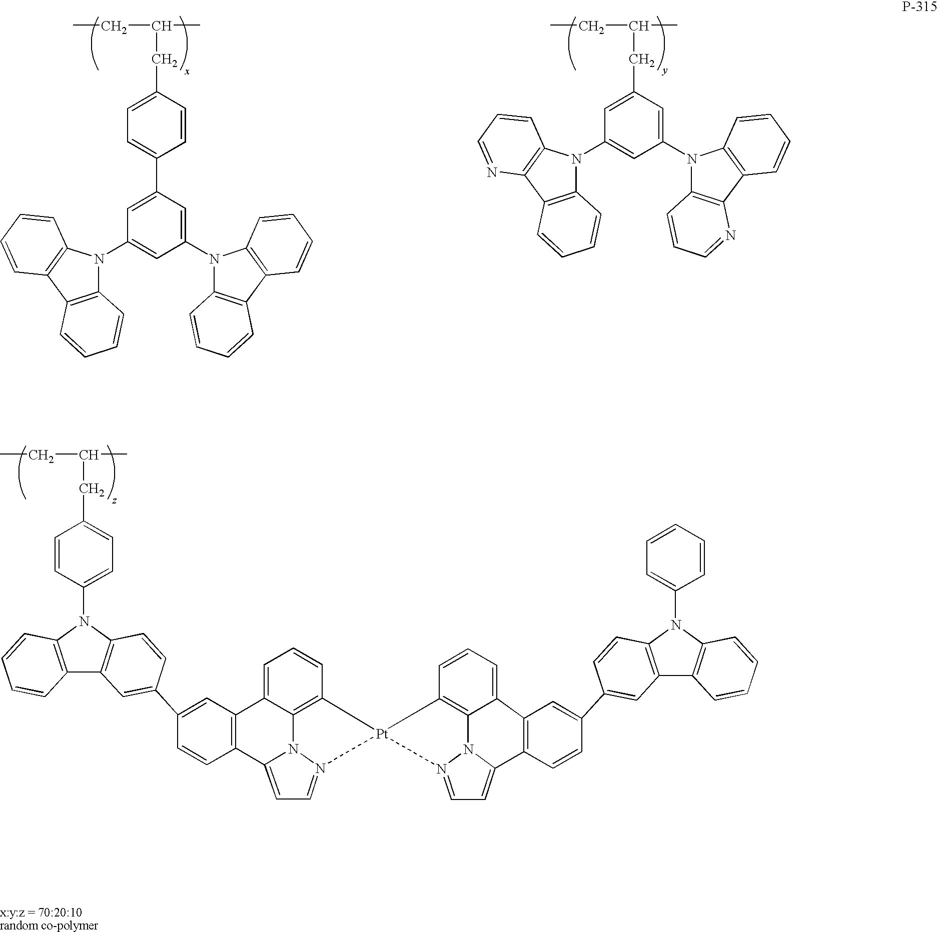

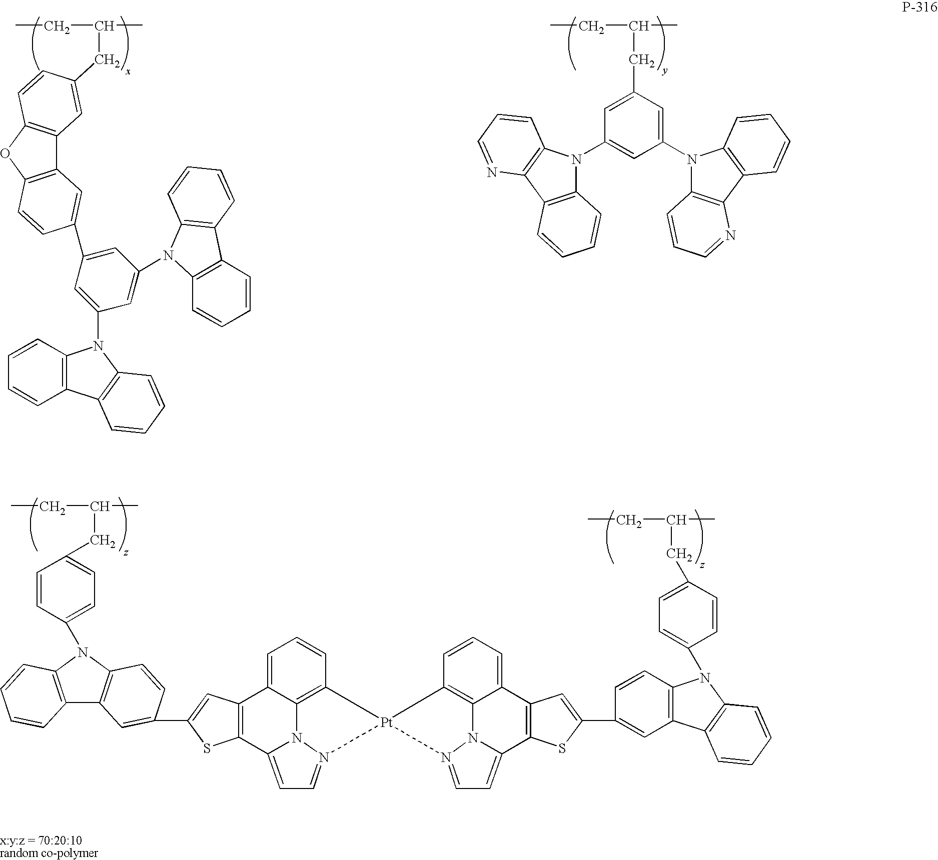

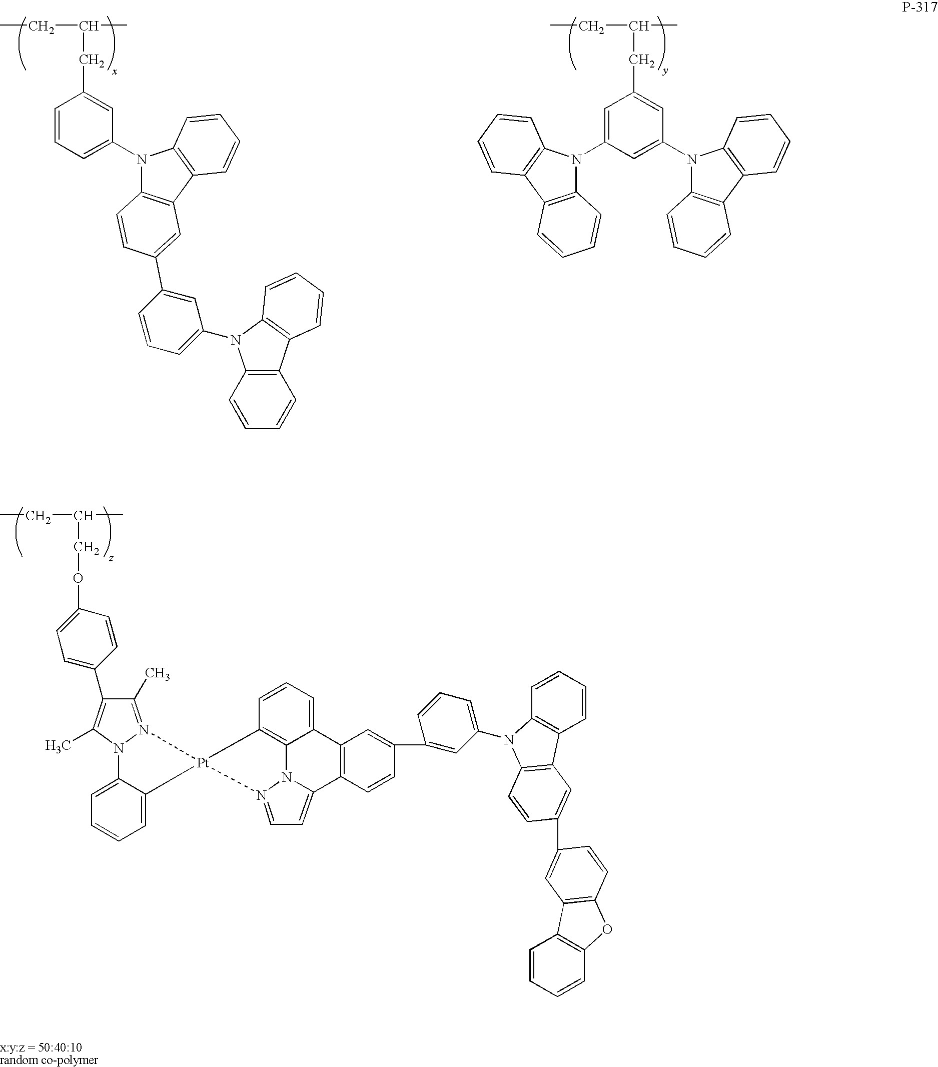

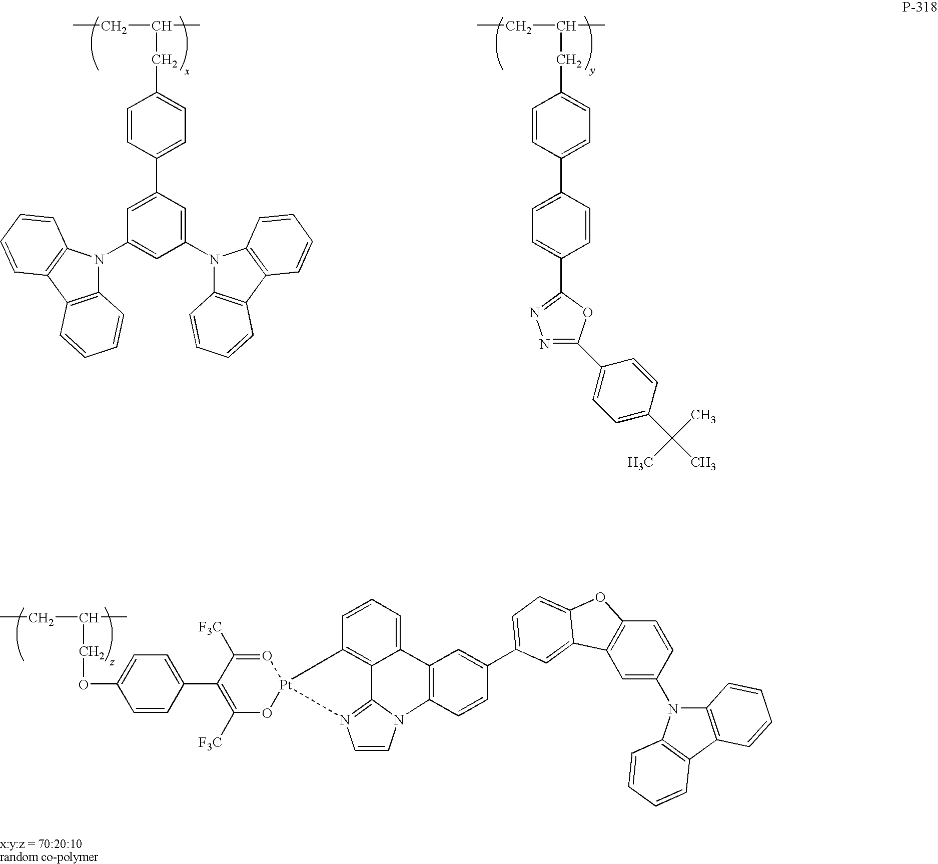

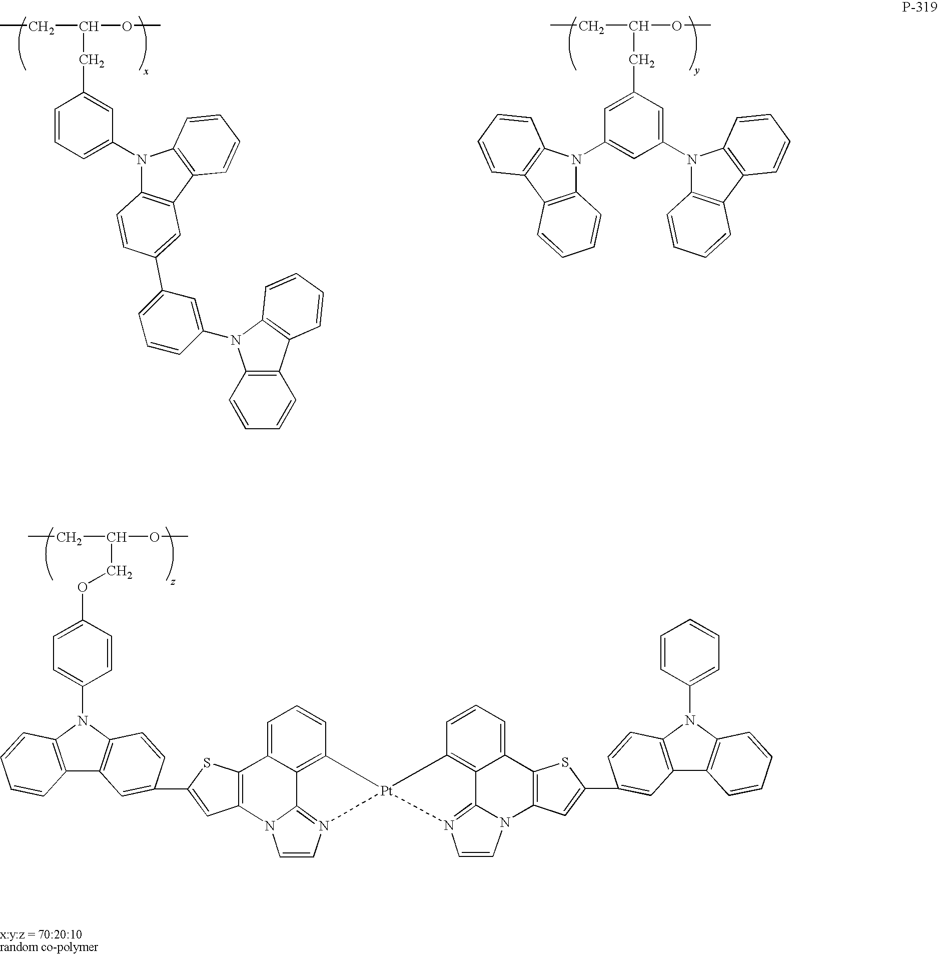

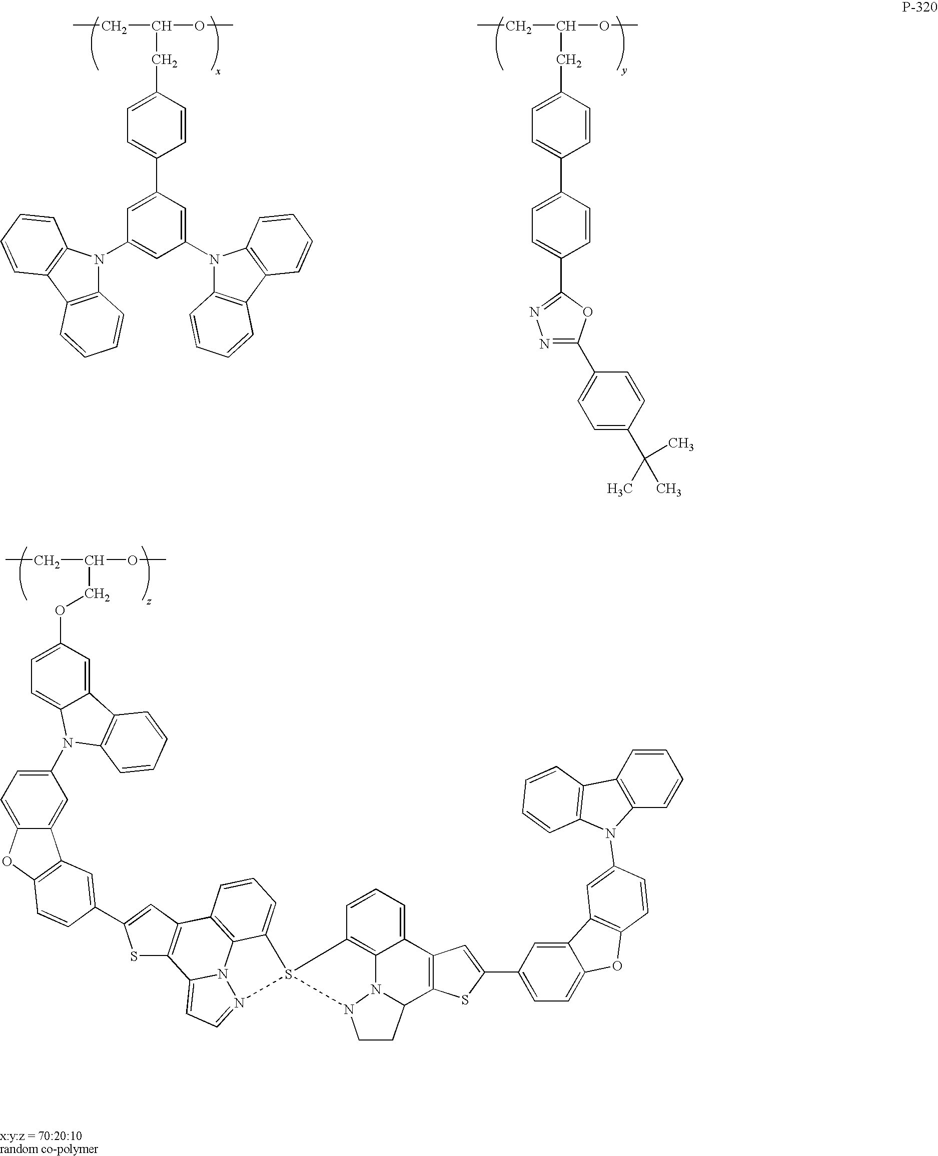

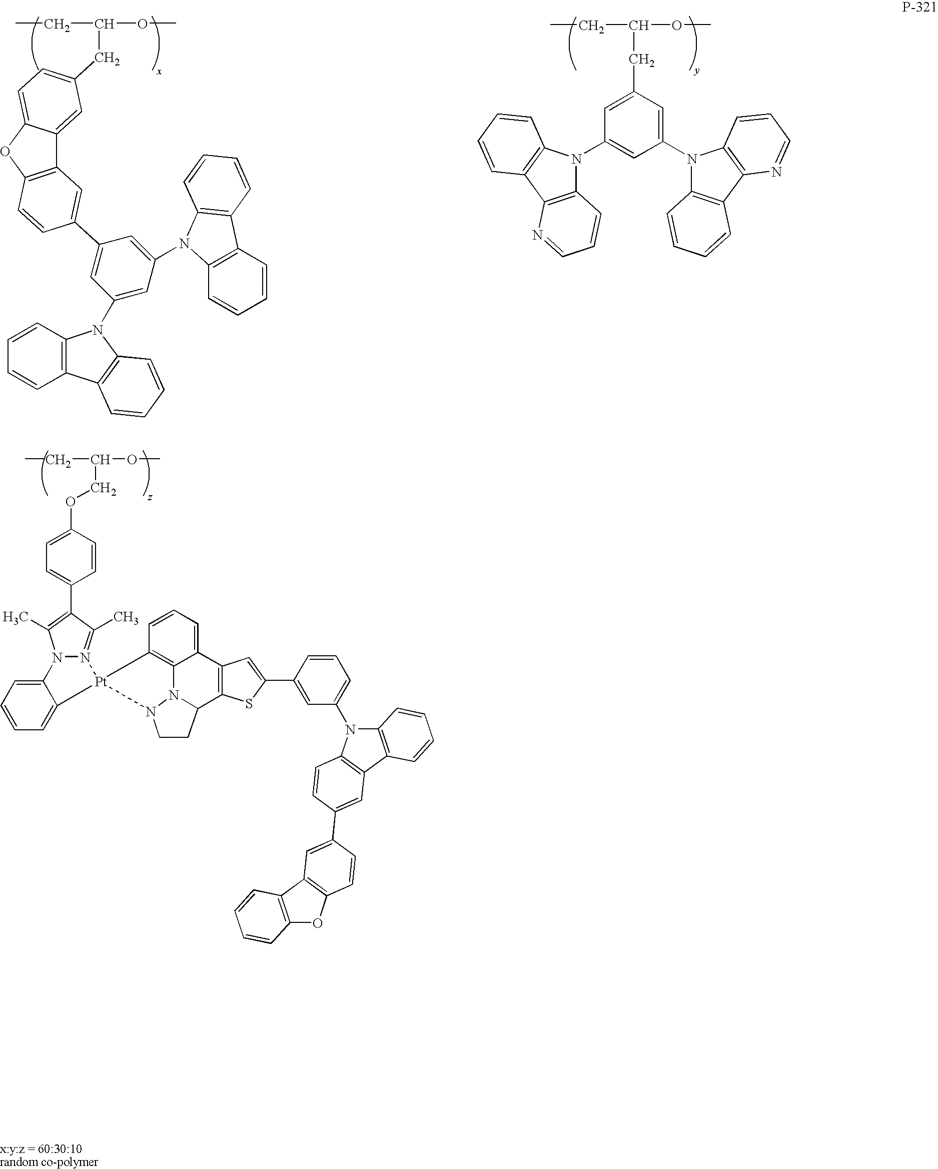

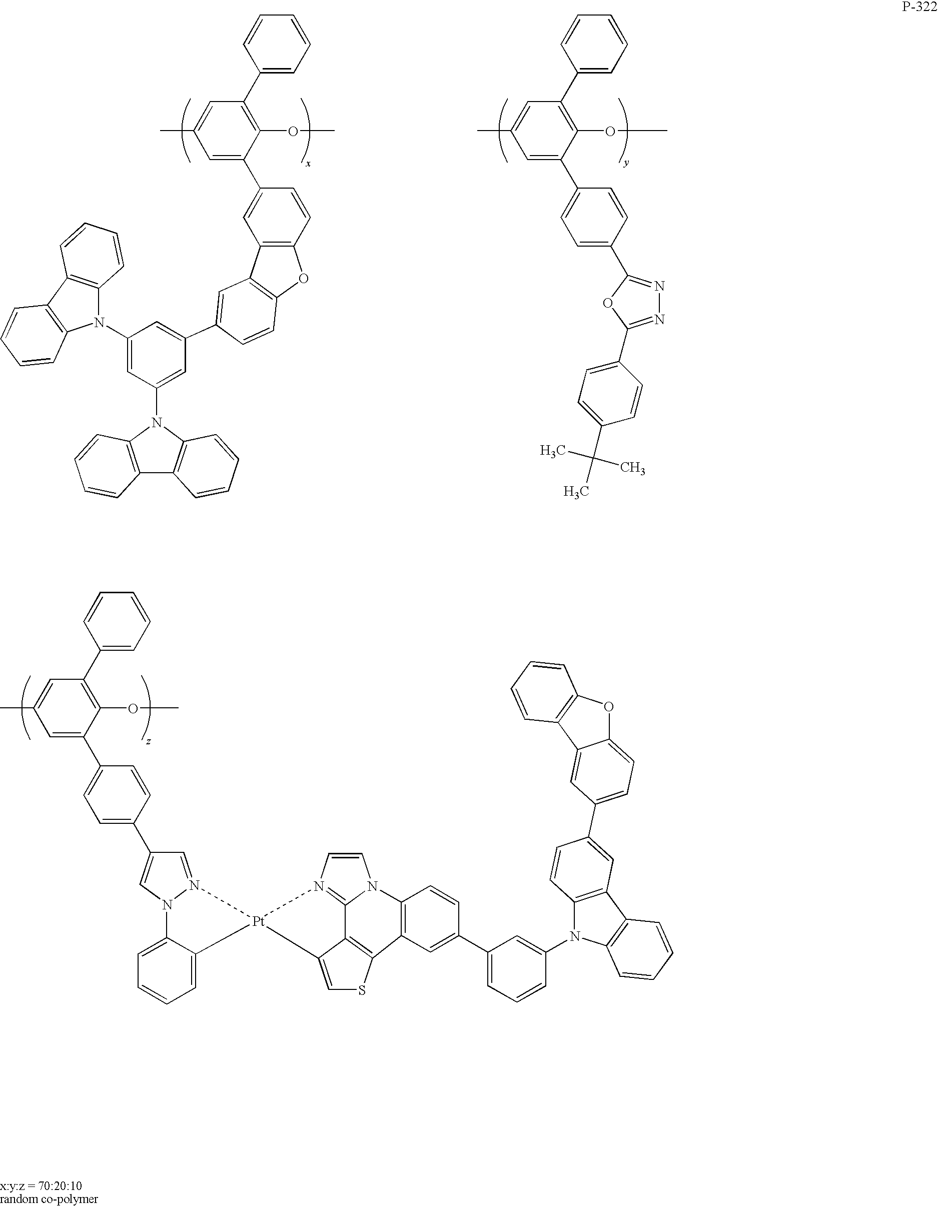

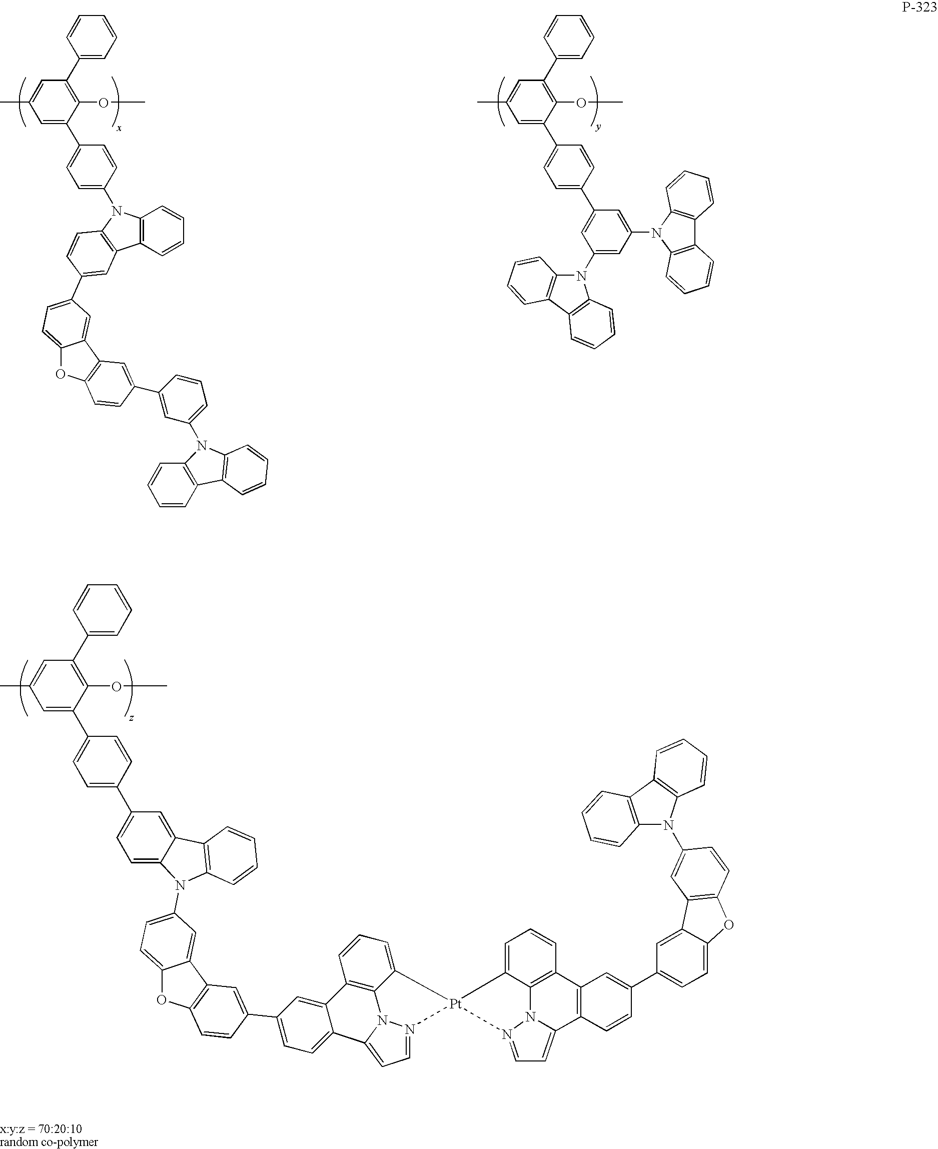

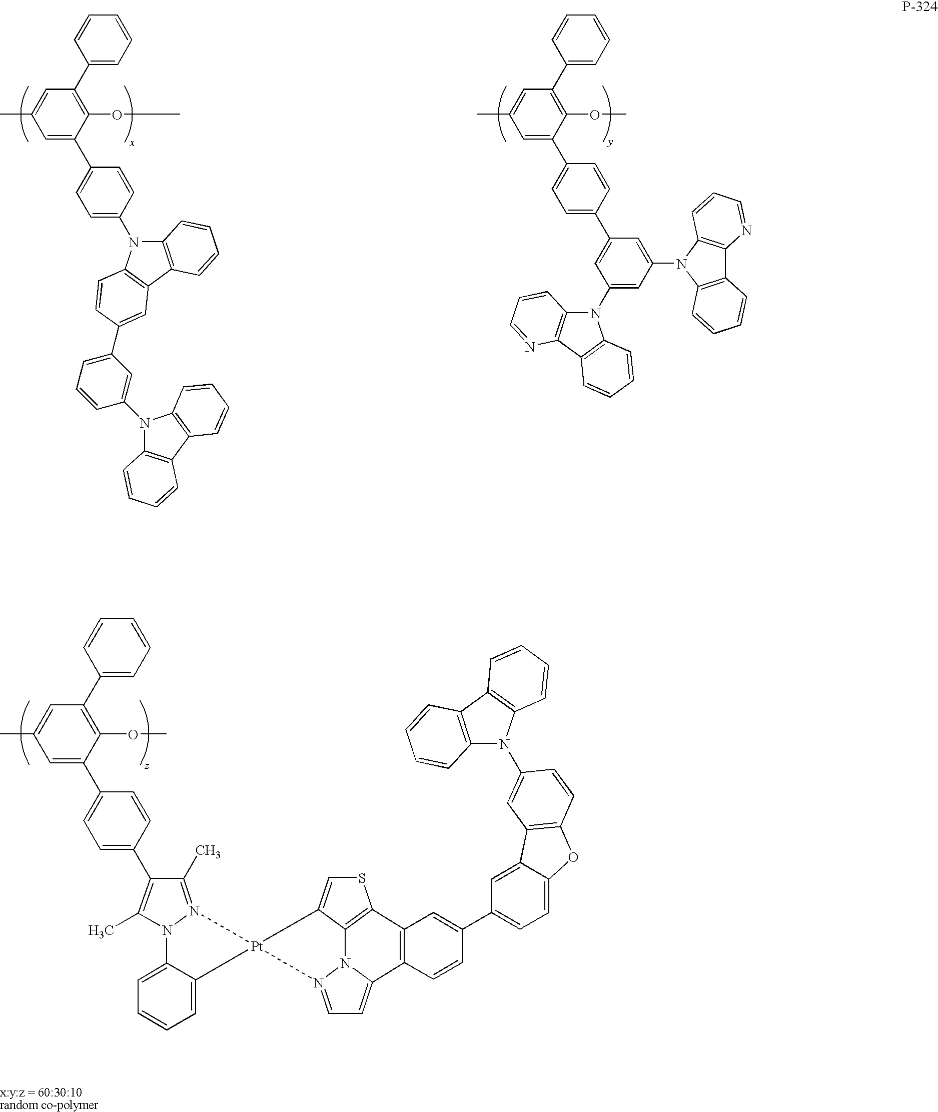

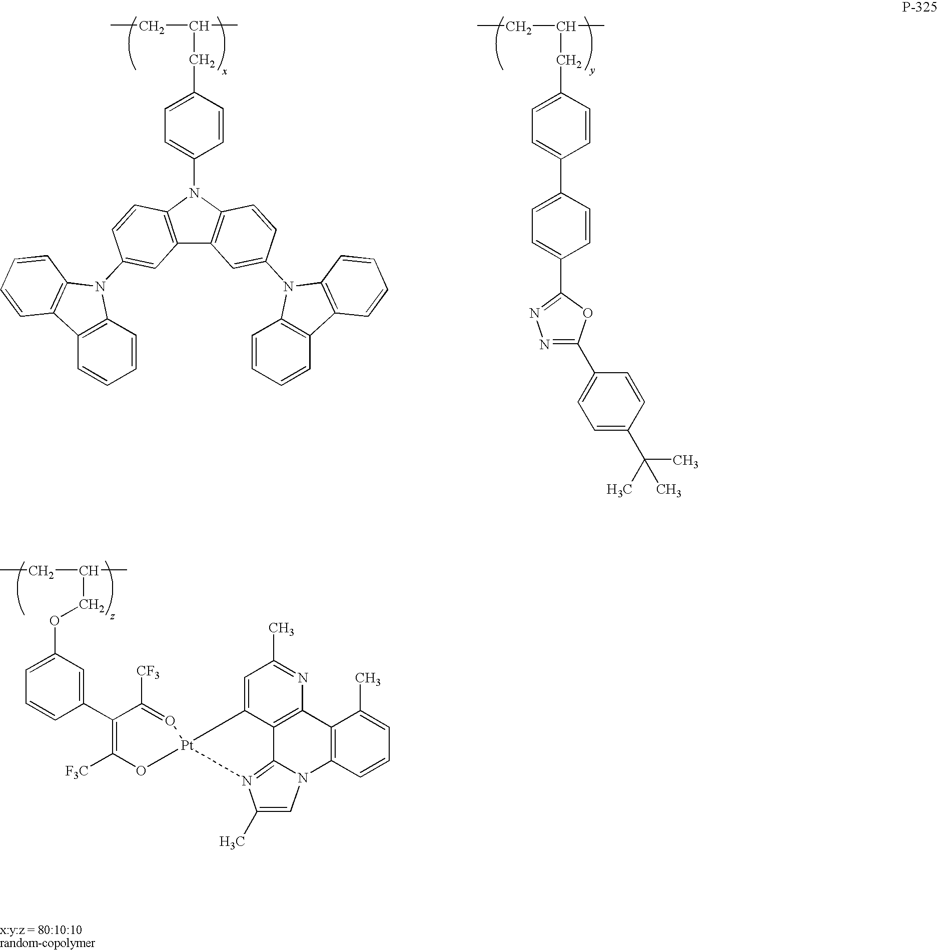

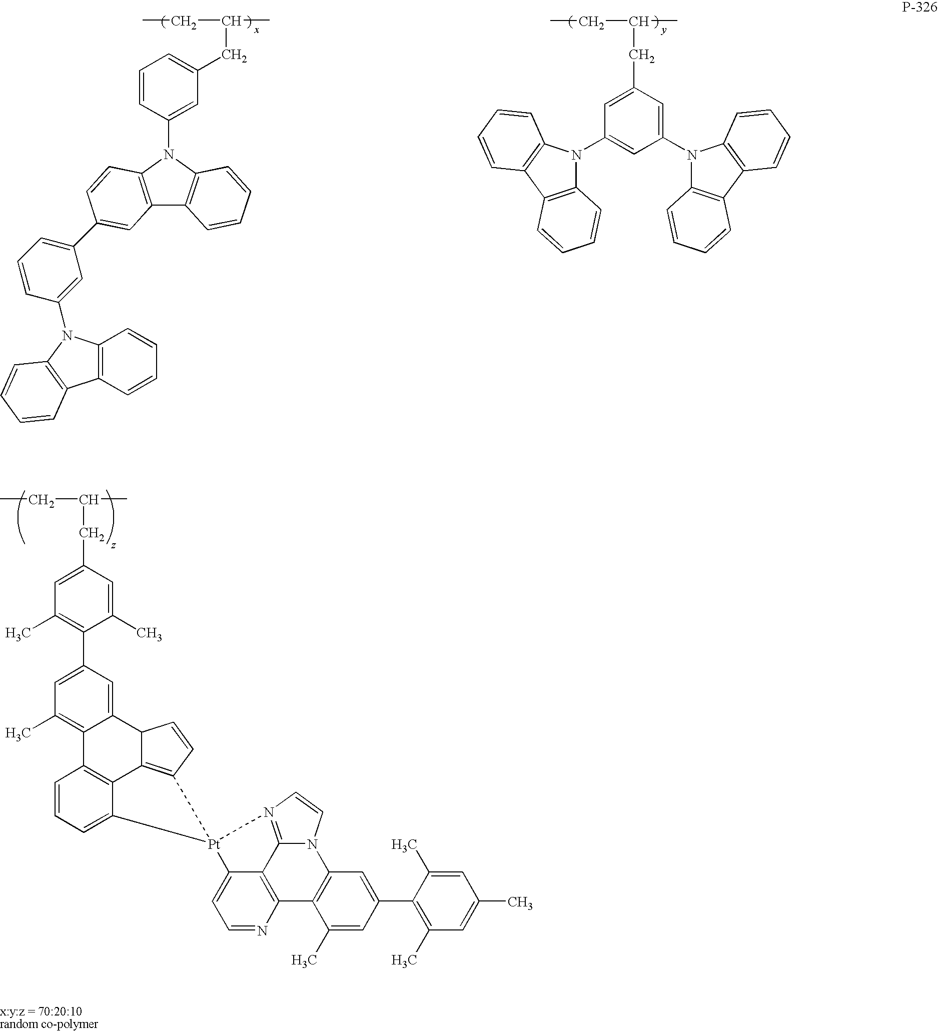

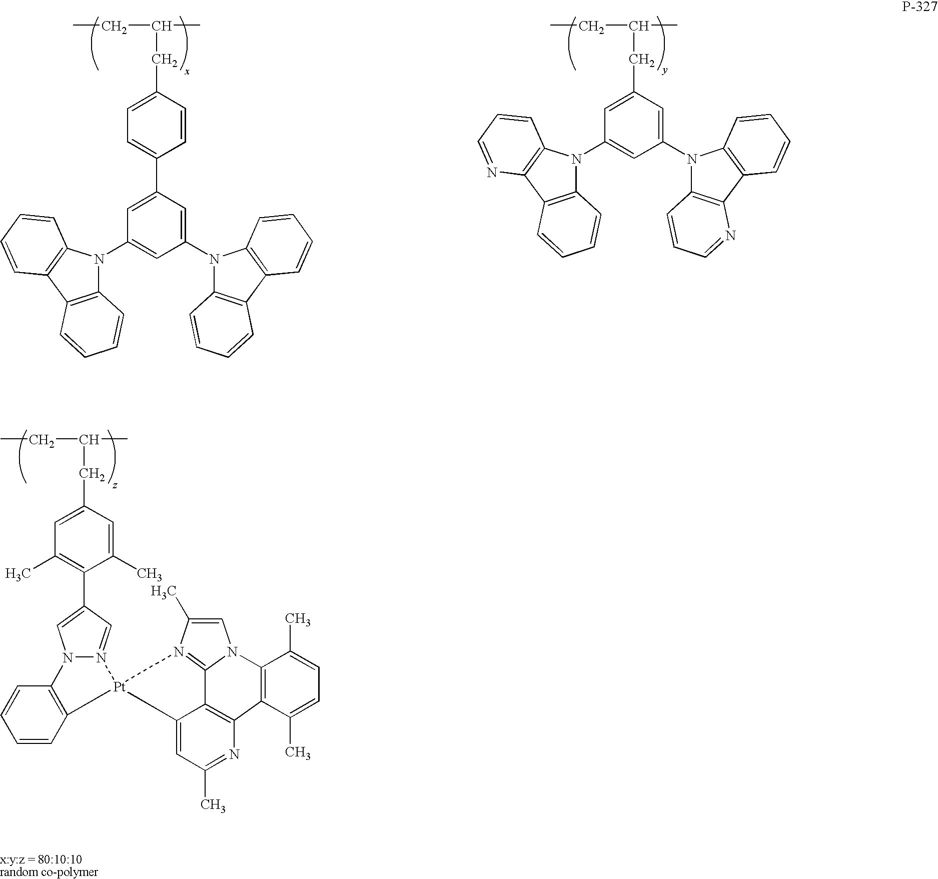

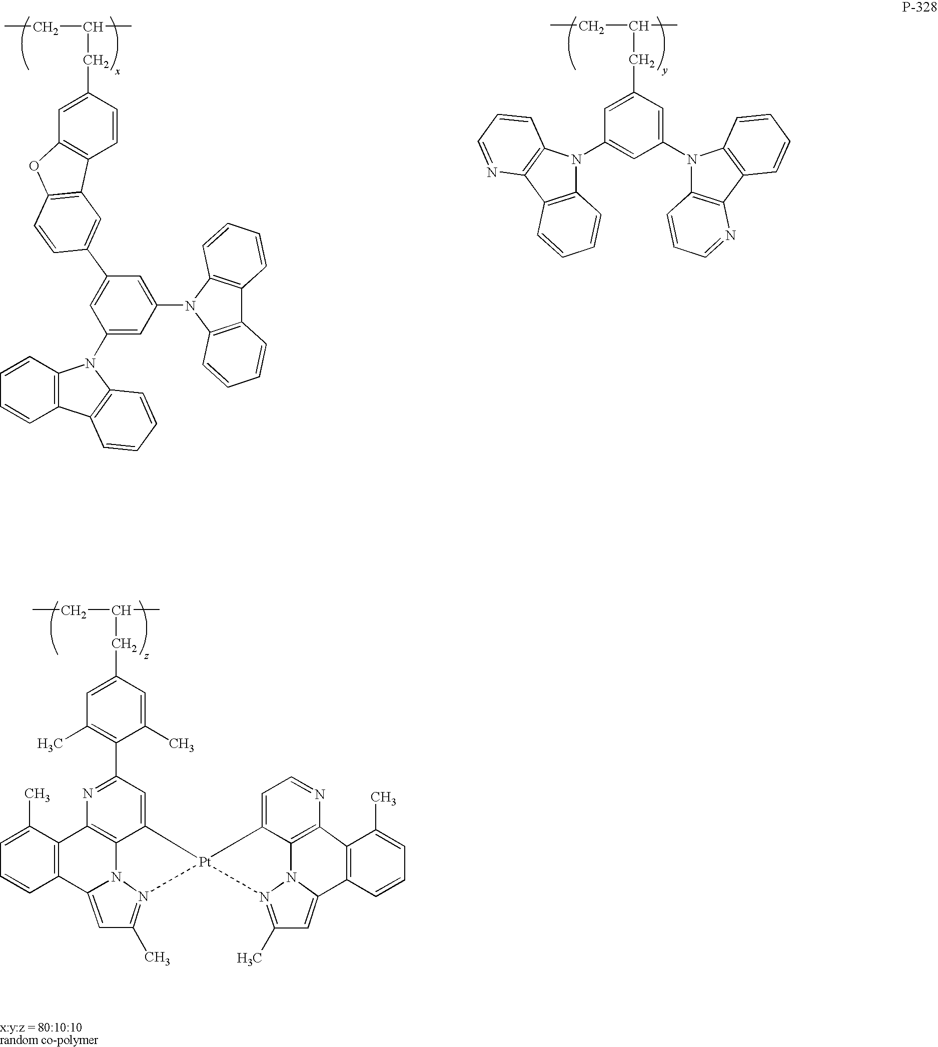

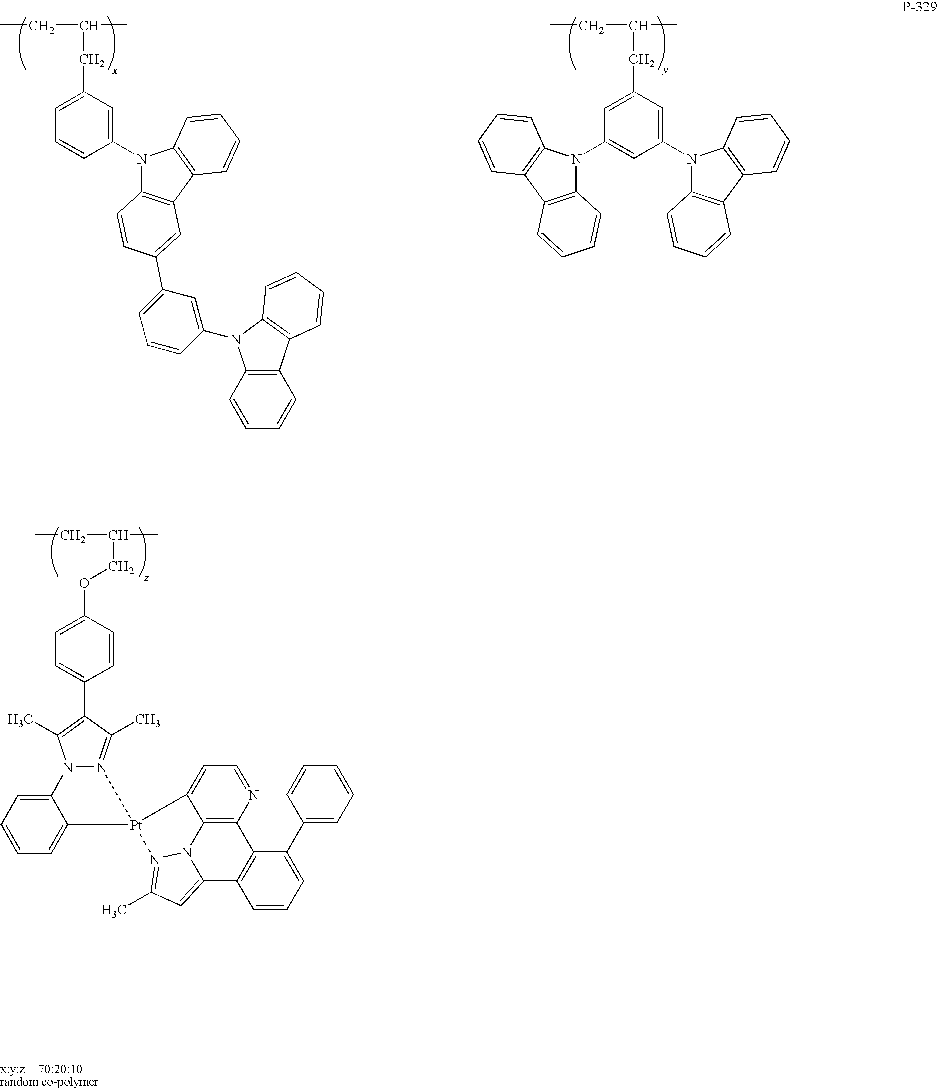

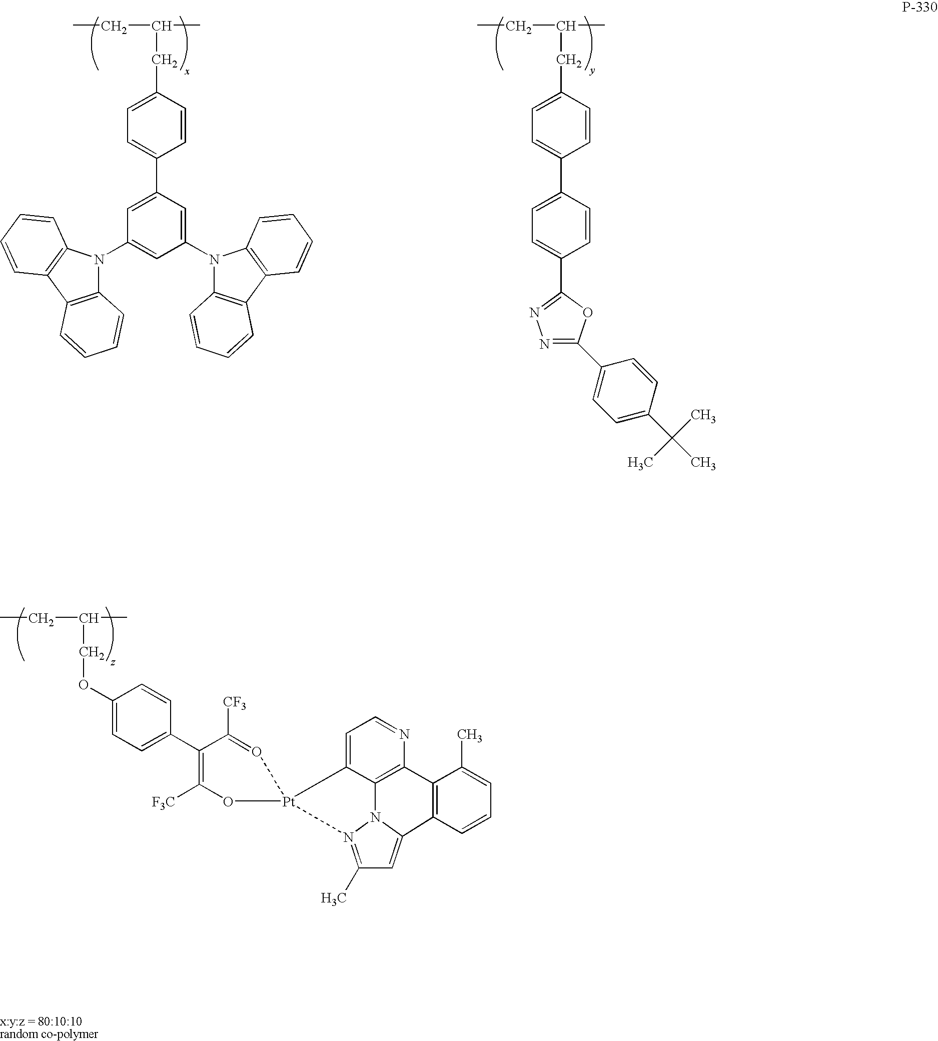

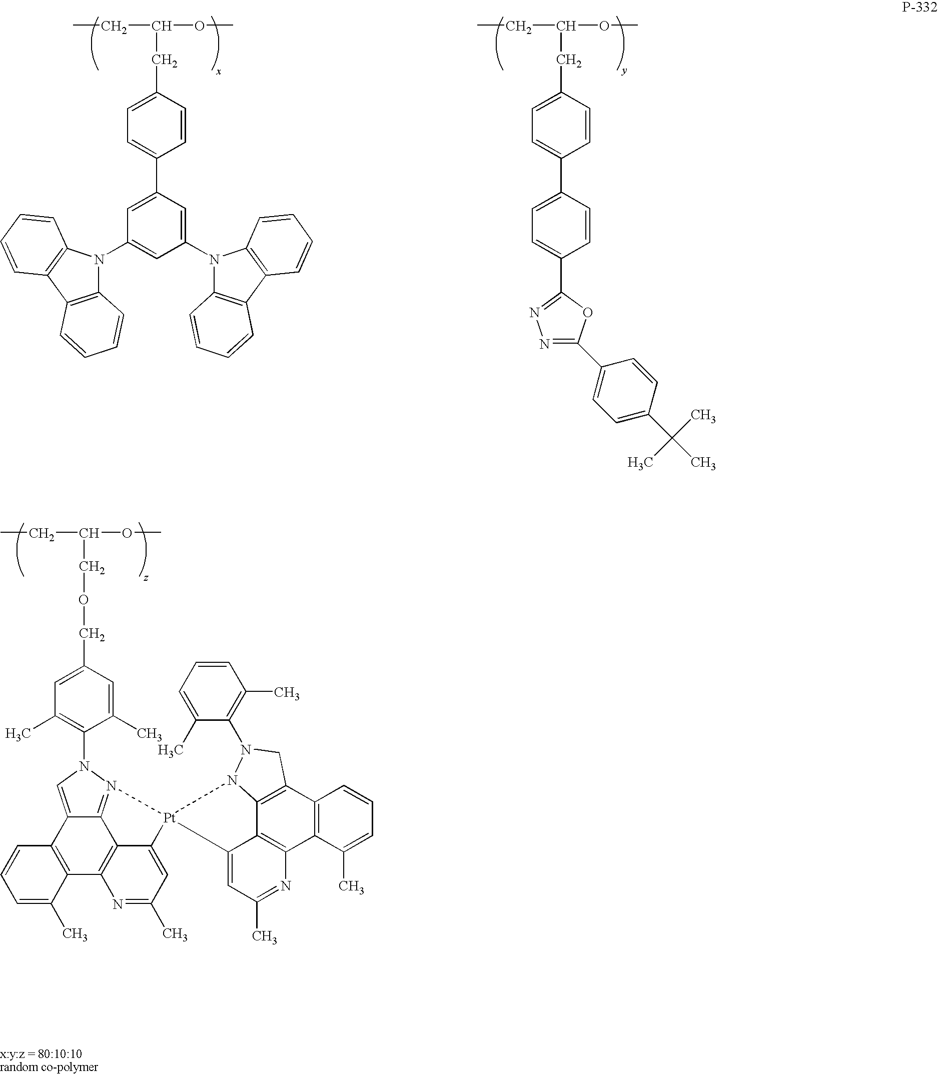

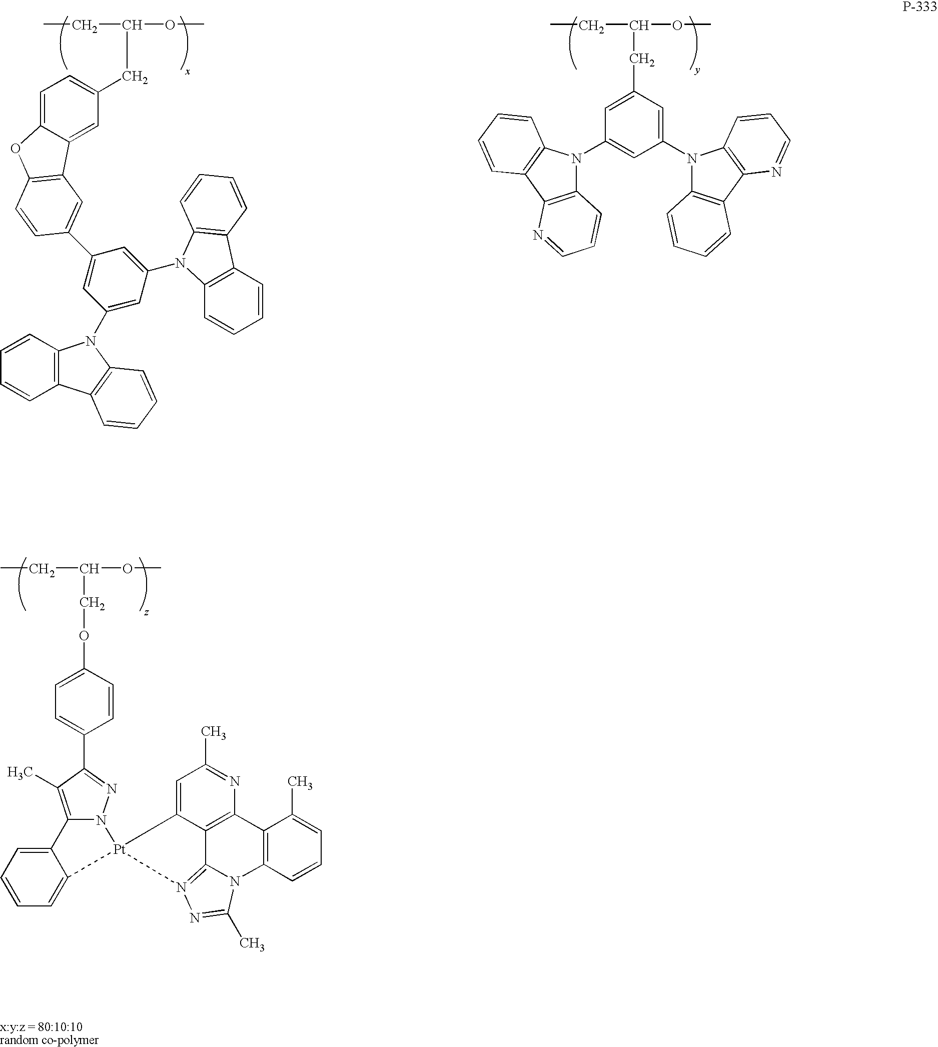

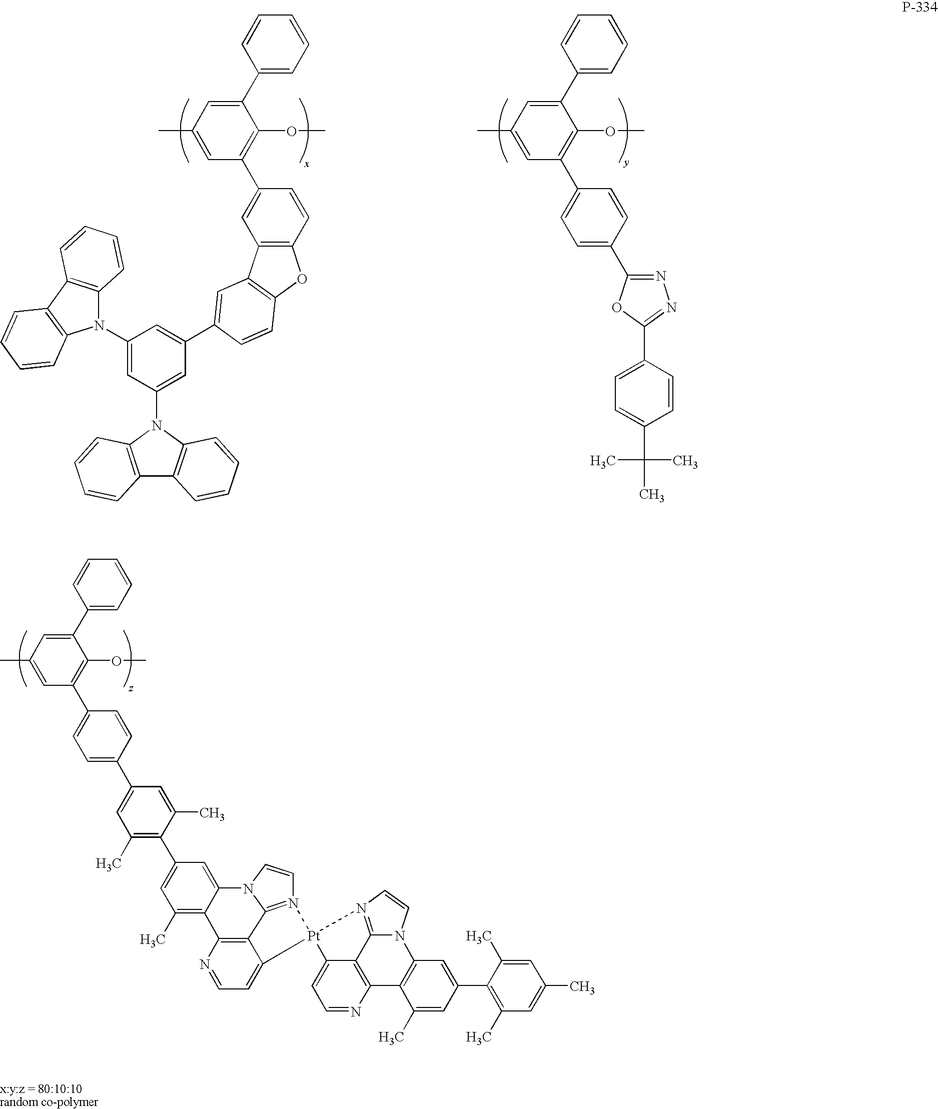

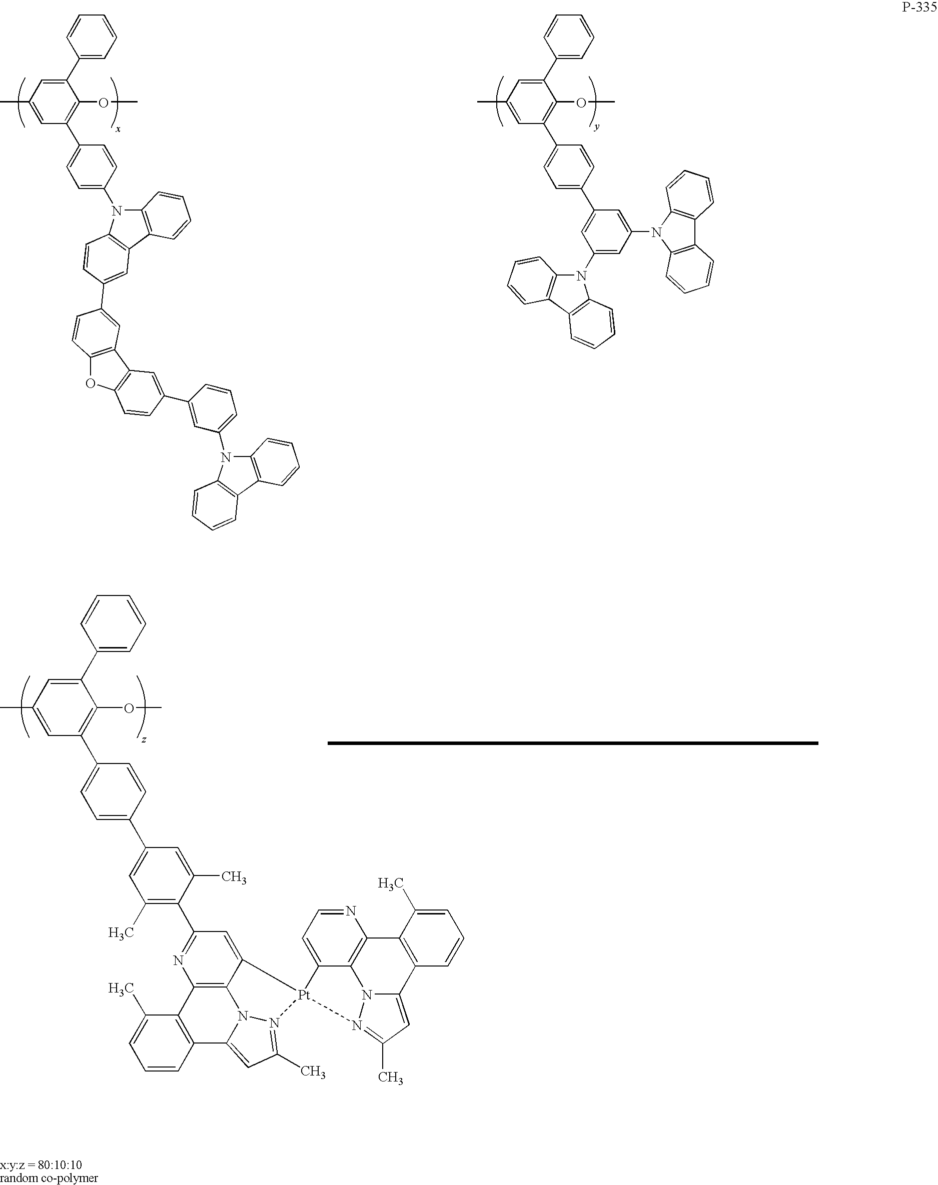

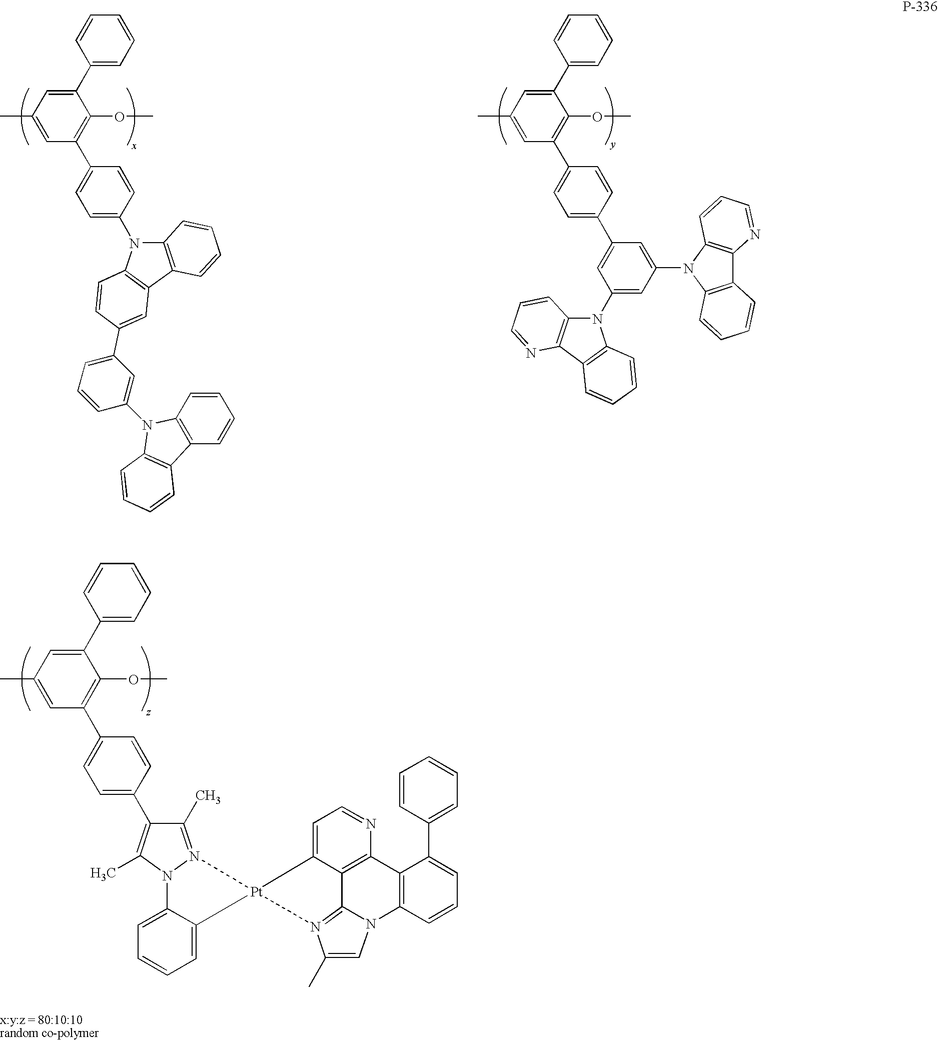

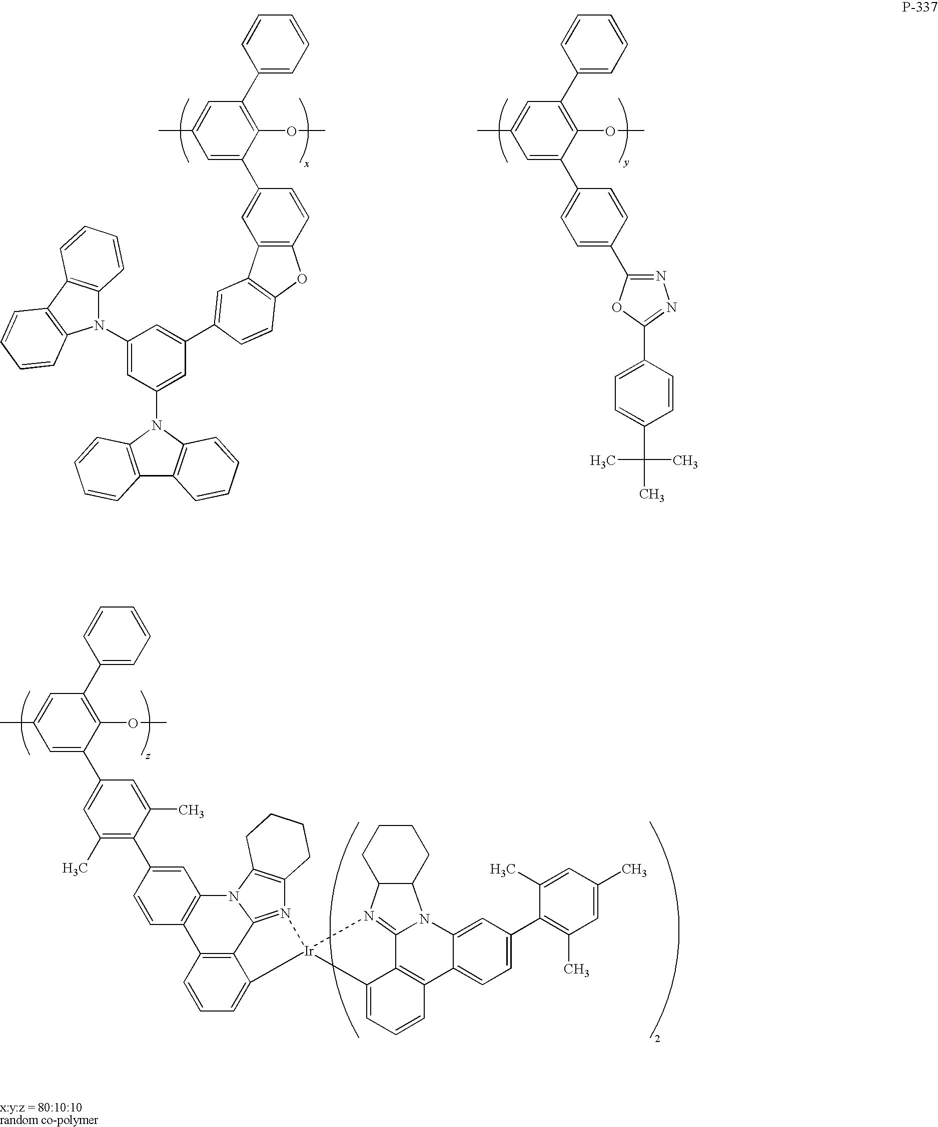

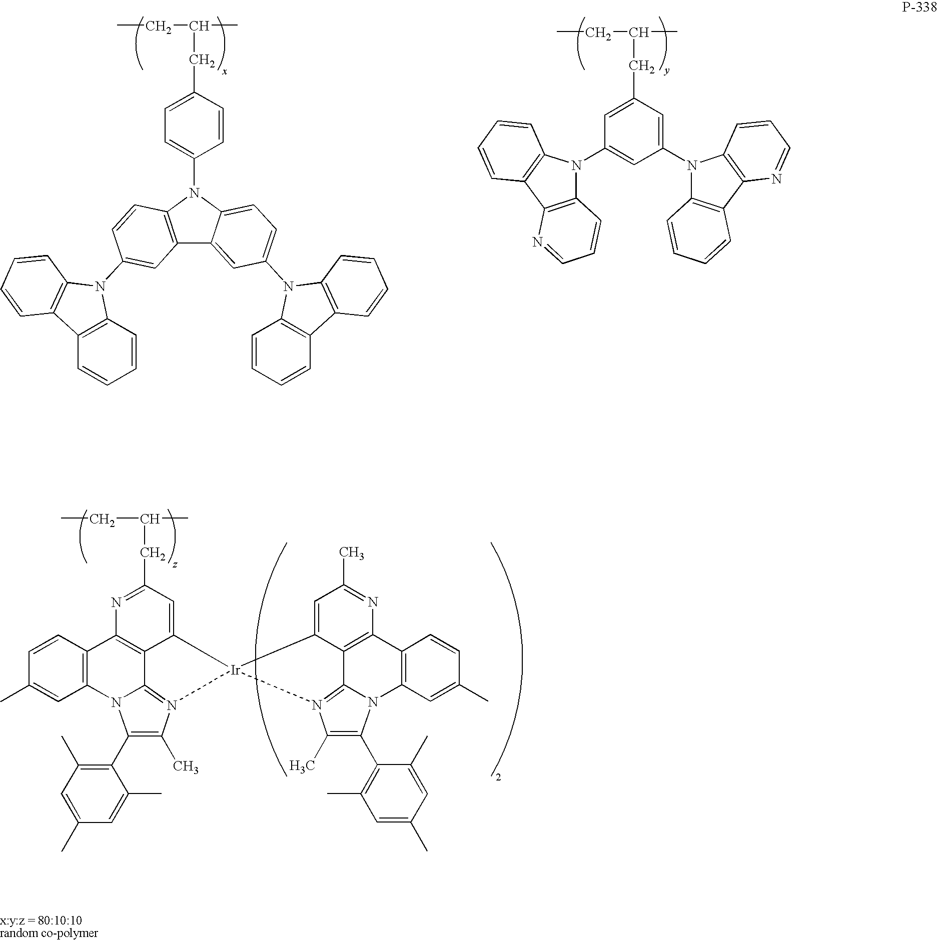

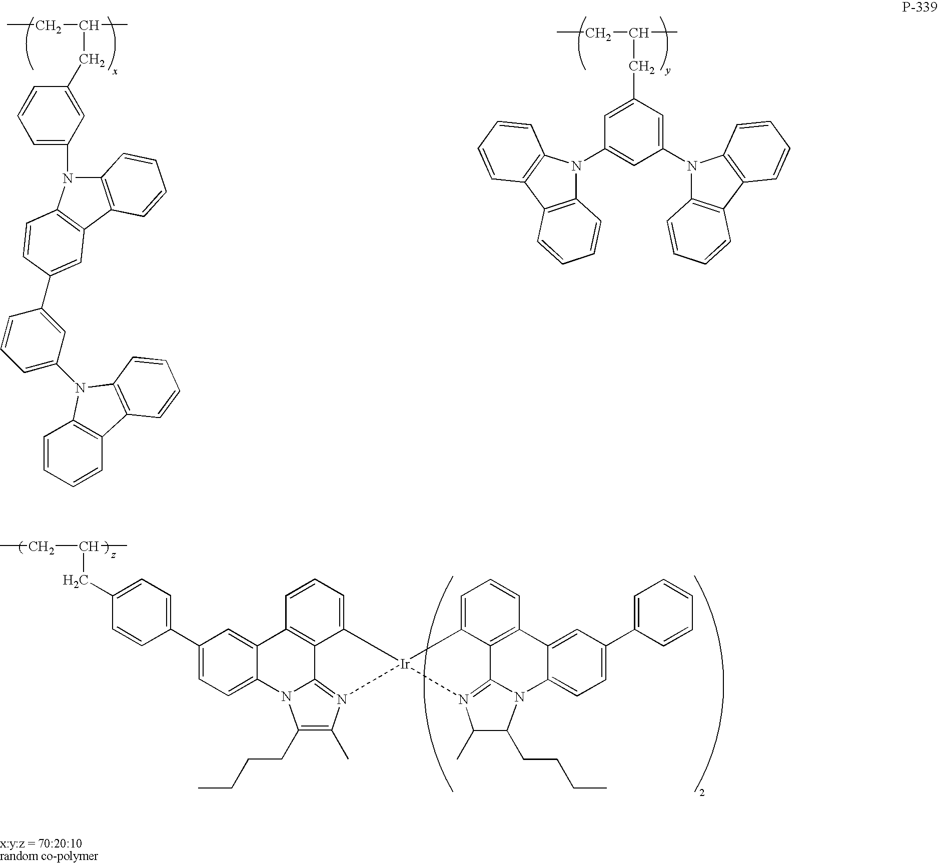

These metal complexes can be synthesized according to a method described in for example, Organic Letter, Vol. 3, No. 16, pp. 2579-2581 (2001); Inorganic Chemistry Vol. 30, No. 8, pp. 1685-1687 (1991); J. Am. Chem. Soc., Vol. 123, p. 4304 (2001); Inorganic Chemistry Vol. 40, No. 7, pp. 1704-1711 (2001); Inorganic Chemistry Vol. 41, No. 12, pp. 3055-3066 (2002); New Journal of Chemistry, Vol. 26, p. 1171 (2002); Organic Letter, Vol. 8, No. 3, pp. 415-418 (2006); and references described in these literatures.

Synthetic examples of the metal complex in the invention will be shown below, but the invention is not specifically limited.

### Synthetic Example 1

### Synthesis of Exemplified compound A-81

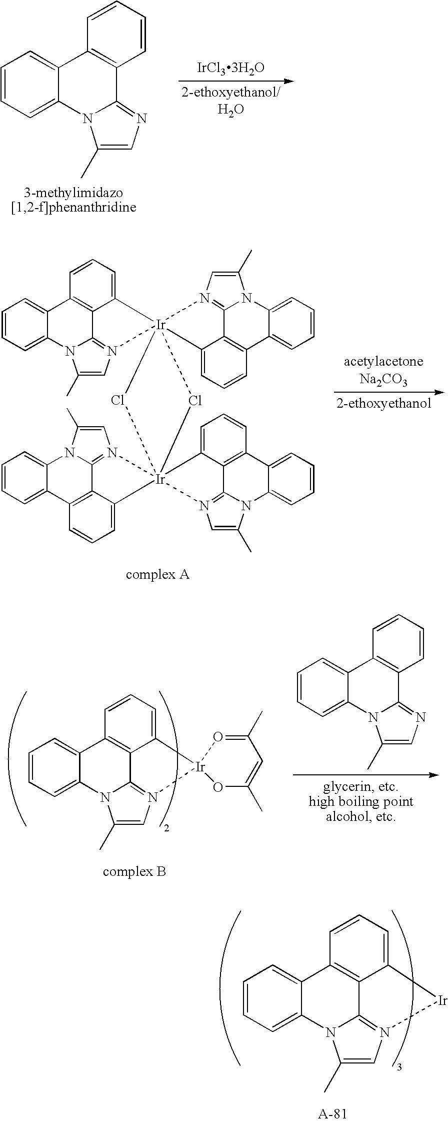

### Step 1: Synthesis of Complex A

A 100 ml four neck flask was charged with 0.9 g (0.003875 mol) of 3-methylimidazo[1,2-f]phenanthridine, 13 ml of 2-ethoxyethanol and 3 ml of water, equipped with a nitrogen-introducing tube, a thermometer and a condenser, and set on an oil bath on a stirrer.

The resulting mixture solution was further added with 0.55 g (0.001560 mol) of IrCl₃.3H₂O and 0.16 g (0.001560 mol) of triethylamine, and the contents of the flask were refluxed at around 100° C. for 6 hours to terminate reaction.

After the reaction, the resulting reaction solution was cooled to room temperature, and added with methanol to precipitate a solid. The precipitated solid was filtered off, sufficiently washed with methanol and dried to obtain 1.05 g of Complex A (yield: 98.1%).

### Step 2: Synthesis of Complex B

A 50 ml four neck flask was charged with 1.0 g (0.0007244 mol) of Complex A, 0.29 g of acetylacetone, 1.0 g of sodium carbonate and 24 ml of 2-ethoxyethanol, equipped with a nitrogen-introducing tube, a thermometer and a condenser, and set on an oil bath on a stirrer.

Nitrogen introduced into the flask, the mixture solution was heated with stirring at around 80° C. for 1.5 hours.

After the reaction, the resulting reaction solution was cooled to room temperature, and added with methanol to precipitate a crystal. The precipitated crystal was filtered off, washed with 30 ml of water and with 10 ml of methanol, and dried to obtain 0.73 g of Complex B (yield; 67.0%).

### Step 3: Synthesis of Exemplified Compound A-81

A 50 ml four neck flask was charged with 0.4 g (0.0005306 mol) of Complex B, 0.37 g of 3-methylimidazo[1,2-f]phenanthridine, 20 ml of glycerin and 20 ml of propylene glycol, equipped with a nitrogen introducing tube, a thermometer and an air cooling pipe, and set on an oil bath on a stirrer. Nitrogen introduced into the flask, the mixture solution was heated with stirring at 170° C. to around 180° C. for 20 hours to terminate reaction.

After the reaction, the resulting reaction solution was cooled to room temperature, and added with methanol to precipitate a crystal. The precipitated crystal was filtered off to obtain 0.37 g of crude solid.

The resulting solid was subjected to column chromatography (development solvent; dichloromethane) to obtain a crystal. The resulting crystal was heat suspended in a mixture solvent of tetrahydrofuran and ethyl acetate, and purified to obtain 0.2 g of Exemplified Compound A-81 (yield: 42.5%).

The chemical structure of the obtained Exemplified Compound A-81 was confirmed according to ¹H-NMR (nuclear magnetic resonance spectroscopy). The measurement conditions, the chemical shift of each peak of the spectra and proton number, etc. are shown below.

¹H-NMR (400 MHz, CD₂Cl₂)

Measurement apparatus: JEOL JNM-AL400 (400 MHz), produced by Nippon Densi Co., Ltd.
Assignation of spectra (Chemical shift δ, Proton number, Peak shape)

### 8.49 (1H, d), 8.27 (1H, d), 7.57 (4H, m), 7.07 (1H, t), 6.80 (1H, s), 2.89 (3H, s)

The emitted light wavelength of a solution of Exemplified Compound A-81 was 465 nm (the emitted light wavelength measured employing dichloromethane as a solvent of the solution).

In the invention, the emitted light wavelength of exemplified compounds is measured according to the following procedures.

Firstly, the absorption spectra of the exemplified compounds are measured and light having absorption maximum in the wavelength regions of from 300 to 350 nm is determined as an excitation light.

Employing the determined excitation light, the emitted light wavelength is measured through fluorescence spectrophotometer F-4500 (produced by Hitachi Seisakusho Co., Ltd.), while bubbling the solution with nitrogen.

The solvents used in the solution are not limited, but 2-methyltetrahydrofuran or dichloromethane is preferably used in view of solubility of the compounds.

It is preferred that the solution for the measurement is sufficiently diluted, and the concentration of the compounds in the solution is preferably from 10⁻⁶ to 10⁻⁴ mol/liter.

The temperature at the measurement is not limited, but it is preferably from room temperature to 77K.

### Synthetic Example 2

### Synthesis of Exemplified Compound A-97

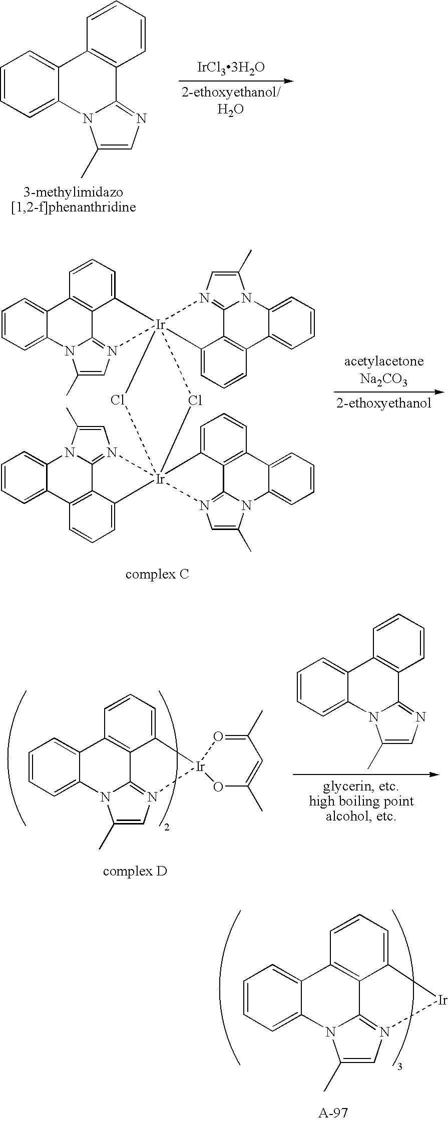

Step 1: The same reaction and post-processing as step 1 of Synthetic Example 1 were conducted, except that 1.5 g of 2-methylimidazo[1,2-f]phenanthridine were used as a synthetic starting material of Complex C, instead of 3-methylimidazo[1,2-f]phenanthridine. Thus, 1.37 g of Complex C were obtained (yield: 77.0%).
Step 2: The same reaction and post-processing as step 2 of Synthetic Example 1 were conducted, except that 1.0 g (0.0007244 mol) of Complex C was used as a synthetic material of Complex D. Thus, 0.42 g of Complex D were obtained (yield: 38.5%).

### Step 3: Synthesis of Exemplified Compound A-97

A 50 ml four neck flask was charged with 0.386 g (0.0005120 mol) of Complex D, 0.357 g of 2-methylimidazo[1,2-f]phenanthridine and 20 ml of glycerin, equipped with a nitrogen introducing tube, a thermometer and an air cooling pipe, and set on an oil bath on a stirrer. Nitrogen introduced into the flask, the mixture solution was heated with stirring at around 150° C. for 4.5 hours to terminate reaction.

After the reaction, the resulting reaction solution was cooled to room temperature, and added with methanol to precipitate a crystal. The precipitated crystal was filtered off to obtain 0.38 g of crude solid.

The resulting solid was subjected to column chromatography (development solvent: toluene/ethyl acetate) to obtain a crystal. The resulting crystal was heat suspended in a mixture solvent of tetrahydrofuran and ethyl acetate, and purified to obtain 0.3 g of Exemplified Compound A-97 (yield: 66.60).

The chemical structure of the Compound A-97 obtained above was confirmed according to ¹H-NMR (nuclear magnetic resonance spectroscopy). The measurement conditions, the chemical shift of each peak of the spectra and proton number, etc. are shown below.

¹H-NMR (400 MHz, tetrahydrofuran-d8)

Measurement apparatus: JEOL JNM-AL400 (400 MHz), produced by Nippon Densi Co. Ltd.
Assignation of spectra (Chemical shift δ, Proton number, Peak shape)

8.48 (1H, d), 7.93 (1H, d), 7.75 (1H, s), 7.64 (1H, d), 7.54 (1H, t), 7.46 (1H, t), 6.95 (1H, t), 6.83 (1H, d), 1.85 (3H, s)

The emitted light wavelength of a solution of Exemplified Compound A-81 was 455 nm (the emitted light wavelength measured employing 2-methyltetrahydrofuran as a solvent of the solution).

It is preferred that the compound in the invention having a partial structure represented by any of formulae (1) through (4) is contained as a phosphorescence dopant (which is one kind of emission dopants) in the light emission layer of the organic EL element of the invention. However, the compound may be contained in a layer other than the light emission layer.

The light emission layer in the invention is characterized in that the phosphorescence emitting metal complex is used in combination with a host compound having a glass transition temperature of not less than 110° C. However, the compounds used are not specifically limited, and may be a low molecular compound, a polymer having a recurring unit, a low molecular compound having a polymerizable group such as a vinyl group or an epoxy group (a vapor-deposition polymerizable light emitting host) or one or more kinds thereof.

### <<Host Compound Having a Glass Transition Temperature of not Less Than 110° C.>>

The host compound in the invention having a glass transition temperature of not less than 110° C. will be explained below.

Typical examples of the host compound in the invention having a glass transition temperature of not less than 110° C. include carbazole derivatives, triarylamine derivatives, aromatic borane derivatives, nitrogen-containing heterocyclic compounds, thiophene derivatives, furan derivatives, compounds having a basic skeleton of oligoarylene compounds, carboline derivatives, diazacarbazole derivatives (those in which at least one of the carbon atoms of the hydrocarbon ring which constitutes a carboline ring of carboline derivatives is replaced with a nitrogen atom).

Among these, the host compound in the invention is preferably a host compound having at least three of a partial structure represented by formula (a) described above.

### (Partial Structure Represented by Formula (a))

The partial structure represented by formula (a) will be explained below.

The substituent represented by R′ or R″ in X of the partial structure represented by formula (a) is the same as denoted above in the substituent represented by R1a through R1i in the partial structure represented by any of formulae (1) through (4). Among these, X is preferably NR′ or O, and R′ is preferably an aromatic hydrocarbon group (also referred to an aromatic carbon ring group or an aryl group, for example, a phenyl group, a p-chlorophenyl group, a mesityl group, a tolyl group, a xylyl group, a naphthyl group, an anthryl group, an azulenyl group, an acenaphthenyl group, a fluorenyl group, a phenanthryl group, an indenyl group, a pyrenyl group, or a biphenylyl group) or an aromatic heterocyclic group (for example, a furyl group, a thienyl group, a pyridyl group, a pyridazinyl group, a pyrimidinyl group, a pyrazinyl group, a triazinyl group, an imidazolyl group, a pyrazolyl group, a thiazolyl group, a quinazolinyl group, or a phthalazinyl group).

The above aromatic hydrocarbon group or aromatic heterocyclic group may have the substituent represented by R1a through R1i in the partial structure represented by any of formulae (1) through (4).

In formula (a), as the aromatic ring represented by Ar there is an aromatic hydrocarbon ring or an aromatic heterocyclic ring. Further, the above aromatic ring may be either a single ring or a condensed ring, and may have a substituent such as the substituent represented by R1a through R1i in the partial structure represented by any of formulae (1) through (4) or not.

In the partial structure represented by formula (a), examples of the aromatic hydrocarbon ring represented by Ar include a benzene ring, a biphenyl ring, a naphthalene ring, an azulene ring, an anthracene ring, a phenanthrene ring, a pyrene ring, a chrysene ring, a naphthacene ring, a triphenylene ring, an o-terphenyl ring, an m-terphenyl ring, a p-terphenyl ring, an acenaphthene ring, a coronene ring, a fluorene ring, a fluoroanthrene ring, a naphthacene ring, a pentacene ring, a perylene ring, a pentaphene ring, a picene ring, a pyrene ring, a pyranthrene ring, and an anthraanthorene ring. These rings may have the substituent represented by R1a through R1i in the partial structure represented by any of formulae (1) through (4).

In the partial structure represented by formula (a), examples of the aromatic heterocyclic ring represented by Ar include a furan ring, a dibenzofuran ring, a thiophene ring, an oxazole ring, a pyrrole ring, a pyridine ring, a pyridazine ring, a pyrimidine ring, a pyrazine ring, a triazine ring, a benzimidazole ring, an oxadiazole ring, a triazole ring, an imidazole ring, a pyrazole ring, a triazole ring, an indole ring, an indazole ring, a benzimidazole ring, a benzothiazole ring, a benzoxazole ring, a quinoxaline ring, a quinazoline ring, a cinnoline ring, a quinoline ring, an isoquinoline ring, a phthalazine ring, a naphthyridine ring, a carbazole ring, a carboline ring, and a diazacarbazole ring (in which one of the carbon atoms of the hydrocarbon ring constituting a carboline ring is further replaced with a nitrogen atom).

These rings may have the substituent represented by R1a through R1i in the partial structure represented by any of formulae (1) through (4).

Among these, the aromatic ring represented by Ar in formula (a) is preferably a carbazole ring, a carboline ring, a dibenzofuran ring or a benzene ring, more preferably a carbazole ring, a carboline ring or a benzene ring, still more preferably a benzene ring having a substituent, and most preferably a benzene ring having a carbazolyl group.

Further, the aromatic ring represented by Ar in formula (a) is preferably a condensed ring having three or more rings. Typical examples of the aromatic hydrocarbon condensed ring having three or more rings include a naphthacene ring, an anthracene ring, a tetracene ring, a pentacene ring, a hexacene ring, a phenanthrene ring, a pyrene ring, a benzopyrene ring, a benzazulene ring, a chrysene ring, a benzochrysene ring, an acenaphthene ring, an acenaphthylene ring, a triphenylene ring, a coronene ring, a benzocoronene ring, a hexabenzocoronene ring, a fluorene ring, a benzofluorene ring, a fluoranthene ring, a perylene ring, a naphthoperylene ring, a pentabenzoperylene ring, a benzoperylene ring, a pentaphene ring, a picene ring, a pyranthorene ring, a coronene ring, a naphthocoronene ring, an ovalene ring and an anthraanthorene ring.

These rings may further have the substituent as described above.

Further, typical examples of the aromatic heterocyclic condensed ring having three or more rings include an acridine ring, a benzoquinoline ring, a carbazole ring, a carboline ring, a phenazine ring, a phenanthridine ring, a phenanthroline ring, a carboline ring, a cyclazine ring, a quindoline ring, a thepenidine ring, a quinindoline ring, a triphenodithiazine ring, a triphenodioxazine ring, a phenanthridine ring, an anthrazine ring, a perymidine ring, a diazacarbazole ring (referring to a compound in which any one of the carbon atoms constituting a carboline ring is replaced with a nitrogen atom), a phenanthroline ring, a benzofuran ring, a dibenzothiophene ring, a naphthofuran ring, a naphthothiophene ring, a benzofuran ring, a benzothiophene ring, a naphthodifuran ring, a naphthodithiophene ring, an anthrafuran ring, an anthradifuran ring, an anthrathiophene ring, an anthradithiophene ring, a thianthrene ring, a phenoxathiin ring, and a thiophanthrene ring (being a naphthothiophene ring). These rings may have a substituent.

In formula (a), n is an integer of from 0 to 8, and preferably from 0 to 3. Particularly when X is O or S, n is preferably 1 or 2.

(Host Compound Represented by Formula (a-1), (a-2) or (a-3))

The host compound in the invention comprises at least three of a partial structure represented by formula (a). The host compound in the invention is preferably a compound represented by formula (a-1), (a-2) or (a-3) below.

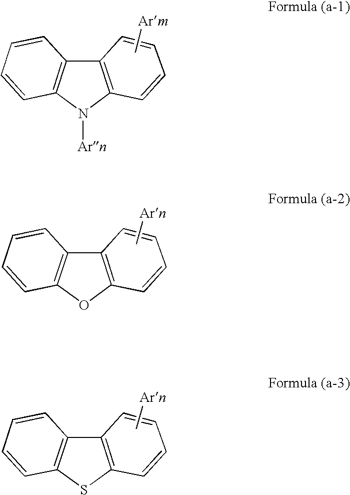

In formulae above, Ar′ and Ar″ represent an aromatic ring. The aromatic ring is the same as denoted above in the aromatic ring represented by Ar in formula (a) above. n represents an integer of not less than 1, and m represents an integer of not less than 0.

Typical examples of the host compound in the invention will be listed later, but the invention is not limited thereto.

It is confirmed that all of the examples have a glass transition temperature of not less than 110° C. The glass transition temperature (also referred to as glass transition point) in the invention can be determined employing a DSC (differential scanning calorimeter) available on the market.

Preferred embodiment of the host compound in the invention will be explained below.

The host compound in the invention may be a low molecular compound, a polymer having a recurring unit, or a low molecular compound having a polymerizable group such as a vinyl group or an epoxy group (a vapor-deposition polymerizable light emitting host).

The host compound is preferably a compound having a hole and electron transporting capability, restraining shift of an emission light wavelength to a longer wavelength side and having a high Tg (glass transition temperature).

### (Tg (Glass Transition Temperature) of Host Compound)

The Tg of the host compound in the invention is not less than 110° C., and preferably 130° C. The upper limit of the Tg is not specifically limited, but is preferably not more than 250° C. in view of solvent solubility or vapor deposition properties of the host compound in the manufacture of an EL element.

### (Lowest Excitation Triplet Energy)

The lowest excitation triplet energy of the host compound in the invention is not less than 2.75 eV, which is essential to obtain high emission efficiency. Particularly when used in combination with a blue light emission dopant, it is preferred that the host compound has a lowest excitation triplet energy of not less than 2.75 eV in order to prevent energy transfer from the excitation triplet energy of the dopant.

The upper limit of the excitation triplet energy of the host compound is not specifically limited, but is preferably not more than 3.2 eV, since too high energy in the excited state lowers stability.

### (Level of Highest Occupied Molecular Orbital Homo)

The highest occupied molecular orbital HOMO energy level of the host compound in the invention is preferably not less than −5.6 eV in obtaining high emission efficiency, although the reason is not clear.

The phosphorescence emitting metal complex exhibits behavior having high hole trapping ability which is considered to be due to its high association property. In order to conduct smooth transfer of positive holes from the phosphorescence emitting metal complex to the host compound in the light emission layer in the center of which the emission regions are positioned, the HOMO energy level of the host compound is not less than −5.6 eV, and preferably not less than −5.44 eV.

### (Level of Lowest Unoccupied Molecular Orbital LUMO)

The lowest unoccupied molecular orbital LUMO energy level of the host compound is preferably not less than −1.45 eV in improving emission efficiency and emission lifetime. Although the reason is not clear, when the phosphorescence emitting compound in the invention is used, holes in the light emission layer are difficult to transfer and light emission regions are likely to locate on the side of the anode in the light emission layer.

Therefore, restraint of injection of electrons in the light emission layer moves the light emission regions to the center of the light emission layer. Accordingly; it is assumed that restraint of injection in the light emission layer of electrons migrating from the cathode enables migration of the light emission regions to the center of the light emission layer.

It is assumed that the lowest unoccupied molecular orbital energy level of the host compound necessary to control injection of electrons into the light emission layer is −1.45 eV.

In the invention, the energy of the highest occupied molecular orbital (HOMO) level and the lowest unoccupied molecular orbital (LUMO) level is obtained as a value (in terms of eV), which is calculated by performing structural optimization employing Gaussian 98 (Gaussian 98, Revision A. 11.4, M J. Frisch, et al., Gaussian, Inc., Pittsburgh Pa., 2002), which is a software for molecular orbital calculation of Gaussian, Inc., and B3LYP/6-31G* as a key word. The reason that the calculated value above is effective is because the calculated value obtained by the above method and experimental values exhibit high correlation.

The excitation triplet energy in the invention is defined by the following formula.

X=1239.8/Y

wherein X is an excitation triplet energy (eV), Y is a phosphorescence 0-0 band (nm). The phosphorescence 0-0 band (nm) can be determined as described below.

A host compound to be measured is dissolved in a mixed solvent of well-deoxygenated ethanol/methanol (4/1 by volume) and placed in a cell for phosphorescence measurement, followed by irradiation of exciting light at a liquid nitrogen temperature of 77 K to measure an emission spectrum 100 ms after completion of the irradiation of exciting light. It is conceivable that since phosphorescence features a longer emission life than fluorescence, most of the light remaining after the 100 ms have elapsed is phosphorescence. Incidentally, a compound exhibiting a phosphorescence lifetime of shorter than 100 ms may be measured by shortening a delay time. However, in the cases when shortening the delay time to the extent that the shortened delay time is not distinguished from the life of fluorescence, a problem occurs in that phosphorescence and fluorescence each are indistinguishable, and therefore it is necessary to select an appropriate delay time capable of distinguishing therebetween.

For a compound insoluble in the solvent system described above, any appropriate solvent, which can dissolve the compound, may be employed (it is not substantially problematic since a solvent effect on the phosphorescence wavelength in the above measurement method is negligible.).

Plural kinds of known host compounds may be used in combination as the host compound. Usage of plural kinds of host compounds can adjust charge transfer, and obtain an organic EL element with high efficiency. Further, usage of plural kinds of phosphorescence compounds can mix light with a different color, and can emit light with any color. It is possible to select the type of a phosphorescence emitting compound and regulate the doping amount of the compound, which enables application to lighting and backlights.

Typical examples of the host compound in the invention will be listed below, but the invention is not limited thereto.

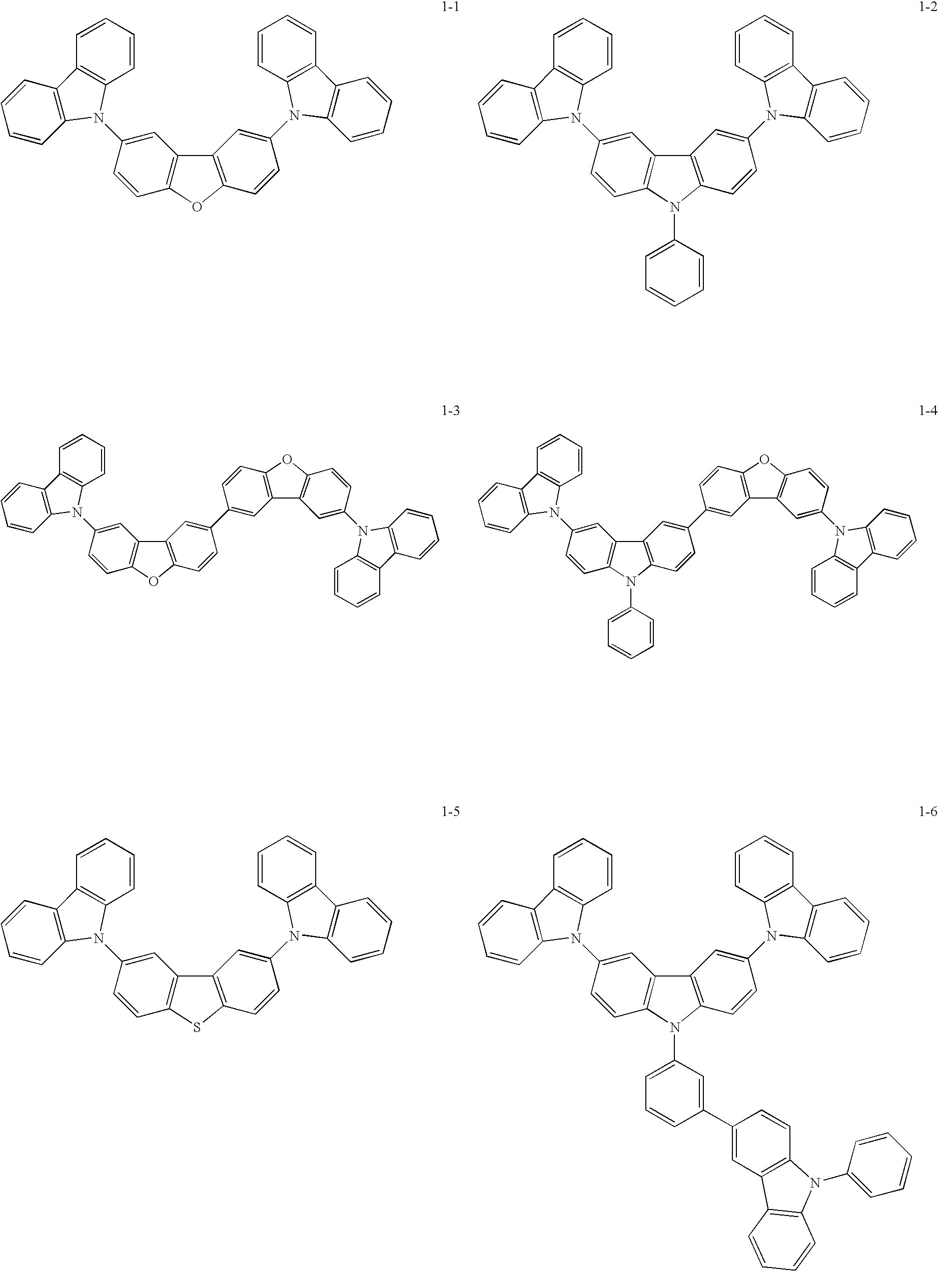

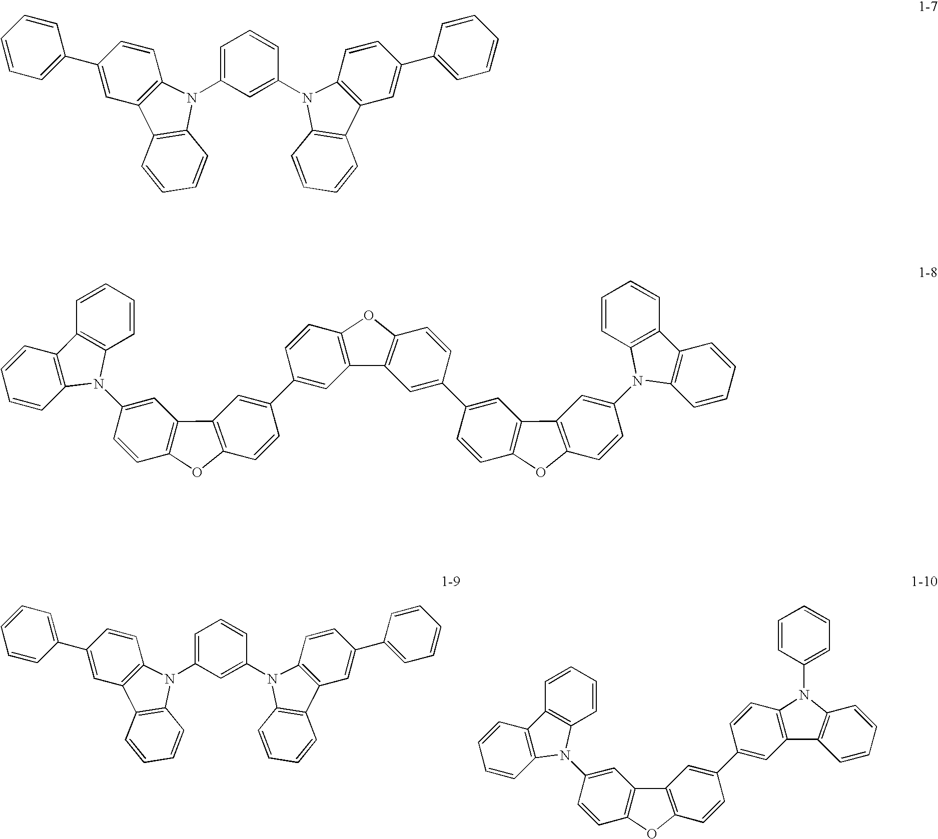

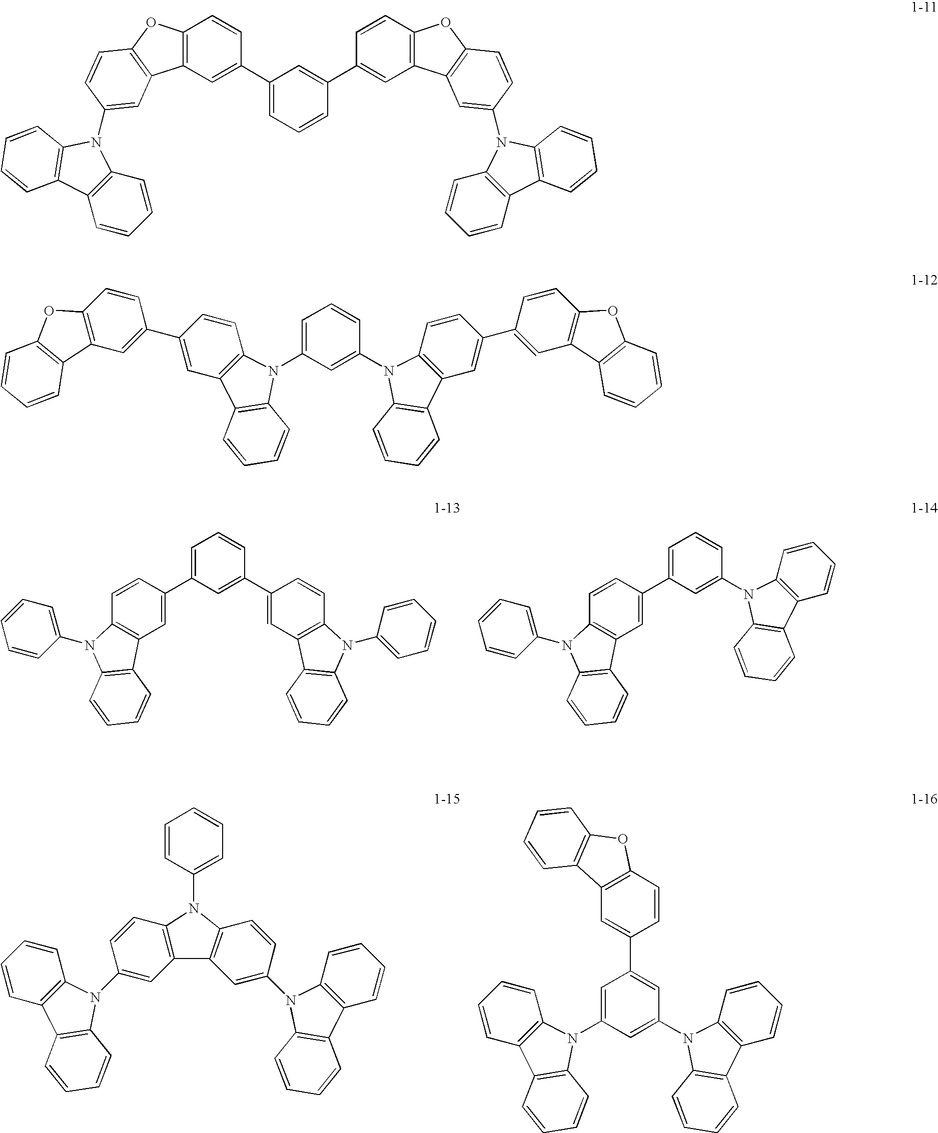

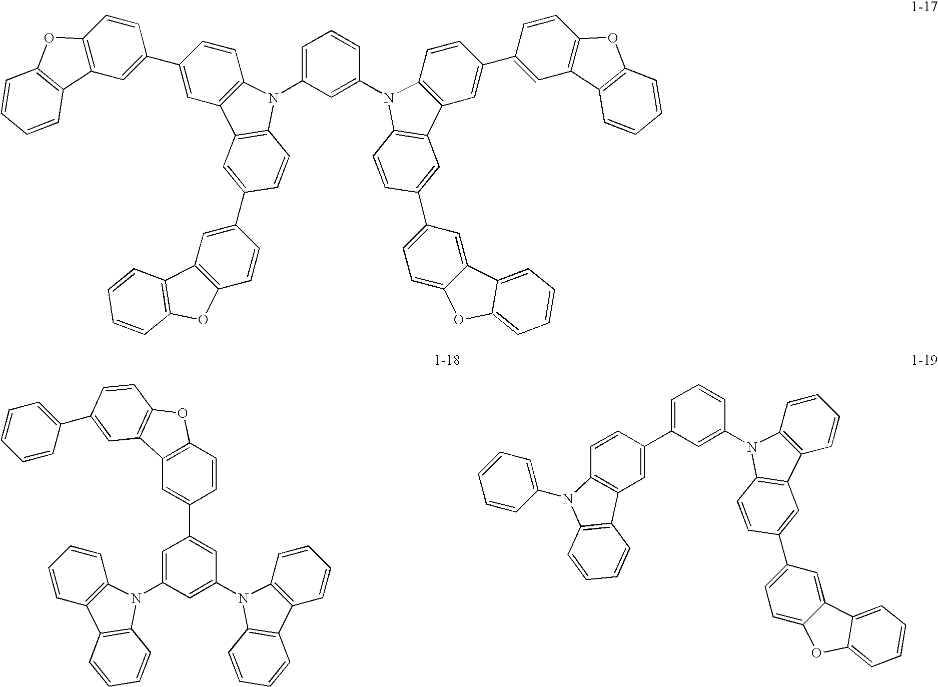

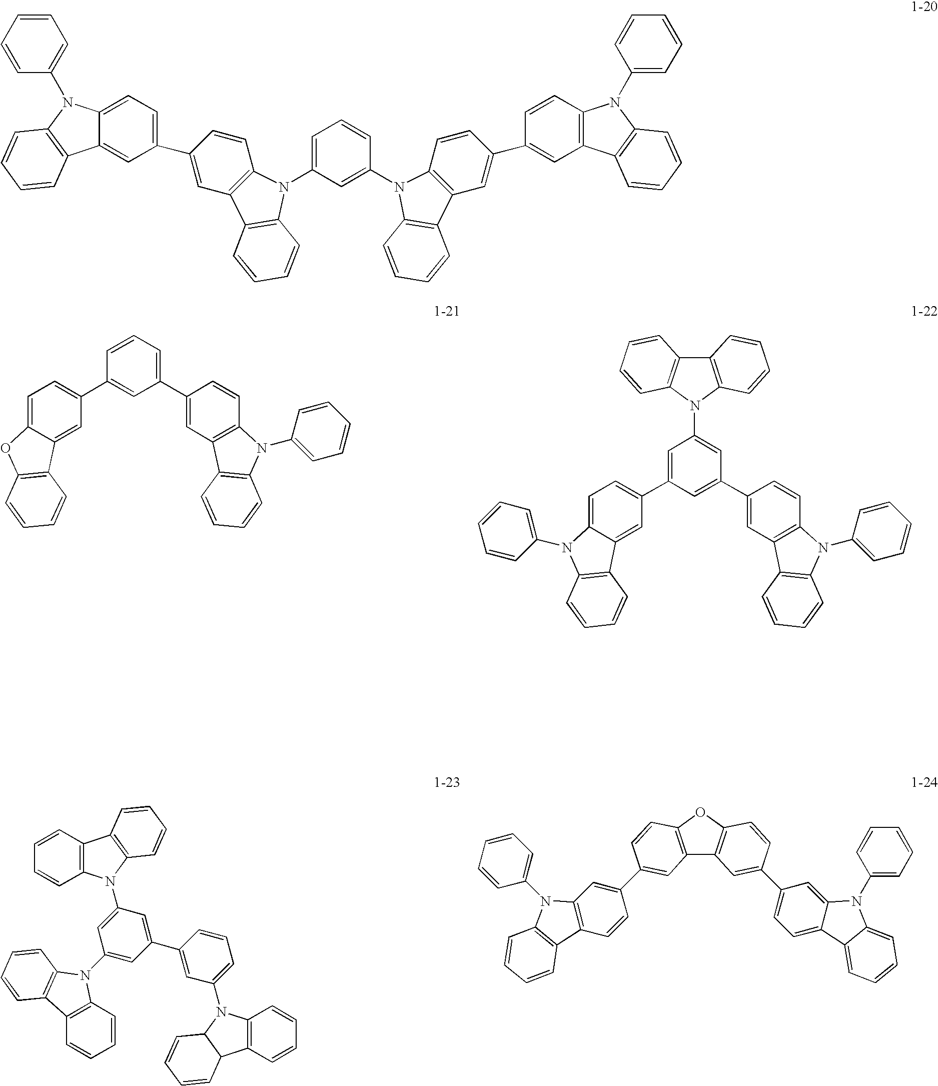

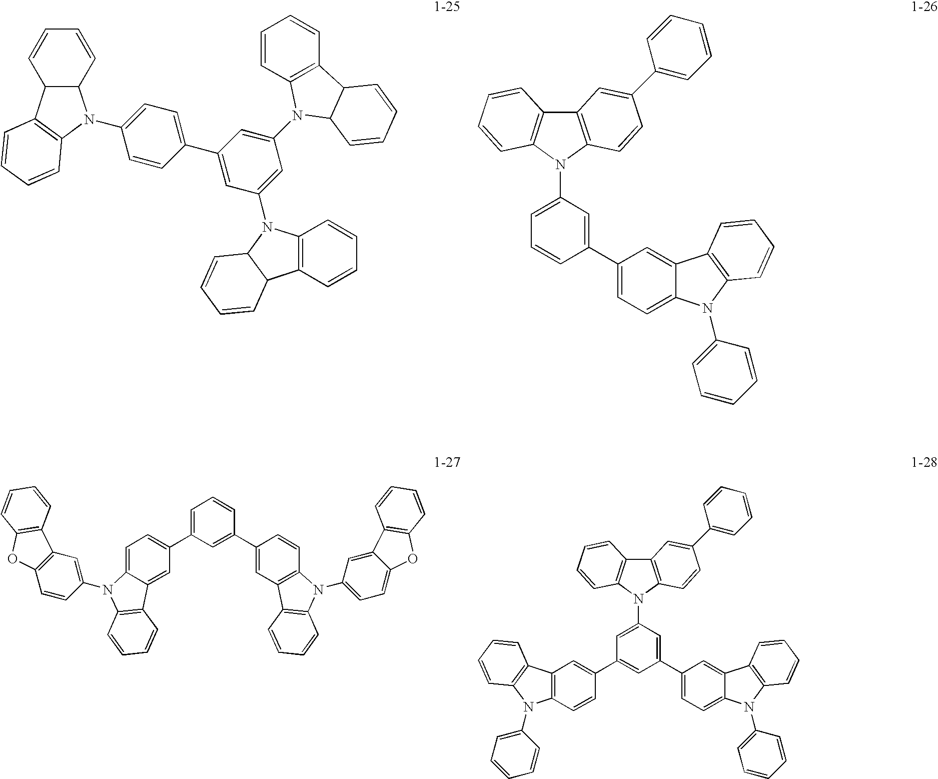

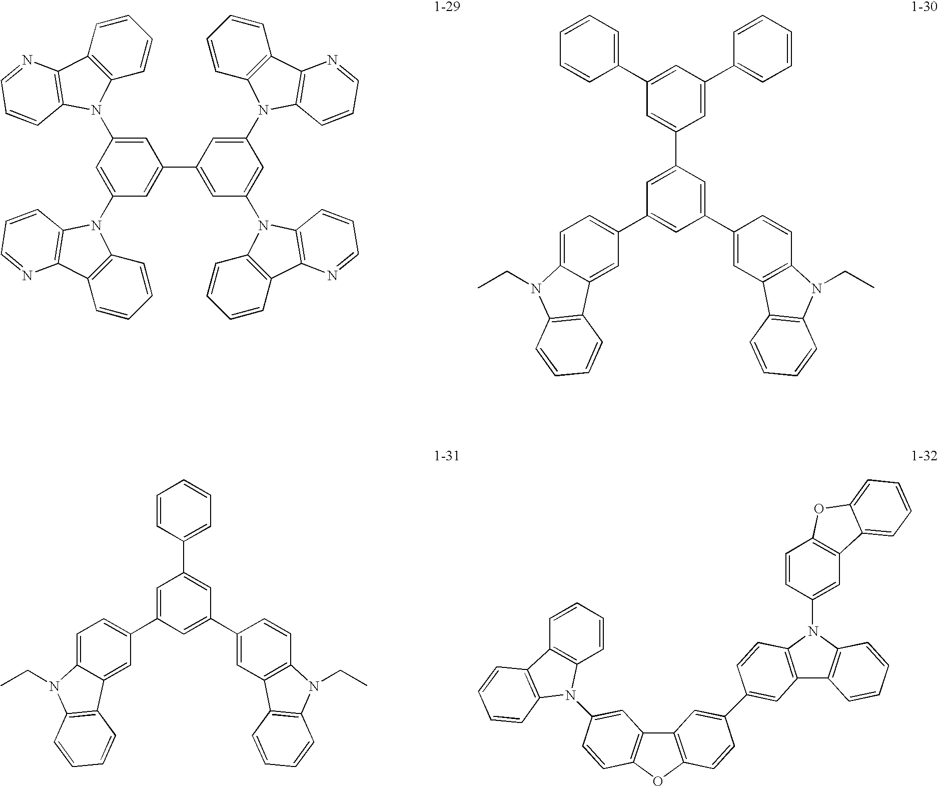

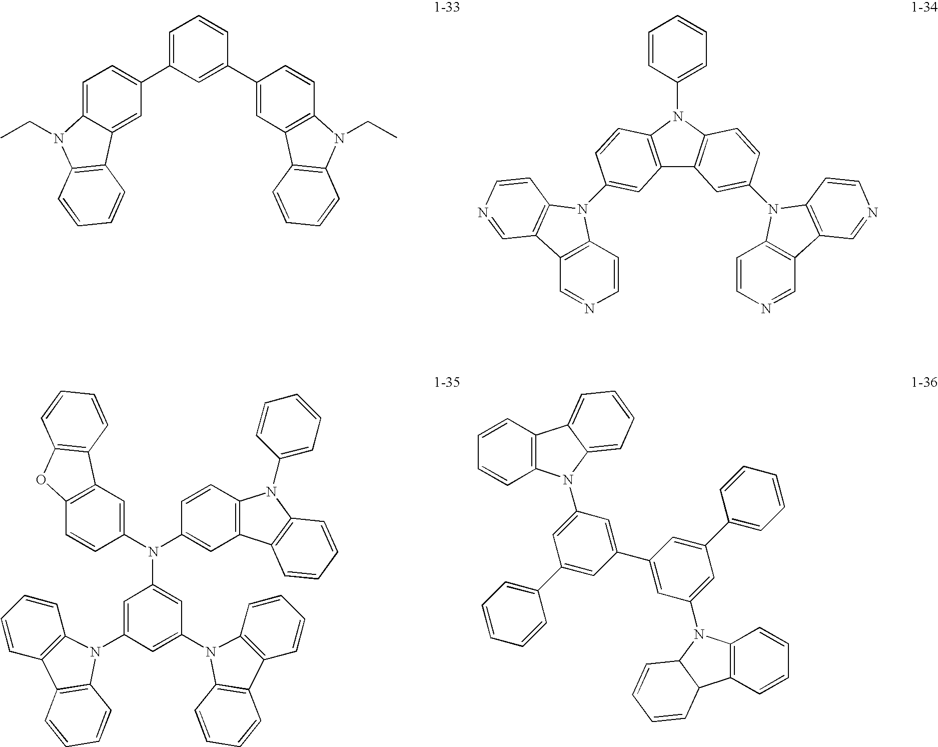

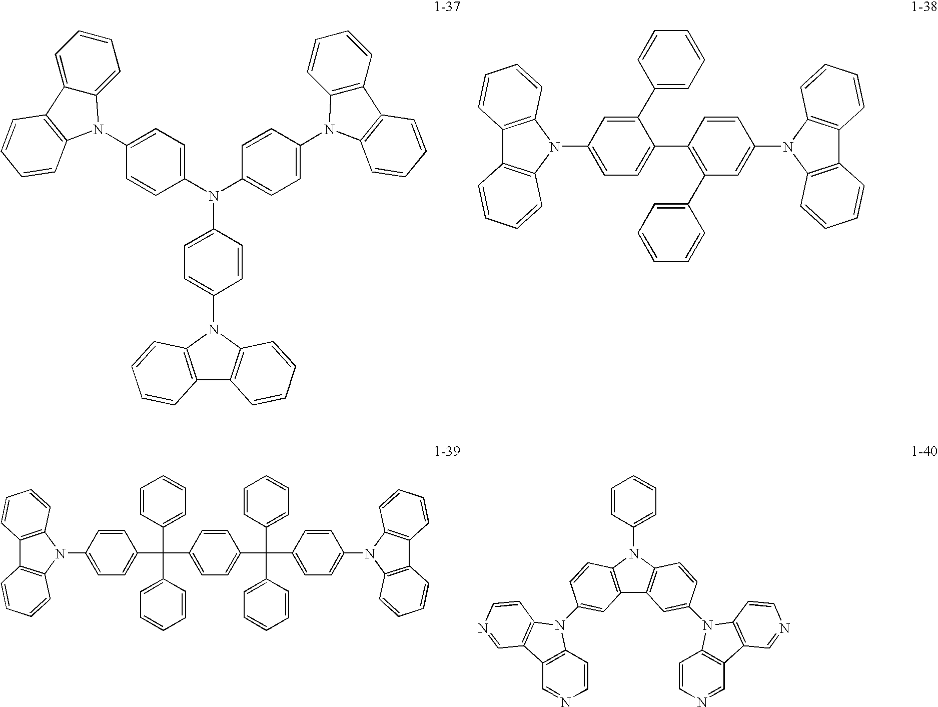

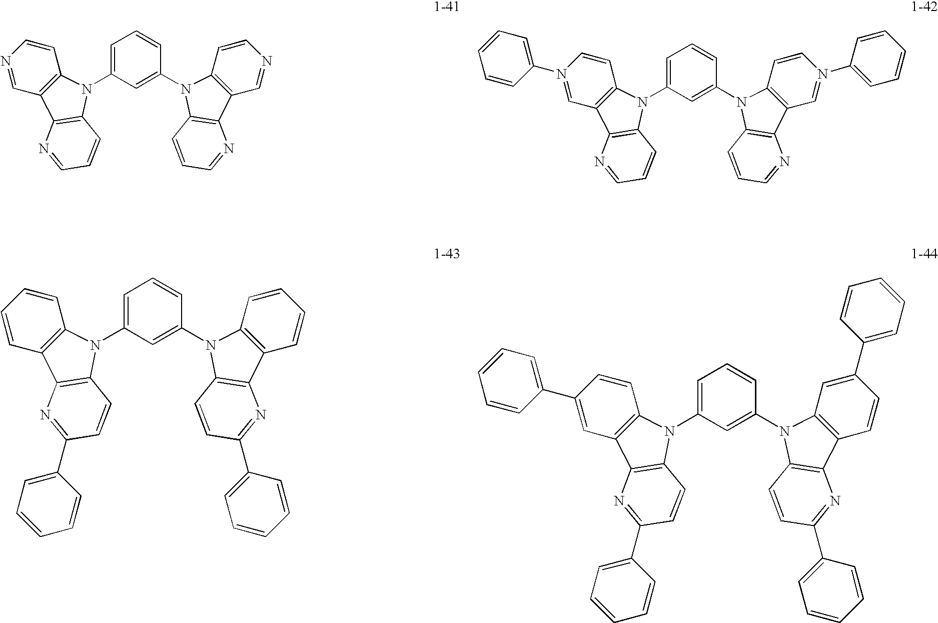

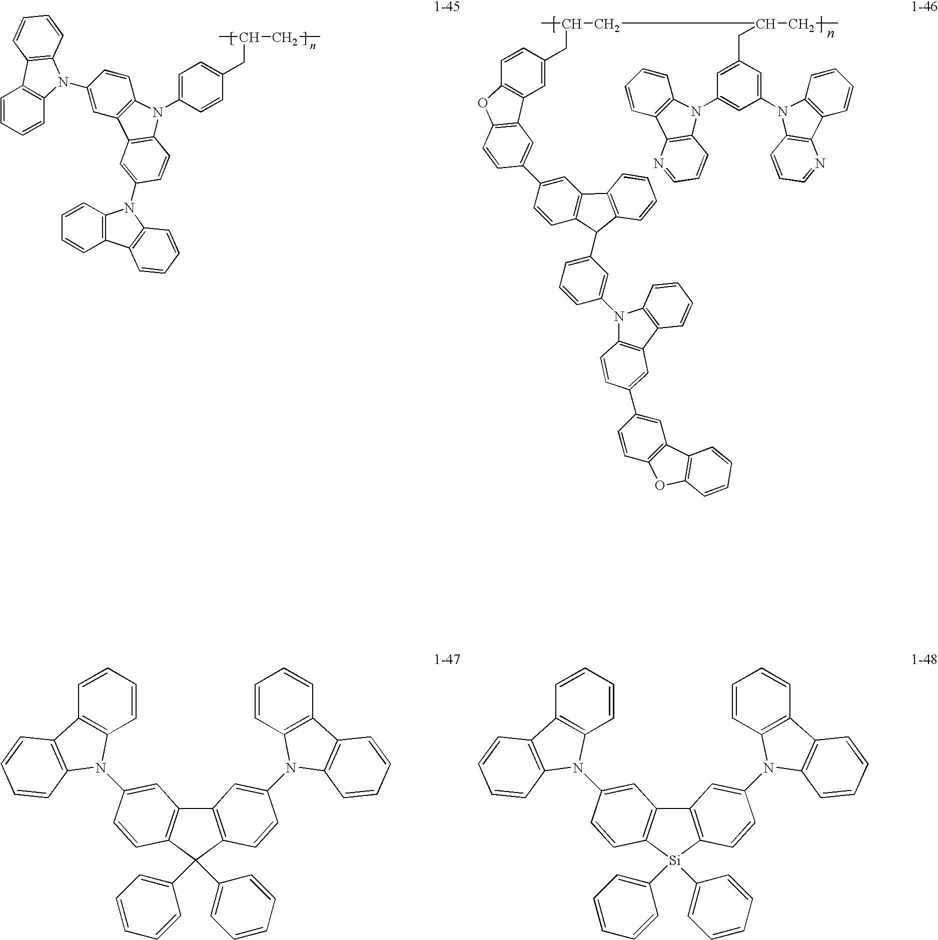

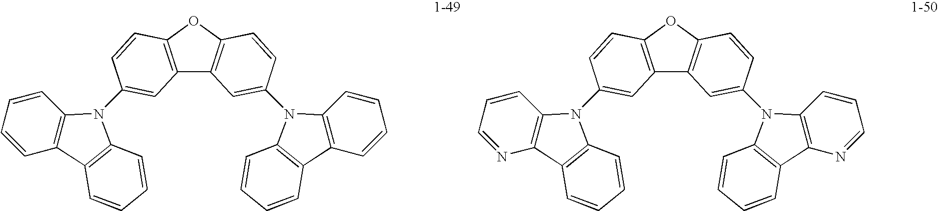

<<Constituent Layer of Organic EL element)

The constituent layer of the organic EL element of the invention will be explained below. In the invention, Preferred examples of the constituent layer of the organic EL element of the invention will be shown below., but the invention is not limited thereto.

(i): Anode/Light emission layer/Electron transporting layer/Cathode
(ii): Anode/Hole transporting layer/Light emission layer/Electron transporting layer/Cathode
(iii): Anode/Hole transporting layer/Light emission layer/Hole blocking layer/Electron transporting layer/Cathode
(iv): Anode/Hole transporting layer/Light emission layer/Hole blocking layer/Electron transporting layer/Cathode buffering layer/Cathode
(v): Anode/Anode buffering layer/Hole transporting layer/Light emission layer/Hole blocking layer/Electron transporting layer/Cathode buffering layer/Cathode

In the organic EL element of the invention, a blue emission layer has an emission maximum in the range of from preferably 430 to 480 nm, a green emission layer has an emission maximum in the range of from preferably 510 to 550 nm, and a red emission layer has an emission maximum in the range of from preferably 600 to 640 nm, and a display employing these layers is preferred. At least these three layers may be laminated in order to prepare a white emission layer. A non-light emission layer may be provided as an intermediate layer between these emission layers. It is preferred that the organic EL element of the invention is a white emission layer or an illuminating device employing the same.

Each layer constituting the organic EL element of the invention will be explained below.

### <<Light Emission Layer>>

The light emission layer in the invention is a layer where electrons and holes, injected from electrodes, an electron transporting layer or a hole transporting layer, are recombined to emit light. The portions where light emits may be in the light emission layer or at the interface between the light emission layer and the layer adjacent thereto.

The total thickness of the light emission layer is not particularly limited. In view of improving layer uniformity and stability of emitted light color against driving electric current without requiring unnecessary high voltage on light emission, the above thickness is adjusted to be in the range of preferably from 2 nm to 5 μm, more preferably from 2 to 200 nm, and still more preferably from 10 to 20 nm.

Employing an emission dopant or a host compound each described later, the light emission layer is formed according to a known thin layer formation method such as a vacuum deposition method, a spin coat method, a casting method, an LB method or an ink jet method.

The light emission layer of the organic EL element of the invention preferably contains a host compound and at least one kind of an emission dopant (also referred to as phosphorescence dopant or a phosphorescence emission dopant) and a fluorescence dopant.

### (Host Compound (Also Referred to as Emission Host))

The host compound used in the invention will be explained below.

Herein, the host compound in the invention is defined as a compound which is contained in the light emission layer in an amount of not less than 20% by weight and which has a phosphorescence quantum yield at room temperature (25° C.) of less than 0.1. The phosphorescence quantum yield of the host compound is preferably less than 0.01. The content of the host compound in the light emission layer is preferably not less than 20% by weight.

The host compound in the invention is a host compound having a glass transition temperature of not less than 110° C. which is contained in the light emission layer, and may be used in combination with known host compounds.

Usage of plural host compounds can adjust charge transfer, and obtain an organic EL element with high efficiency. Further, usage of plural emission dopants described later can mix light with a different color, and can emit light with any color.

The emission host used in the invention may be a conventional low molecular weight compound, a polymeric compound having a repeating unit or one or more kinds of a low molecular weight compound (vapor-polymerizable emission host) with a polymerizable group such as a vinyl group or an epoxy group.

Typical examples of the known host compounds include those described in the following Documents.

For example, Japanese Patent O.P.I. Publication Nos. 2001-257076, 2002-308855, 2001-313179, 2002-319491, 2001-357977, 2002-334786, 2002-8860, 2002-334787, 2002-15871, 2002-334788, 2002-43056, 2002-334789, 2002-75645, 2002-338579, 2002-105445, 2002-343568, 2002-141173, 2002-352957, 2002-203683, 2002-363227, 2002-231453, 2003-3165, 2002-234888, 2003-27048, 2002-255934, 2002-260861, 2002-280183, 2002-299060, 2002-302516, 2002-305083, 2002-305084 and 2002-308837.

### (Emission Dopant)

The emission dopant in the invention will be explained.

As the emission dopant in the invention, a fluorescence dopant (also referred to as a fluorescent compound) or a phosphorescence dopant (also referred to as a phosphorescence emitter, a phosphorescent compound or a phosphorescence emission compound) can be used. As the emission dopant (also referred to simply as emission material) used in the light emission layer or the emission unit of the organic EL element of the invention, a phosphorescence dopant is preferably used in addition to the host compound as described above in obtaining an organic EL element with high emission efficiency.

### (Phosphorescence Dopant)

The phosphorescence dopant in the invention will be explained.

The phosphorescence dopant in the invention is a compound which emits light from the excitation triplet, can emit phosphorescence at room temperature (25° C.), and has a phosphorescent quantum yield at 25° C. of not less than 0.01. The phosphorescent quantum yield at 25° C. is preferably not less than 0.1.

The phosphorescent quantum yield can be measured according to a method described in the fourth edition “Jikken Kagaku Koza 7”, Bunko II, page 398 (1992) published by Maruzen. The phosphorescent quantum yield can be measured in a solution employing various kinds of solvents. The phosphorescence dopant in the invention is a compound, in which the phosphorescent quantum yield measured employing any one of the solvents satisfies the above-described definition (not less than 0.01).

The light emission of the phosphorescence dopant is divided in two types in principle, one is an energy transfer type in which recombination of a carrier occurs on the host to which the carrier is transported to excite the host, the resulting energy is transferred to the phosphorescence dopant, and light is emitted from the phosphorescence dopant, and the other is a carrier trap type in which recombination of a carrier occurs on the phosphorescence dopant, a carrier trap material, and light is emitted from the phosphorescence dopant. However, in each type, it is necessary that energy level of the phosphorescence dopant in excited state is lower than that of the host compound in excited state.

The phosphorescence dopant can be suitably selected from those used in the light emission layer of an organic EL element.

The phosphorescence dopant in the invention is preferably a complex compound containing a metal belonging to groups 8 to 10 on the periodic table, and is more preferably an iridium compound, an osmium compound, a platinum compound (a platinum complex) or a rare earth compound, and most preferably an iridium compound.

The compound used as the phosphorescence dopant in the invention is preferably the phosphorescence emission metal complex described above having as a ligand a 6-member aromatic compound condensed with three or more of 5- or 6-member aromatic rings, and more preferably the compound as described above having a partial chemical structure represented by any or formulae (1) through (4). Typical examples thereof include exemplified compounds as listed above. As the emission dopant in the invention, known compounds as listed below can be used in combination.

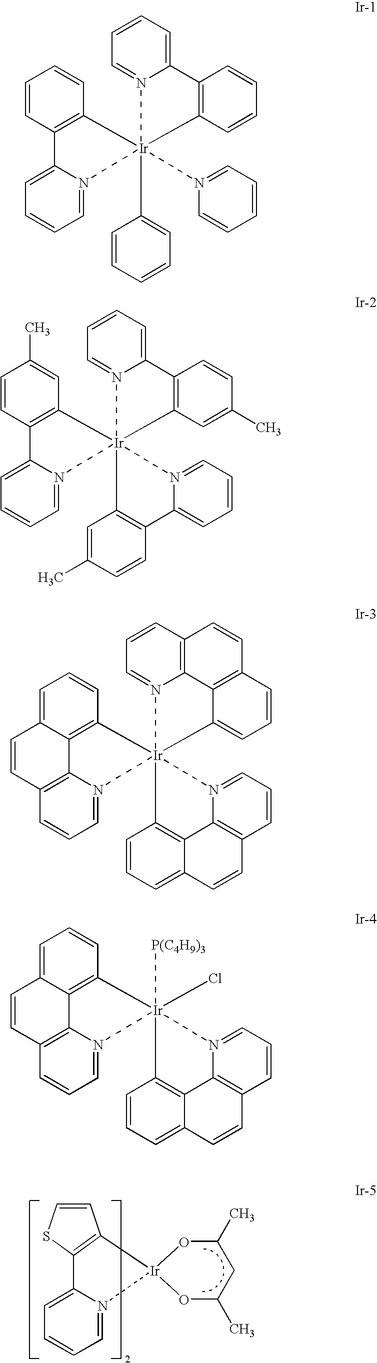

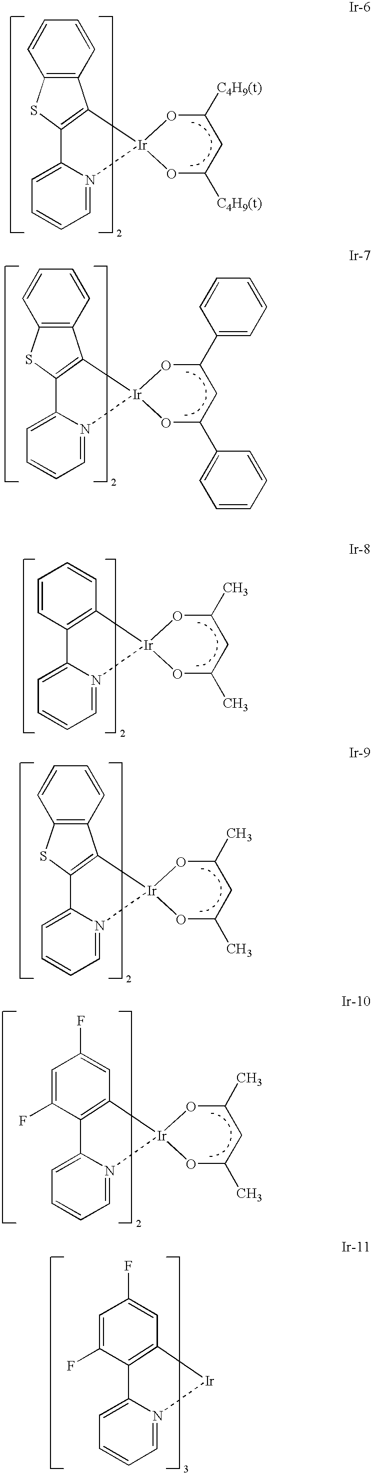

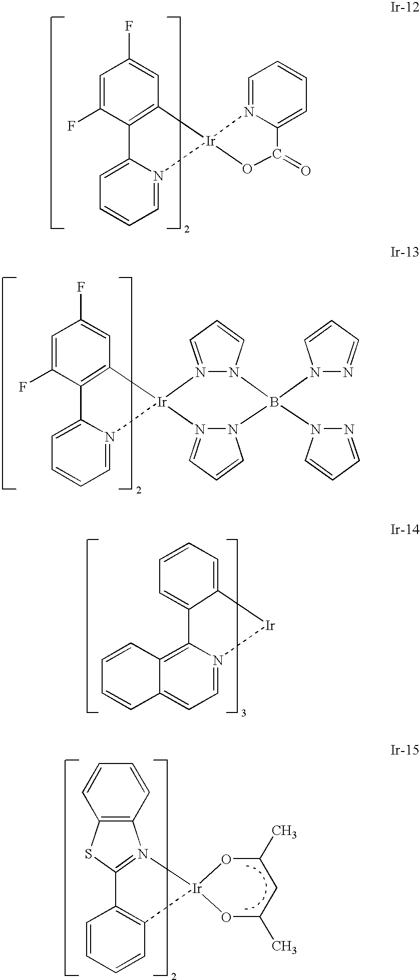

(Fluorescence Dopant (also Referred to as Fluorescent Compound))

Examples of the fluorescence dopant (fluorescent compound) include a coumarin dye, a cyanine dye, a chloconium dye, a squarylium dye, an oxobenzanthracene dye, a fluorescene dye, a rhodamine dye, a pyrylium dye, a perylene dye, a stilbene dye, a polythiophene dye and rare earth complex type fluorescent compound.

Next, an injecting layer, a blocking layer, and an electron transporting layer used in the constituent layer of the organic EL element of the invention will be explained.

### <<Injecting Layer Electron Injecting Layer, Hole Injecting Layer>>

The injecting layer is optionally provided, for example, an electron injecting layer or a hole injecting layer, and may be provided between the anode and the light emission layer or hole transporting layer, and between the cathode and the light emission layer or electron transporting layer as described above.

The injecting layer herein referred to is a layer provided between the electrode and an organic layer in order to reduce the driving voltage or to improve of light emission efficiency, which is detailed in “Electrode Material”, Div. 2 Chapter 2, pp. 123-166 of “Organic EL element and its frontier of industrialization” (published by NTS Corporation, Nov. 30, 1998). As the injecting layer there are a hole injecting layer (an anode buffer layer) and an electron injecting layer (a cathode buffer layer).

The anode buffer layer (hole injecting layer) is described in Japanese Patent O.P.I. Publication Nos. 9-45479, 9-260062, and 8-288069 etc., and its examples include a phthalocyanine buffer layer represented by a copper phthalocyanine layer, an oxide buffer layer represented by a vanadium oxide layer, an amorphous carbon buffer layer, a polymer buffer layer employing an electroconductive polymer such as polyaniline (emeraldine), and polythiophene, etc.

The cathode buffer layer (electron injecting layer) is described in Japanese Patent O.P.I. Publication Nos. 6-325871, 9-17574, and 10-74586, etc. in detail, and its examples include a metal buffer layer represented by a strontium or aluminum layer, an alkali metal compound buffer layer represented by a lithium fluoride layer, an alkali earth metal compound buffer layer represented by a magnesium fluoride layer, and an oxide buffer layer represented by an aluminum oxide. The buffer layer (injecting layer) is preferably very thin and has a thickness of preferably from 0.1 nm to 5 μm depending on kinds of the material used.

### <<Blocking Layer: Hole Blocking Layer, Electron Blocking Layer>>

The blocking layer is a layer provided if necessary in addition to the fundamental constituent layer as described above, and is for example a hole blocking layer as described in Japanese Patent O.P.I. Publication Nos. 11-204258, and 11-204359, and on page 237 of “Organic EL element and its frontier of industrialization” (published by NTS Corporation, Nov. 30, 1998).

The hole blocking layer is an electron transporting layer in a broad sense, and is comprised of material having an ability of transporting electrons but an extremely poor ability of holes, which can increase a recombination probability of electrons and holes by transporting electrons and blocking holes.

Further, the constitution of an electron transporting layer described later can be used in the hole blocking layer in the invention as necessary.

The hole blocking layer in the organic EL element of the invention is preferably provided to be in contact with a light emission layer.

It is preferred that the hole blocking layer contains a carbazole derivative, a carboline derivative, or a diazacarbazole derivative (herein, the diazacarbazole derivative is a compound in which one of the carbon atoms constituting the carboline ring is substituted with a nitrogen atom), each being denoted above as the host compound.

Further, in the invention, when there are a plurality of light emission layers which emit a plurality of different color lights, it is preferable that a light emission layer which emits a light having emission maximum in the shortest wavelength of all the light emission layers is provided closest to the anode. In such a case, it is preferred that a hole blocking layer is additionally provided between the above light emission layer which emits a light having emission maximum in the shortest wavelength and a light emission layer which is provided closest to the anode, except for the above layer. Further, it is preferred that at least 50% by weight of compounds, which are incorporated in the hole blocking layer arranged in the above position, has an ionization potential 0.3 eV higher than that of the host compound contained in the light emission layer which emits a light having emission maximum in the shortest wavelength.

Ionization potential is defined as energy required to transfer an electron in the highest occupied molecular orbital to the vacuum level, and can be determined by the methods described below:

(1) The ionization potential can be obtained as a value obtained by rounding to one decimal a value (in terms of eV), which is calculated by performing structural optimization employing Gaussian 98 (Gaussian 98, Revision A. 11.4, M J. Frisch, et al., Gaussian, Inc., Pittsburgh Pa., 2002), which is a software for molecular orbital calculation of Gaussian, Inc., and B3LYP/6-31G* as a key word, and the calculated value (being the value in terms of eV unit) is rounded off at the second decimal place. Background in which the calculated value above is effective is that the calculated value obtained by the above method and experimental values exhibit high correlation.

(2) It is also possible to obtain ionization potential via a direct measurement method employing a photoelectron spectroscopy. For example, it is possible to appropriately employ a low energy electron spectrometer “Model AC-1”, produced by Riken Keiki Co., Ltd., or a method known as ultraviolet photoelectron spectroscopy.

On the other hand, the electron blocking layer is a hole transporting layer in a broad sense, and is comprised of material having an ability of transporting holes but an extremely poor ability of electrons, which can increase a recombination probability of electrons and holes by transporting holes and blocking electrons.

The constitution of the hole transporting layer as described later can be used as that of the electron blocking layer. The thickness of the hole blocking layer or electron transporting layer is preferably from 3 to 100 nm, and more preferably from 5 to 30 nm.

### <<Hole Transporting Layer>>

The hole transporting layer is comprised of a hole transporting material having an ability of transporting holes, and a hole injecting layer and an electron blocking layer are included in the hole transporting layer in a broad sense. The hole transporting layer may be a single layer or plural layers.

The hole transporting material has a hole injecting ability, a hole transporting ability or an ability to form a barrier to electrons, and may be either an organic substance or an inorganic substance. Examples of thereof include a triazole derivative, an oxadiazole derivative, an imidazole derivative, a polyarylalkane derivative, a pyrazoline derivative and a pyrazolone derivative, a phenylenediamine derivative, an arylamine derivative, an amino substituted chalcone derivative, an oxazole derivative, a styryl anthracene derivative, a fluorenone derivative, a hydrazone derivative, a stilbene derivative, a silazane derivative, an aniline copolymer, and an electroconductive oligomer, particularly a thiophene oligomer.

As the hole transporting material, those described above are used, but a porphyrin compound, an aromatic tertiary amine compound, or a styrylamine compound is preferably used, and an aromatic tertiary amine compound is more preferably used.

Typical examples of the aromatic tertiary amine compound and styrylamine compound include N,N,N′,N′-tetraphenyl-4,4′-diaminophenyl, N,N′-diphenyl-N,N′-bis(3-methylphenyl)-[1,1′-biphenyl]-4,4′-diamine (TPD), 2,2′-bis(4-di-p-tolylaminophenyl)propane, 1,1-bis(4-di-p-tolylaminophenyl)cyclohexane, N,N,N′,N′-tetra-p-tolyl-4,4′-diaminobiphenyl, 1,1-bis(4-di-p-tolylaminophenyl)-4-phenylcyclohexane, bis(4-dimethylamino-2-methylphenyl)-phenylmethane, bis(4-di-p-tolylaminophenyl)phenylmethane, N,N′-diphenyl-N,N′-di(4-methoxyphenyl)-4,4′-diaminobiphenyl, N,N,N′,N′-tetraphenyl-4,4′-diaminodiphenyl ether, 4,4′-bis(diphenylamino)quardriphenyl, N,N,N-tri(p-tolyl)amine, 4-(di-p-tolylamino)-4′-[4-(di-p-tolylamino)styryl]stilbene, 4-N,N-diphenylamino(2-diphenylvinyl)benzene, 3-methoxy-4′-N,N-diphenylaminostylbenzene, N-phenylcarbazole, compounds described in U.S. Pat. No. 5,061,569 which have two condensed aromatic rings in the molecule thereof such as 4,4′-bis[N-(1-naphthyl)-N-phenylamino]biphenyl (NPD), and compounds described in Japanese Patent O.P.I. Publication No. 4-308688 such as 4,4′,4″-tris[N-(3-methylphenyl)-N-phenylamino]-triphenylamine (MTDATA) in which three triphenylamine units are bonded in a starburst form.

A polymer in which the material mentioned above is introduced in the polymer chain or a polymer having the material as the polymer main chain can be also used.

As the hole injecting material or the hole transporting material, inorganic compounds such as p-type-Si and p-type-SiC are usable.

So-called p-type hole transporting materials as disclosed in JP-A No. 11-251067 or described in the literature of J. Huang et al. (Applied Physics Letters 80 (2002), p. 139) are also applicable. In the present invention, these materials are preferably utilized since an emitting element exhibiting a higher efficiency is obtained.

The hole transporting layer can be formed by layering the hole transporting material by a known method such as a vacuum deposition method, a spin coat method, a casting method, an Ink jet method, and an LB method.

The thickness of the hole transporting layer is not specifically limited, but is ordinarily from 5 nm to 5 μm, and preferably from 5 to 200 nm. The hole transporting layer may be composed of a single layer structure comprising one or two or more of the materials mentioned above.

A positive hole transporting layer having high p-type property doped with impurity can be utilized. Examples thereof include those described in Japanese Patent O.P.I. Publication Nos. 4-297076, 2000-196140 and 2001-102175, and J. Appl. Phys., 95, 5773 (2004), and so on.

It is preferable in the invention to employ such a positive hole transporting layer having high p-type property, since an element with lower power consumption can be prepared.

### <<Electron Transporting Layer>>

The electron transporting layer comprises a material (an electron transporting material) having an electron transporting ability, and in a broad sense refers to an electron injecting layer or a hole blocking layer. The electron transporting layer can be provided as a single layer or plural layers.

An electron transporting material (which serves also as a hole blocking material) used in a single electron transporting layer or in the electron transporting layer closest to the cathode of plural electron transporting layers has a function of incorporating electrons injected from a cathode to a light emission layer, and can be selected from known compounds. Examples thereof include a nitro-substituted fluorene derivative, a diphenylquinone derivative, a thiopyran dioxide derivative, a carbodiimide, a fluolenylidenemethane derivative, an anthraquinodimethane, an anthrone derivative, and an oxadiazole derivative.

Moreover, a thiadiazole derivative which is formed by substituting the oxygen atom in the oxadiazole ring of the foregoing oxadiazole derivative with a sulfur atom, and a quinoxaline derivative having a quinoxaline ring known as an electron withdrawing group are usable as the electron transporting material. A polymer in which the material mentioned above is introduced in the polymer side chain or a polymer having the material as the polymer main chain can be also used.

A metal complex of an 8-quinolynol derivative such as aluminum tris-(8-quinolynol) (Alq₃), aluminum tris-(5,7-dichloro-8-quinolynol), aluminum tris-(5,7-dibromo-8-quinolynol), aluminum tris-(2-methyl-8-quinolynol), aluminum tris-(5-methyl-8-quinolynol), or zinc bis-(8-quinolynol) (Znq₂), and a metal complex formed by replacing the central metal of the foregoing complexes with another metal atom such as In, Mg, Cu, Ca, Sn, Ga or Pb, can be used as the electron transporting material.

Furthermore, a metal free or metal-containing phthalocyanine, and a derivative thereof, in which the molecular terminal is replaced by a substituent such as an alkyl group or a sulfonic acid group, are also preferably used as the electron transporting material. The distyrylpyrazine derivative exemplified as a material for the light emission layer may preferably be employed as the electron transporting material. An inorganic semiconductor such as n-type-Si and n-type-SiC may also be used as the electron transporting material in a similar way as in the hole injecting layer or in the hole transporting layer.

The electron transporting layer can be formed employing the above-described electron transporting materials and a known method such as a vacuum deposition method, a spin coat method, a casting method, a printing method including an ink jet method or an LB method. The thickness of the electron transporting layer is not specifically limited, but is ordinarily from 5 nm to 5 μm, and preferably from 5 to 200 nm. The electron transporting layer may be composed of a single layer comprising one or two or more of the electron transporting material.

An electron transporting layer having high n property doped with impurity can be utilized. Examples thereof include those described in Japanese Patent O.P.I. Publication Nos. 4-297076, 10-270172, 2000-196140, 2001-102175, and J. Appl. Phys., 95, 5773 (2004), and so on.

It is preferred in the invention that use of such an electron transport layer having high n property can provide an element with lower power consumption.

### <<Anode>>

For the anode of the organic EL element, a metal, an alloy, or an electroconductive compound each having a high working function (not less than 4 eV), and mixture thereof are preferably used as the electrode material. Typical examples of such an electrode material include a metal such as Au, and a transparent electroconductive material such as CuI, indium tin oxide (ITO), SnO₂ or ZnO.

A material such as IDIXO (In₂O₃—ZnO) capable of forming an amorphous and transparent conductive layer may be used. The anode may be prepared by forming a thin layer of the electrode material according to a depositing or spattering method, and by forming the layer into a desired pattern according to a photolithographic method. When required precision of the pattern is not so high (not less than 100 μm), the pattern may be formed by depositing or spattering of the electrode material through a mask having a desired form.

When a coatable material such as an organic conductive compound is used, a wet coating method such as a printing method or a coating method can be used. When light is emitted through the anode, the transmittance of the anode is preferably 10% or more, and the sheet resistance of the anode is preferably not more than several hundreds Ω/□. The thickness of the layer is ordinarily within the range of from 10 nm to 1 μm, and preferably from 10 to 200 nm, although it may vary due to kinds of materials used.

### <<Cathode>>

On the other hand, for the cathode, a metal (also referred to as an electron injecting metal), an alloy, and an electroconductive compound each having a low working function (not more than 4 eV), and a mixture thereof is used as the electrode material. Concrete examples of such an electrode material include sodium, sodium-potassium alloy, magnesium, lithium, a magnesium/copper mixture, a magnesium/silver mixture, a magnesium/aluminum mixture, magnesium/indium mixture, an aluminum/aluminum oxide (Al₂O₃) mixture, indium, a lithium/aluminum mixture, and a rare-earth metal.

Among them, a mixture of an electron injecting metal and a metal higher in the working function than that of the electron injecting metal, such as the magnesium/silver mixture, magnesium/aluminum mixture, magnesium/indium mixture, aluminum/aluminum oxide (Al₂O₃) mixture, lithium/aluminum mixture, or aluminum is suitable from the view point of the electron injecting ability and resistance to oxidation.

The cathode can be prepared forming a thin layer of such an electrode material by a method such as a deposition or spattering method. The sheet resistance as the cathode is preferably not more than several hundreds Ω/□, and the thickness of the layer is ordinarily from 10 nm to 5 μm, and preferably from 50 to 200 nm. It is preferred in increasing emission luminance that either the anode or the cathode of the organic EL element, through which light passes, is transparent or semi-transparent.

After a layer of the metal described above as a cathode is formed to give a thickness of from 1 to 20 nm, a layer of the transparent electroconductive material as described in the anode is formed on the resulting metal layer, whereby a transparent or semi-transparent cathode can be prepared. Employing this cathode, an element can be manufactured in which both anode and cathode are transparent.

### <<Substrate>>

The substrate (also referred to as a base body, a base plate, a base material or a support) employed for the organic EL element of the invention is not restricted to specific kinds of materials such as glass and plastic, as far as it is transparent. When light is taken out from the substrate side, the substrate is preferably transparent. Examples of the substrate preferably used include glass, quartz and light transmissible plastic film. Especially preferred one is a resin film capable of providing flexibility to the organic EL element.

Examples of materials for the resin film include polyesters such as polyethylene terephthalate (PET) and polyethylene naphthalate (PEN), polyethylene, polypropylene, cellophane, cellulose esters and their derivatives such as cellulose diacetate, cellulose triacetate, cellulose acetate butylate, cellulose acetate propionate (CAP), cellulose acetate phthalate (TAC), and cellulose nitrate, polyvinylidene chloride, polyvinylalcohol, polyethylenevinylalcohol, syndiotactic polystyrene, polycarbonate, norbornane resin, polymethylpentene, polyetherketone, polyimide, polyether sulfone (PES), polyphenylene sulfide, polysulfones, polyether imide, polyetherketone imide, polyamide, fluorine resin, nylon, polymethyl methacrylate, acryl or polyarylates, and cyclo-olefin resins such as ARTON (commercial name, manufactured by JSR Corp.) or APEL (commercial name, manufactured by Mitsui Chemicals Inc.).

On the surface of the resin film, an inorganic or organic cover film or a hybrid cover film comprising the both may be formed, and the cover film is preferably one with a barrier ability having a vapor permeability (at 25±0.5° C. and at (90±2)% RH) of not more than 0.01 g/(m²·24 h) measured by a method stipulated by JIB K 7129-1992, and more preferably one with a high barrier ability having an oxygen permeability of not more than 10⁻³ ml/(m²·24 hr-MPa) as well as a vapor permeability of not more than 10⁻⁵ g/(m²⁰·24 h), measured by a method stipulated by JIB K 7126-1987.

Any materials capable of preventing penetration of substance such as moisture and oxygen causing degradation of the element are usable for forming the barrier film, and for example, silicon oxide, silicon dioxide and silicon nitride are usable. It is more preferred that the barrier film has a multi-laminated layer structure composed of a layer of the inorganic material and a layer of an organic material for improving fragility of the film. It is preferred that the both layers are alternatively laminated several times though there is no limitation as to the lamination order of the inorganic layer and the organic layer.

The method for forming the barrier film is not specifically limited and, for example, a vacuum deposition method, a spattering method, a reaction spattering method, a molecule beam epitaxy method, a cluster-ion beam method, an ion plating method, a plasma polymerization method, an atmospheric pressure plasma polymerization method, a plasma CVD method, a laser CVD method, a heat CVD method and a coating method are applicable, and the atmospheric pressure plasma polymerization method as described in Japanese Patent O.P.I. Publication No. 2004-68143 is particularly preferred.

As the opaque substrate, for example, a plate of metal such as aluminum and stainless steel, a film or plate of opaque resin and a ceramic substrate are cited.

The external light emission efficiency of the organic electroluminescent element of the invention is preferably not less than 1%, and more preferably not less than 5% at room temperature.

Herein, external quantum yield (%) is represented by the following formula:

External quantum yield (%)=(the number of photons emitted to the exterior of the organic electroluminescent element×100)/(the number of electrons supplied to the organic electroluminescent element)

A hue improving filter such as a color filter may be used in combination or a color conversion filter which can convert from emission light color from an organic EL element to multi-color employing a fluorescent compound may be used in combination. In the case where the color conversion filter, the λmax of the light emitted from the organic EL element is preferably not more than 480 nm.

### <<Sealing>>

As the sealing means used in the invention, there is a method in which adhesion of a sealing member to an electrode and a substrate is carried out employing an adhesive agent.

The sealing member is formed so as to cover the displaying area of the organic EL element and may have a flat plate shape or a concave plate shape, and the transparency and the electric insulation property thereof are not specifically limited.

Typical examples of the sealing member include a glass plate, a polymer plate, a polymer film, a metal plate and a metal film. As the glass plate, a plate of soda-lime glass, barium strontium-containing glass, lead glass, aluminosilicate glass, boron silicate glass, barium boron silicate glass or quartz is usable.

As the polymer plate, a plate of polycarbonate, acryl resin, polyethylene terephthalate, polyether sulfide or polysulfone is usable. As the metal plate, a plate composed of one or more kinds of metals selected from stainless steel, iron, copper, aluminum, magnesium, nickel, zinc, chromium, titanium, molybdenum, silicon, germanium, tantalum and their alloy is cited.

In the invention, the polymer film and the metal film are preferably used since the element can be made thinner.

The polymer film is one having an oxygen permeability of not more than 1×10⁻³ ml/(m²·24 hr·atm), measured by a method stipulated by JIS K 7126-1987, and a vapor permeability (at 25±0.5° C. and at (90±2)% RH) of not more than 1×10⁻³ g/(m²·24 h), measured by a method stipulated by JIS K 7129-1992.

For making the sealing material into the concave shape, a sandblast treatment and a chemical etching treatment are used

As the adhesive agent, there are mentioned a photo-curable or thermo-curable adhesive agent containing a reactive vinyl group such as an acryl type oligomer or a methacryl type oligomer, and a moisture curable adhesive agent such as 2-cyanoacrylate. Examples of the adhesive agent include an epoxy type thermally and chemically (two liquid type) curable adhesive agents, a hot-melt type polyamide, polyester or polyolefin adhesive agents and a cationic curable type UV curable epoxy adhesive agent.

The organic EL element is degraded by heat treatment in some cases, and therefore, an adhesive agent capable of being cured within the temperature range of from room temperature to 80° C. is preferred. A drying agent may be dispersed in the adhesive agent. Coating of the adhesive agent onto the adhering portion may be performed by a dispenser available on the market or by printing such as screen printing.

It is preferred that a layer comprising an inorganic or organic material is formed as a sealing layer on an electrode placed on the side facing a substrate an organic layer provided between the substrate and the electrode, so as to cover the electrode and the organic layer and contact with the substrate. In such a case, a material for forming the sealing layer may be a material having a function to inhibit permeation of a substance such as water and oxygen causing degradation of the element, and for example, silicon oxide, silicon dioxide and silicon nitride are usable. The sealing layer preferably has a multi-laminated layer structure composed of a layer of the inorganic material and a layer of an organic material for improving fragility of the layer.

The method for forming the layer is not specifically limited and, for example, a vacuum deposition method, a spattering method, a reaction spattering method, a molecule beam epitaxy method, a cluster-ion beam method, an ion plating method, a plasma polymerization method, an atmospheric pressure plasma polymerization method, a plasma CVD method, a laser CVD method, a heat CVD method and a coating method are applicable.

In the space between the sealing layer and the displaying portion of the organic EL element, an inactive gas such as nitrogen or argon or an inactive liquid such as fluorinated hydrocarbon or silicone oil is preferably injected in the form of gas or liquid phase. The space can be made vacuum. A hygroscopic compound can be enclosed inside.

Examples of the hygroscopic compound include a metal oxide such as sodium oxide, potassium oxide, calcium oxide, barium oxide, magnesium oxide or aluminum oxide; a sulfate such as sodium sulfate, calcium sulfate, magnesium sulfate or cobalt sulfate; a metal halide such as calcium chloride, magnesium chloride, cesium fluoride, tantalum fluoride, cerium bromide, magnesium bromide, barium iodide or magnesium iodide; and a perchlorate such as barium perchlorate or magnesium perchlorate. An anhydride of the sulfate, halide and perchlorate is suitably applicable.

### <<Protection Layer, Protection Plate>>

A protection layer or a protection plate may be provided on the sealing layer formed on the side facing the substrate through the organic layer or outside the sealing layer in order to raise the mechanical strength of the element. Particularly when sealing is carried out by the sealing layer as described above, such a protection layer or plate is preferably provided, since strength of the element is not so high. As materials for the protection layer or plate, the same glass plate, polymer plate, polymer film, metal plate and metal film as those described above to be used for sealing are usable. The polymer film is preferably used from the viewpoint of light weight and thin layer formation property.

### <<Light Extraction>>

It is generally said that, in the organic EL element, light is emitted in a layer whose refractive index (the refractive index is about 1.7 to 2.1) is higher than that of air, and only 15 to 20% of the light emitted in the light emission layer can be extracted. This is because light which enters a boundary (a boundary between a transparent substrate and the atmosphere) at an angle θ larger than a critical angle is totally reflected and cannot be extracted from the element, or because light is totally reflected at a boundary between the transparent substrate and the transparent electrode or between the transparent substrate and the light emission layer, so that the light exits from the side of the element through the transparent electrode or the light emission layer.

As methods to improve the light extraction efficiency, there are a method to form concavity and convexity on the surface of the transparent substrate to prevent total internal reflection at a boundary between the transparent substrate and atmospheric air (see U.S. Pat. No. 4,774,435); a method to provide light focusing properties to the substrate to improve the efficiency (see Japanese Patent O.P.I. Publication No. 63-314795); a method to form a reflection surface on the side of the element (see Japanese Patent O.P.I. Publication No. 1-220394); a method to form a flat layer having an intermediate refractive index between the substrate and the light emission layer to form an anti-reflection layer (see Japanese Patent O.P.I. Publication No. 62-172691); a method to form a flat layer having a low refractive index between the substrate and the light emission layer (see Japanese Patent O.P.I. Publication No. 2001-202827); and a method to form a diffraction lattice at a boundary between any two of the substrate, the transparent electrode and the light emission layer (including a boundary between the substrate and atmospheric air) (see Japanese Patent O.P.I. Publication No. 11-283751).

In the present invention, these methods can be used in combination with the organic electroluminescent element of the present invention. Also, a method of forming a flat layer having a lower refractive index than that of the substrate between the substrate and the light emission layer, or a method of forming a diffraction lattice at a boundary between any of the substrate, transparent electrode and light emission layer (including a boundary between the substrate and the atmosphere) can be preferably used.

In the present invention, an element exhibiting further higher luminance and durability can be obtained by combining these methods.

When a low refractive index medium with a thickness greater than light wavelength is formed between a transparent electrode and a transparent substrate, the extraction efficiency of light, which comes out of the transparent electrode, increases, as the refractive index of the medium decreases.

As a low refractive index layer, aerogel, porous silica, magnesium fluoride and fluorine-containing polymer are cited, for example. Since refractive index of the transparent substrate is generally 1.5 to 1.7, the refractive index of the low refractive index layer is preferably 1.5 or less and more preferably 1.35 or less.

The thickness of a low refractive index medium is preferably twice or more of the wavelength of the light in the medium, because when the thickness of the low refractive index medium is such that the electromagnetic wave exuding as an evanescent wave enters the transparent substrate, the effect of the low refractive index layer is reduced.

A method to provide a diffraction lattice at a boundary where the total internal reflection occurs or in some of the media has feature that the effect of enhancing the light extraction efficiency increases. The intension of this method is to provide a diffraction lattice at a boundary between any of the layers or in any of the mediums (in the transparent substrate or in the transparent electrode) and extract light which cannot exit due to total reflection occurring at a boundary between the layers among lights emitted in the light emission layer, which uses the property of the diffraction lattice that can change the direction of light to a specific direction different from the direction of reflection due to so-called Bragg diffraction such as primary diffraction or secondary diffraction.

It is preferred that the diffraction lattice to be provided has a two-dimensional periodic refractive index. This is because, since light generated in the light emission layer is emitted randomly in all the directions, only the light proceeding in a specific direction can be diffracted when a general one-dimensional diffraction lattice having a periodic refractive index distribution only in a specific direction is used, which does not greatly increase the light extraction efficiency.

However, by using a diffraction lattice having a two-dimensional refractive index distribution, the light proceeding in all the directions can be diffracted, whereby the light extraction efficiency is increased.

The diffraction lattice may be provided at a boundary between any of the layers on in any of the mediums (in the transparent substrate or in the transparent electrode), but it is preferably provided in the vicinity of the organic light emission layer where the light is emitted.

The period of the diffraction lattice is preferably about ½ to 3 times the wavelength of light in the medium.

The array of the diffraction lattice is preferably two-dimensionally repeated as in the shape of a square lattice, a triangular lattice, or a honeycomb lattice.

### <<Light Focusing Sheet>>

In the organic EL element of the invention, luminance in a specified direction can be increased, for example, by providing a structure in the form of a micro-lens array on the light extraction side surface of the substrate or in combination with a so-called light focusing sheet, whereby light is focused in a specific direction, for example, in the front direction to the light emitting plane of the element.

As an example of a micro-lens array, there is one in which quadrangular pyramids having a side of 30 μm and having a vertex angle of 90° are two-dimensionally arranged on the light extraction side surface of the substrate. The side of the quadrangular pyramids is preferably from 10 to 100 μm. When the length of the side is shorter than the above range, the light is colored due to the effect of diffraction, while when it is longer than the above range, it becomes unfavorably thick.

As the light focusing sheet, one practically applied for an LED backlight of a liquid crystal display is applicable. Examples of such a sheet include a brightness enhancing film (BEF) produced by SUMITOMO 3M Inc.

As the shape of a prism sheet, there may be included one in which a triangle-shaped strip having a vertex angle of 90° and a pitch of 50 μm provided on a substrate, one having round apexes, one having a randomly changed pitch or other ones.

In order to control an emission angle of light emitted from the light emitting element, a light diffusion plate or film may be used in combination with the light focusing sheet. For example, a diffusion film (Light-Up), produced by KIMOTO Co., Ltd., can be used

### <<Preparation Method of Organic EL Element>>

As one example of the preparation method of the organic EL element of the invention, an organic EL element having the constitution, Anode/Hole injecting layer/Hole transporting layer/Light emission layer/Electron transporting layer/Electron injecting layer/Cathode will be explained below.

A thin layer of a desired electrode material such as a material of the anode is formed on a suitable substrate by a deposition or sputtering method to prepare an anode having a thickness of not more than 1 μm, and preferably from 10 to 200 nm.

Then, organic compound thin layers such as a hole injecting layer, a hole transporting layer, a light emission layer, a hole blocking layer and an electron injecting layer, which constitute the organic EL element, are formed on the resulting anode.

As methods for formation of these layers, there are a vapor deposition method and a wet process method (such as a spin coating method, a casting method, an ink jet method or a printing method) as described above. A spin coating method, an ink jet method and a printing method are preferred, since a uniform layer is likely to be formed and a pinhole is difficult to be formed.

As liquid mediums in which materials for the organic EL element of the invention are dissolved or dispersed, there may be employed ketones such as methyl ethyl ketone or cyclohexanone; aliphatic acid esters such as ethyl acetate; halogenated hydrocarbons such as dichlorobenzene; aromatic hydrocarbons such as toluene, xylene, mesitylene, and cyclohexylbenzene; aliphatic hydrocarbons such as cyclohexane, decaline and dodecane; and organic solvents such as DMF and DMSO.

Further, the dispersion can be carried out employing a dispersion method such as an ultrasonic wave dispersion method, a high shearing force dispersion method or a medium dispersion method.

After these layers have been formed, a thin layer comprised of a material for a cathode is formed thereon to prepare a cathode, employing, for example, a deposition method or sputtering method to give a thickness of not more than 1 μm, and preferably from 50 to 200 nm. Thus, a desired organic EL element is obtained.

Further, the organic EL element can be prepared in the reverse order, in which the cathode, the electron transporting layer, the hole blocking layer, the light emission layer, the hole transporting layer, the hole injecting layer, and the anode are formed in that order.

When a direct current voltage, a voltage of 2 to 40 V is applied to the thus obtained multicolor display, setting the anode as a + polarity and the cathode as a − polarity, light emission occurs. An alternating voltage may be applied. The wave shape of the alternating current may be any one.

### <<Use>>

The organic EL element of the invention can be used as a display device, a display, or various light emission sources. Examples of the light emission sources include an illuminating device (a home lamp or a room lamp in a car), a backlight for a watch or a liquid crystal, a light source for boarding advertisement, a signal device, a light source for a photo memory medium, a light source for an electrophotographic copier, a light source for an optical communication instrument, and a light source for an optical sensor, but are not limited thereto. Particularly, it can be effectively used as a backlight for a liquid crystal or a light source for illumination.

In the organic EL element of the invention, patterning may be carried out through a metal mask or according to an ink-jet printing method. The patterning may be carried out only in electrodes, in both electrodes and light emission layer, or in all the layers of the element. Further, the element can be also prepared according to a conventional method.

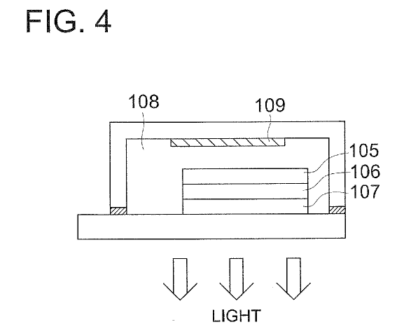

Color of light emitted from the organic EL element of the invention or from the compounds in the invention is specified with color obtained when measurements determined by a spectral radiance luminance meter CS-1000 (produced by Konica Minolta Sensing Co., Ltd.) are applied to the CIE chromaticity coordinates in FIG. 4.16 on page 108 of “Shinpen Shikisai Kagaku Handbook (edited by The Color Science Association of Japan, University of Tokyo Press, 1935).

When the organic EL element of the invention is a white light element, “white” means that when front luminance of a 2° viewing angle is determined via the above method, chromaticity in the CIE 1931 Chromaticity System at 1,000 Cd/m² is in the range of X=0.33±0.07 and Y=0.33±0.07.

### EXAMPLES

The present invention will be explained in the following examples, but is not limited thereto. The chemical structures of compounds used in the examples will be shown below.

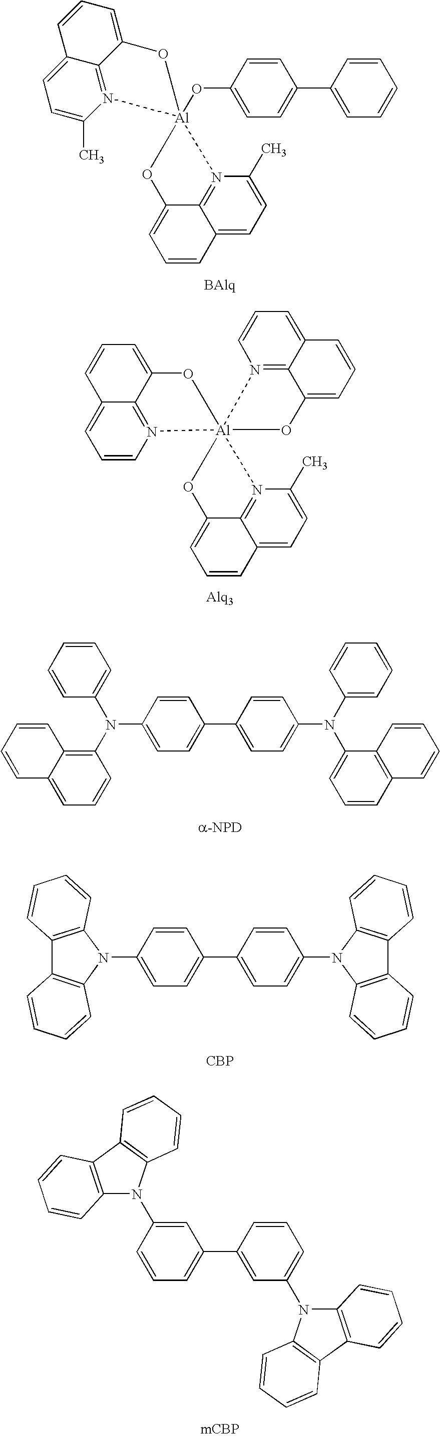

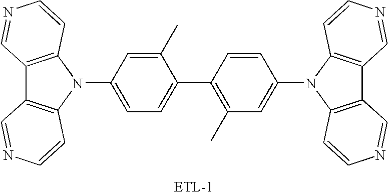

### Example 1

### Preparation of Organic EL Element Sample 1-1

A substrate (NA45, manufactured by NH Technoglass Co., Ltd.), which is composed of a glass plate (100 mm×100 mm×1.1 mm) and a 100 nm ITO (indium tin oxide) layer as an anode, was subjected to patterning treatment. Then the resulting transparent substrate having the ITO transparent electrode was subjected to ultrasonic washing in isopropyl alcohol, dried by a dry nitrogen gas and subjected to UV-ozone cleaning for 5 minutes.

The thus obtained transparent substrate was fixed on a substrate holder of a vacuum deposition apparatus available on the market. Further, 200 mg of α-NPD were put in a first resistive heating molybdenum boat, 200 mg of m-CBP as a host compound were put in a second resistive heating molybdenum boat, 200 mg of ETL-1 were put in a third resistive heating molybdenum boat, 100 mg of Exemplified compound A-97 were put in a fourth resistive heating molybdenum boat, and 200 mg of Alq₃ were put in a fifth resistive heating molybdenum boat. The resulting boats were placed in the vacuum deposition apparatus.

Subsequently, pressure in the vacuum tank was reduced to 4×10⁻⁴ Pa. Then, the boat carrying α-NPD being heated by supplying an electric current to the boat, α-NPD was deposited onto the transparent substrate at a depositing speed of 0.1 nm/sec to form a hole transporting layer with a thickness of 40 nm.

After that, the boat carrying m-CBP and the boat carrying Exemplified compound (1) being heated by supplying an electric current to both boats, m-CBP at a depositing speed of 0.2 nm/sec and Exemplified compound (1) at a depositing speed of 0.012 nm/sec were co-deposited onto the resulting hole transporting layer to form a light emission layer with a thickness of 40 nm. The temperature of the substrate at the time of the deposition was room temperature.

Subsequently, the boat carrying ETL-1 being heated by supplying an electric current to the boat, ETL was deposited onto the resulting light emission layer at a depositing speed of 0.1 nm/sec to form a hole blocking layer with a thickness of 10 nm.

Further, the boat carrying Alqₐ being heated by supplying an electric current to the boat, Alqₐ was deposited onto the resulting hole blocking layer at a depositing speed of 0.1 nm/sec to form an electron transporting layer with a thickness of 40 nm. The temperature of the substrate at the time of the deposition was room temperature.

After that, a 0.5 nm thick lithium fluoride layer and a 110 nm thick aluminum layer were deposited on the resulting material to form a cathode. Thus, organic EL element sample 1-1 was prepared.

The non-light-emitting face of each organic EL element sample was covered with a glass case, and a sealing glass plate having a thickness of 300 μm was piled as a sealing substrate on the cathode so as to be contacted with the transparent substrate, an epoxy type photocurable adhesive, Laxtruck LC0629B (manufactured by Toa Gousei Co., Ltd.) being applied as a sealing material onto the periphery of the glass plate, and then the adhesive was cured by UV ray irradiation from the glass plate to seal. Thus, an illuminating device as shown in FIG. 3 or 4 was prepared and evaluated.

FIG. 3 shows a schematic drawing of an illuminating device. Organic EL element 101 is covered with a glass cover 102. (The sealing of the glass cover was carried out in a globe box filled with nitrogen gas (highly purified nitrogen gas having a purity of 99.999% or more) so that the organic EL element 101 did not contact atmospheric air.)

FIG. 4 is a sectional view of an illuminating device. In FIG. 4, numerical No. 105 is a cathode, numerical No. 106 is an organic EL layer, and numerical No. 107 is a glass substrate with a transparent electrode. In the inside of the glass cover 102, nitrogen gas 108 is introduced and a water-trapping agent 109 is placed.

<<Preparation of Organic EL Element Samples 1-2 through 1-13>>

Organic EL element samples 1-2 through 1-13 were prepared in the same manner as organic EL element sample 1-1 above, except that the emission host and/or the emission dopant were changed to those as shown in Table 1.

<<Evaluation of Organic EL Element Samples 1-1 through 1-13>>

The organic EL element samples 1-1 through 1-13 obtained above were evaluated according to the following method. The results are shown in Table 1.

### (External Quantum Efficiency)

Electric current of 2.5 mA/cm² being supplied to each sample at 23° C. in an atmosphere of a dry nitrogen gas, external quantum efficiency (%) of each sample was measured. The external quantum efficiency (%) was measured employing a spectral radiance luminance meter CS-1000 (produced by Minolta Sensing, Inc.).

### (Lifetime)

when electric current of 2.5 mA/cm² was supplied to each sample, time required to reduce to half of luminance (initial luminance) at the beginning of emission was determined as a half-life period (τ^{0.5}), and evaluated as a measure of lifetime. The luminance was measured employing a spectral radiance luminance meter CS-1000 (produced by Konica Minolta Sensing Co., Ltd.).

### (Color of Emission Light)

When a constant electric current of 2.5 mA/cm² was supplied to each sample at room temperature, color of emission light was visually observed.

### (Storage Stability)

Each organic EL element sample was stored at 85° C. for 24 hours. The resulting sample being supplied with an electric current of 2.5 mA/cm² to emit light, luminance of the emission light was measured. Storage stability was expressed in terms of a relative ratio of luminance after storage to that before storage.

The results are shown in Table 1.

Lifetime and external quantum efficiency in Table 1 were expressed by a relative value when those of organic EL element sample 1-1 were set at 100.

TABLE 1

| | | | | | | | External | | | |
|---|---|---|---|---|---|---|---|---|---|---|
| Sample | | | Tg | T1 | HOMO | LUMO | Quantum | Luminescence | | Re- |
| No. | Host | Dopant | (° C.) | (ev) | (eV) | (eV) | Efficiency | Lifetime | Stability | marks |
| 1-1 | mCBP | A-97 | 92 | 2.83 | −5.45 | −1.33 | 100 | 100 | 55 | Comp. |
| 1-2 | CBP | A-97 | 109 | 2.66 | −5.29 | −1.35 | 81 | 102 | 43 | Comp. |
| 1-3 | 1-2 | A-97 | 113 | 2.93 | — | — | 120 | 145 | 98 | Inv. |
| 1-4 | 1-11 | A-97 | 166 | 2.83 | −5.34 | −1.28 | 115 | 130 | 97 | Inv. |
| 1-5 | 1-10 | A-97 | 132 | 2.79 | −5.27 | −1.44 | 125 | 160 | 96 | Inv. |
| 1-6 | 1-3 | A-97 | 169 | 2.98 | −5.43 | −1.29 | 109 | 142 | 95 | Inv. |
| 1-7 | 1-16 | A-97 | 123 | 2.84 | −5.44 | −1.17 | 113 | 151 | 94 | Inv. |
| 1-8 | 1-36 | A-97 | 133 | 2.78 | −5.39 | −1.29 | 108 | 132 | 97 | Inv. |
| 1-9 | 1-27 | A-97 | 180 | 2.78 | −5.51 | −1.47 | 101 | 115 | 93 | Inv. |
| 1-10 | 1-50 | A-97 | 140 | 2.97 | −5.62 | −1.61 | 102 | 123 | 98 | Inv. |
| 1-11 | 1-49 | A-97 | 122 | 2.98 | −5.38 | −1.44 | 107 | 131 | 97 | Inv. |
| 1-12 | CBP | Ir-12 | 109 | 2.66 | −5.29 | −1.35 | 79 | 20 | 89 | Comp. |
| 1-13 | mCBP | Ir-12 | 92 | 2.83 | −5.45 | −1.33 | 98 | 15 | 85 | Comp. |

Comp.: Comparative, Inv.: Inventive

As is apparent from Table 1 above, inventive organic EL element samples provide high external quantum efficiency and minimize lowering of luminance after storage at 85° C., as compared with comparative organic EL element samples.

### Example 2

### Preparation of Organic EL Element Samples 2-1 Through 2-13

Organic EL element samples 2-1 through 2-13 were prepared in the same manner as organic EL element sample 1-1 above, except that BAlq was used instead of ETL-1 used in the hole blocking layer, and the host and/or the dopant were changed to those as shown in Table 2.

Each of the resulting organic EL element samples was evaluated for External quantum efficiency and storage stability.

TABLE 2

| Sample | | | External Quantum | Storage | Re- |
|---|---|---|---|---|---|
| No. | Host | Dopant | Efficiency | Stability | marks |
| 2-1 | mCBP | A-81 | 100 | 55 | Comp. |
| 2-2 | mCBP | A-205 | 81 | 43 | Comp. |
| 2-3 | 1-10 | A-81 | 120 | 98 | Inv. |
| 2-4 | 1-10 | A-205 | 115 | 97 | Inv. |
| 2-5 | 1-10 | A-97 | 125 | 96 | Inv. |
| 2-6 | 1-10 | B-15 | 109 | 95 | Inv. |
| 2-7 | 1-10 | C-5 | 113 | 94 | Inv. |
| 2-8 | 1-11 | D-3 | 108 | 97 | Inv. |
| 2-9 | 1-11 | A175 | 101 | 93 | Inv. |
| 2-10 | 1-11 | C215 | 102 | 98 | Inv. |
| 2-11 | 1-11 | A-44 | 107 | 97 | Inv. |
| 2-12 | 1-36 | A-81 | 79 | 89 | Inv. |
| 2-13 | 1-36 | A-205 | 98 | 85 | Inv. |

Comp.: Comparative, Inv.: Inventive

As is apparent from Table 2 above, inventive organic EL element samples provide high external quantum efficiency and good storage stability (minimize lowering of luminance after storage at 85° C.), as compared with comparative organic EL element samples.

### Example 3

### Preparation of Full Color Image Display

### (Preparation of Blue Light Emission Element)

Organic EL element sample 1-10 in Example 1 was used as a blue light emission element sample.

### (Preparation of Green Light Emission Element)

Organic EL element sample was prepared in the same manner as in organic EL element sample 1-1 of Example 1, except that Ir-1 was used instead of Exemplified compound A-97, and was used as a green light emission element sample.

### (Preparation of Red Light Emission Element)

Organic EL element sample was prepared in the same manner as in organic EL element sample 1-4 of Example 2, except that Ir-9 was used instead of Exemplified compound A-97, and was used as a red light emission element.

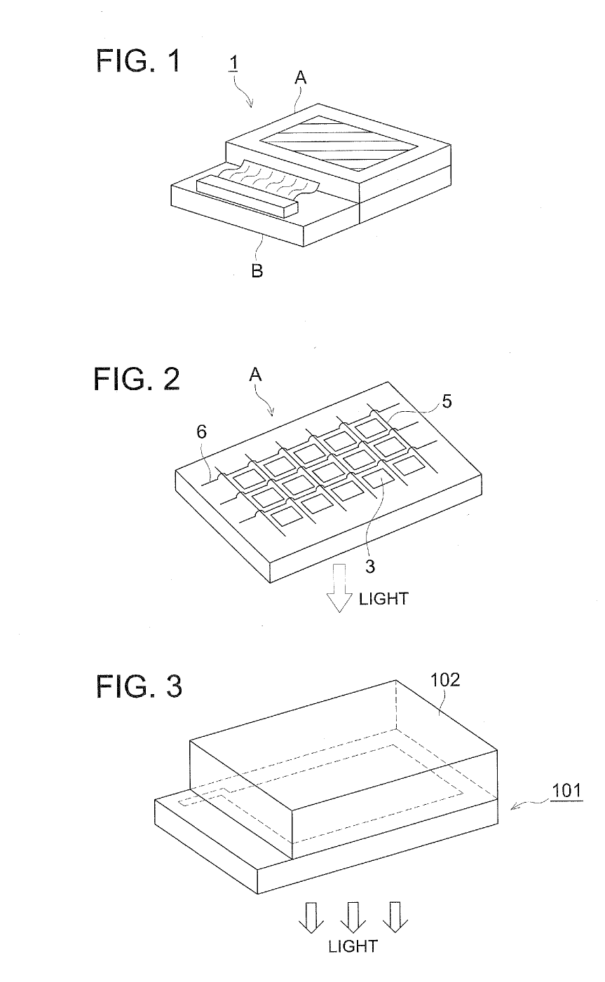

The red, green and blue light emission organic EL element samples prepared above were provided side by side on the same substrate. Thus, a full color image display according to an active matrix method was obtained which had a structure as shown in FIG. 1. FIG. 2 is a schematic drawing of a display section A of the full color image display prepared above.

The display section comprises a base plate, and provided thereon, plural pixels 3 (including blue light emission pixels, green light emission pixels, and red light emission pixels) and a wiring section including plural scanning lines 5 and plural data lines 6. The plural scanning lines 5 and plural data lines 6 each are composed of electroconductive material. The plural scanning lines 5 and plural data lines 6 were crossed with each other at a right angle, and connected with the pixels 3 at the crossed points (not illustrated in detail).

Each of the plural pixels 3, which comprise an organic EL element corresponding to the respective color, a switching transistor as an active element, and a driving transistor, is driven according to an active matrix system. The plural pixels 3, when scanning signal is applied from the scanning lines 5, receives the image data signal from the data lines 6, and emits light corresponding to the image data received. Thus, a full color image display is prepared in which a red light emission pixel, a green light emission pixel, and a blue light emission pixel each are suitably arranged.

A full color clear moving image with high luminance and high durability was obtained by driving the full color image display prepared above.

### Example 4

### Preparation of White Light Emission Element and White Light Illuminating Device

An electrode pattern of 20 mm×20 mm was formed on the transparent electrode substrate of Example 1. An α-NPD layer with a thickness of 25 nm was formed as a hole injecting/transporting layer on the resulting electrode in the same manner as in Example 1. After that, electric current was supplied to the boat carrying H-1, the boat carrying Exemplified compound A-97 and a boat carrying Ir-9, respectively, so that the deposition speed ratio of emission host CBP, emission dopant, Exemplified compound A-97 and Ir-9 was 100:5:0.6, whereby a light emission layer with a thickness of 30 nm was formed as a deposition layer.

subsequently, a hole blocking layer of BAlq with a thickness of 10 nm was formed and then, an electron transporting layer of Alqₐ with a thickness of 40 nm was formed.

Successively, a square mask made of stainless steel having the same shape as the transparent electrode and having a hole was placed on the electron transporting layer in the same manner as in Example 1. After that, a 0.5 nm thick lithium fluoride layer was deposited to form a cathode buffering layer and a 150 nm thick aluminum layer was deposited to form a cathode.

The resulting element was provided with a sealing can having the same structure as Example 1 in the same manner as in Example 1. Thus, a flat lamp, as shown in FIG. 3 or 4, was obtained. When electric current was applied to the resulting flat lamp, white light was emitted, and it has proved that the flat lamp can be employed as an illuminating device.

### Example 5

### Preparation of White Light Emission Element and White Light Illuminating Device

A substrate (NA45, manufactured by NE Technoglass Co., Ltd.), which is composed of a glass plate (100 mm×100 mm×1.1 mm) and a 100 nm ITO (indium tin oxide) layer as an anode, was subjected to patterning treatment. Then the resulting transparent substrate having the ITO transparent electrode was subjected to ultrasonic washing in isopropyl alcohol, dried by a dry nitrogen gas and subjected to UV-ozone cleaning for 5 minutes.

A solution, obtained by diluting poly(3,4-ethylenedioxythiophene)-polystyrene sulfonate (PEDOT/PSS, Baytron P Al 40803 produced by Bayer Co., Ltd.) with pure water to 70%, was applied onto this transparent substrate at 3000 rpm for 30 seconds according to a spin coating method, and dried at 200° C. for one hour to form a first hole transporting layer with a thickness of 30 nm.

The resulting-material was placed under nitrogen atmosphere, and a solution, in which 50 mg of Compound A was dissolved in 10 ml of toluene, was applied onto the resulting first hole transporting layer at 1000 rpm for 30 seconds according to a spin coating method, and subjected to UV irradiation for 180 seconds to undergo photopolymerization and cross-linking reaction, vacuum-dried at 60° C. for one hour to form a second hole transporting layer.

A solution, in which 60 mg of H-5, 3.0 g of Exemplified compound P-201 and 3.0 mg of Ir-9 were dissolved in 6 ml of toluene, was applied onto the second hole transporting layer at 1000 rpm for 30 seconds according to a spin coating method to form a light emission layer.

Successively, the resulting material was fixed on a holder of a vacuum deposition apparatus. Further, 200 mg of BAlq were put in a resistive heating molybdenum boat and placed in the vacuum deposition apparatus.

Subsequently, pressure in the vacuum tank was reduced to 4×10⁻⁴ Pa. Then, the boat carrying BAlq being heated by supplying an electric current, BAlq was deposited onto the resulting light emission layer at a depositing speed of 0.1 nm/sec to form an electron transporting layer with a thickness of 40 nm. During the deposition, the temperature of the substrate was room temperature.

After that, a 0.5 nm thick lithium fluoride layer and a 110 nm thick aluminum layer were deposited on the resulting electron transporting layer to form a cathode. Thus, white light emission organic EL element was prepared.

When electric current was applied to the resulting element, white light was emitted, and it has proved that the element can be employed as an illuminating device.

1. An organic electroluminescent element comprising an anode, a cathode and at least a light emission layer provided between the anode and the cathode, wherein the light emission layer contains a host compound having a glass transition temperature of not less than 110° C. and a phosphorescence emitting metal complex having as a ligand a 6-member aromatic compound condensed with three or more of a 5- or 6-member aromatic ring.

2. The organic electroluminescent element of claim 1, wherein the phosphorescence emitting metal complex has a partial structure represented by any of formulae (1) through (4), 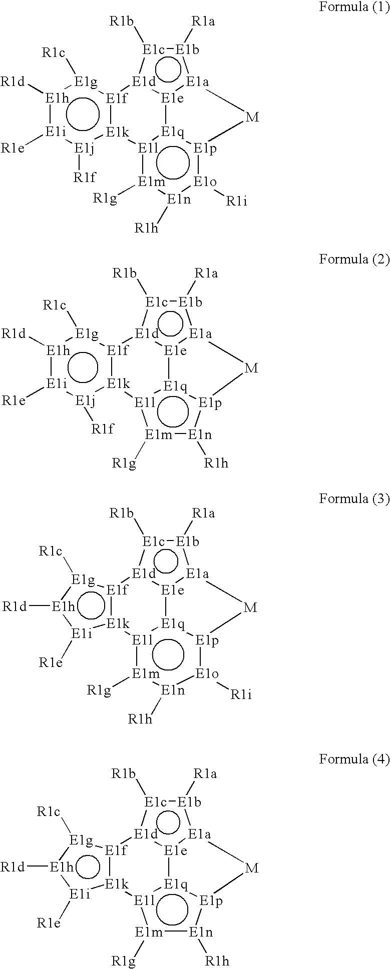
wherein E1a through E1q independently represent a carbon atom or a nitrogen atom; R1a through R1i independently represent a hydrogen atom or a substituent; and M represents a transition metal element belonging to groups 8 to 10 on the periodic table.

3. The organic electroluminescent device of claim 1, wherein the host compound has in one molecule at least three of a partial structure represented by the following formula (a), 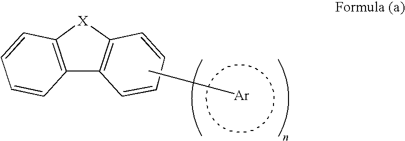
wherein X represents NR′, O, S, CR′R″ or SiR′R″, in which R′ and R″ independently represent a hydrogen atom or a substituent; Ar represents an atomic group necessary to form an aromatic ring; and n represents an integer of from 0 to 8.

4. The organic electroluminescent device of claim 1, wherein the lowest excitation triplet energy of the host compound is not less than 2.75 eV.

5. The organic electroluminescent device of claim 1, wherein the highest occupied molecular orbital (HOMO) energy level of the host compound is not less than −5.6 eV.

6. The organic electroluminescent device of claim 1, wherein the lowest unoccupied molecular orbital (LUMO) energy level of the host compound is not less than −1.45 eV.

7. The organic electroluminescent device of claim 1, wherein M represents platinum or iridium.

8. The organic electroluminescent device of claim 1, wherein the light emission layer is formed employing a wet process.

9. A display comprising the organic electroluminescent device of claim 1.

10. An illuminator comprising the organic electroluminescent device of claim 1.
